(19) United States
(12) Patent Application Publication
(10) Pub. No.: US 2012/0070347 A1
(43) Pub. Date: Mar. 22, 2012

(54) Carbon Conversion System with Integrated Processing Zones

(75) Inventors: Marc Bacon, Stittsville (CA); Andreas Tsangaris, Ottawa (CA)

(73) Assignee: Plasco Energy Group, Inc., Kanata, ON (CA)

(21) Appl. No.: 13/263,326

(22) PCT Filed: Mar. 1, 2011
(86) PCT No.: PCT/CA2011/050123

§ 371 Date: Nov. 17, 2011

Related U.S. Application Data
(60) Provisional application No. 61/309,175, filed on Mar. 1, 2010.
(60) Provisional application No. 61/309,092, filed on Mar. 1, 2010.

(51) Int. Cl. B01J 19/08

(52) U.S. Cl. 422/186.04

(57) ABSTRACT

A Carbon Conversion System having four functional units, each unit comprising one or more zones, wherein the units are integrated to optimize the overall conversion of carbonaceous feedstock into syngas and slag. The processes that occur within each zone of the system can be optimized, for example, by the configuration of each of the units and by managing the conditions that occur within each zone using an integrated control system.

### FIELD OF THE INVENTION

This invention pertains to the field of carbonaceous feedstock gasification and in particular, to a secondary processing system with integrated processing zones for the conversion of a carbonaceous feedstock into a syngas and a slag product.

### BACKGROUND OF THE INVENTION

Gasification is a process that enables the conversion of carbonaceous feedstock, such as municipal solid waste (MSW) or coal, into a combustible gas. The gas can be used to generate electricity, steam or as a basic raw material to produce chemicals and liquid fuels.

Generally, the gasification process consists of feeding carbonaceous feedstock into a heated chamber (the gasifier) along with a controlled and/or limited amount of oxygen and optionally steam.

As the feedstock is heated, water is the first constituent to evolve. As the temperature of the dry feedstock increases, pyrolysis takes place. During pyrolysis the feedstock is thermally decomposed to release hydrogen, carbon monoxide, methane, tars, phenols, and light volatile hydrocarbon gases while the feedstock is converted to char.

Char comprises the residual solids consisting of organic and inorganic materials. After pyrolysis, the char has a higher concentration of carbon than the dry feedstock and may serve as a source of activated carbon. In gasifiers operating at a high temperature (>1,200° C.) or in systems with a high temperature zone, inorganic mineral matter is fused or vitrified to form a molten glass-like substance called slag.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a Carbon Conversion System for the conversion of a carbonaceous feedstock into a syngas and slag product. In accordance with an aspect of the present invention, there is provided a Carbon Conversion System for the conversion of a carbonaceous feedstock into a syngas and slag product, the Carbon Conversion System comprising: (i) a primary processing unit for conversion of carbonaceous feedstock into a primary off-gas and a processed feedstock comprising char, the primary processing unit comprising two or more processing zones, a lateral transfer system, one or more feedstock inputs, wherein the primary processing unit is operatively associated with heating means for delivering heat to the processing zones; (ii) a secondary processing unit adapted to receive the processed feedstock comprising char from the primary processing unit and convert the processed feedstock into a solid residue and a secondary off-gas; (iii) a melting unit operatively associated with the secondary processing unit comprising one or more sources of plasma, the melting unit configured to vitrify the solid residue and optionally generate a melting unit gas; (iv) a reformulating unit for reformulating off-gas to a syngas, the reformulating unit comprising one or more particle separators adapted to reduce particulate load in an input gas, and one or more energy sources configured to provide energy to at least a part of the reformulating unit; and (v) a control system configured to regulate one or more operating parameters of the Carbon Conversion System.

### DESCRIPTION OF THE DRAWINGS

These and other features of the invention will become more apparent in the following detailed description in which reference is made to the appended drawings.

FIG. 1A an illustrative embodiment of the Carbon Conversion System is presented, wherein the system comprises four functional units including a primary processing unit 1, a secondary processing unit 2, a melting unit 3 and a gas reformulating unit 4.

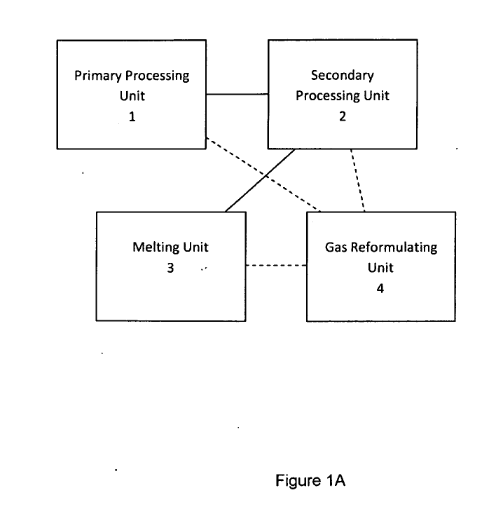

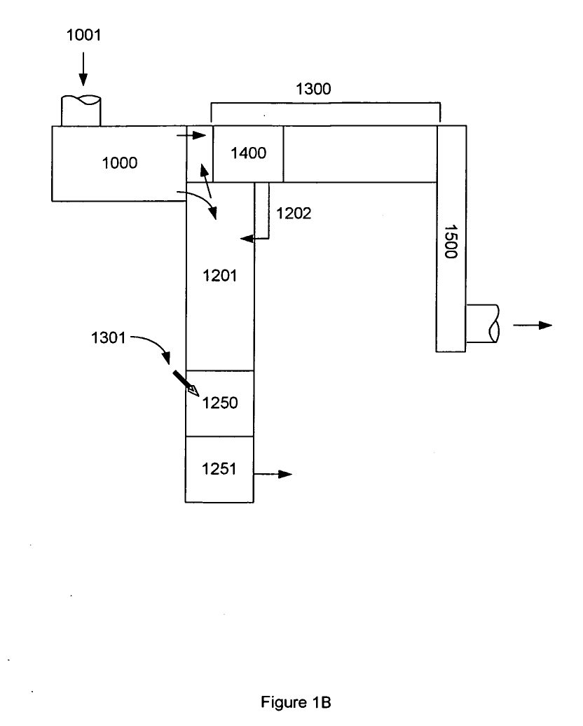

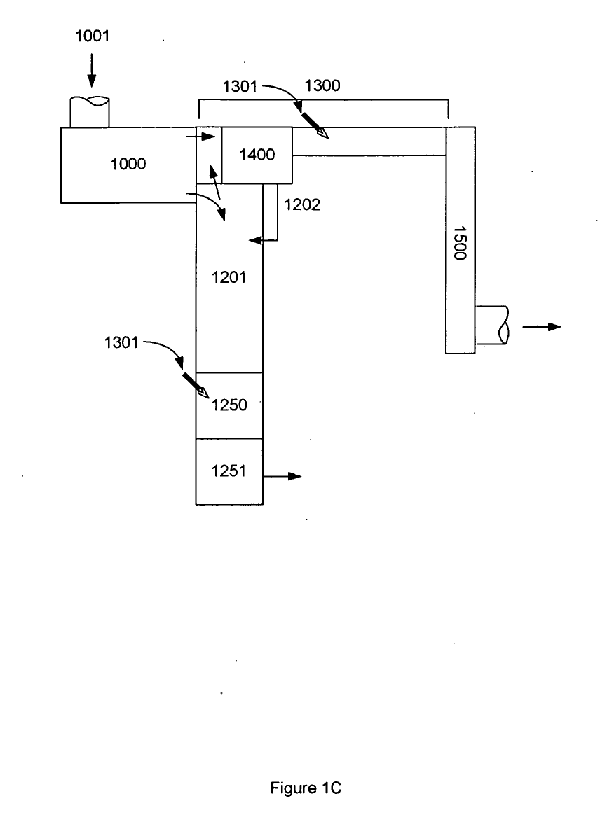

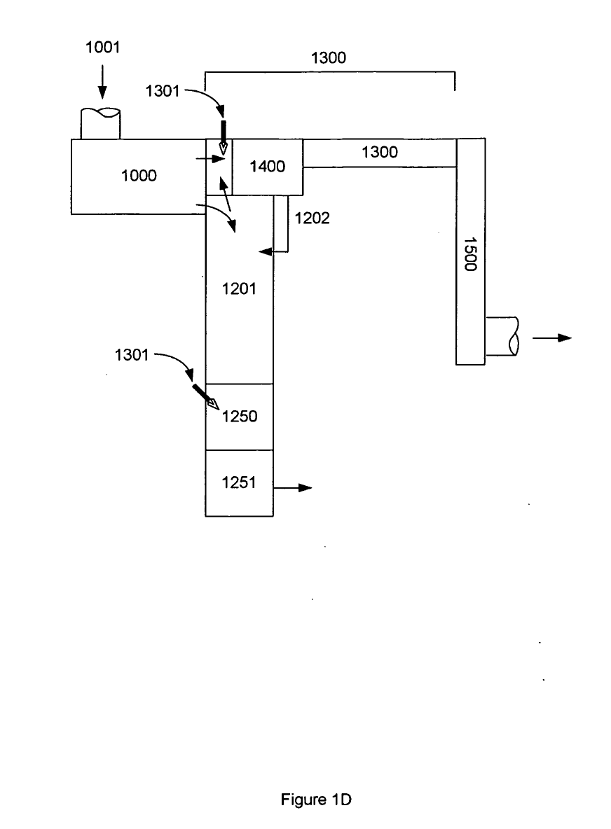

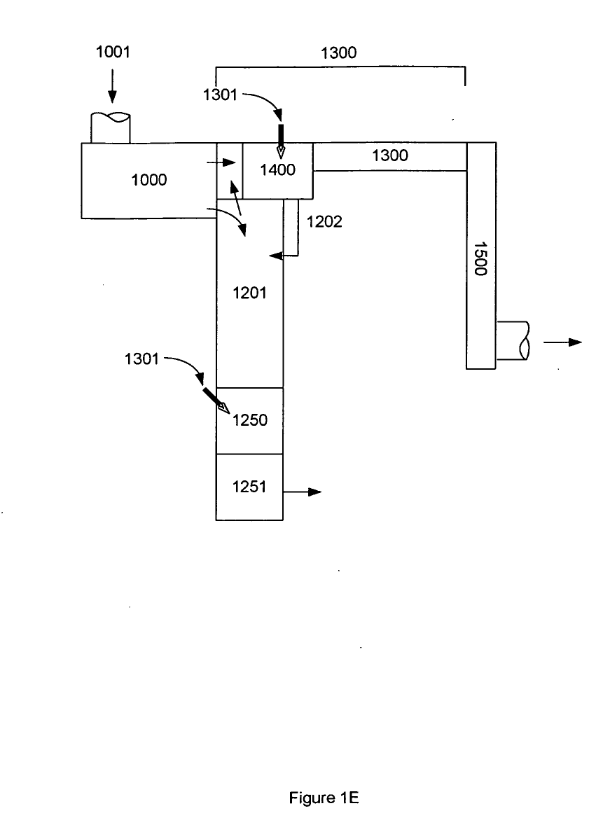

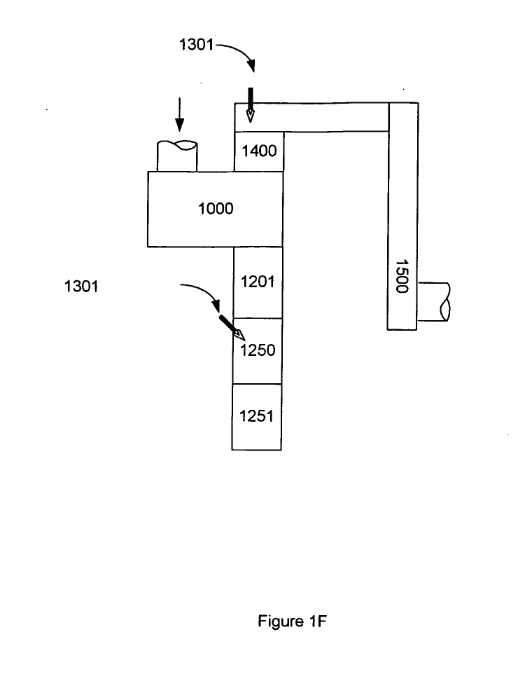

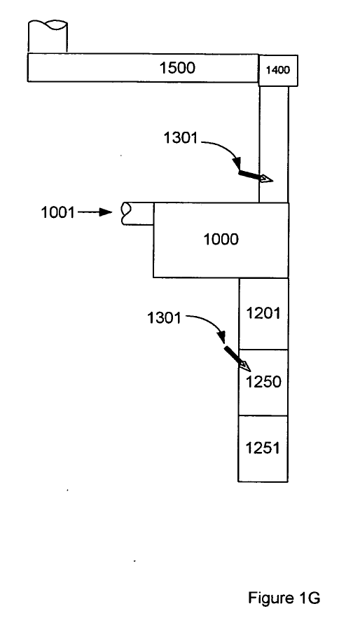

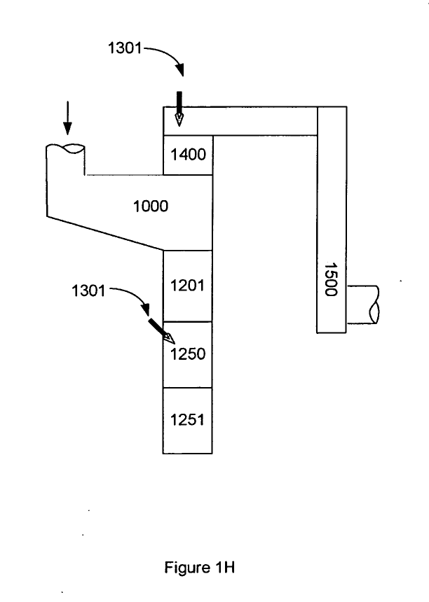

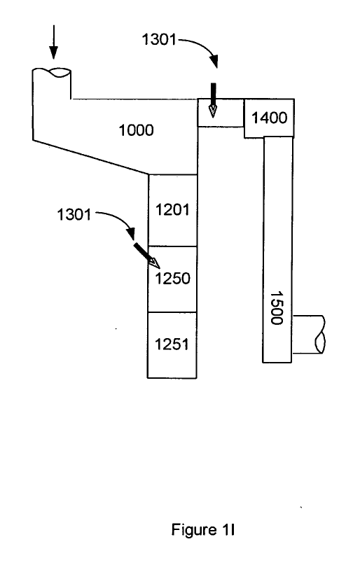

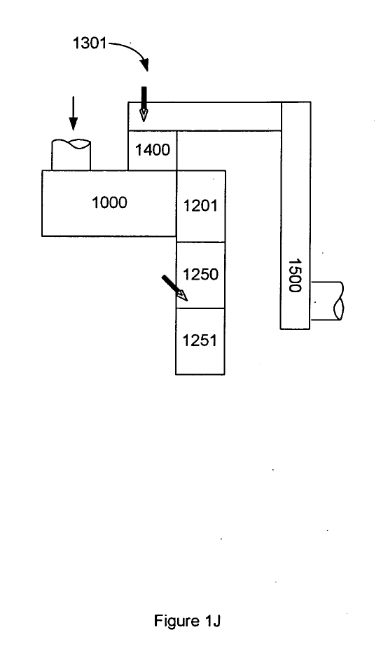

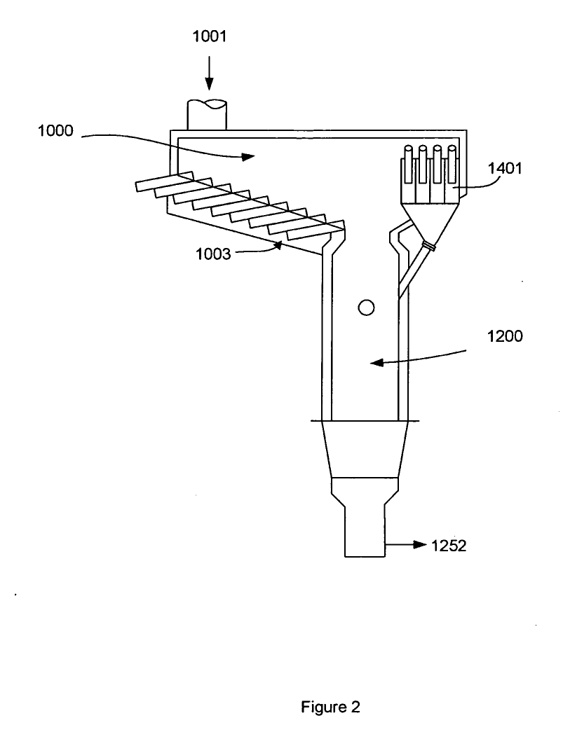

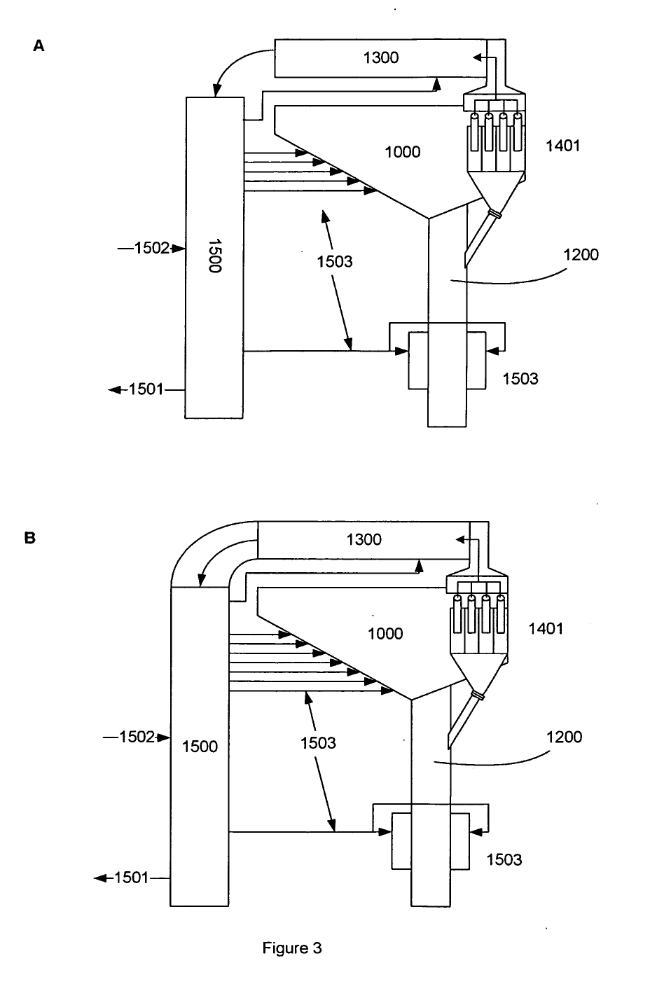

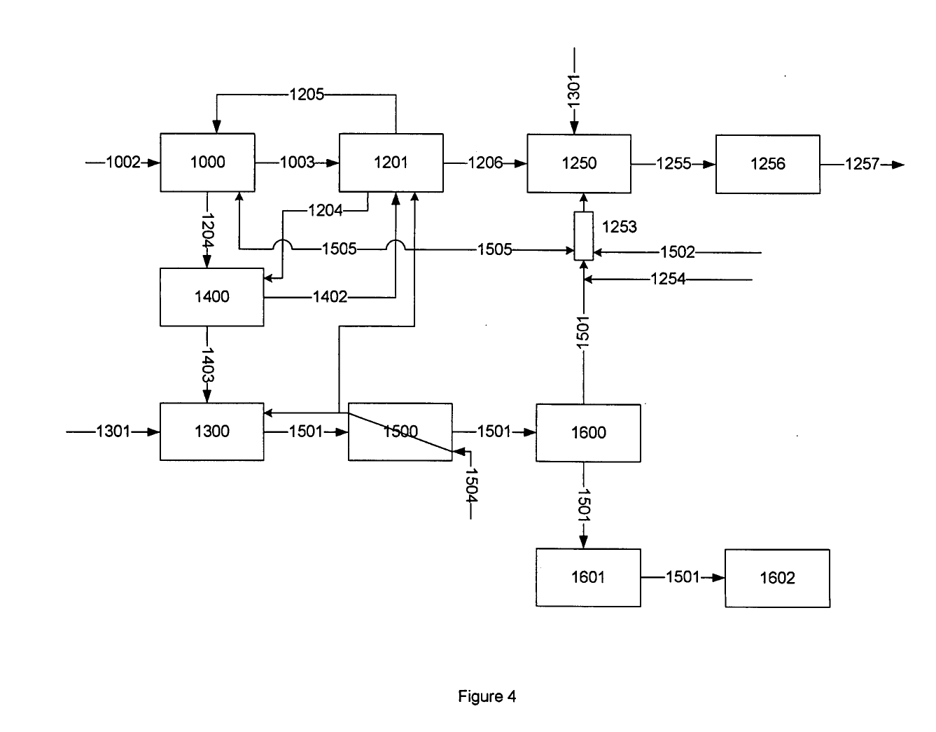

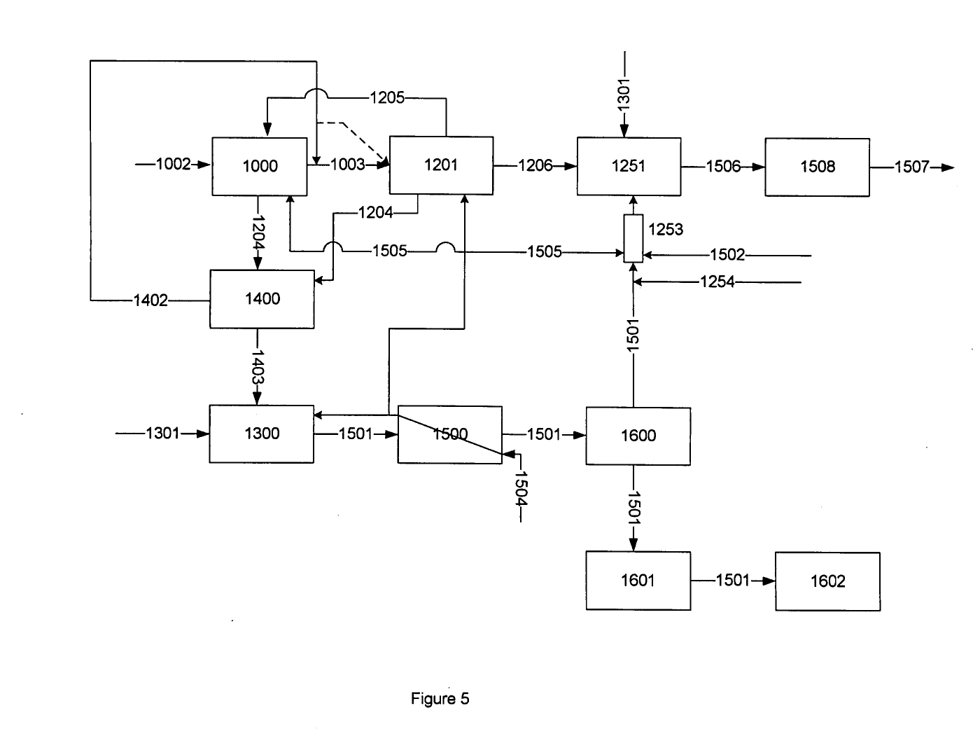

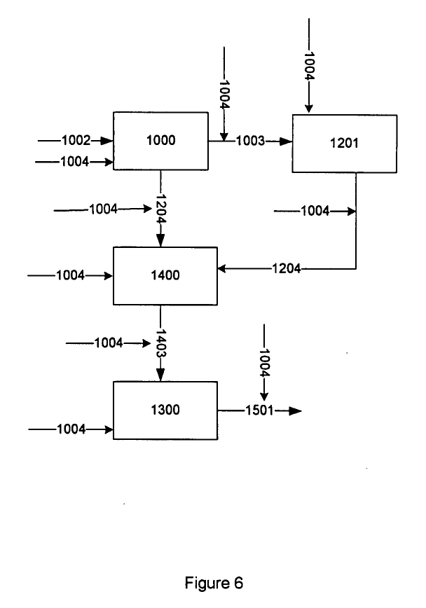

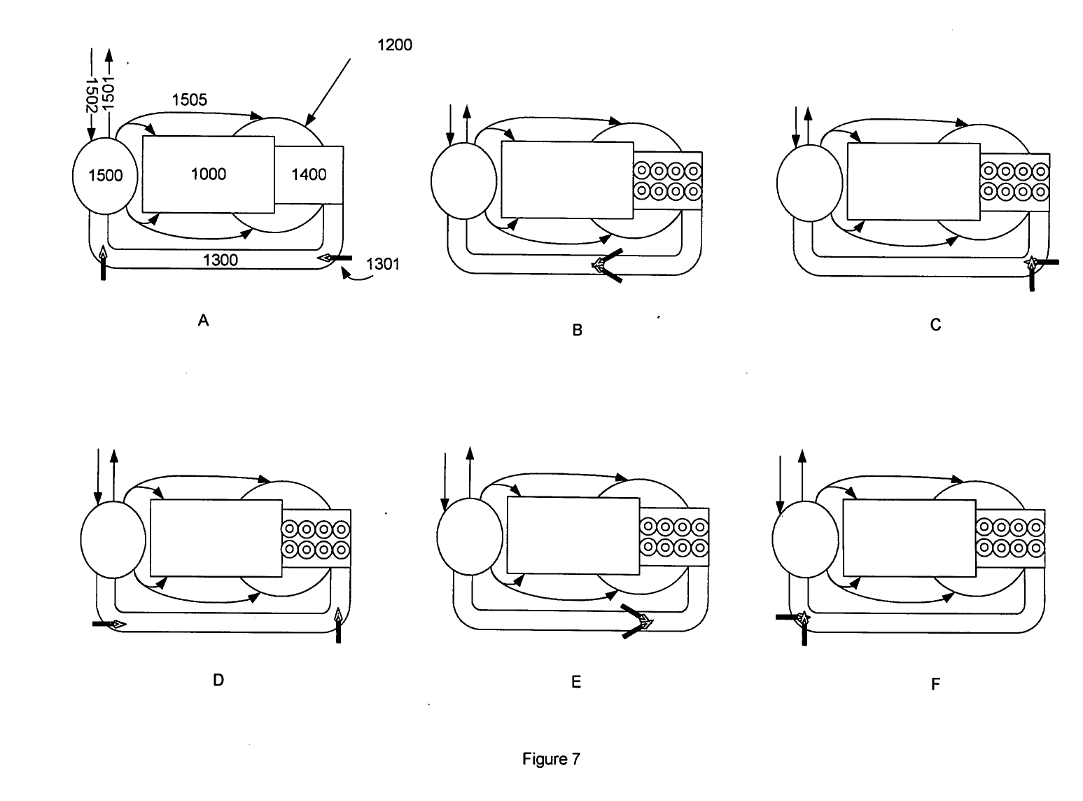

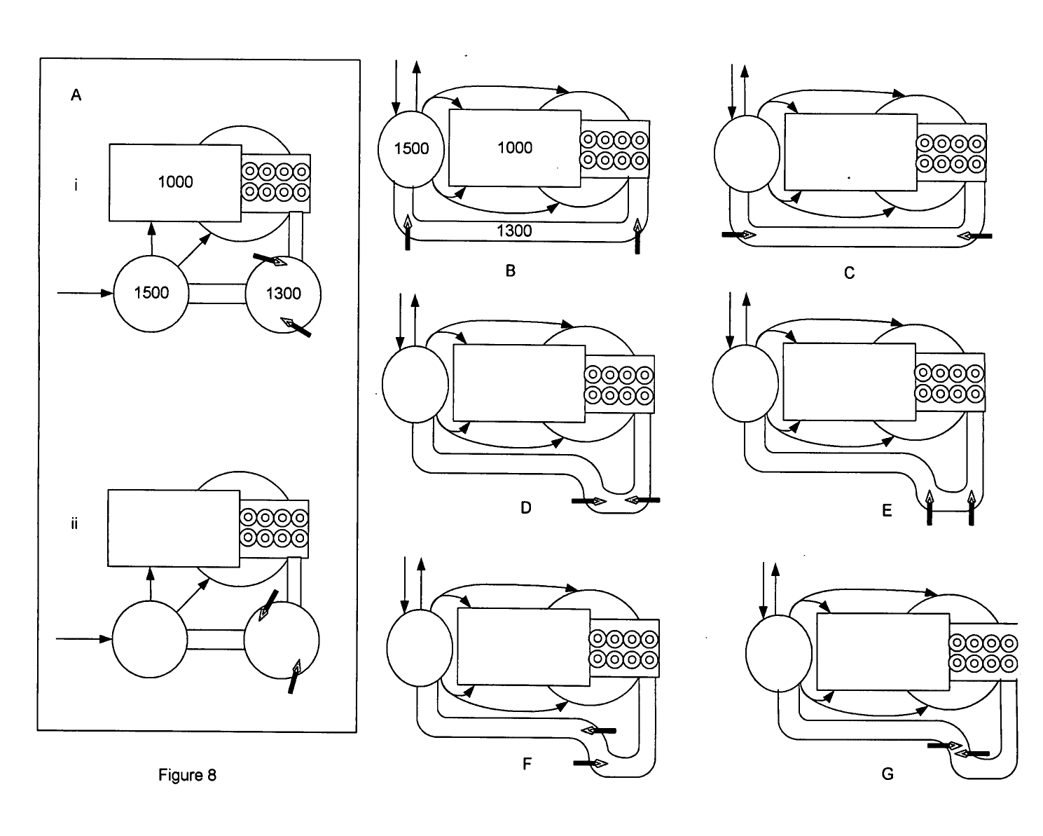

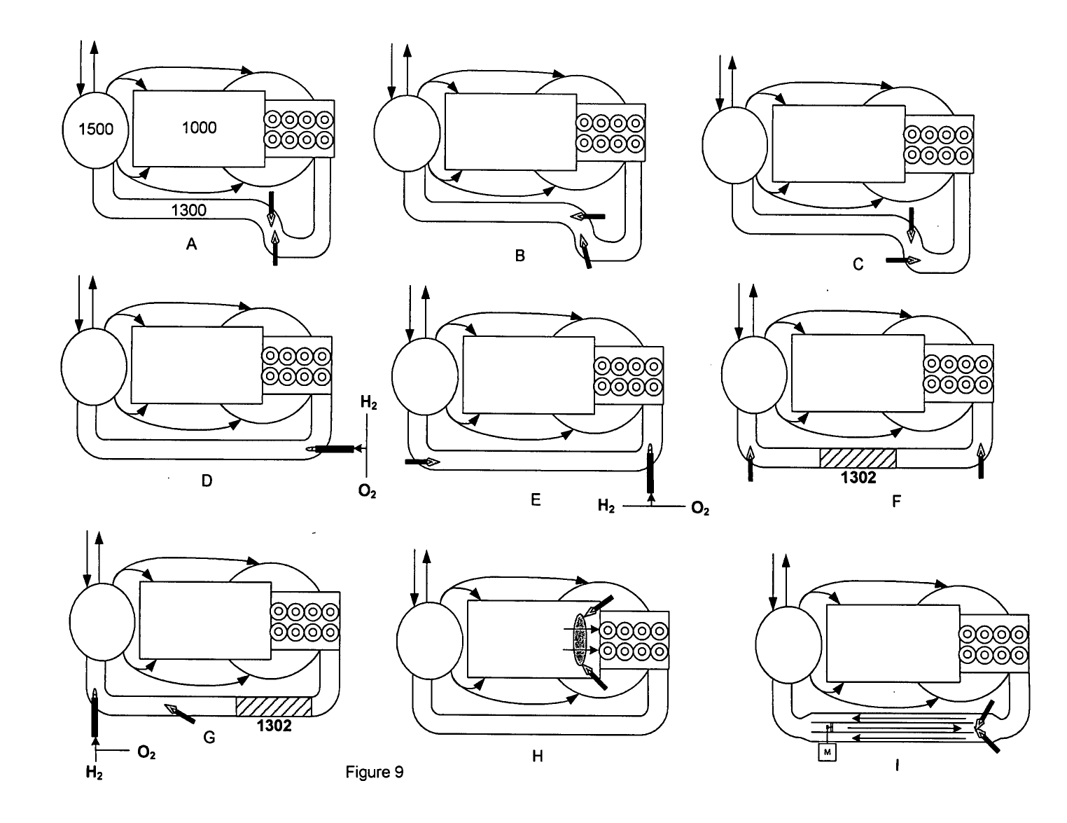

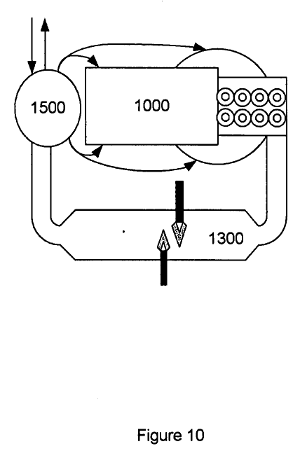

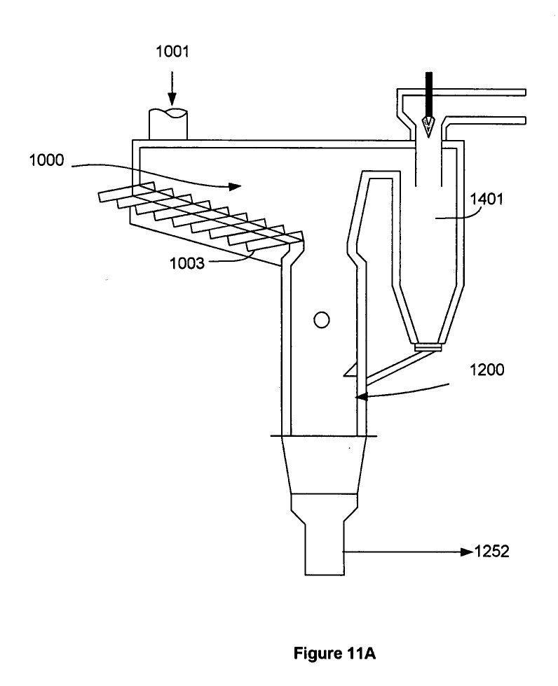

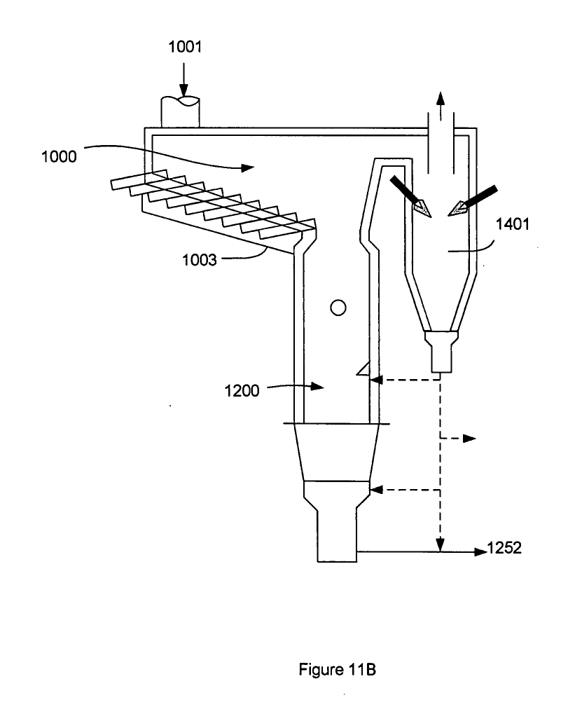

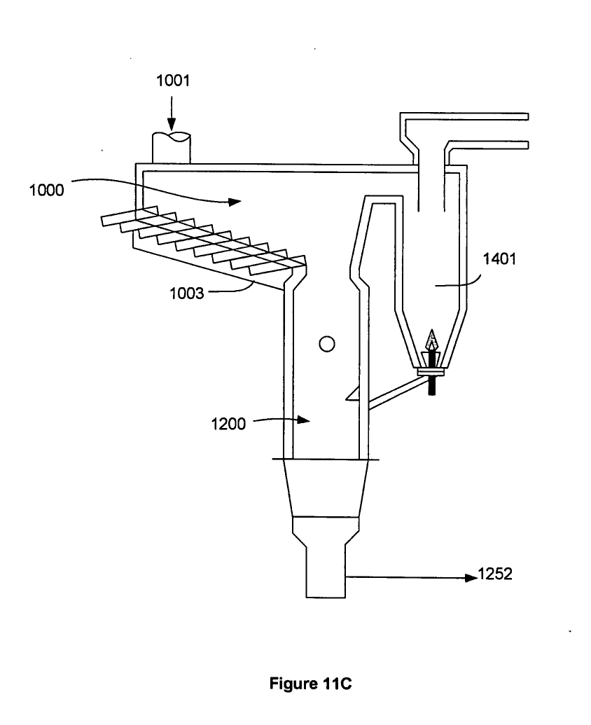

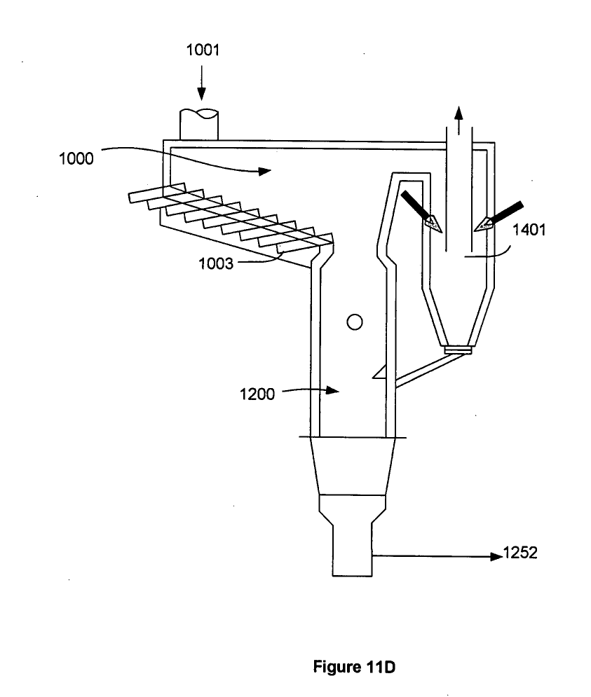

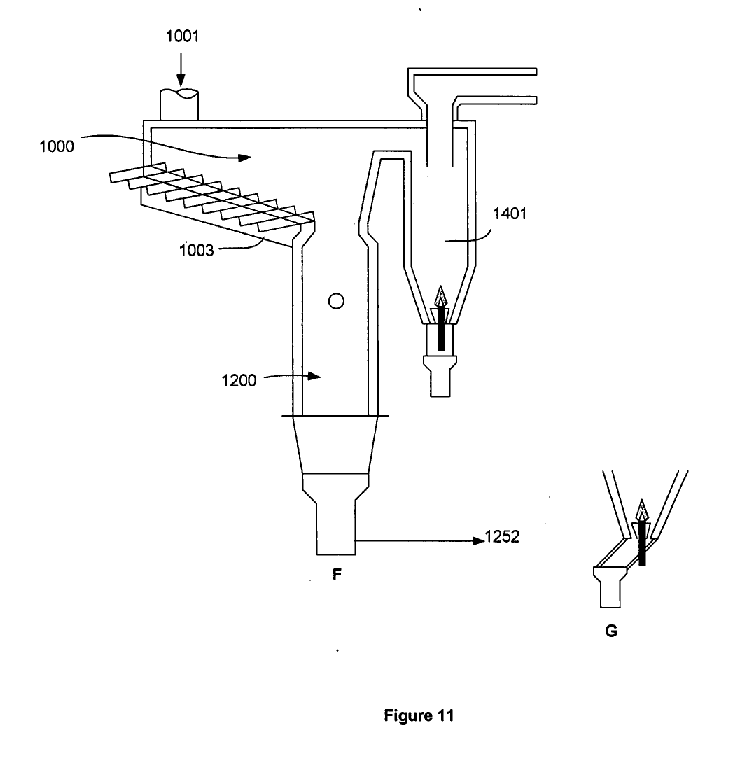

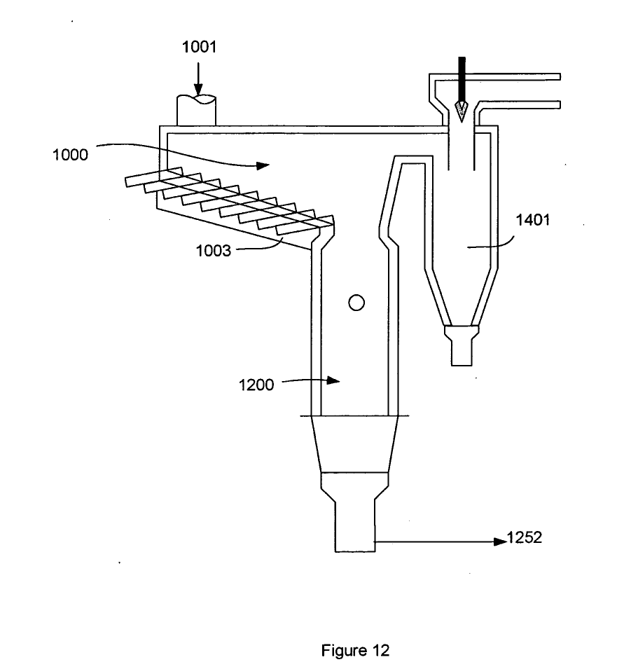

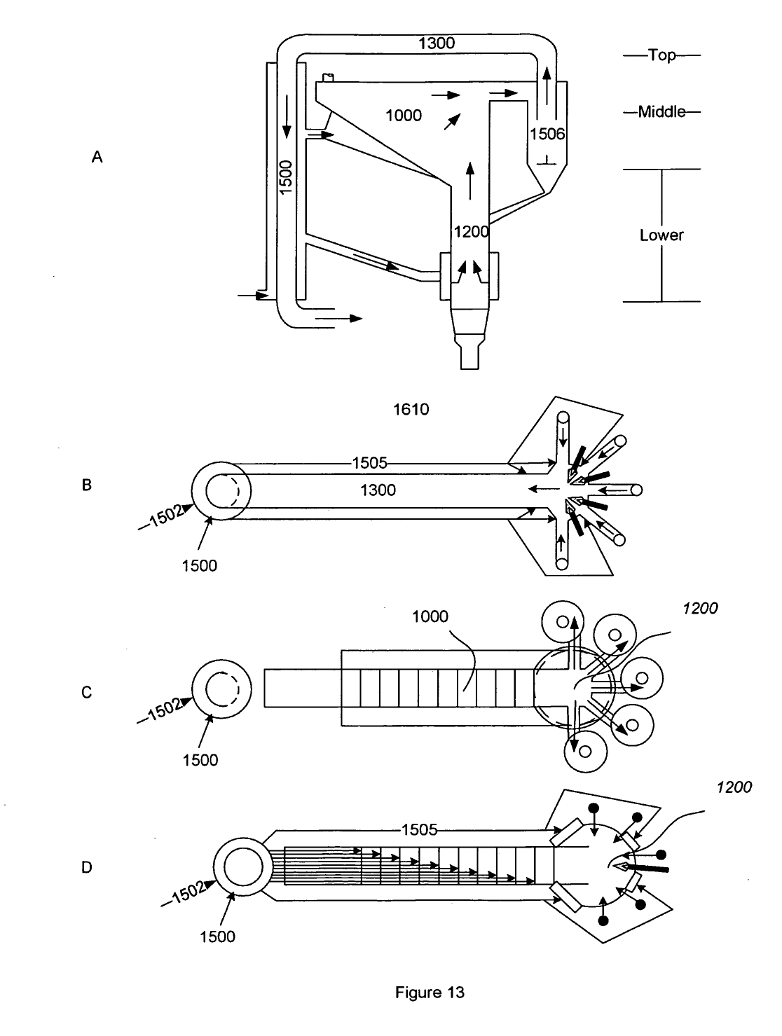

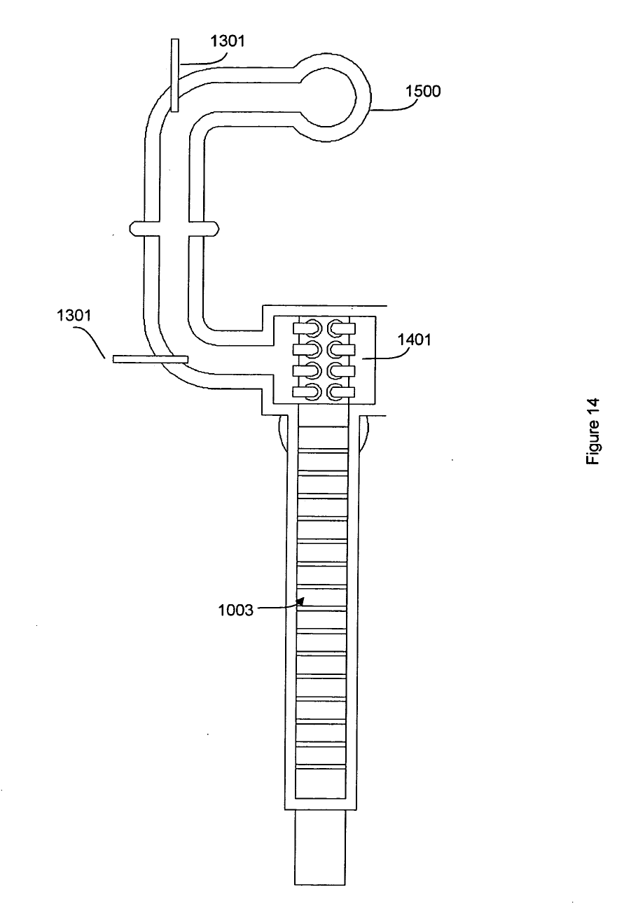

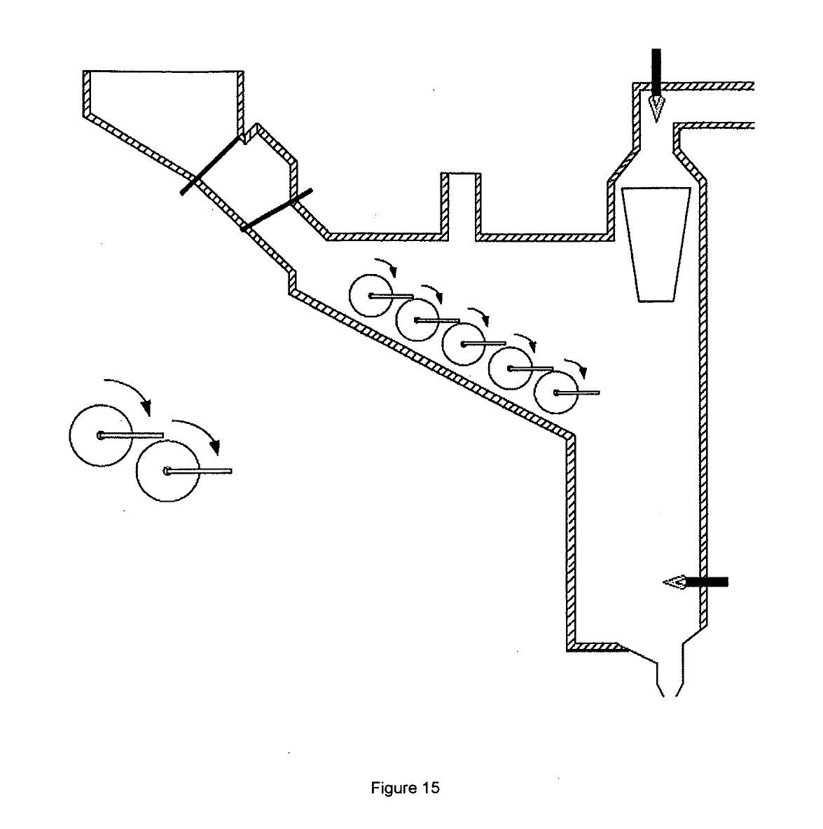

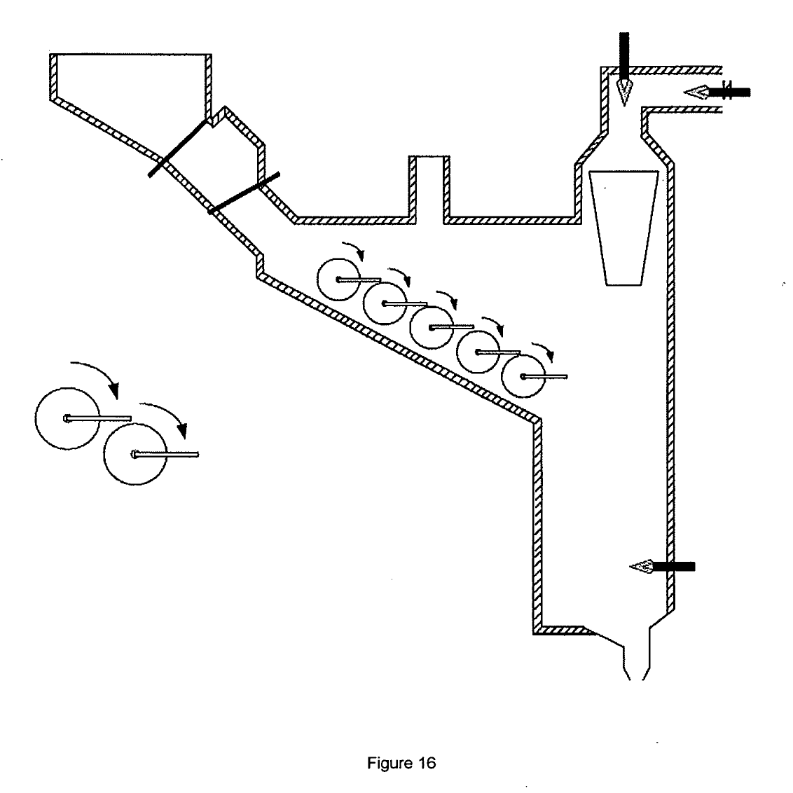

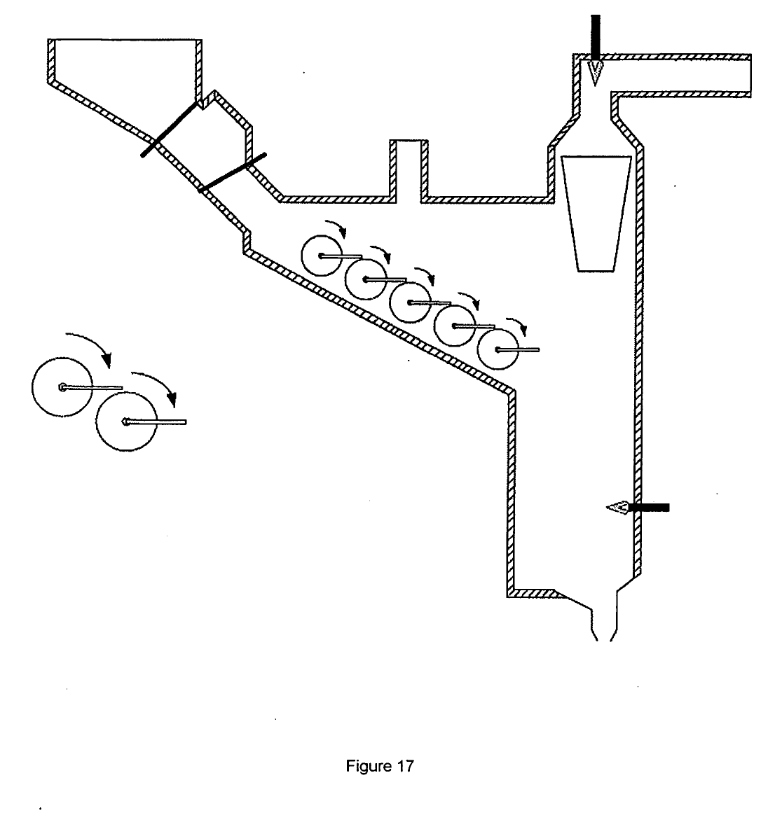

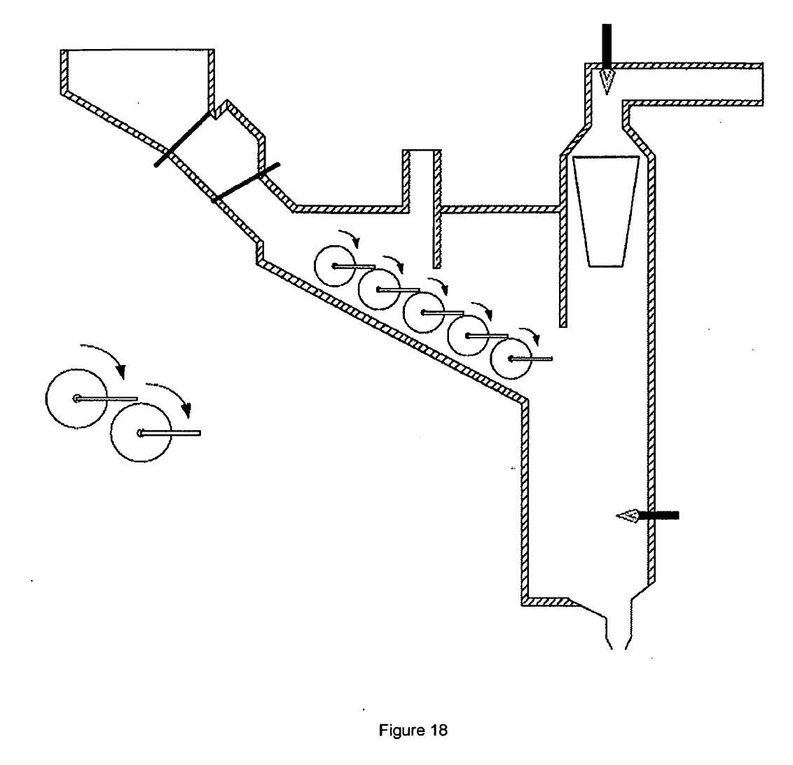

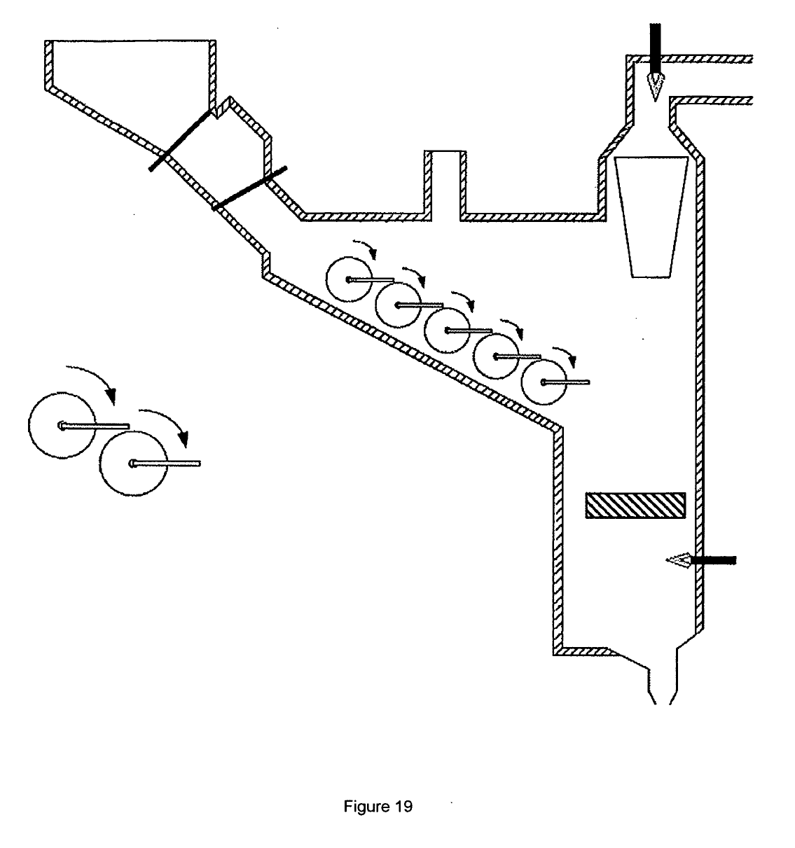

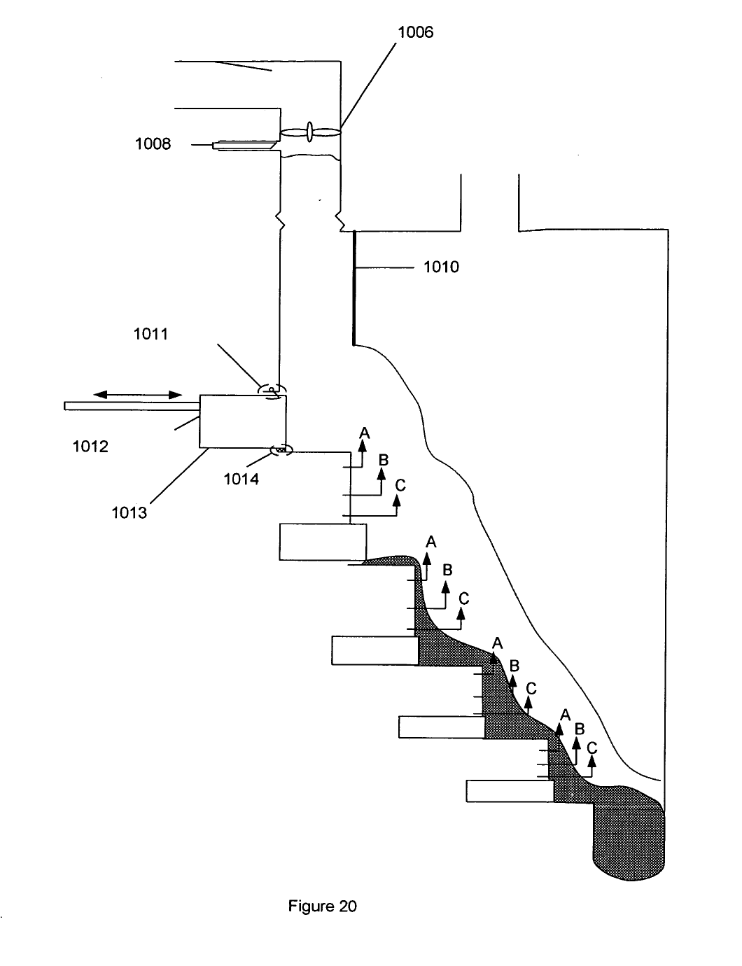

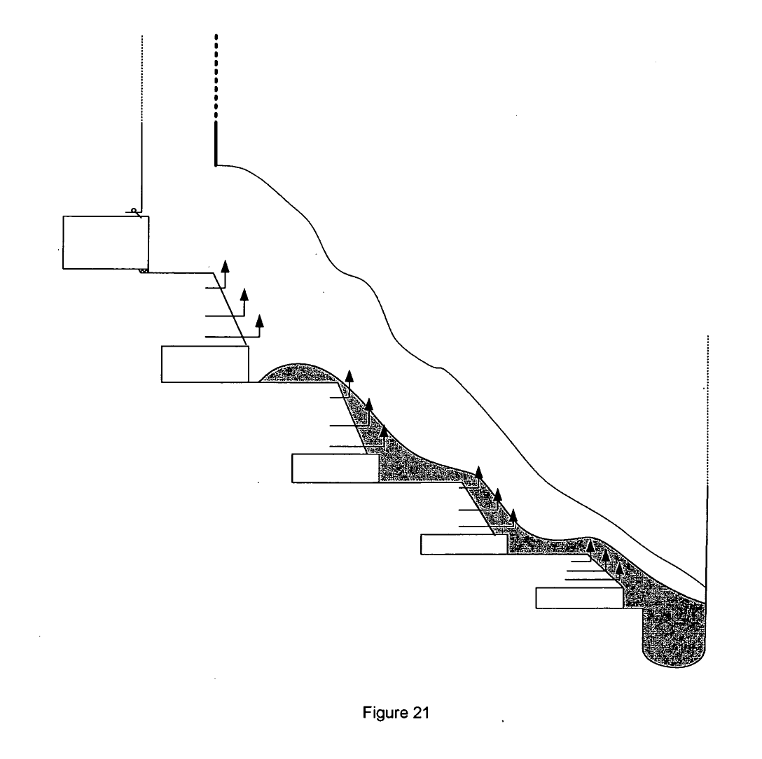

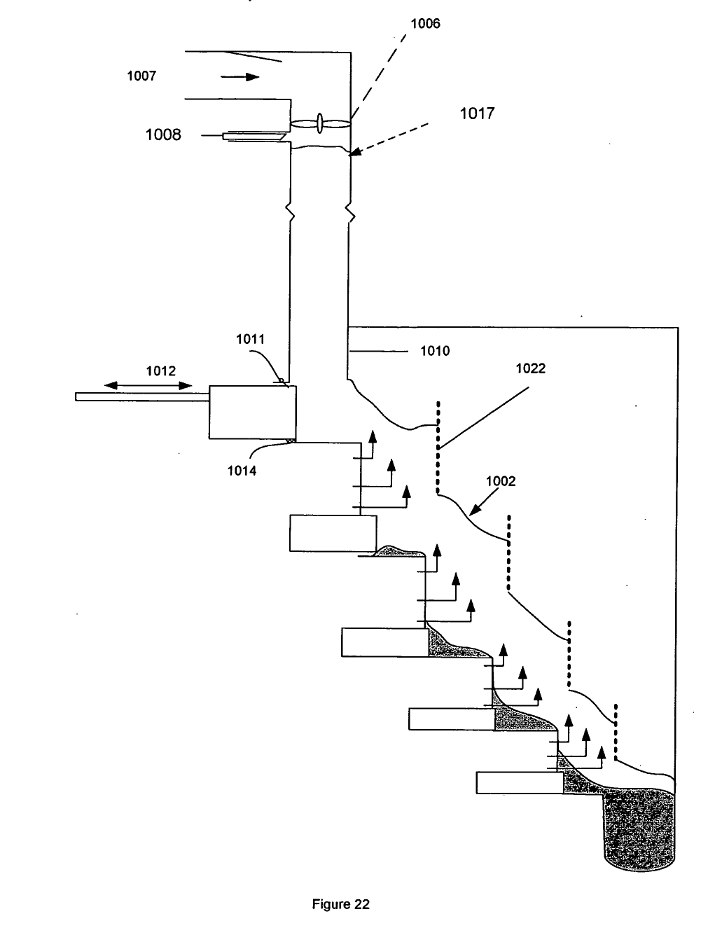

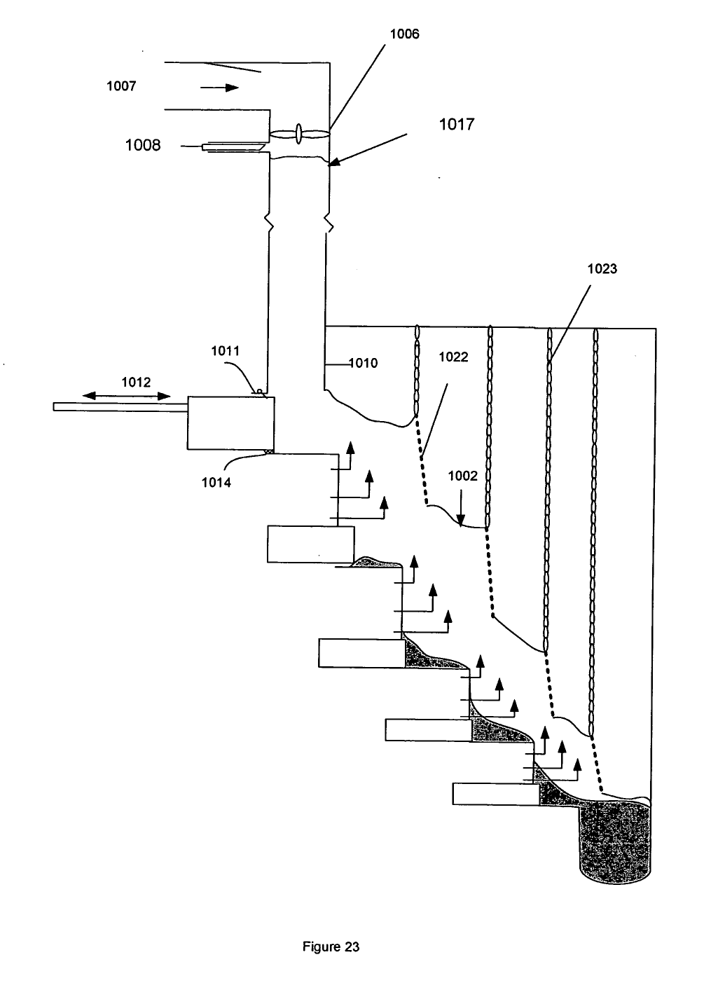

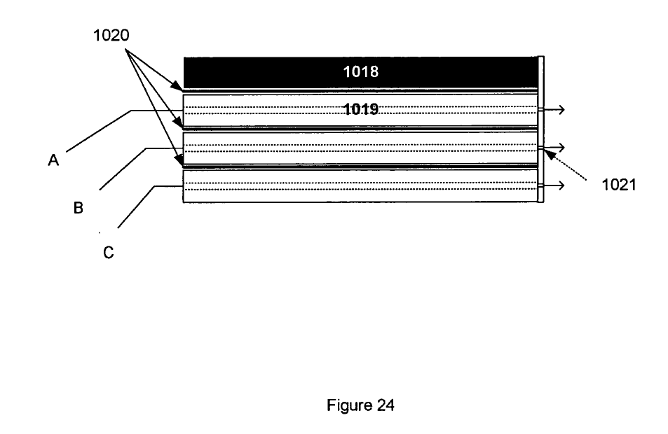

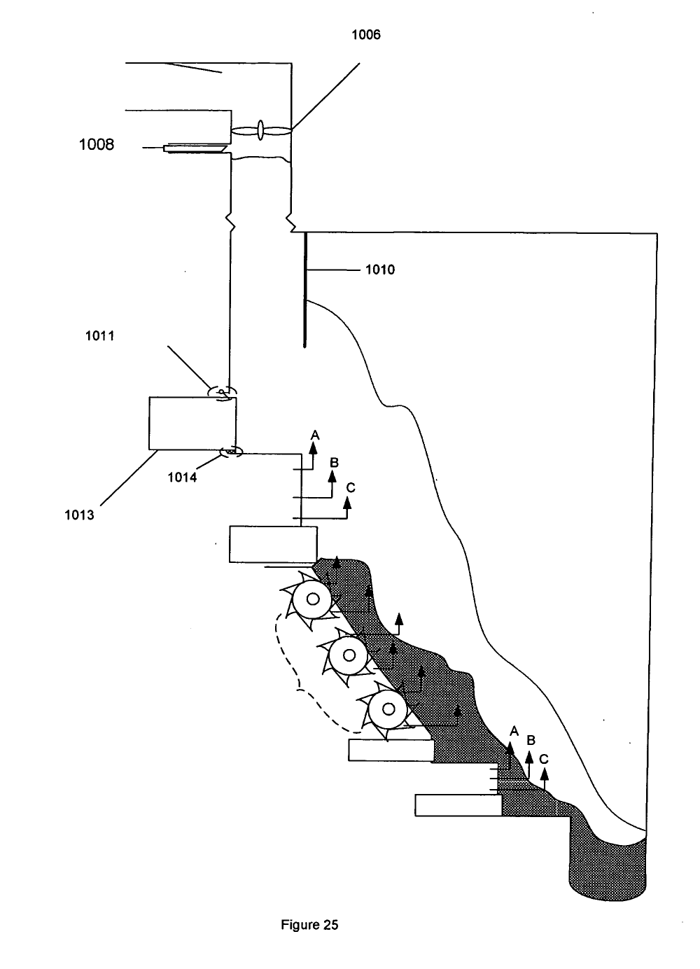

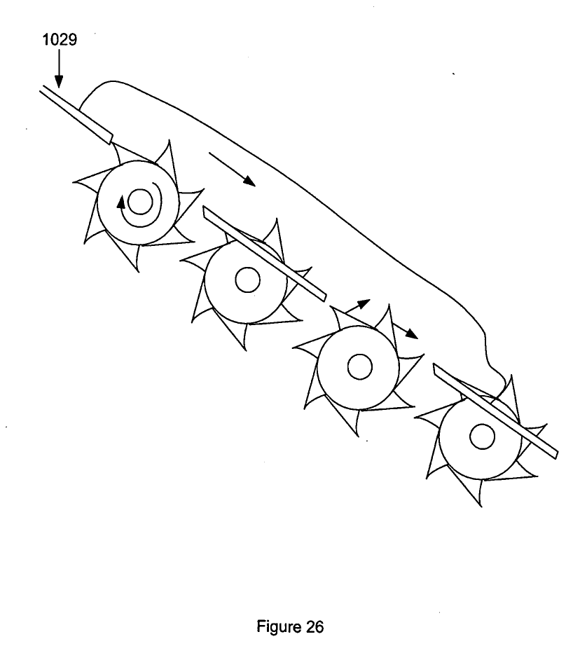

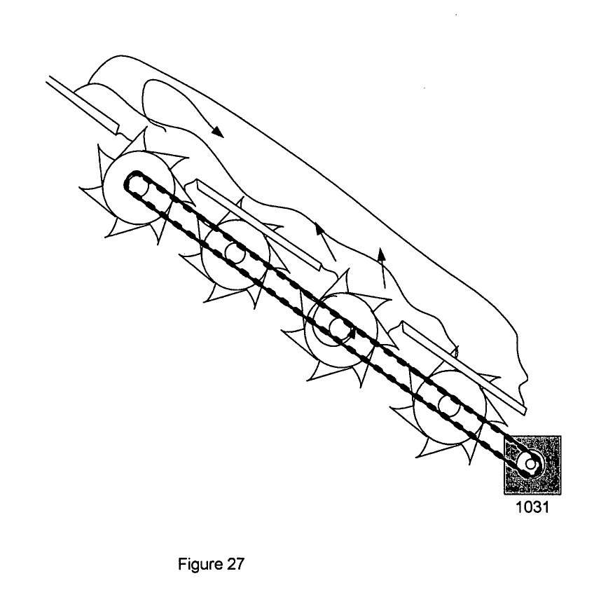

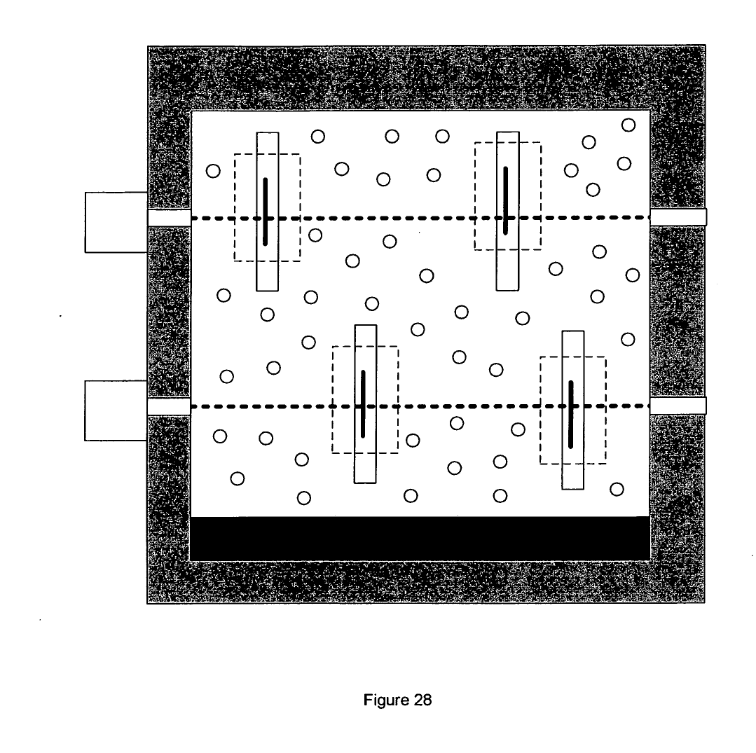

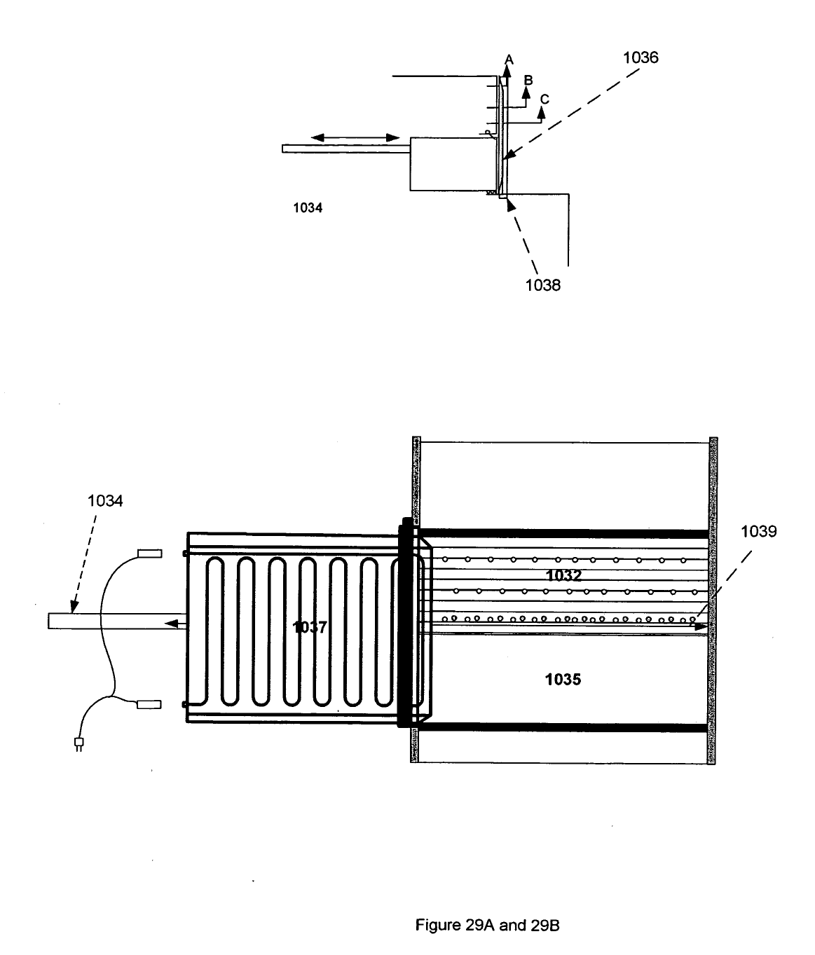

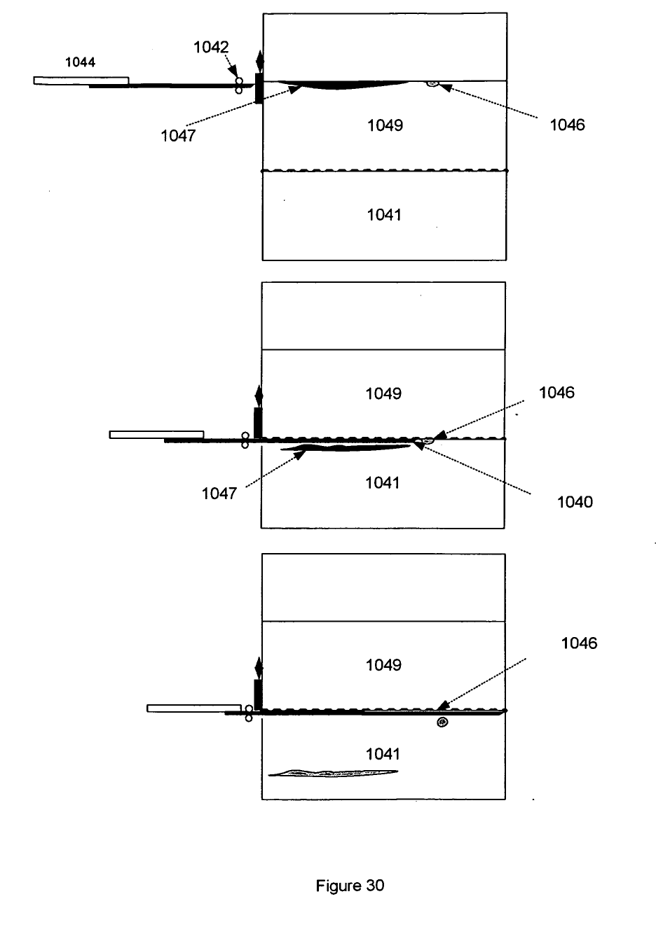

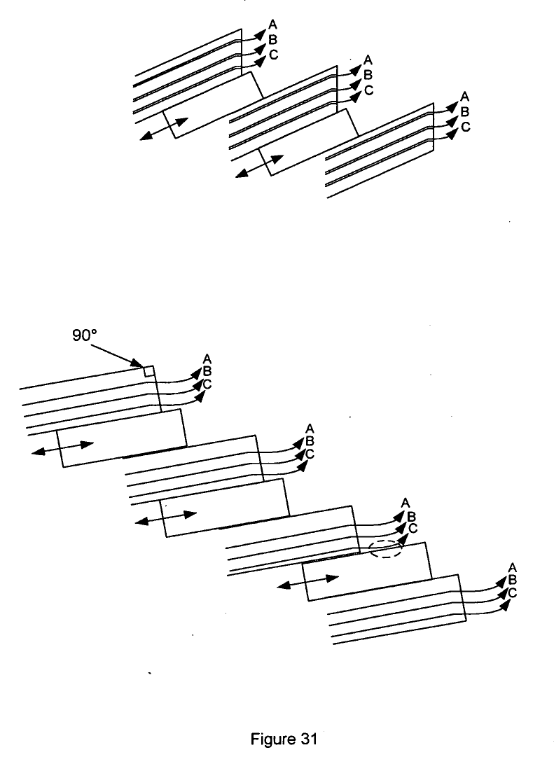

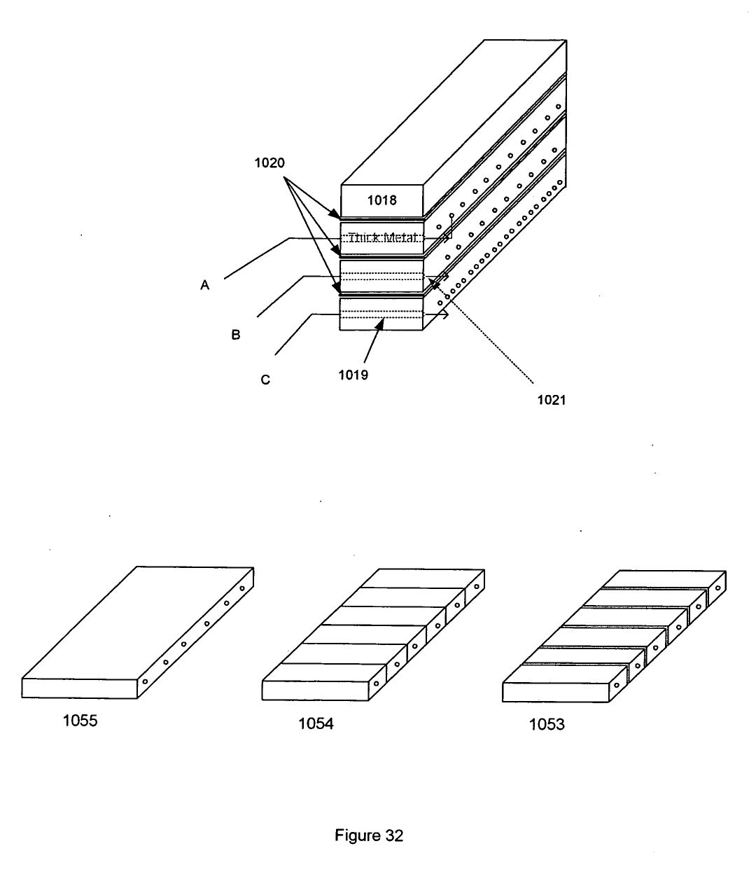

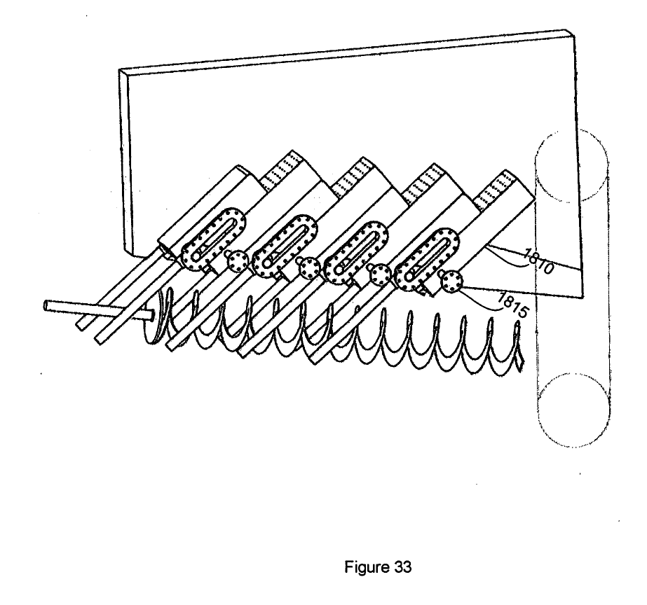

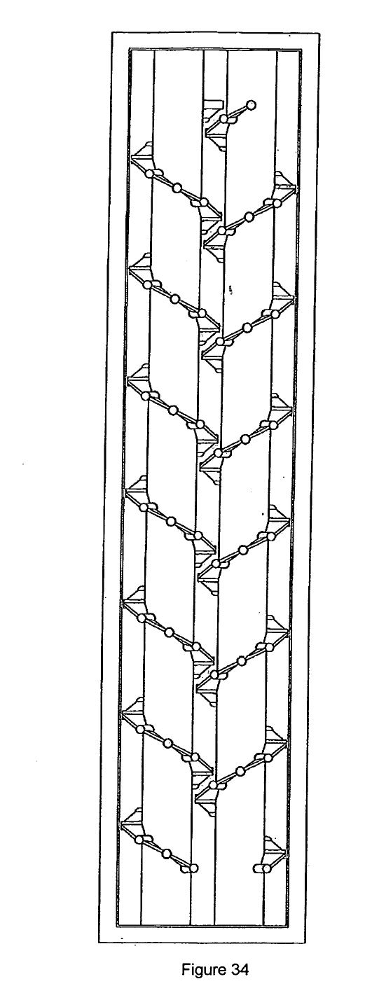

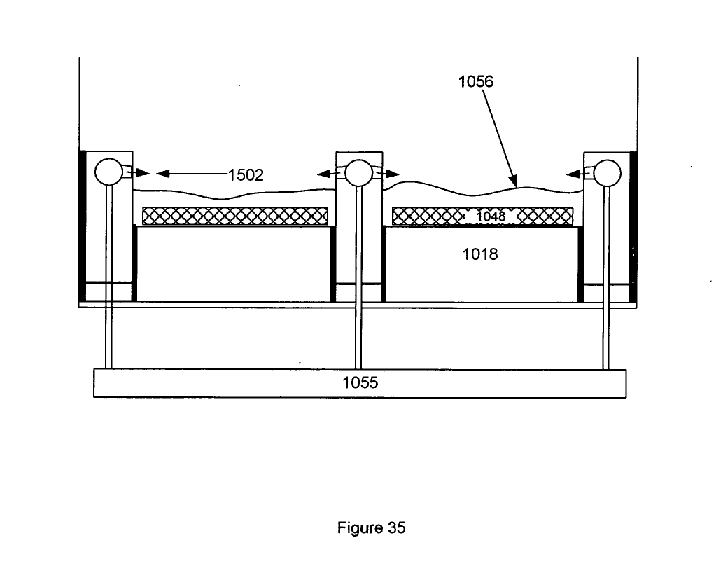

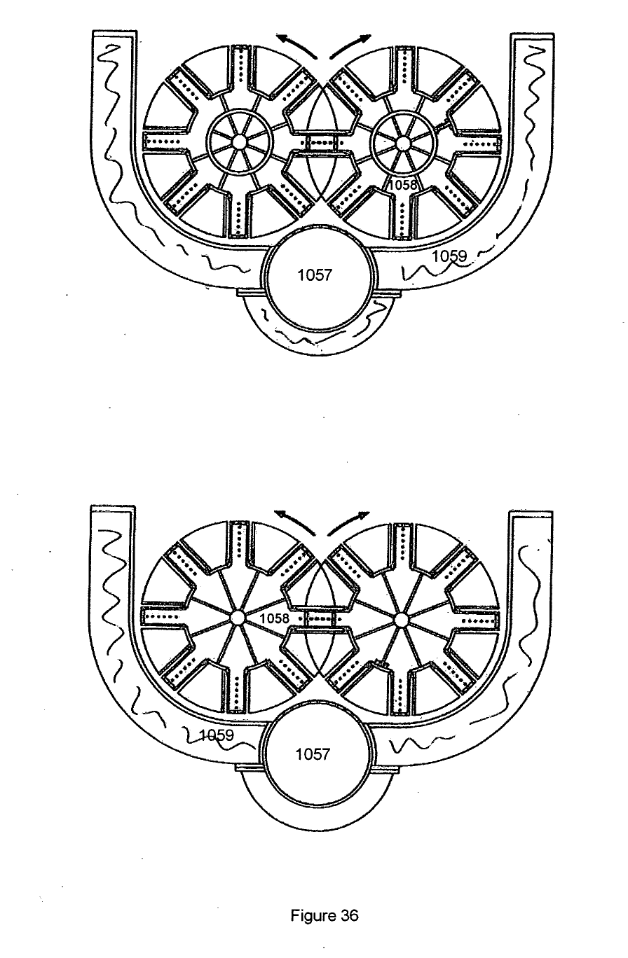

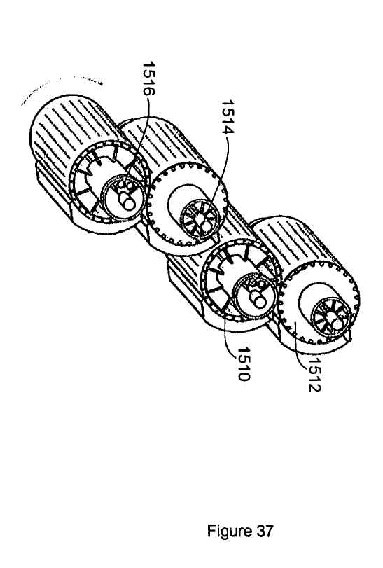

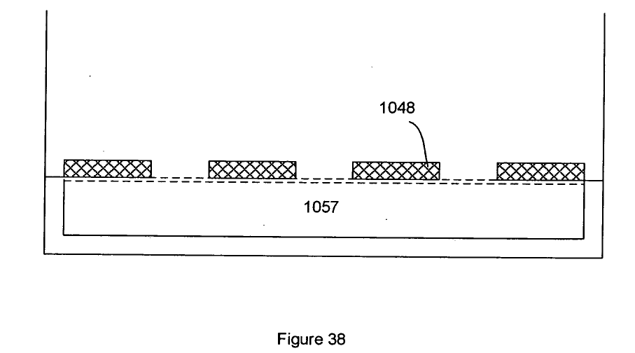

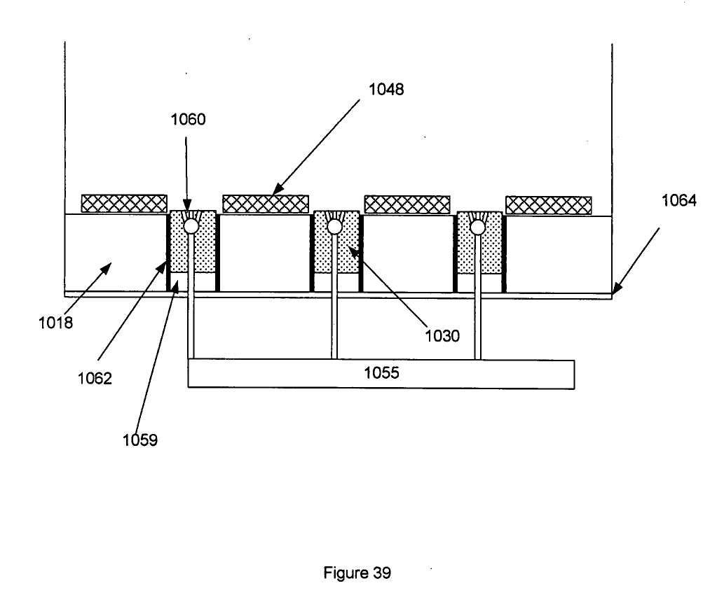

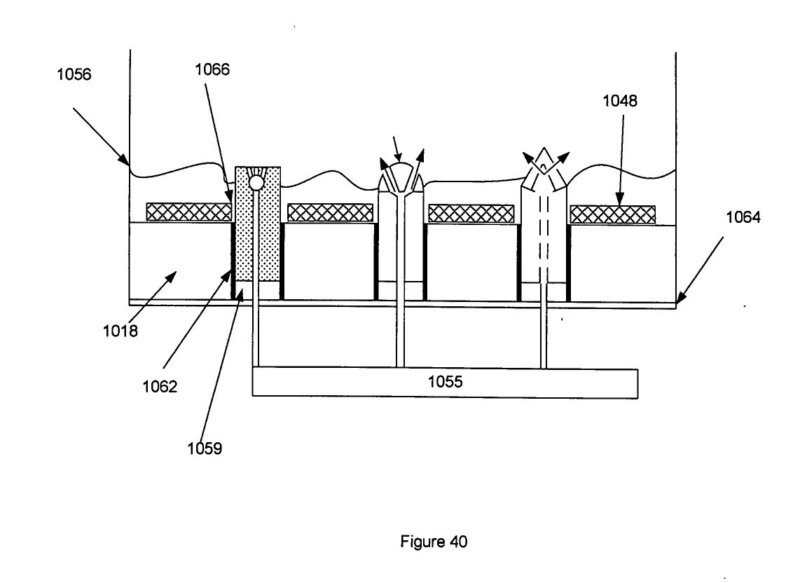

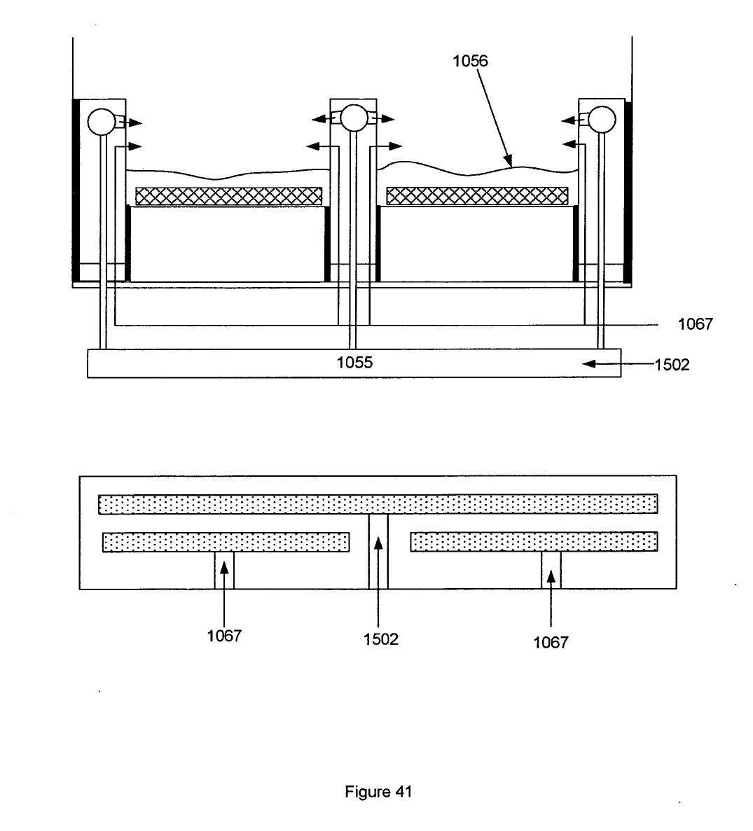

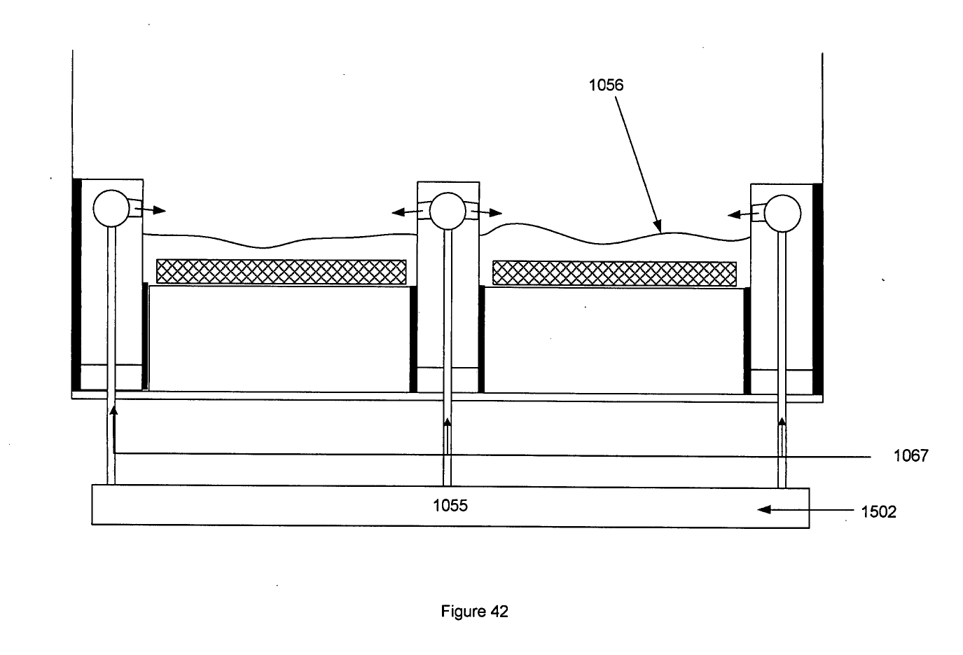

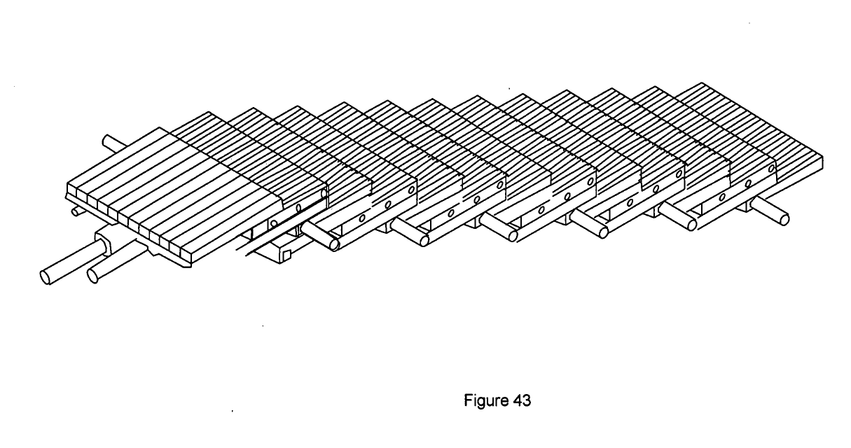

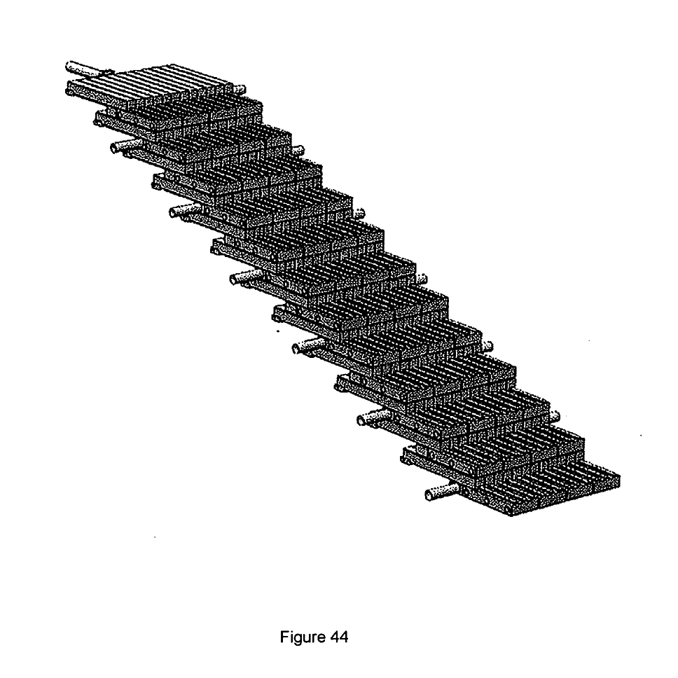

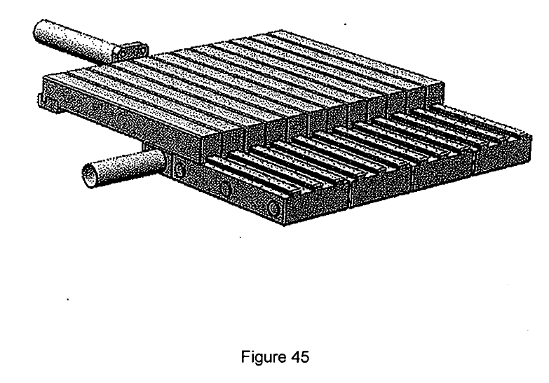

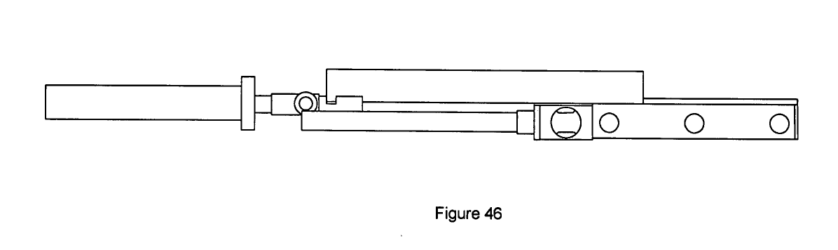

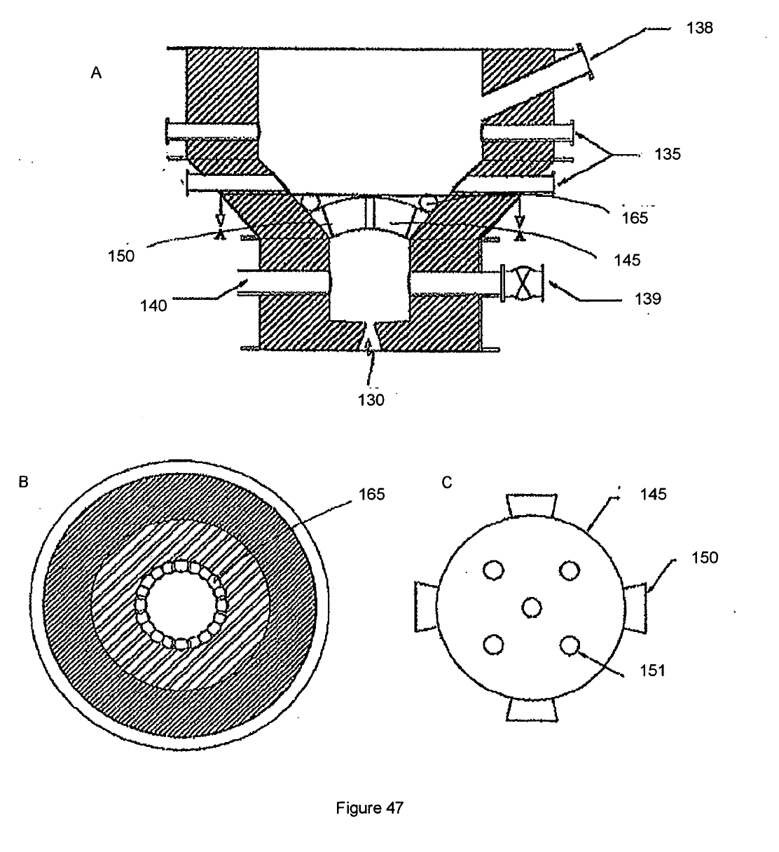

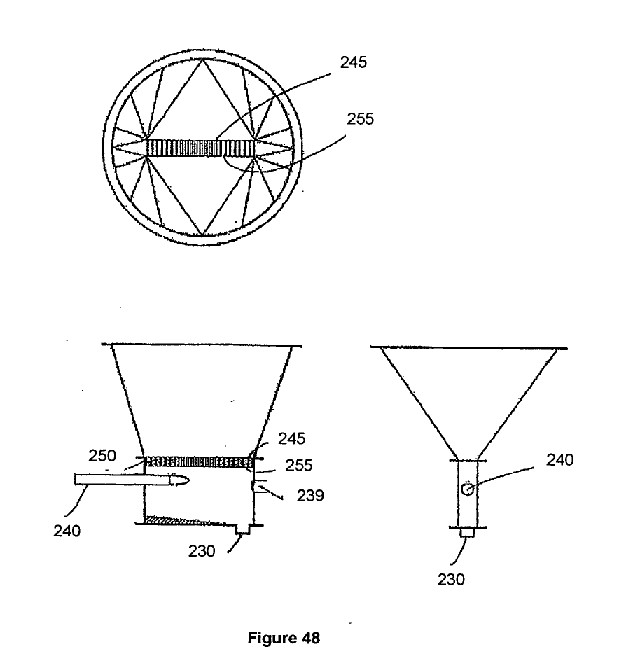

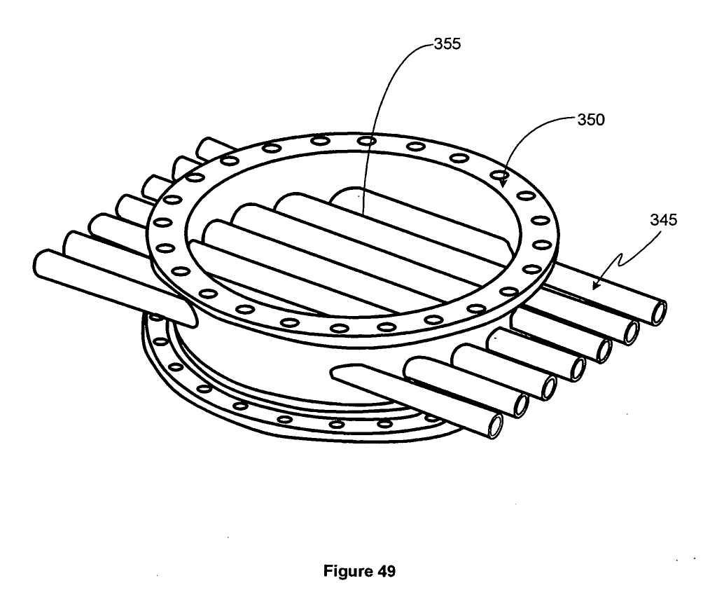

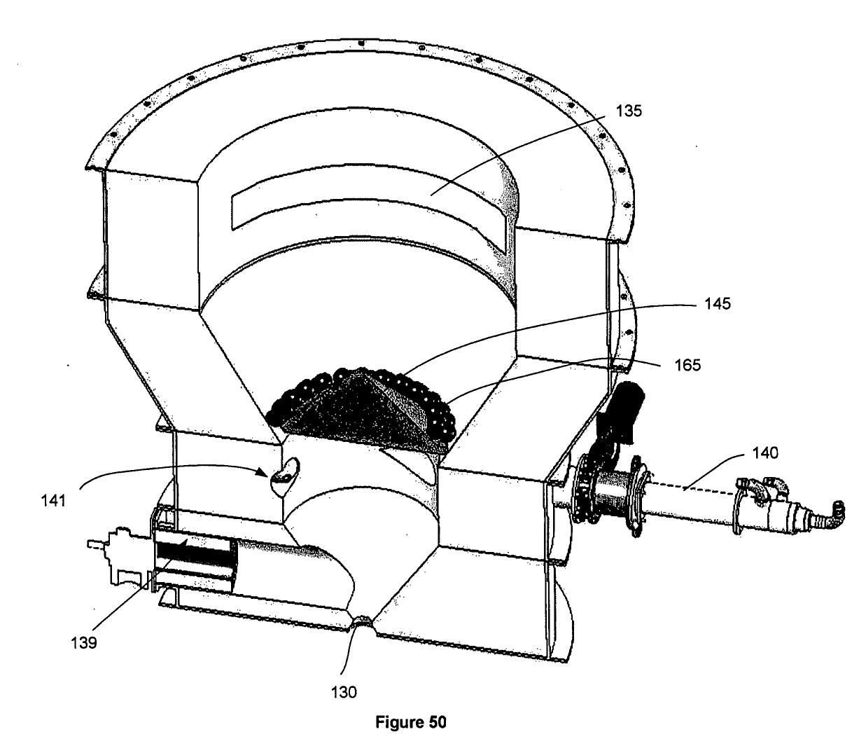

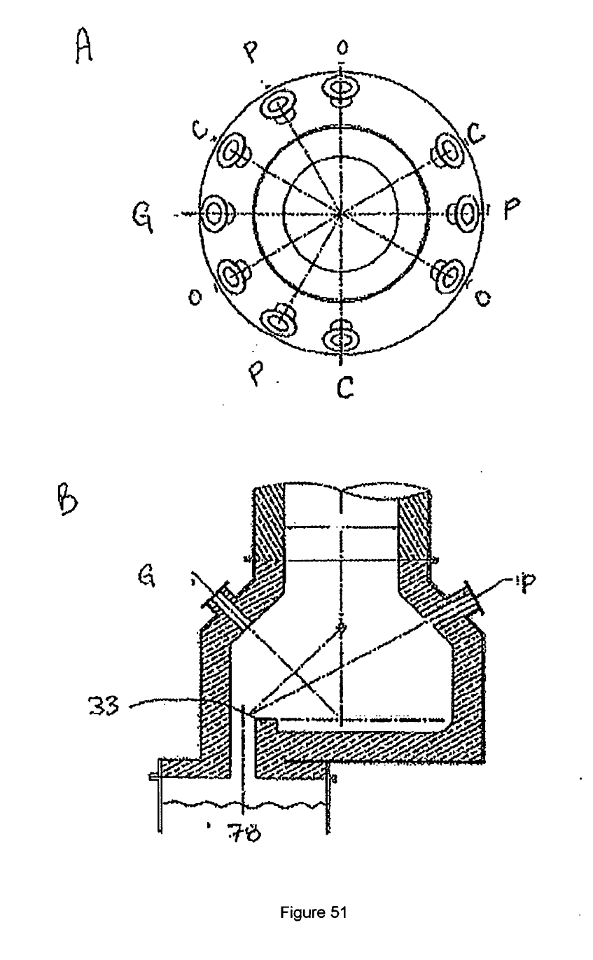

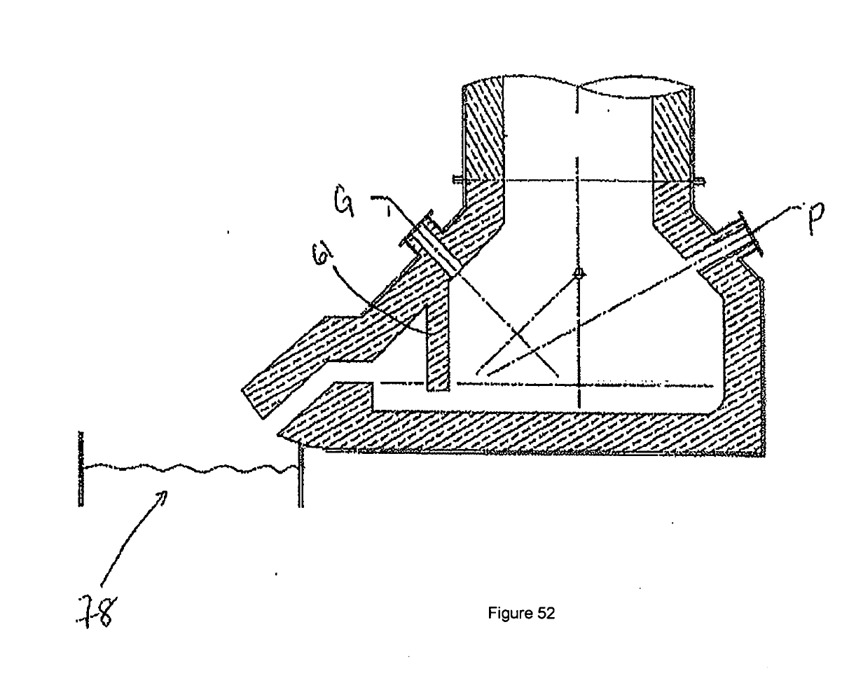

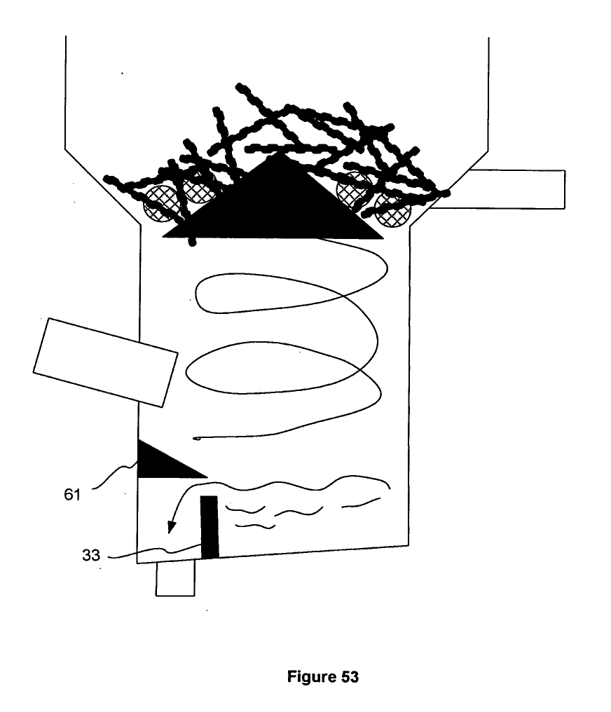

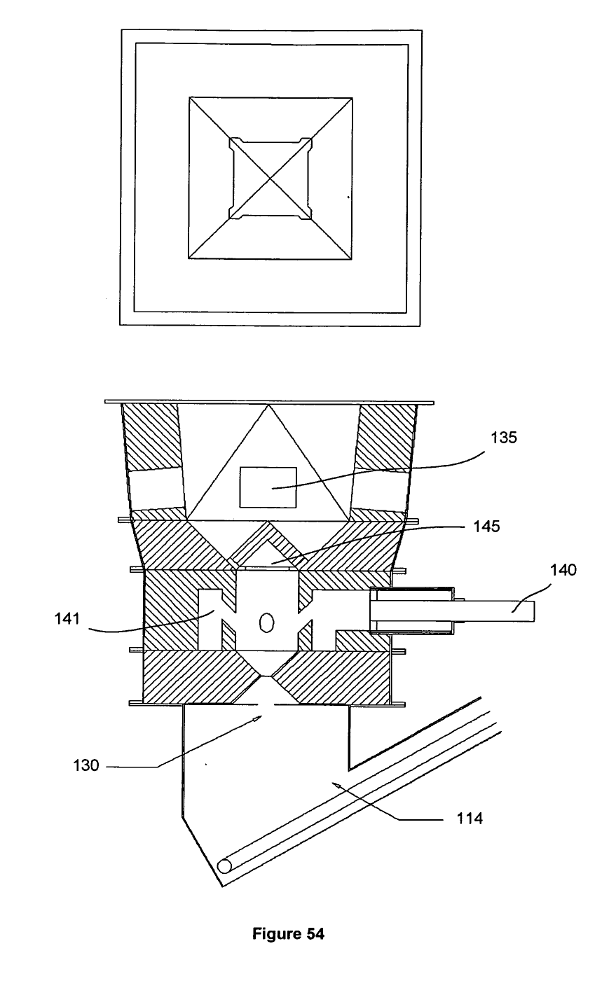

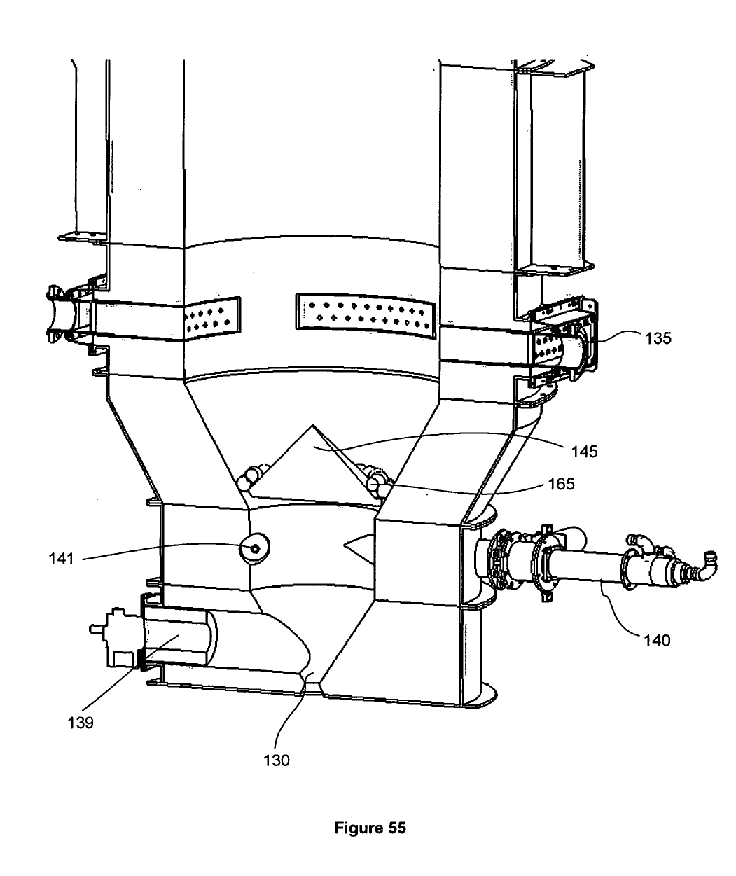

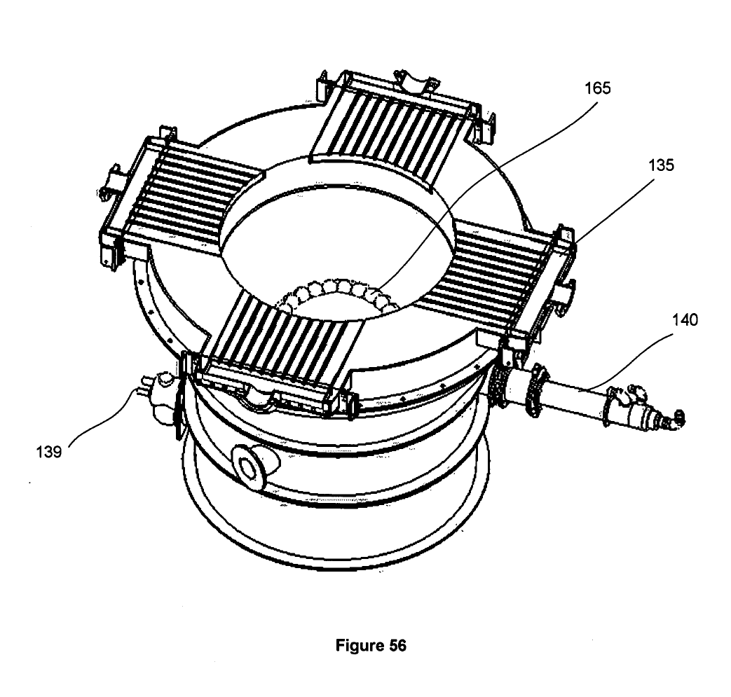

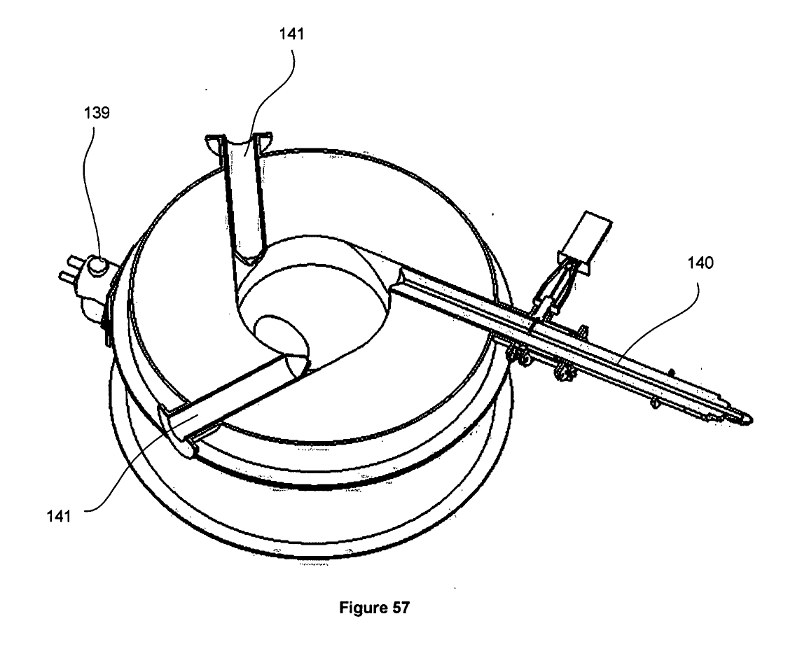

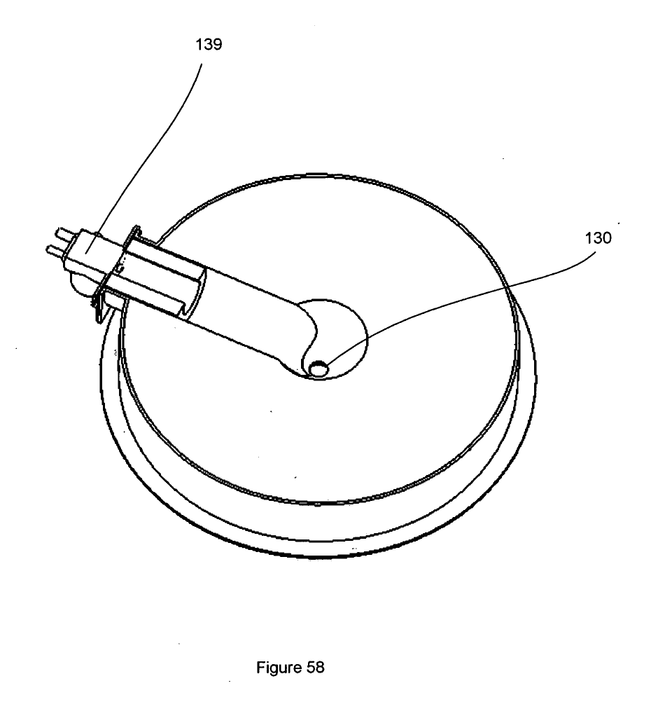

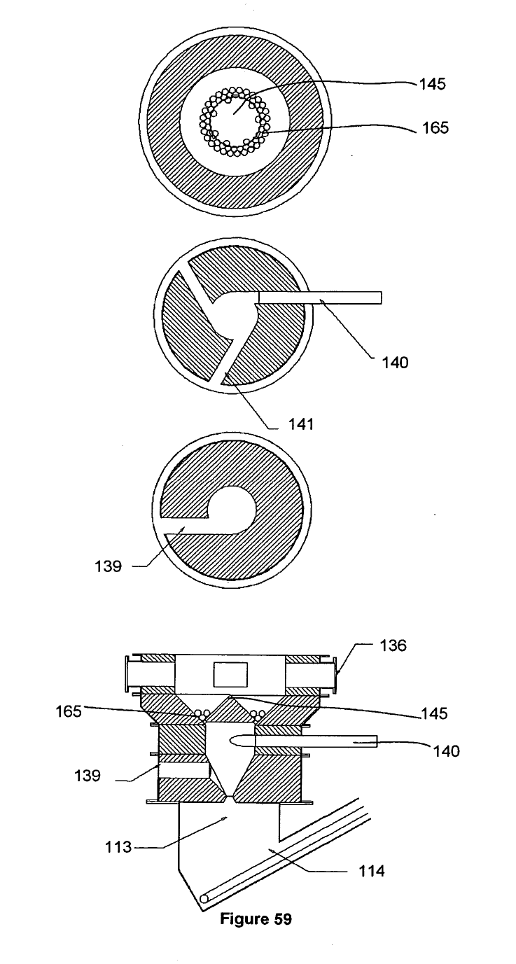

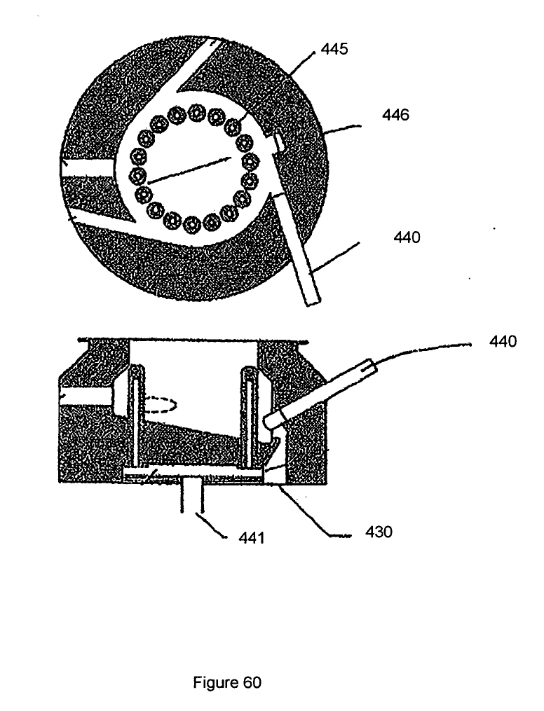

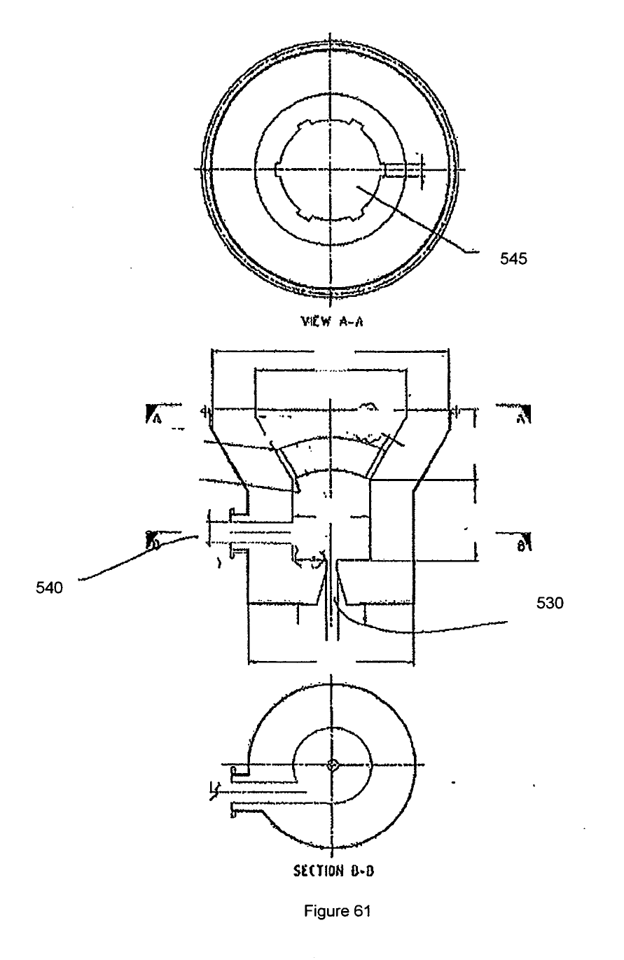

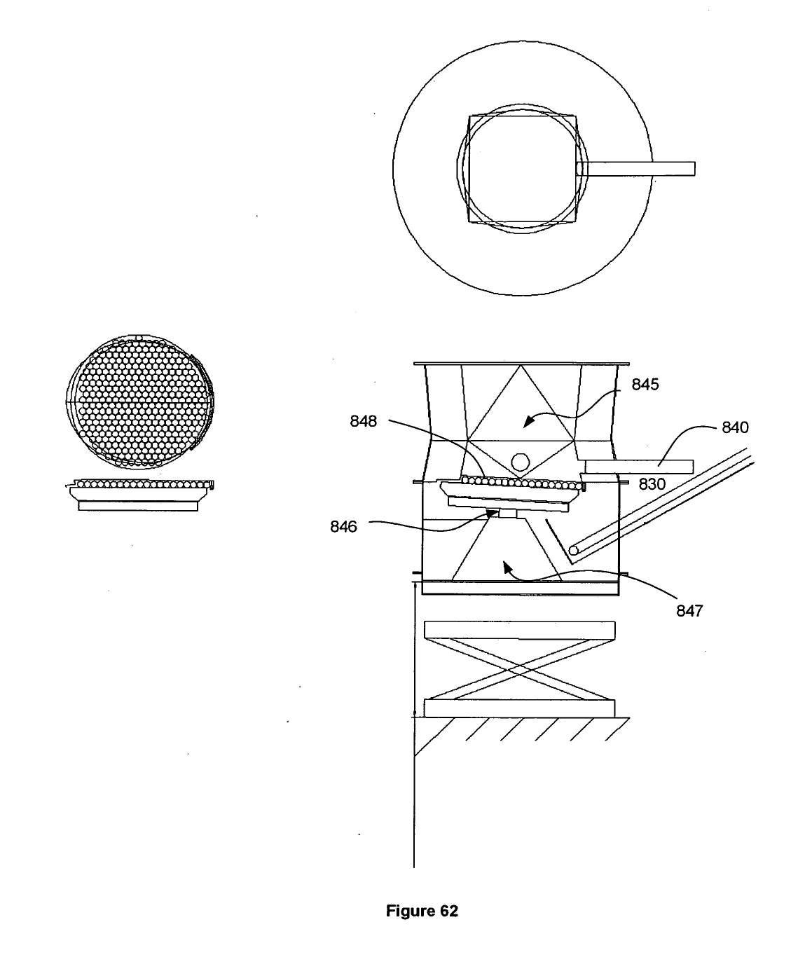

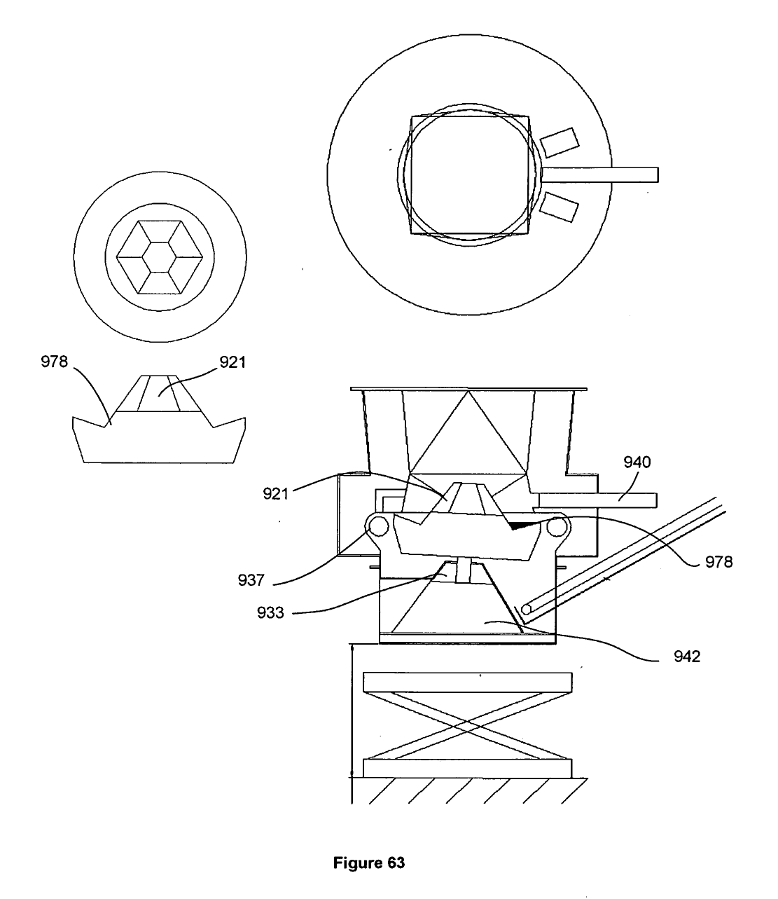

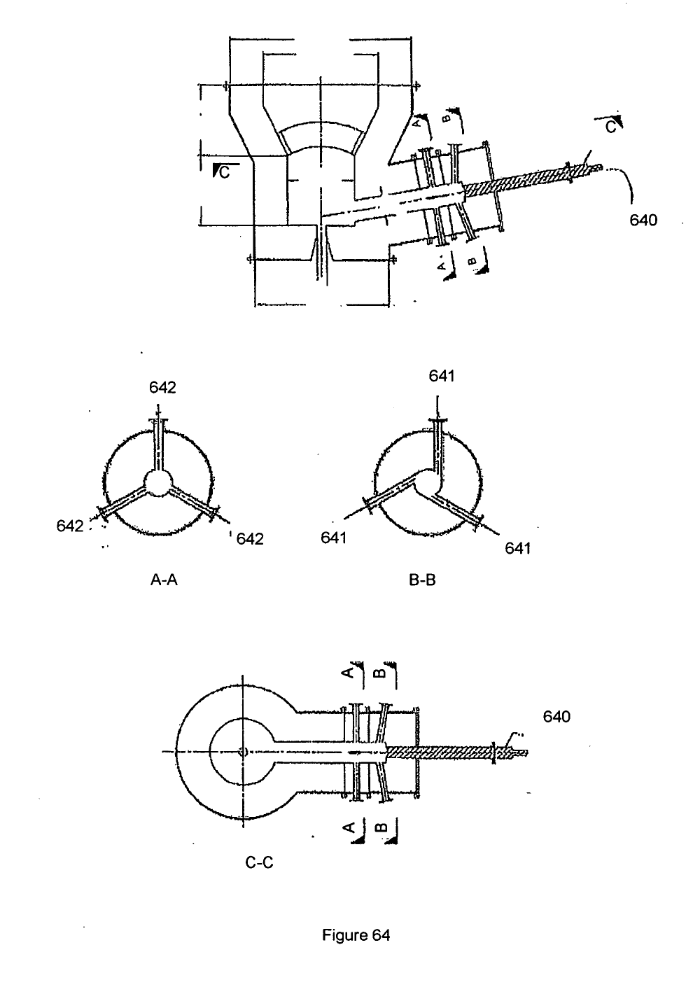

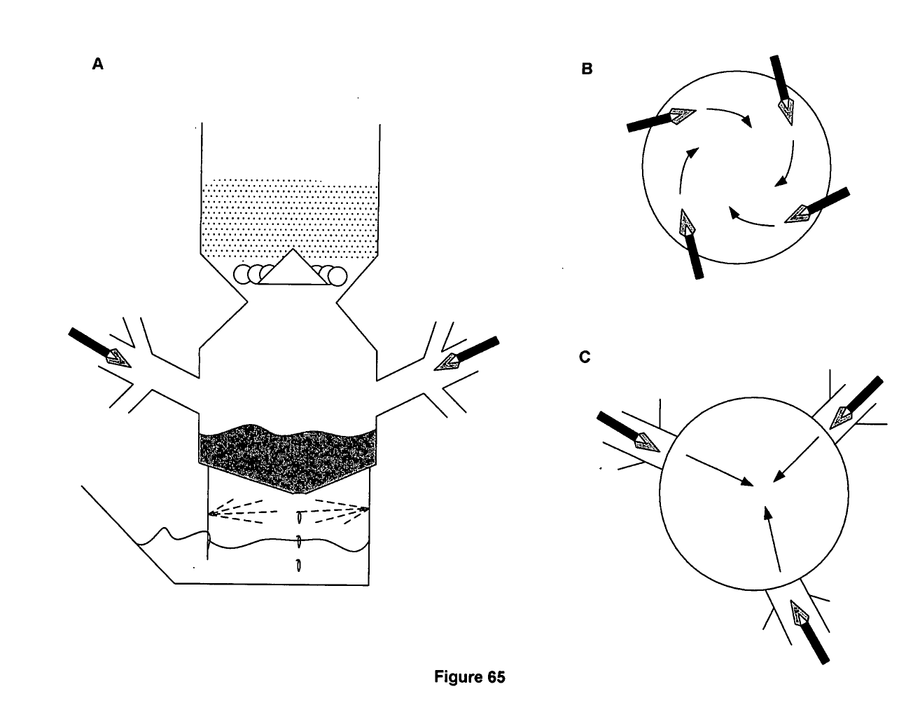

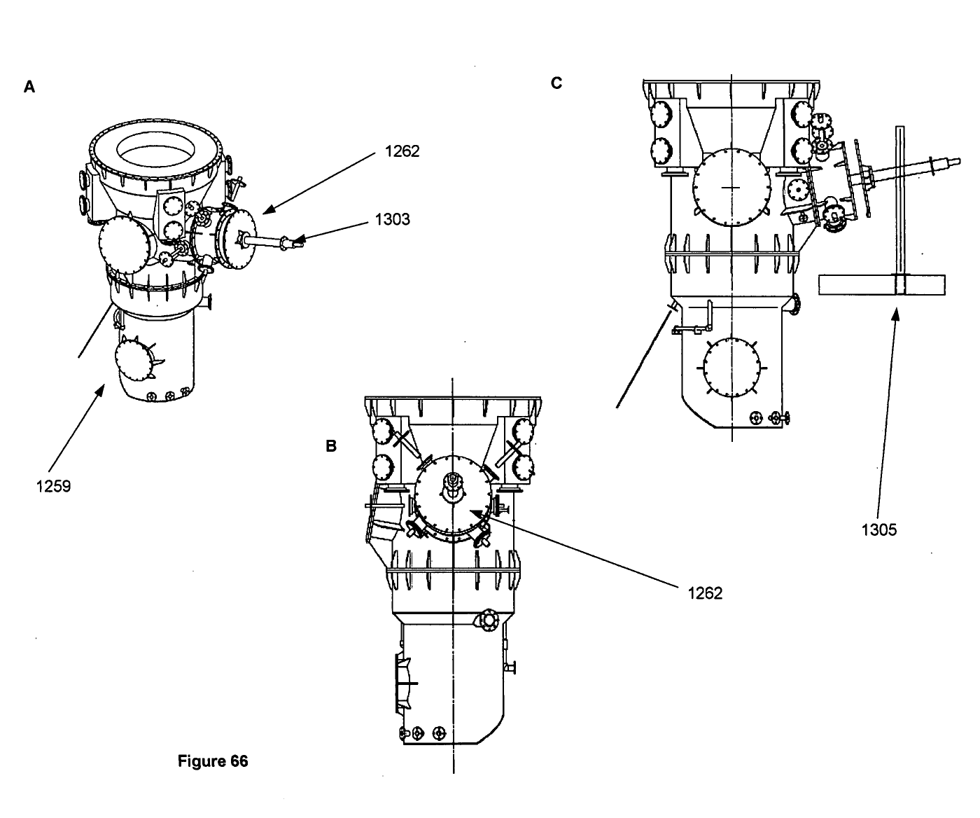

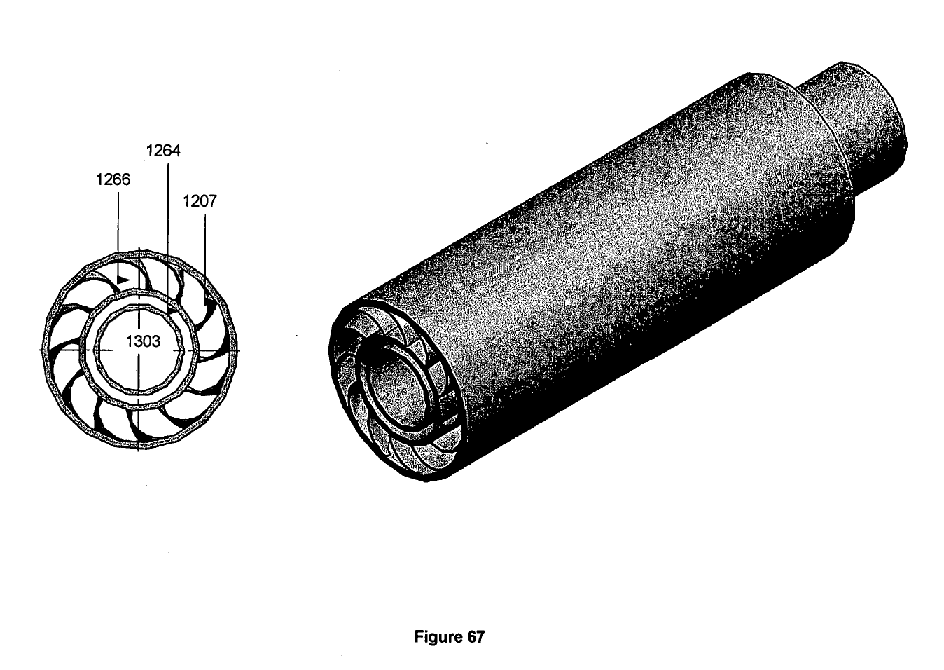

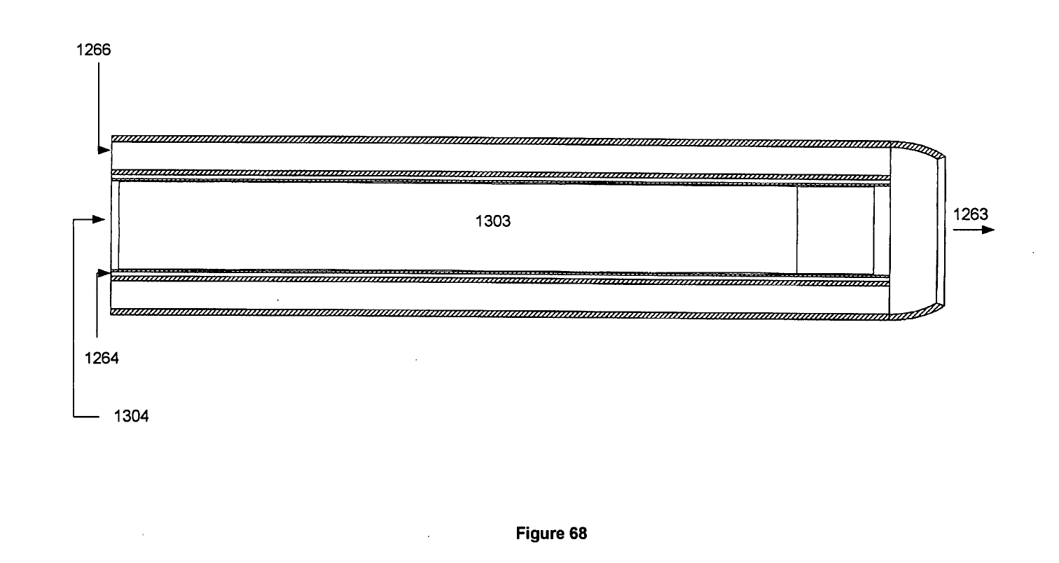

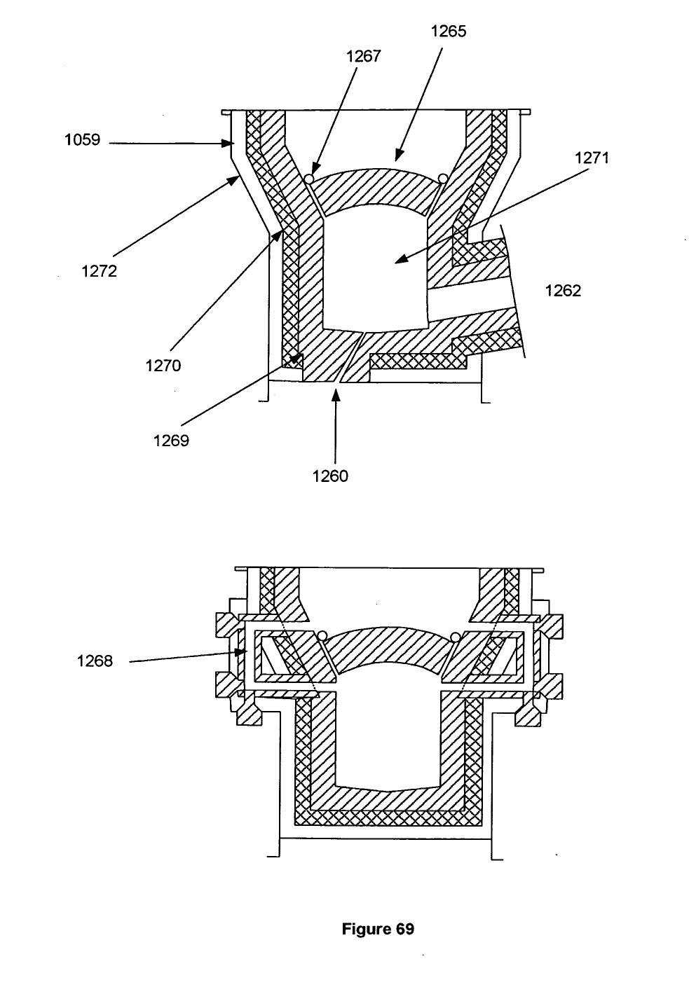

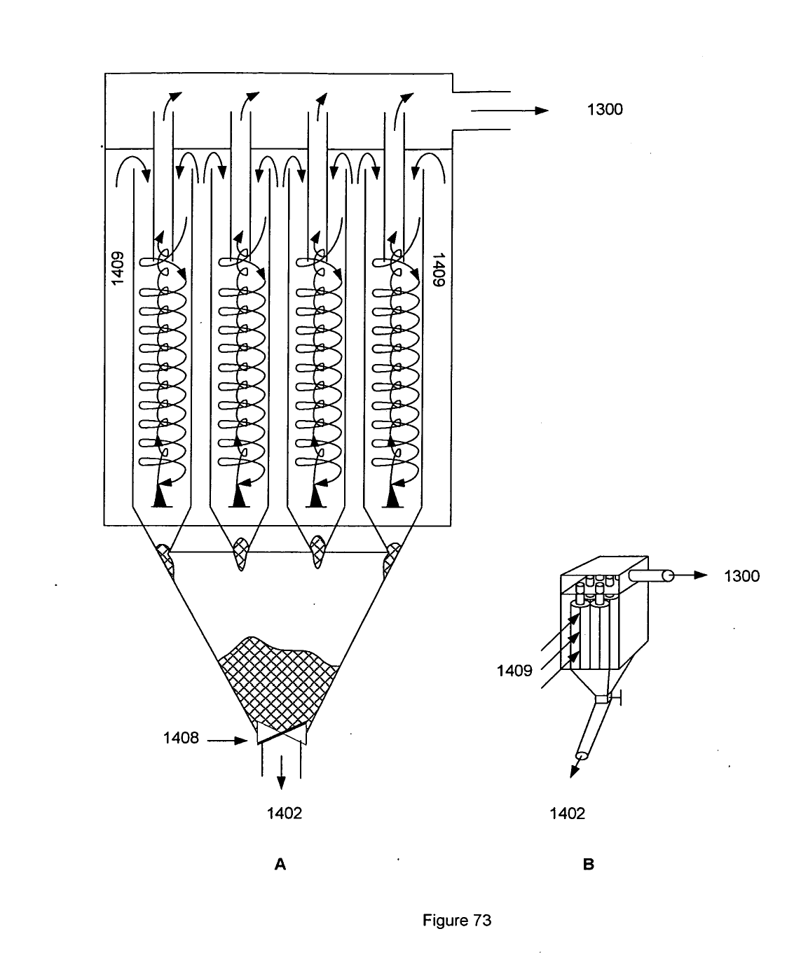

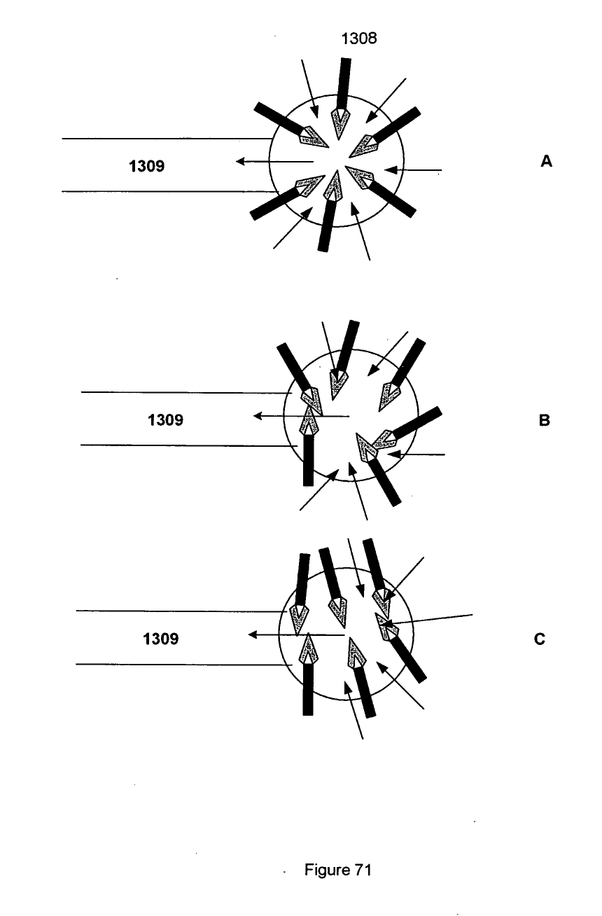

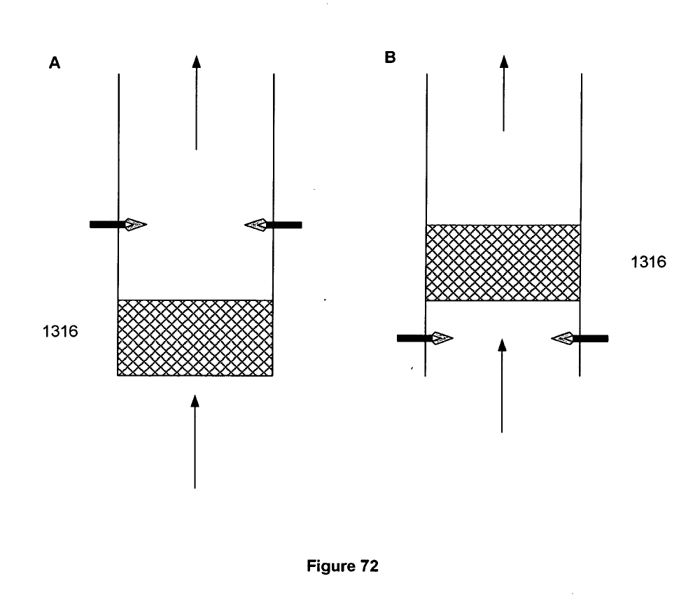

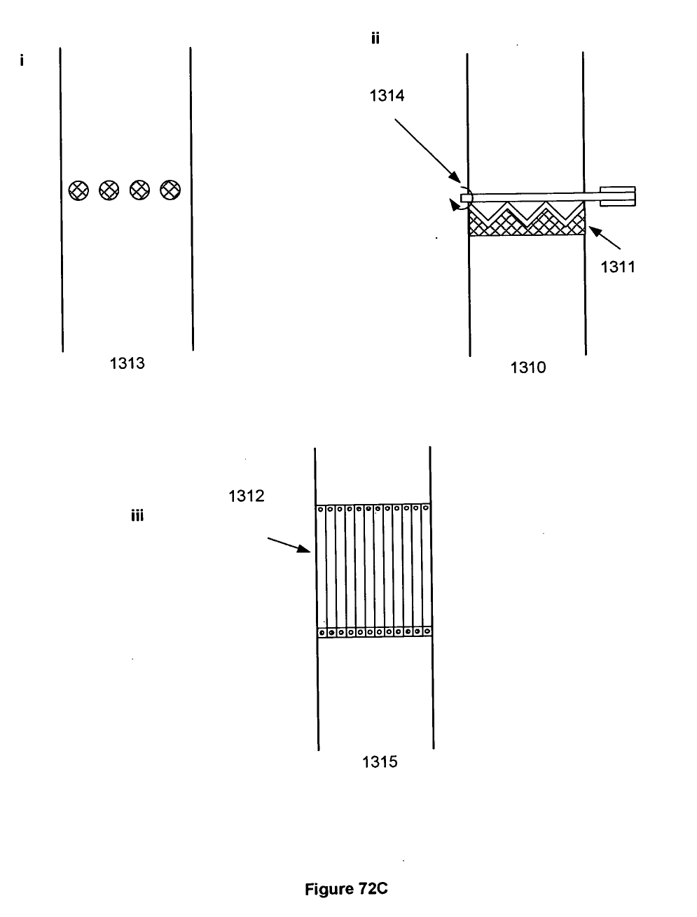

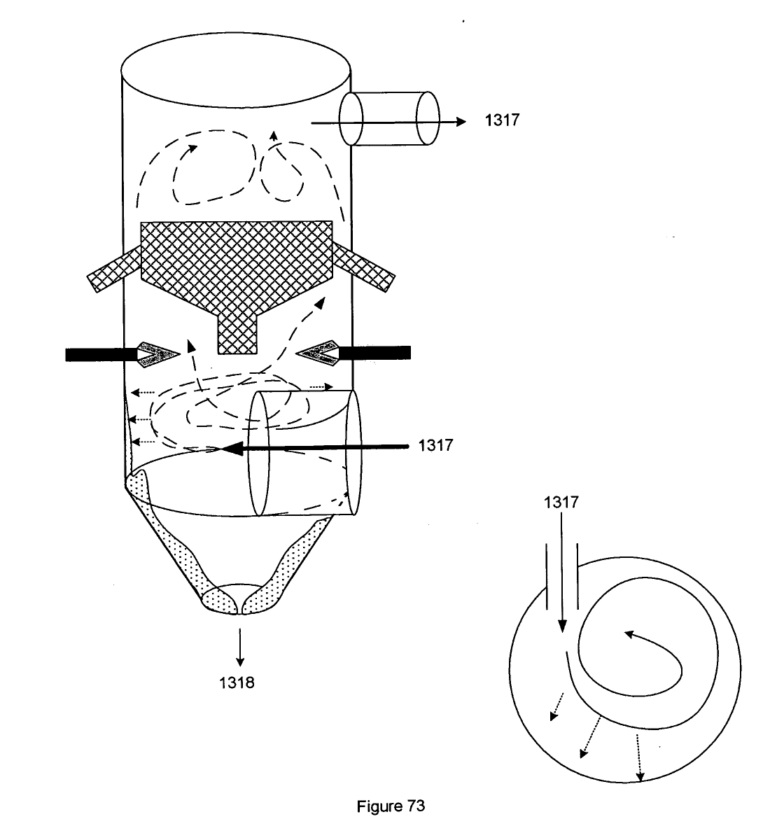

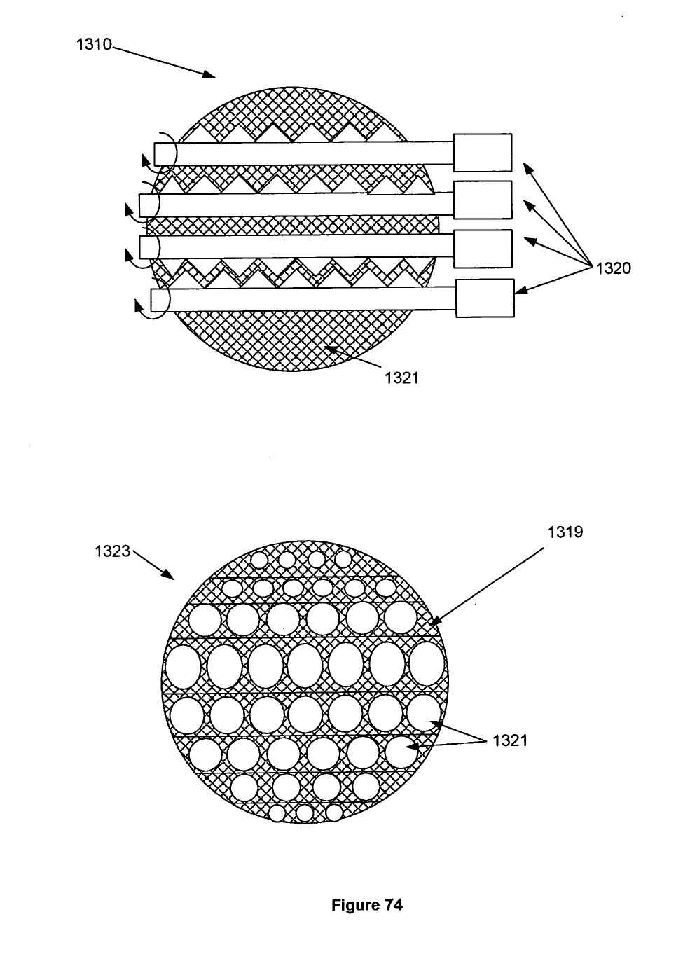

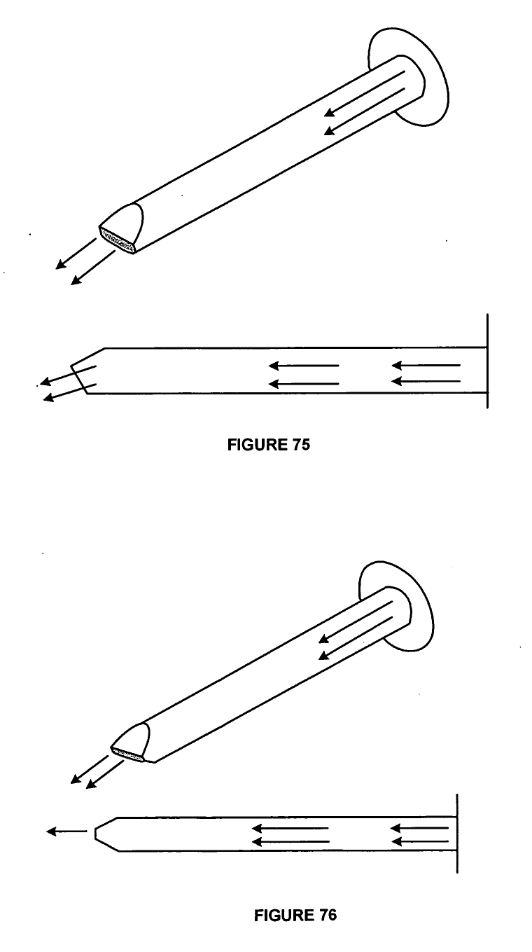

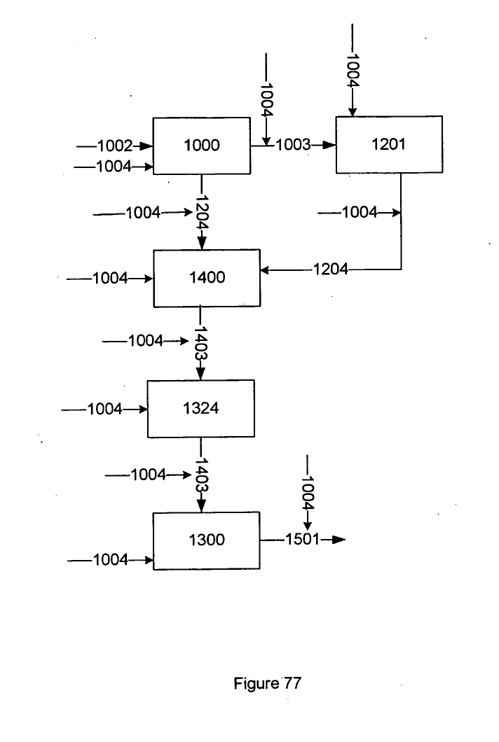

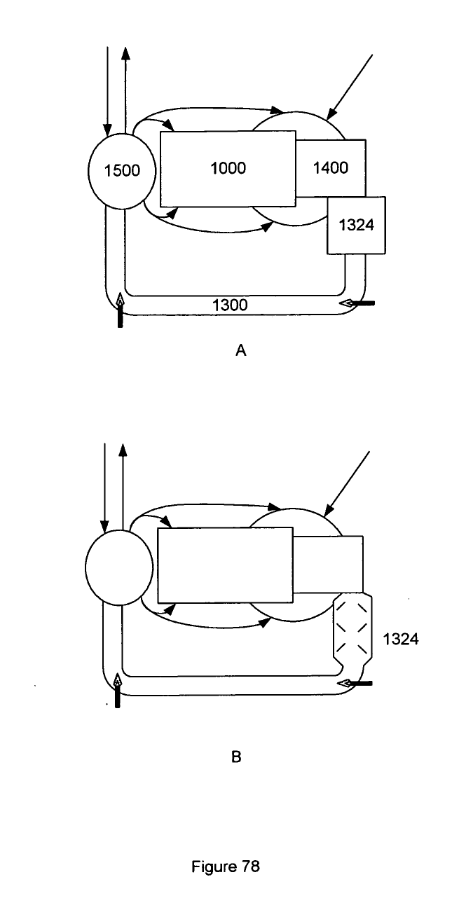

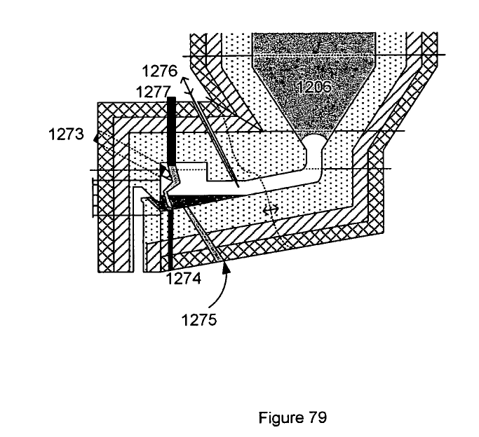

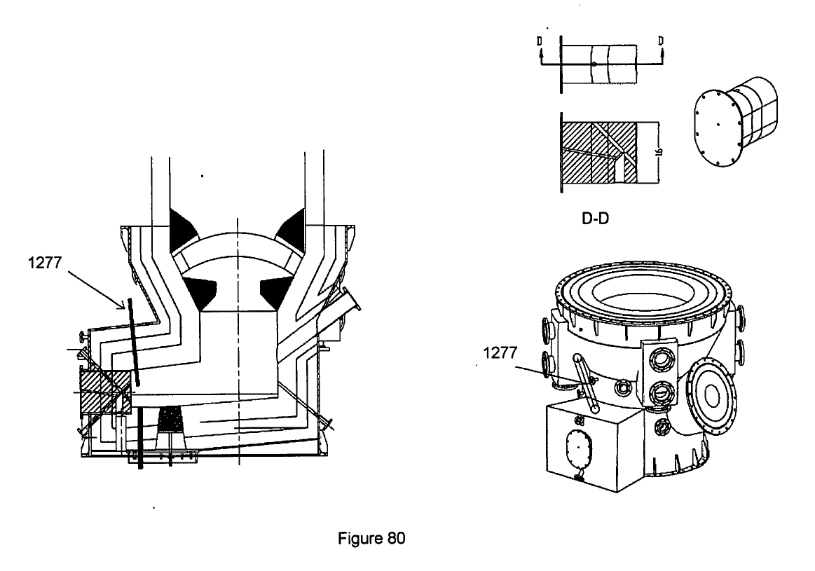

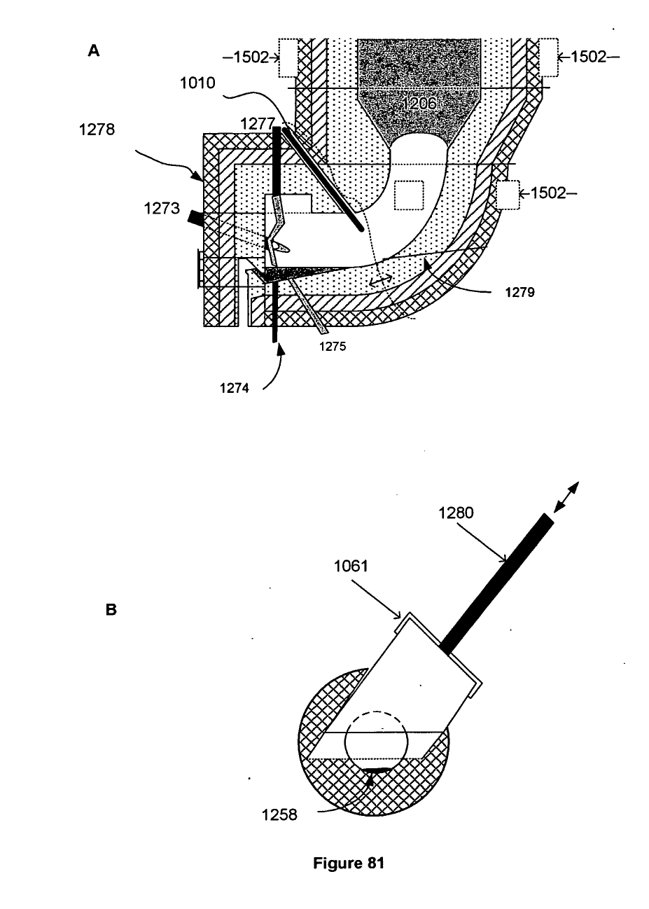

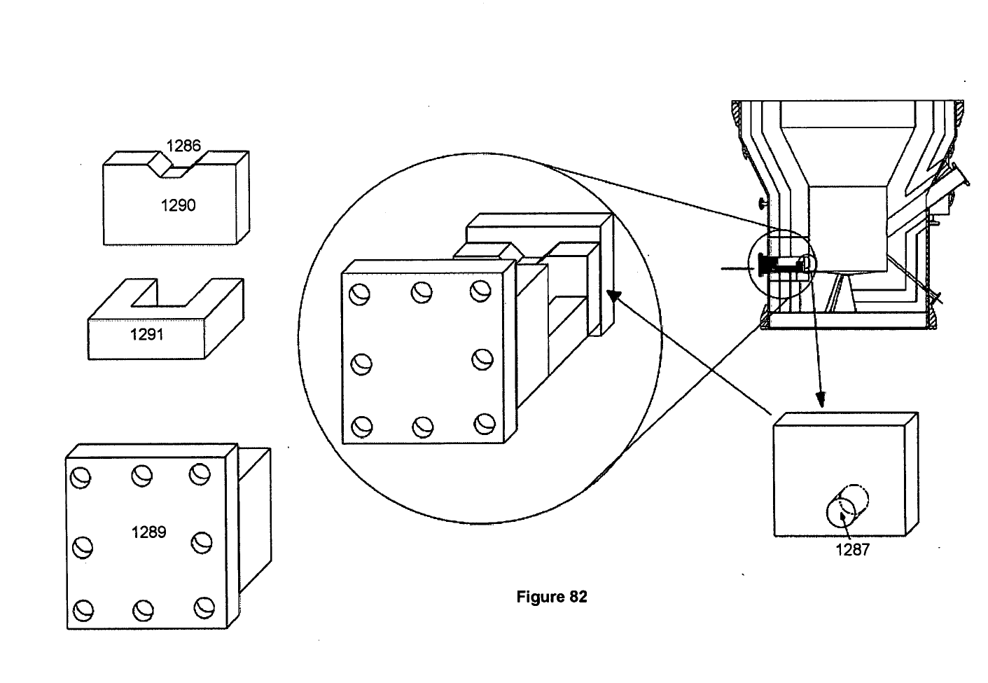

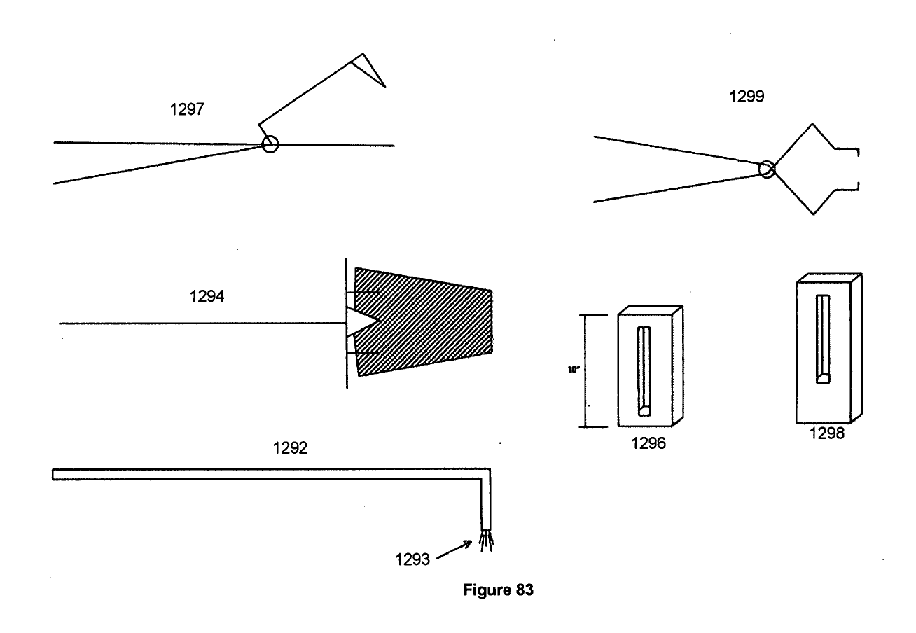

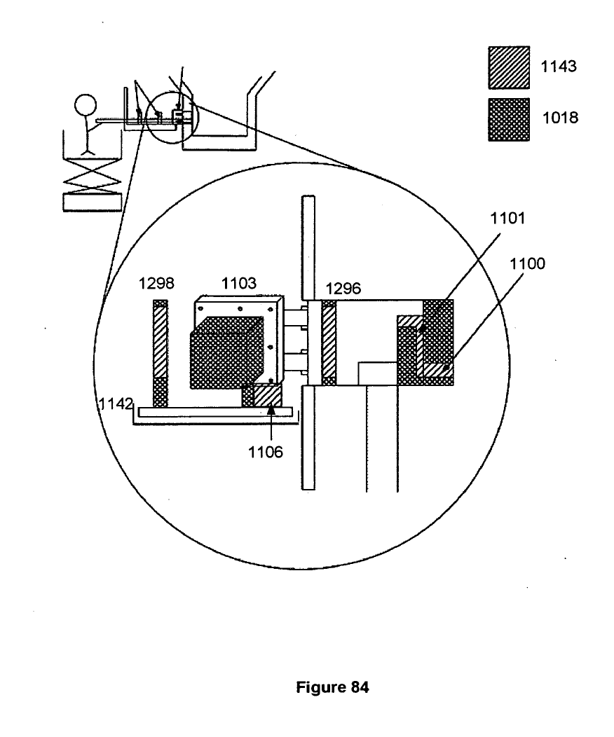

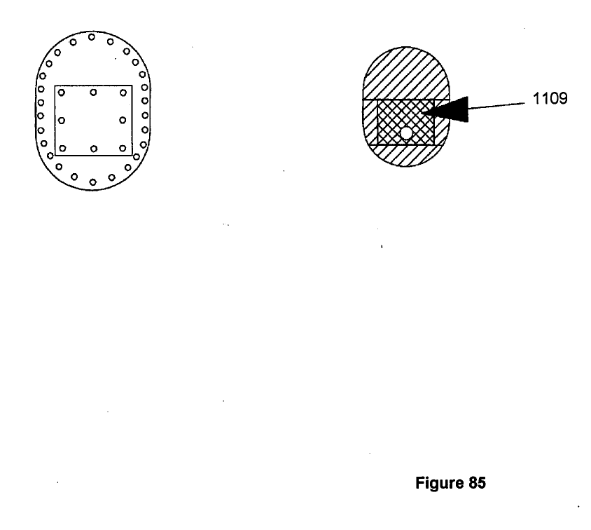

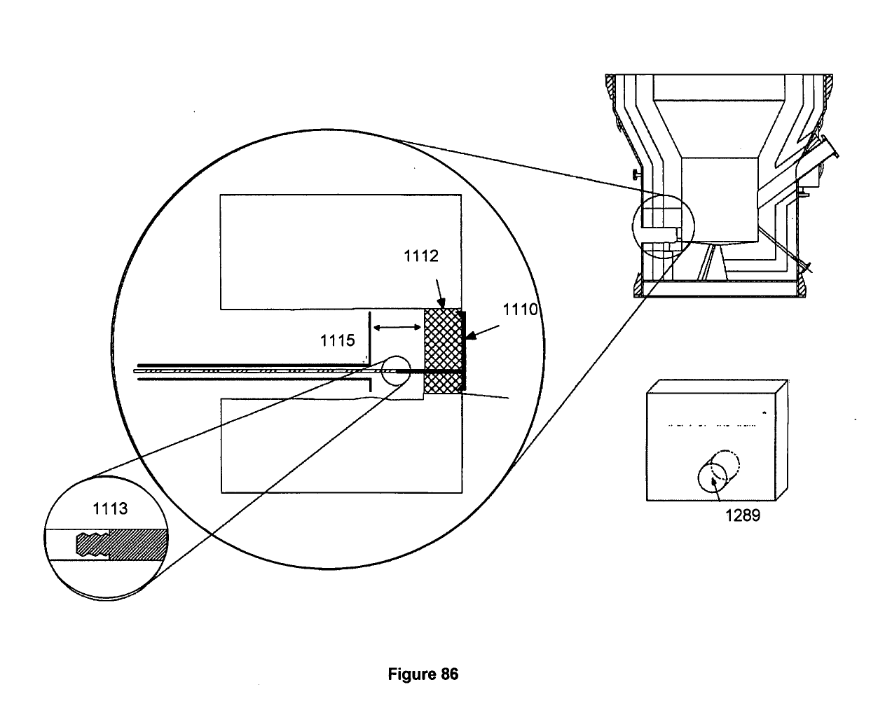

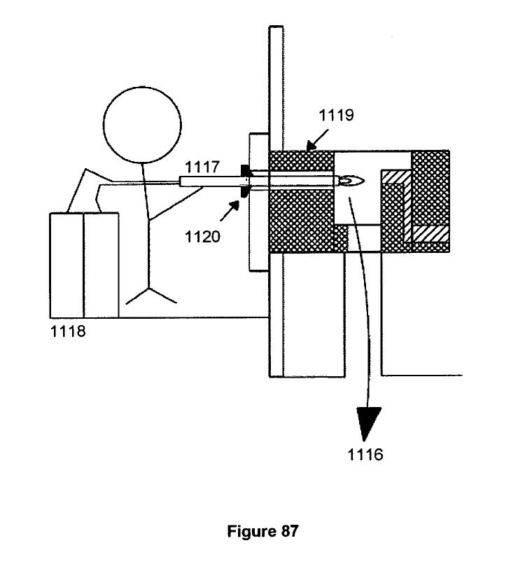

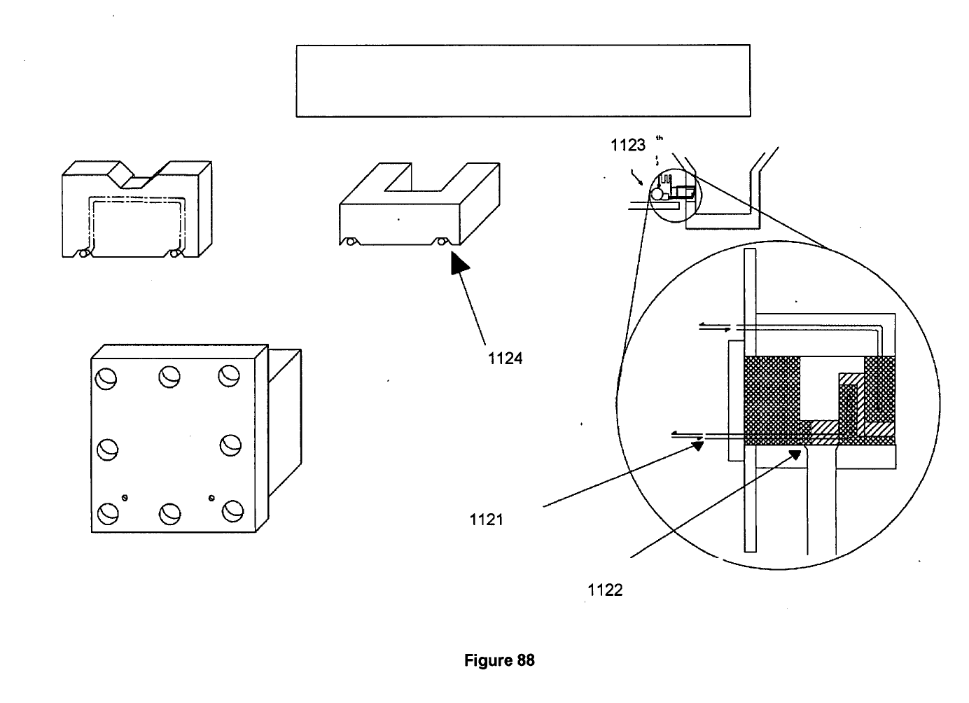

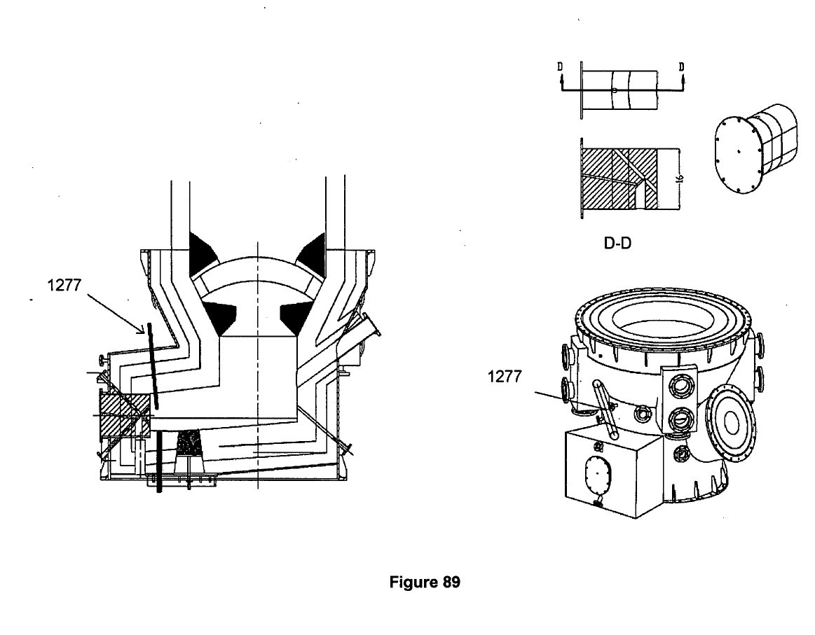

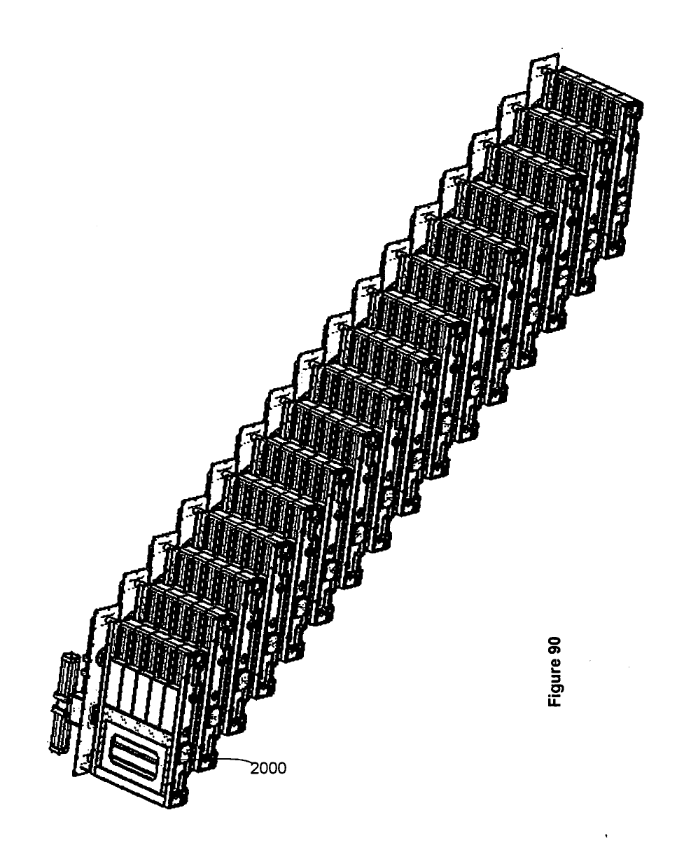

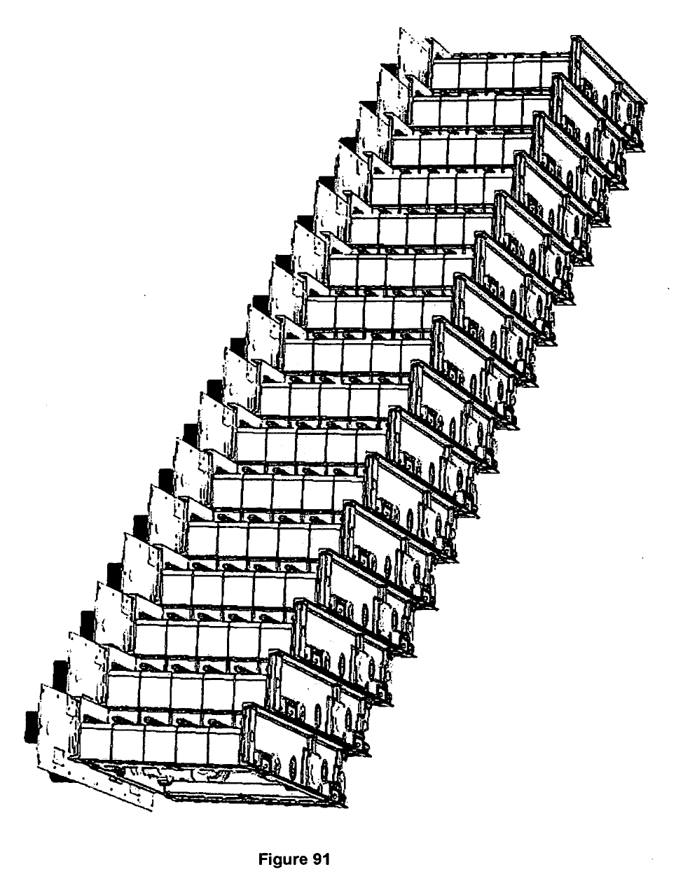

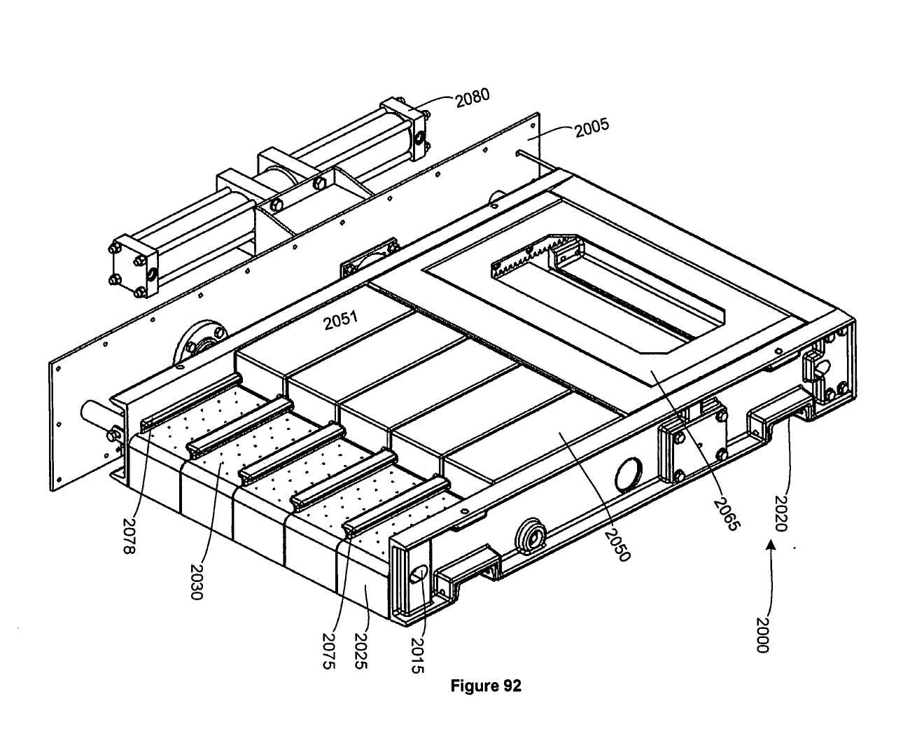

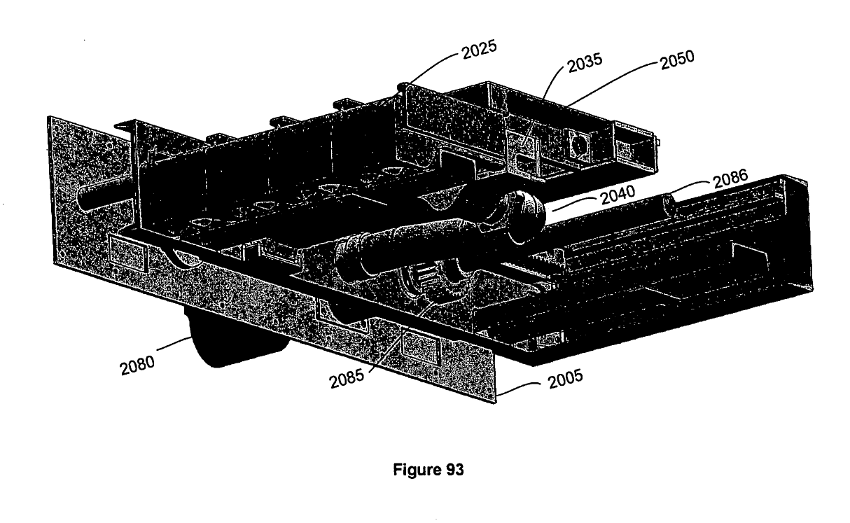

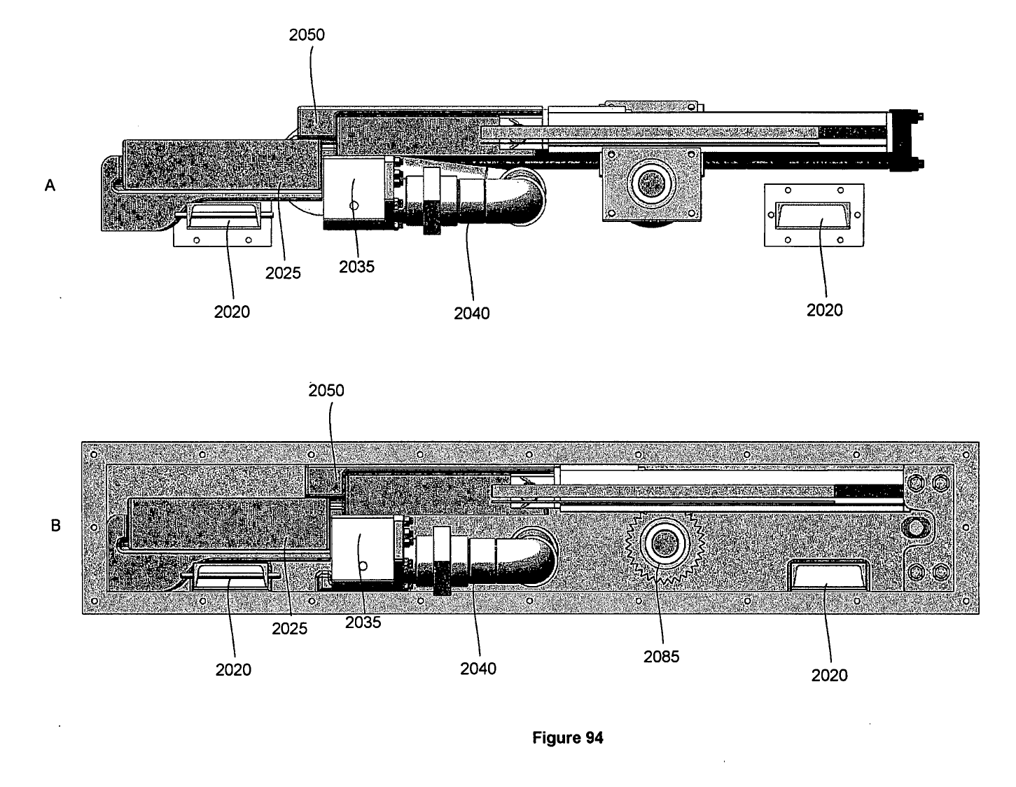

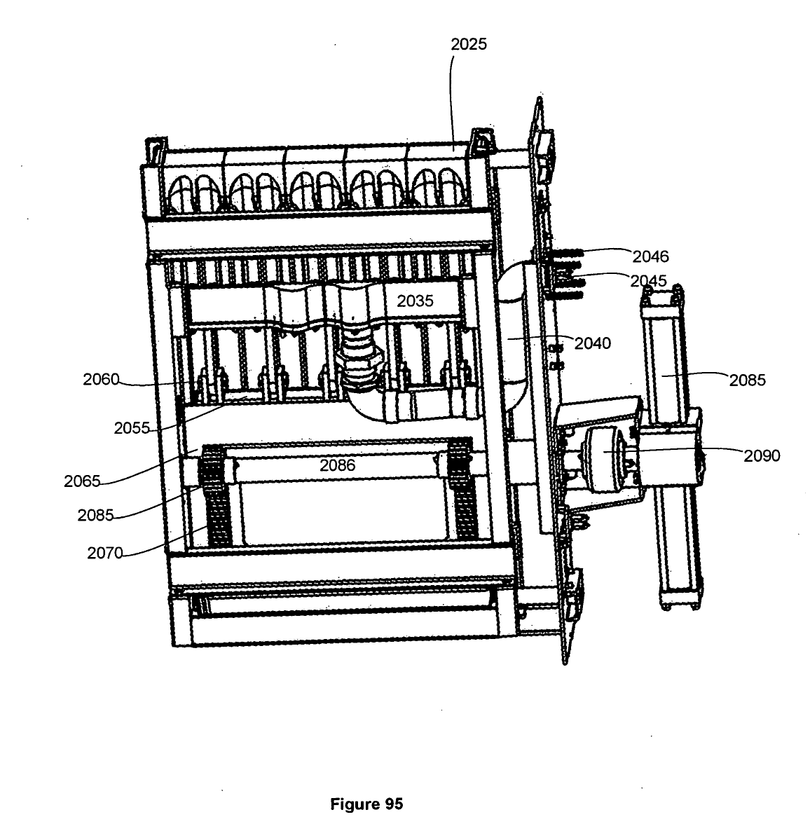

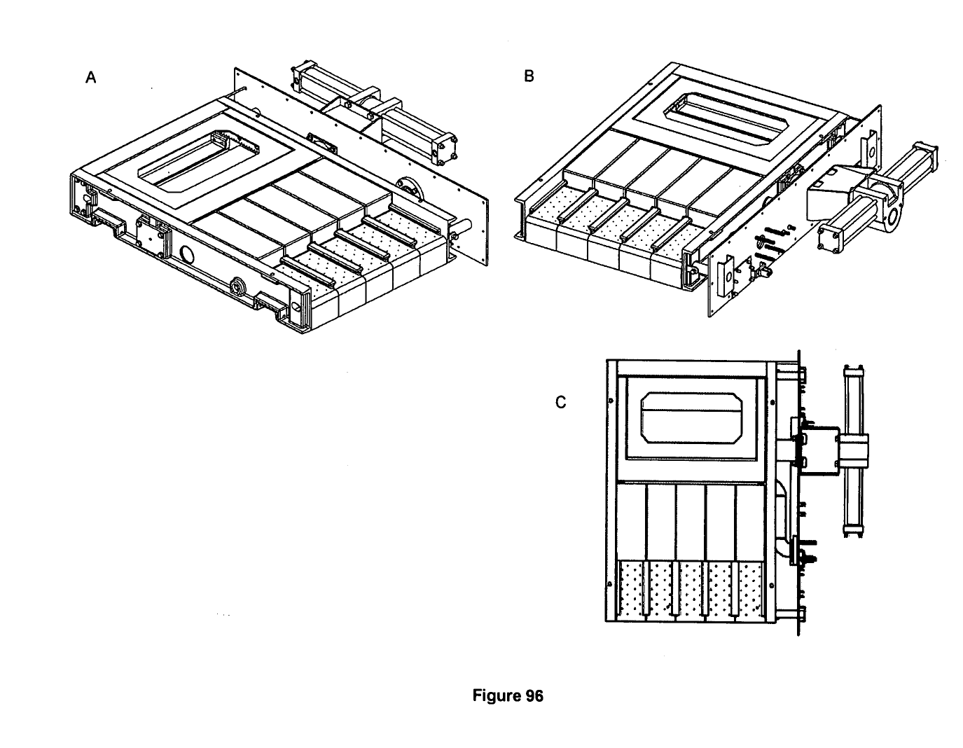

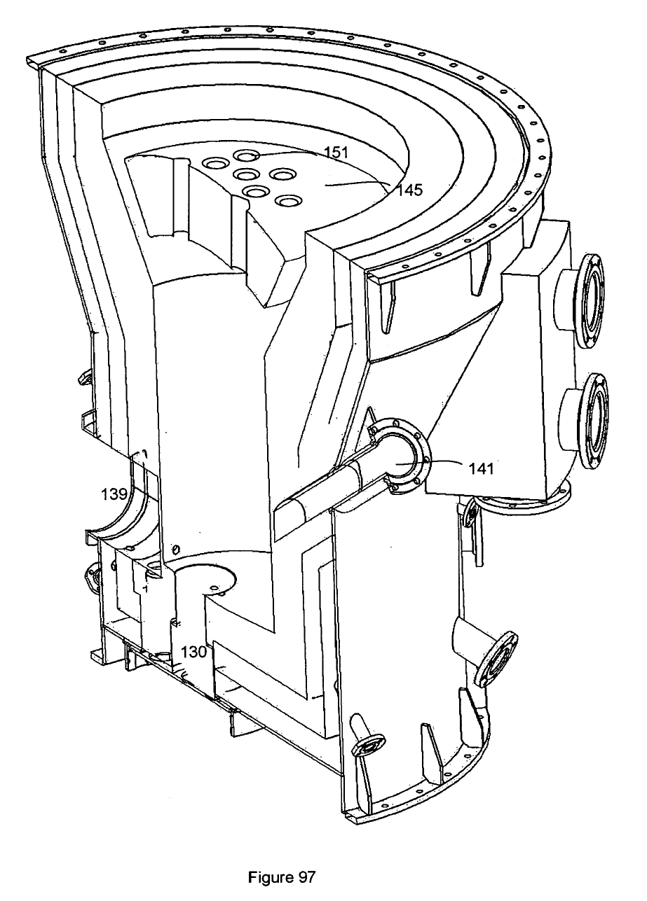

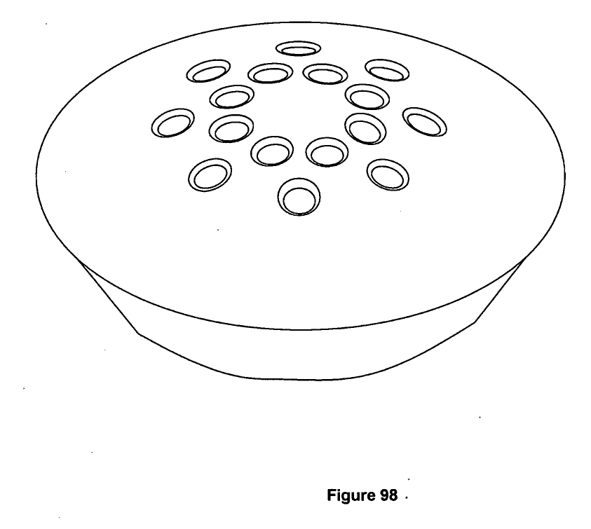

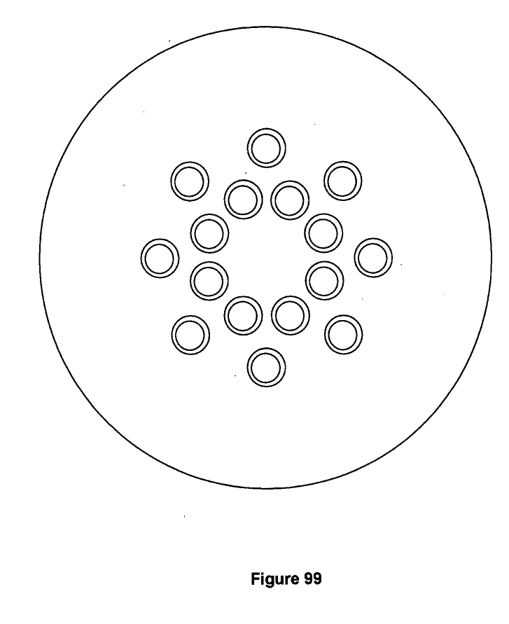

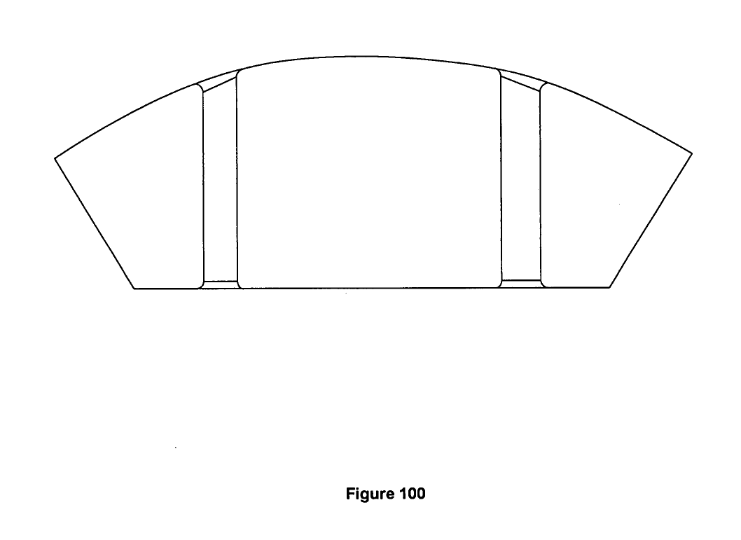

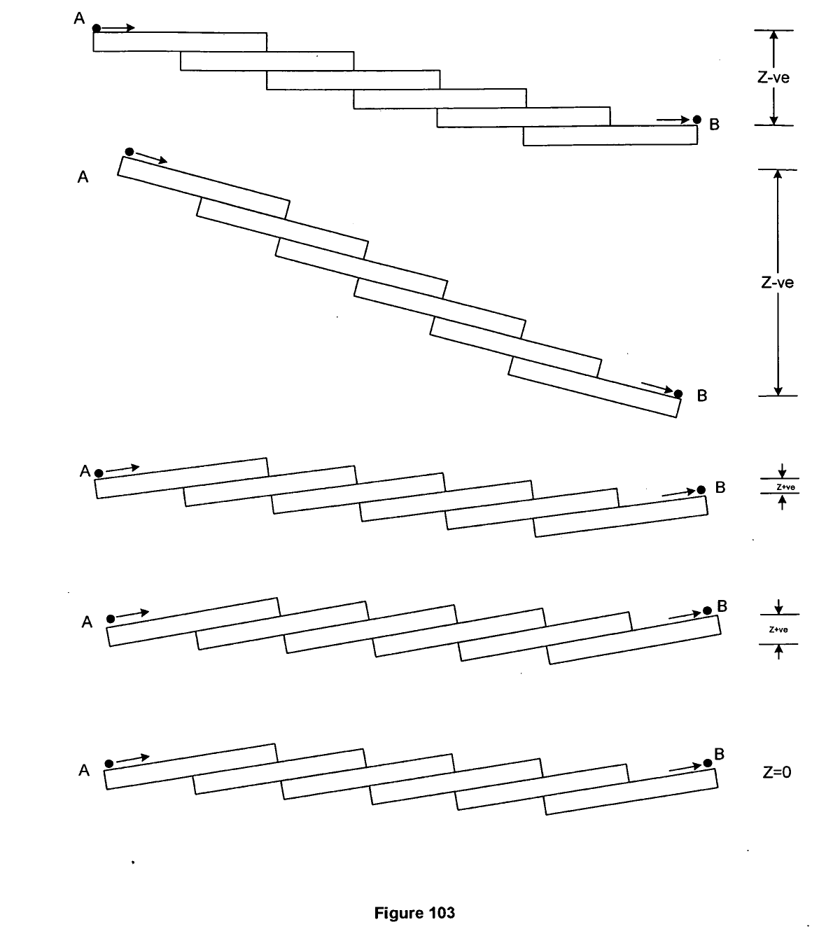

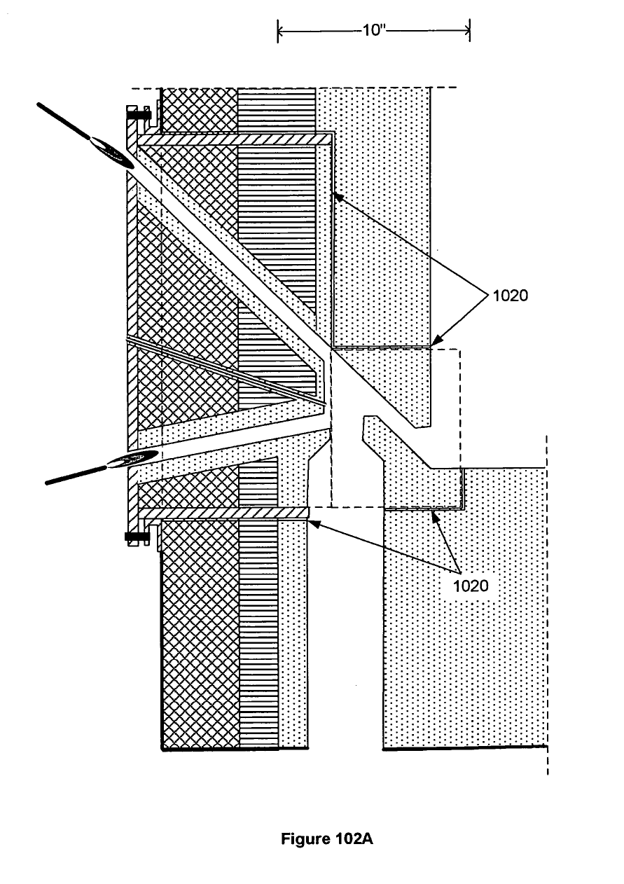

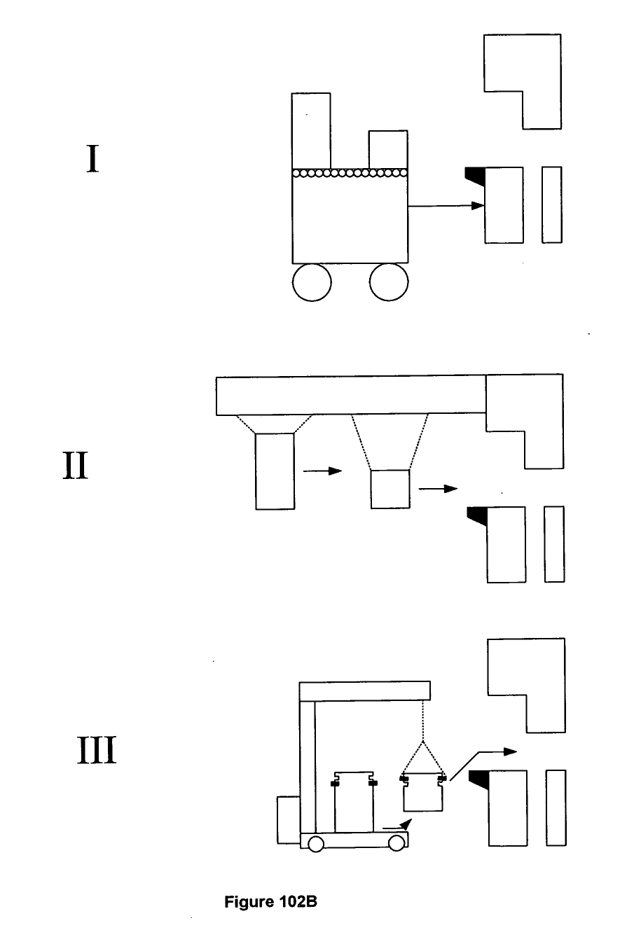

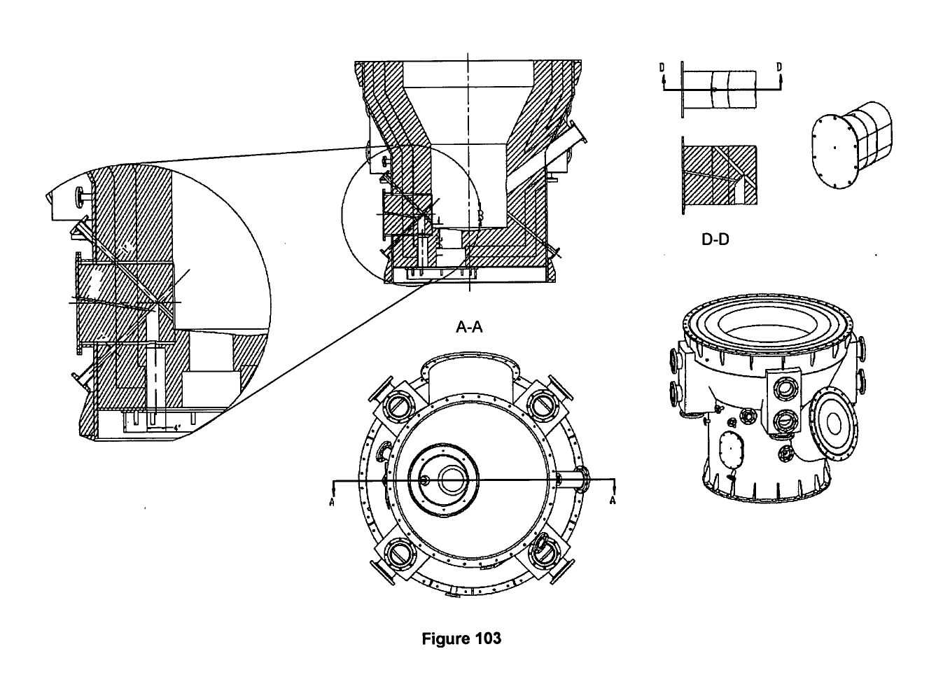

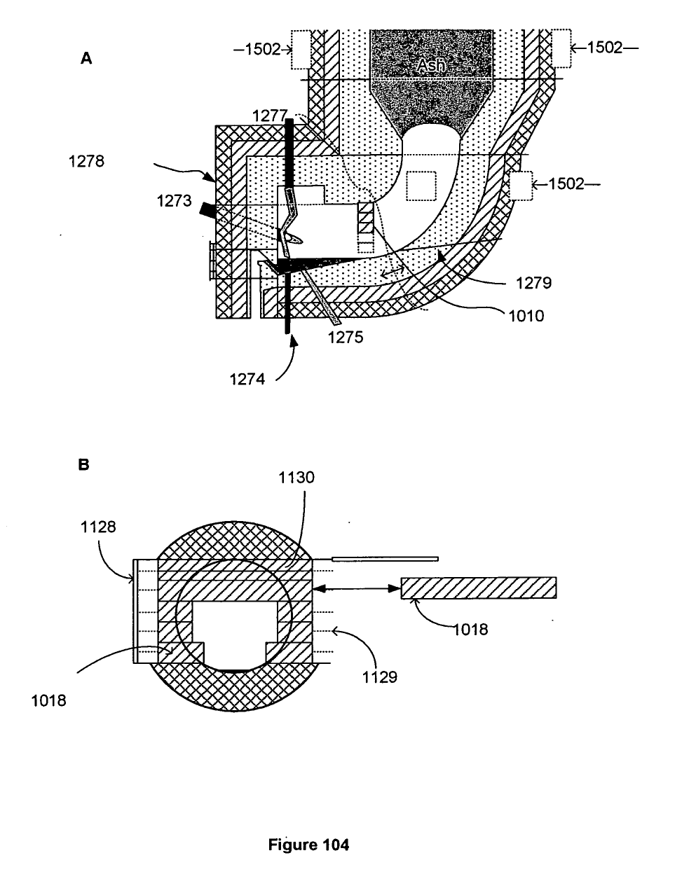

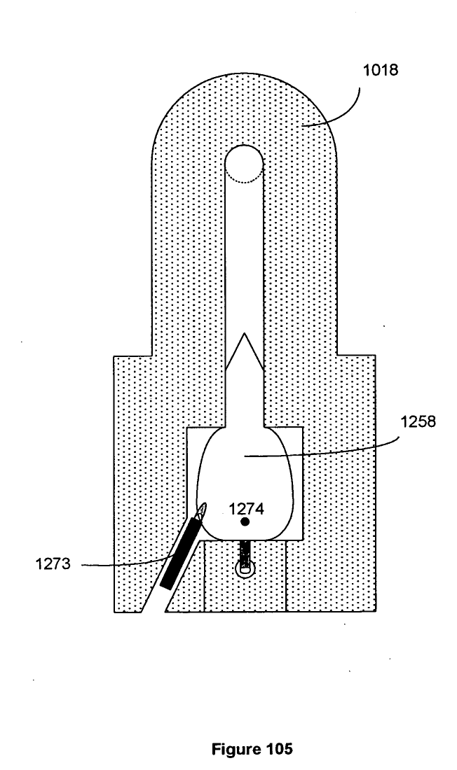

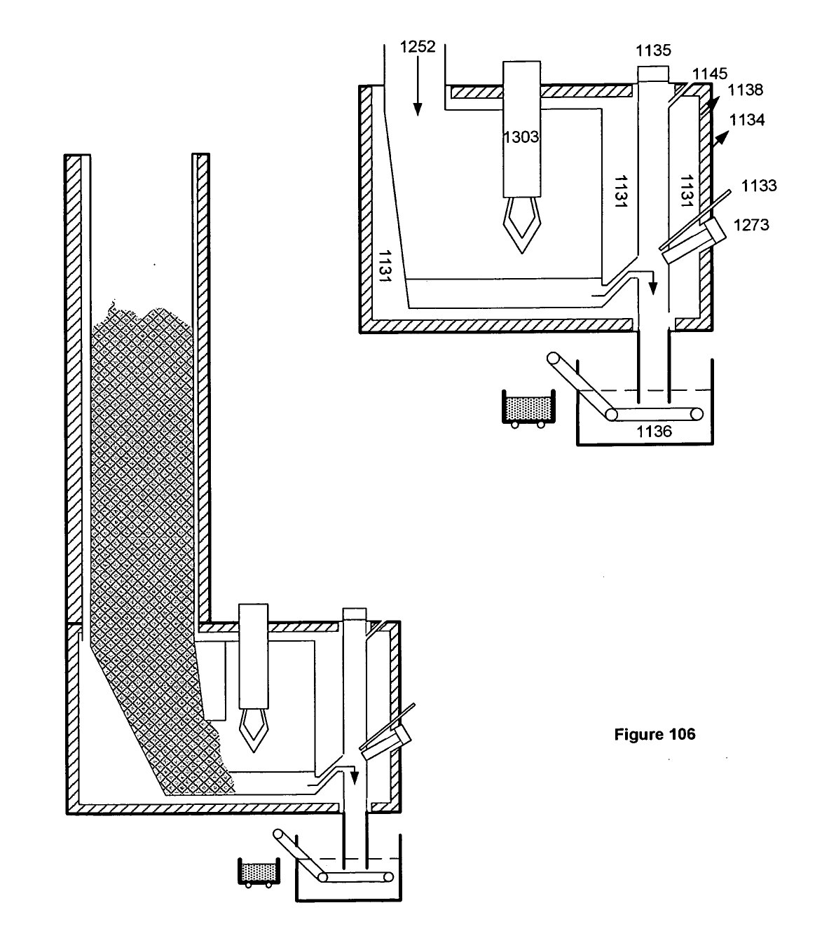

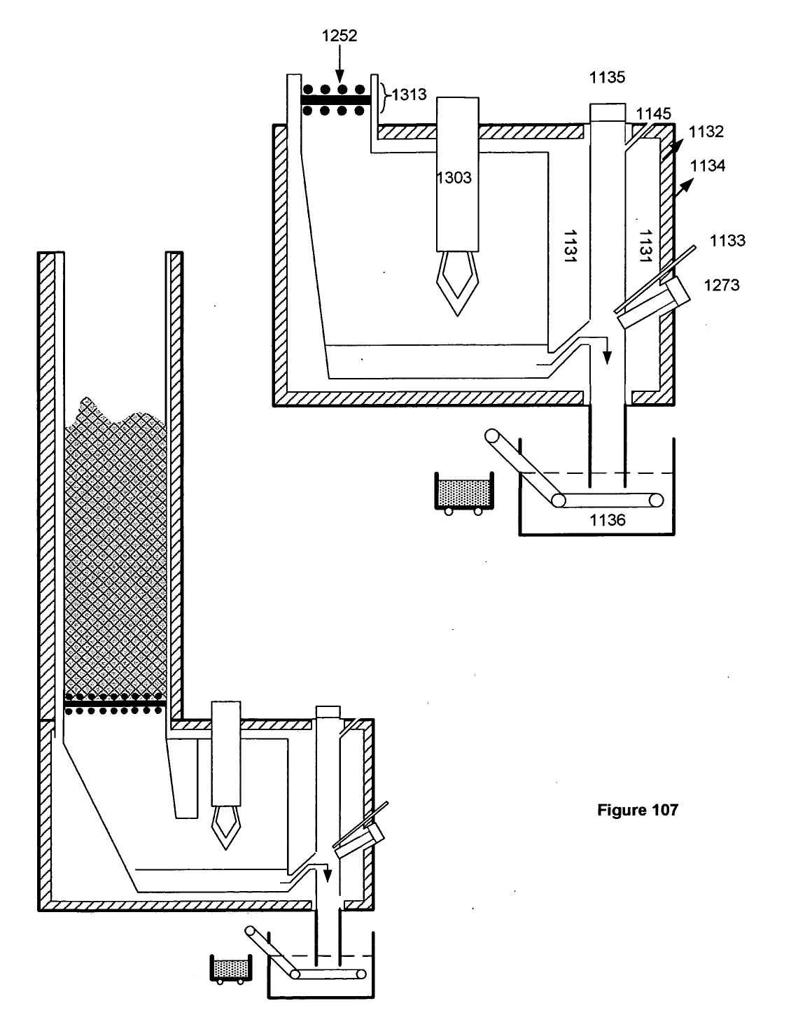

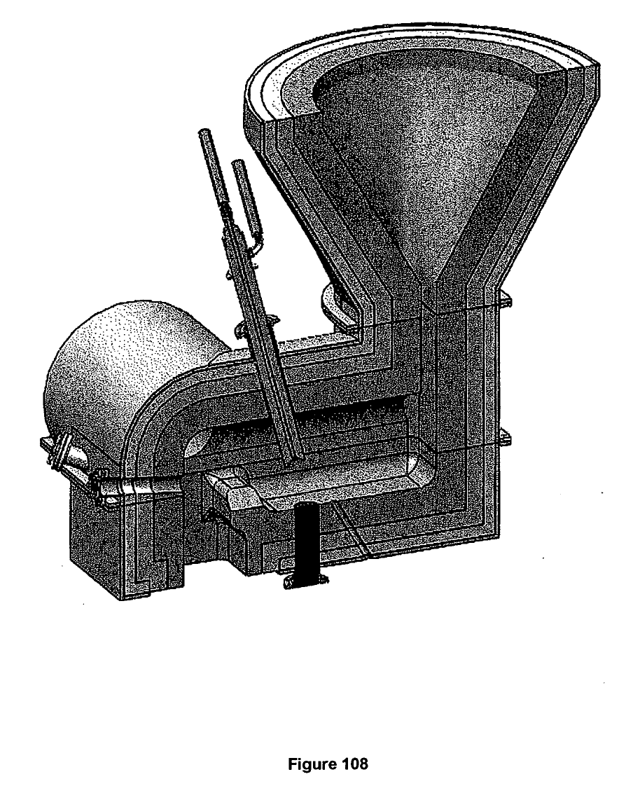

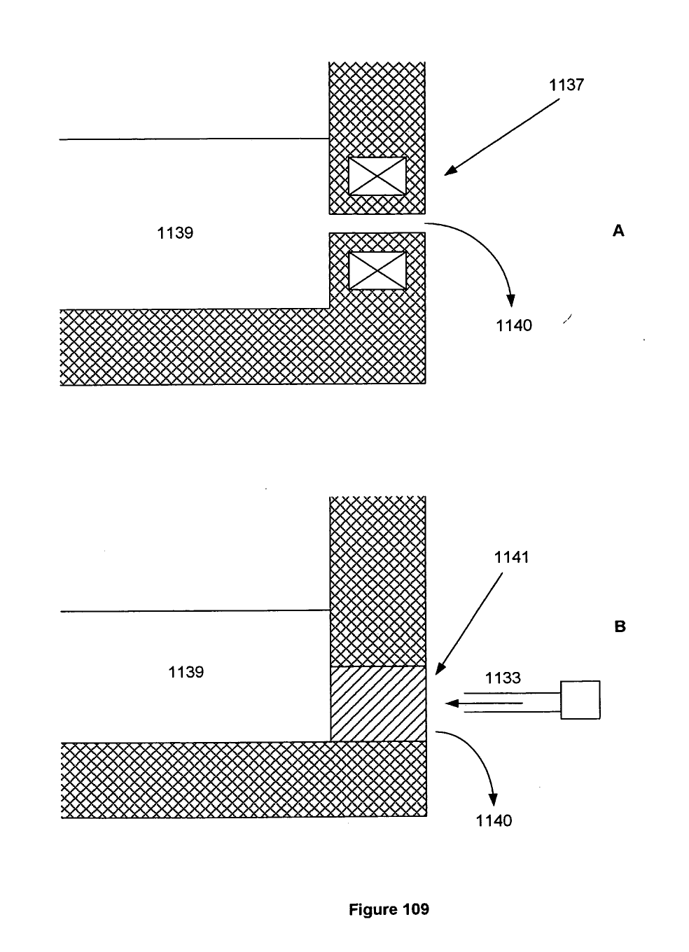

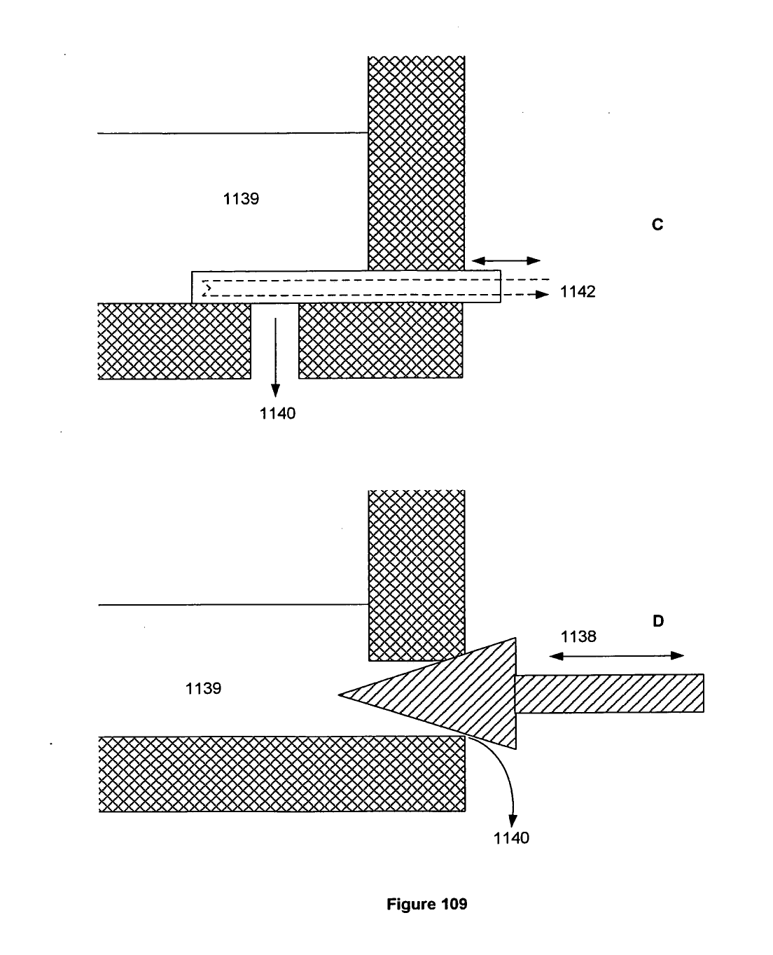

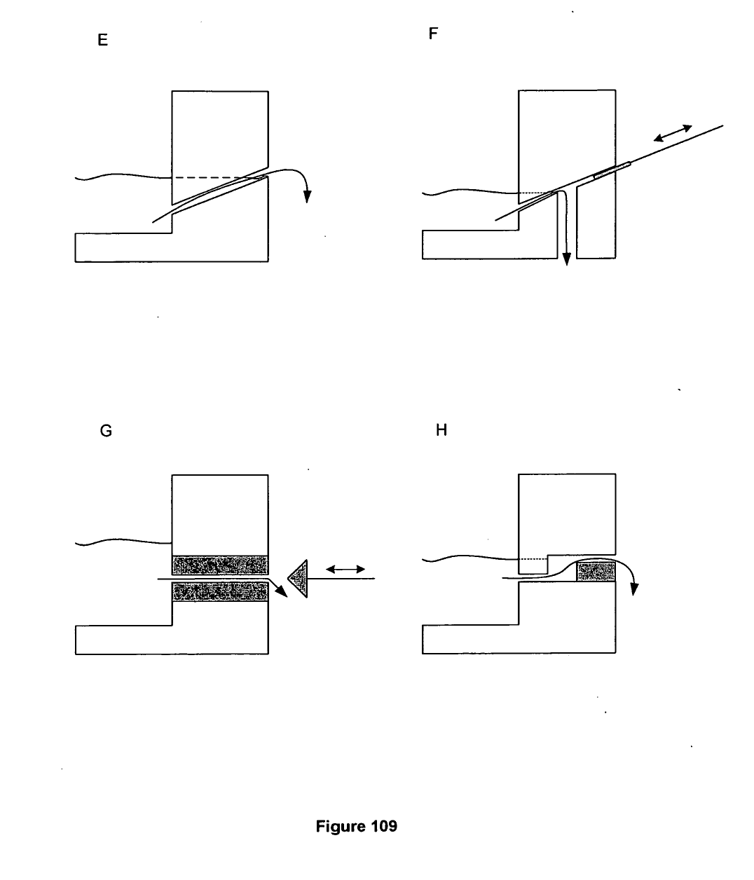

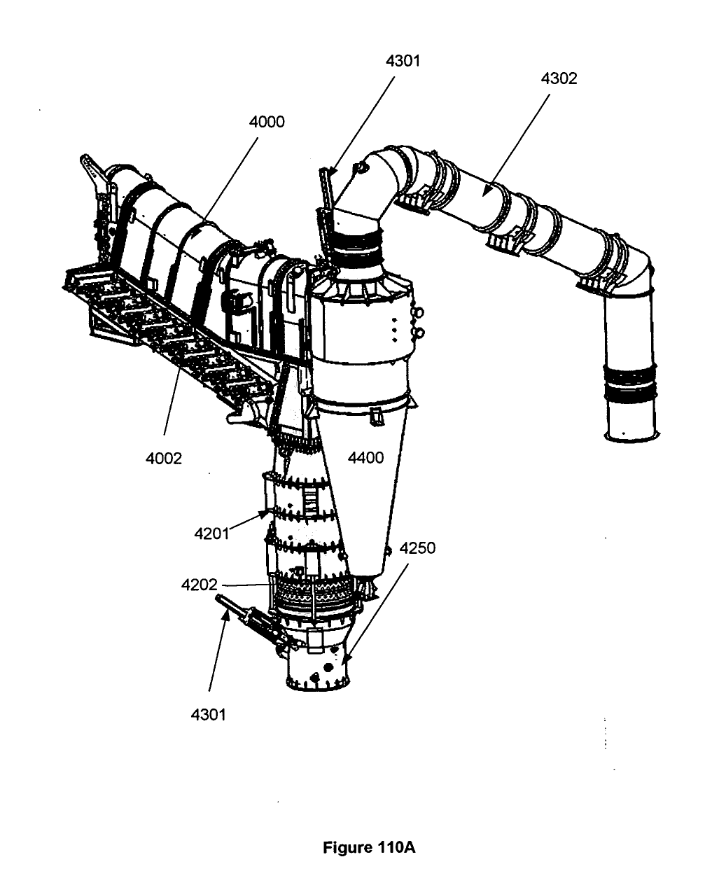

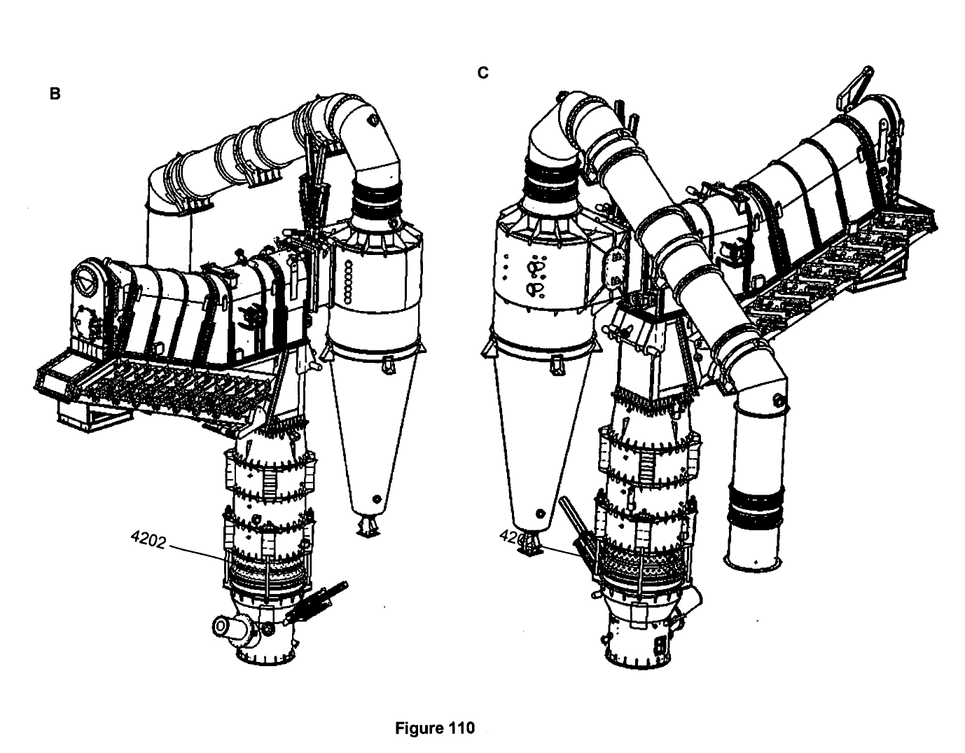

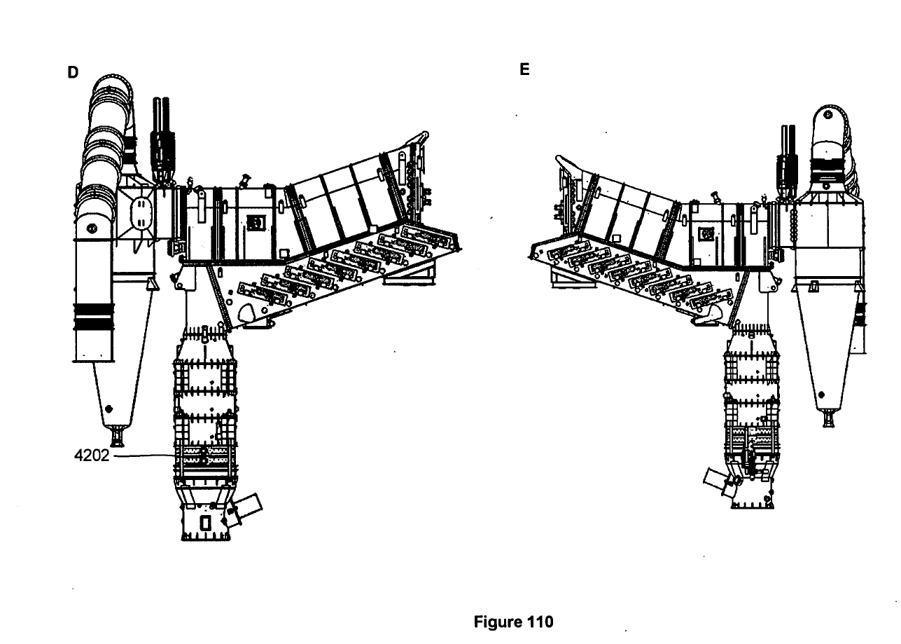

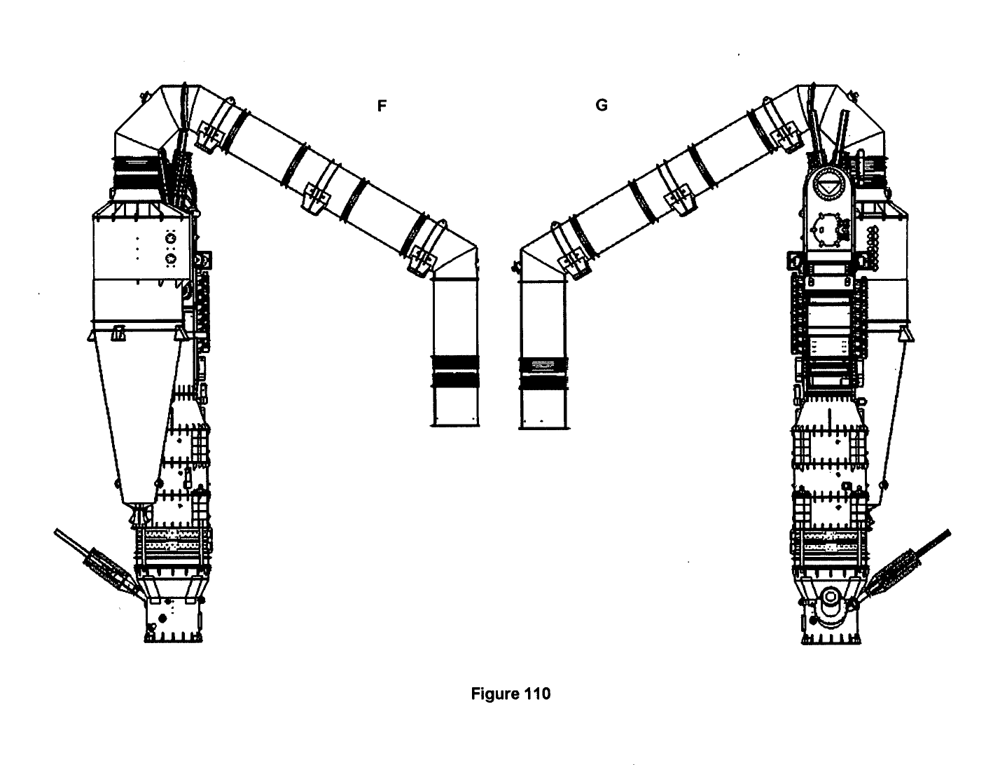

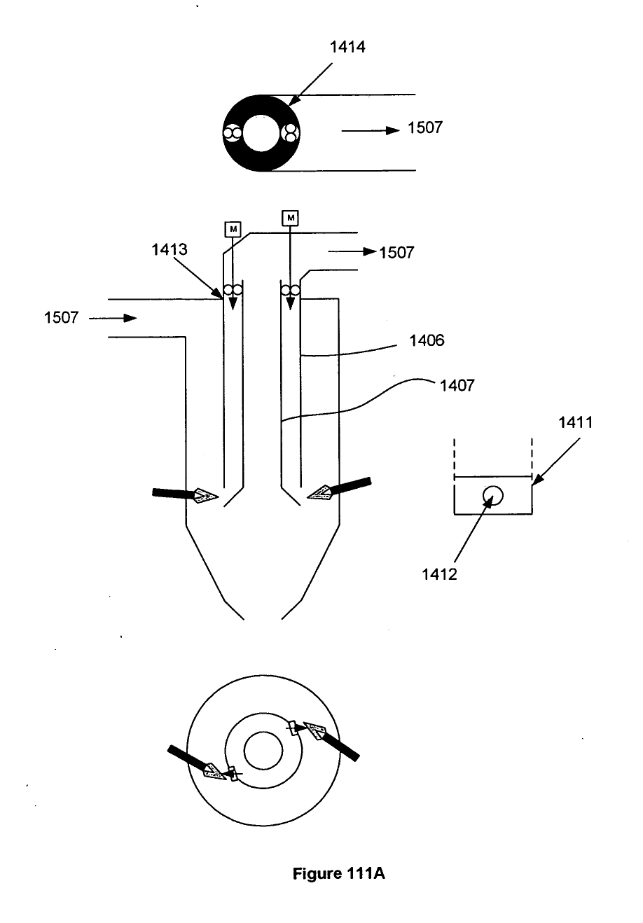

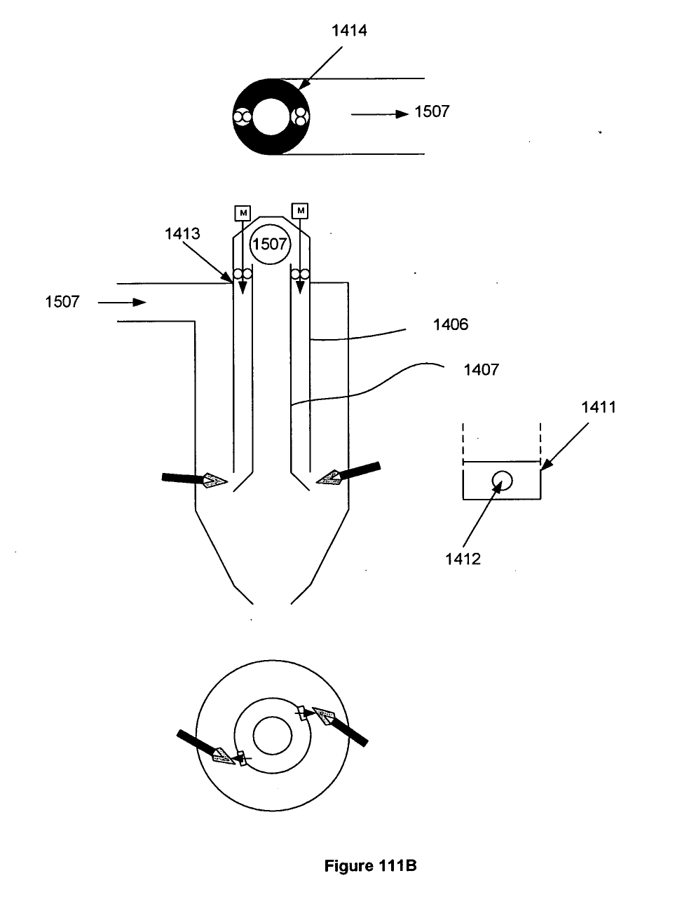

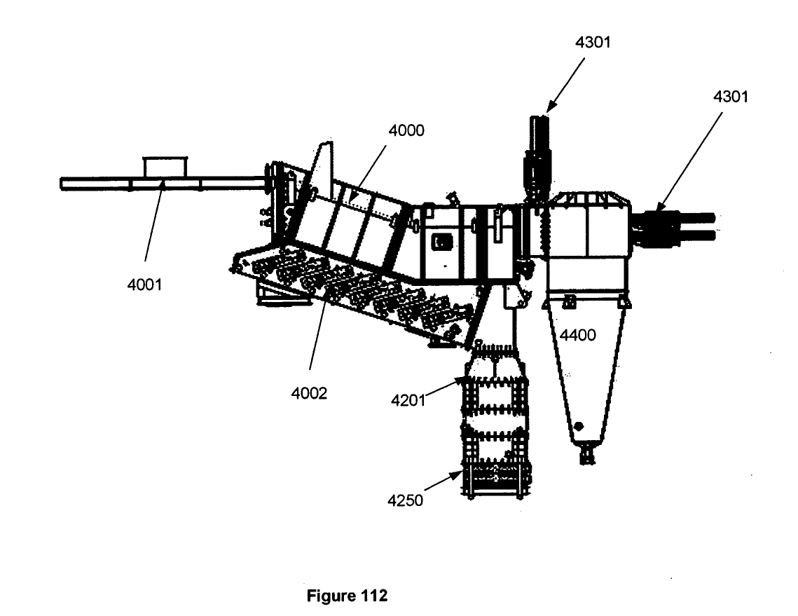

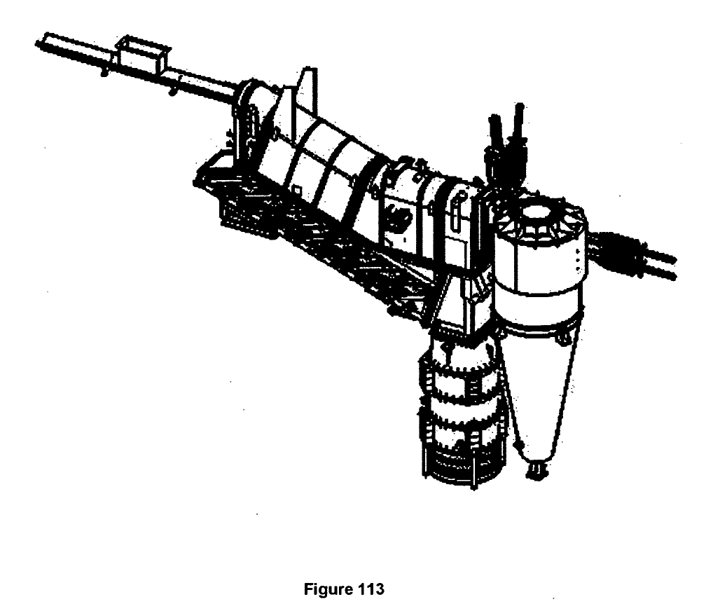

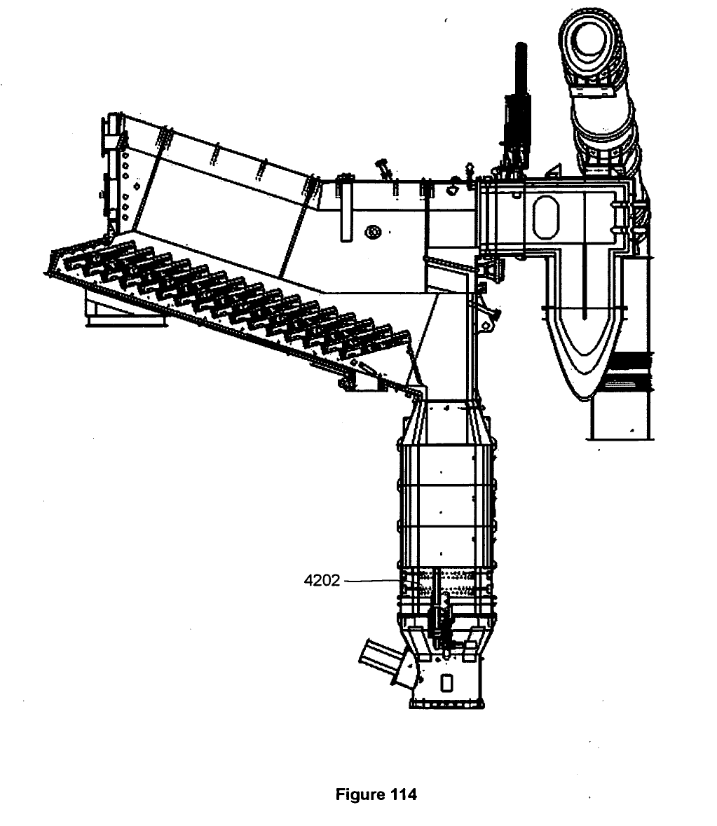

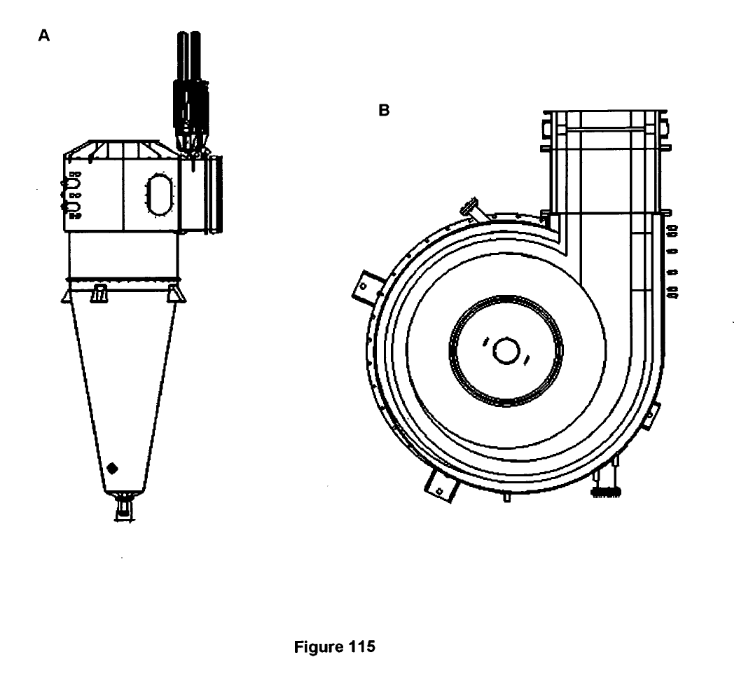

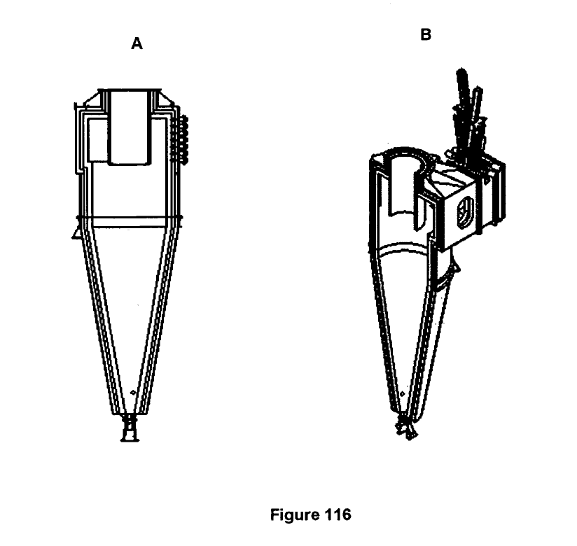

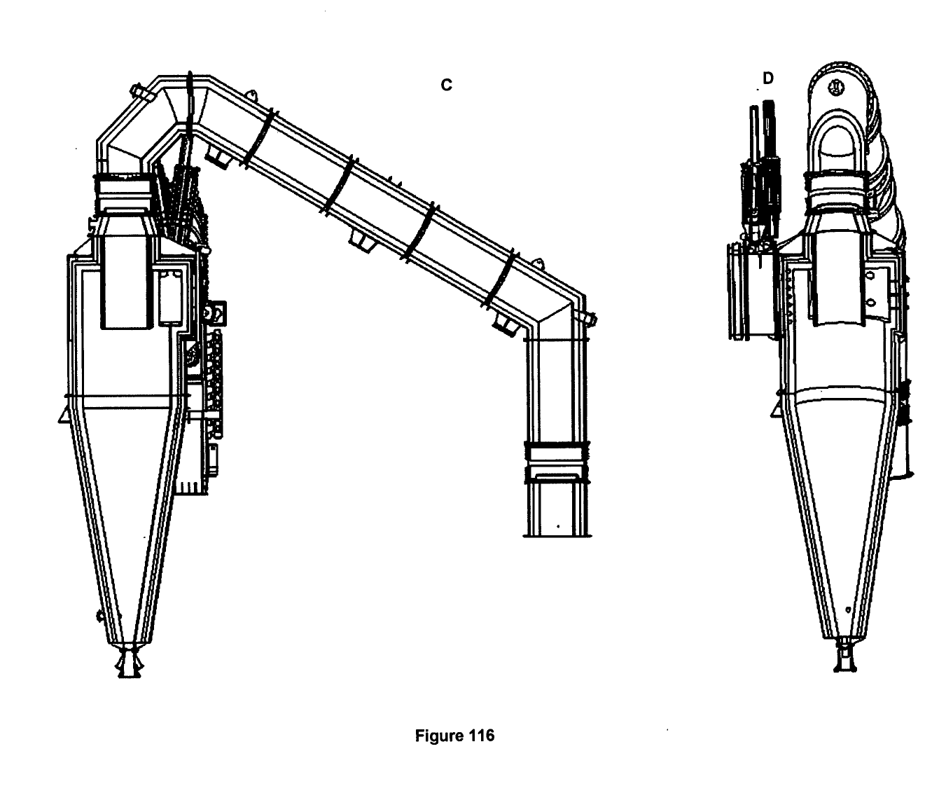

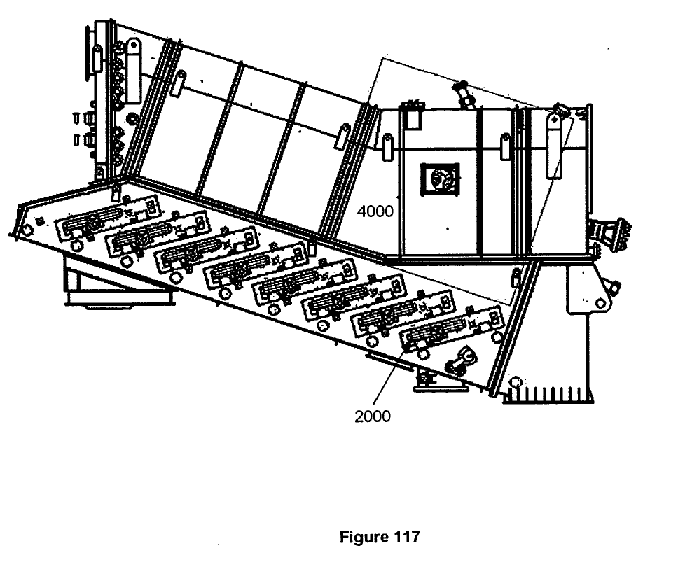

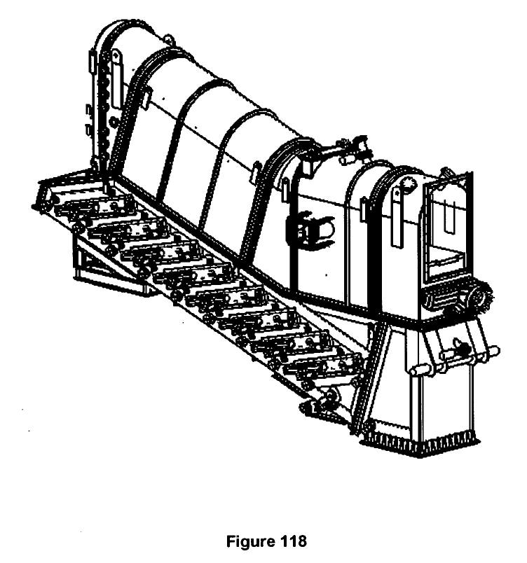

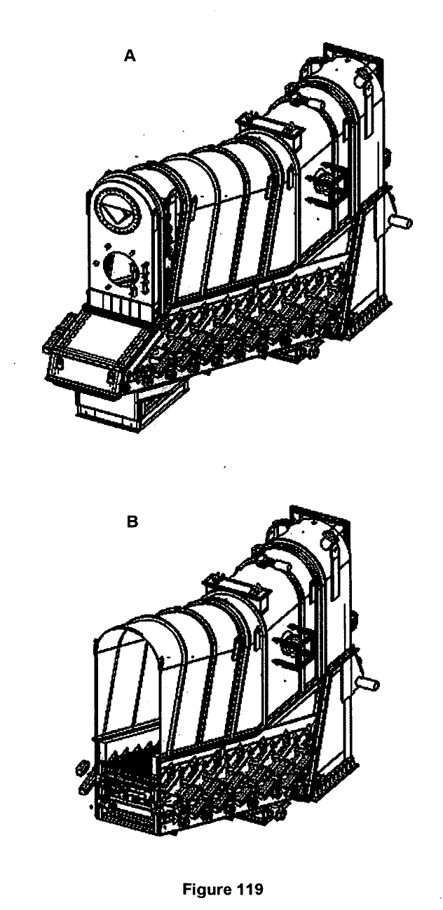

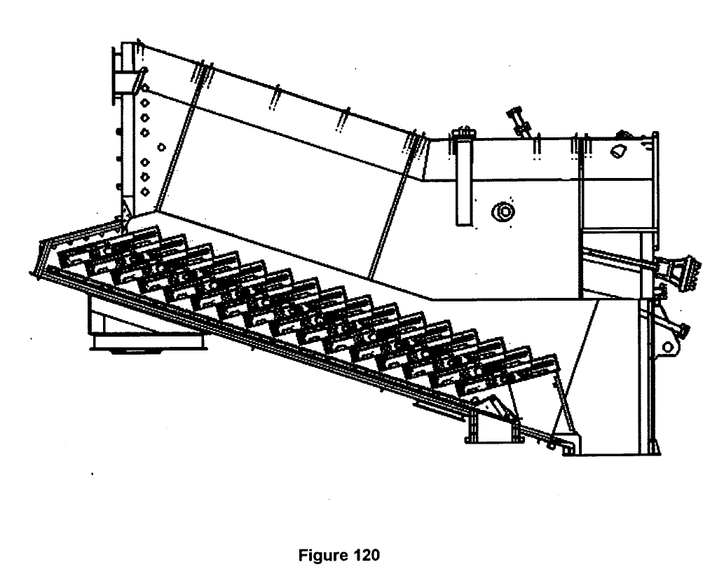

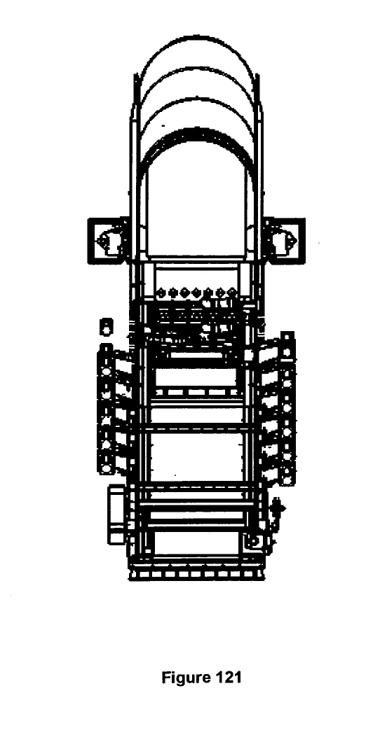

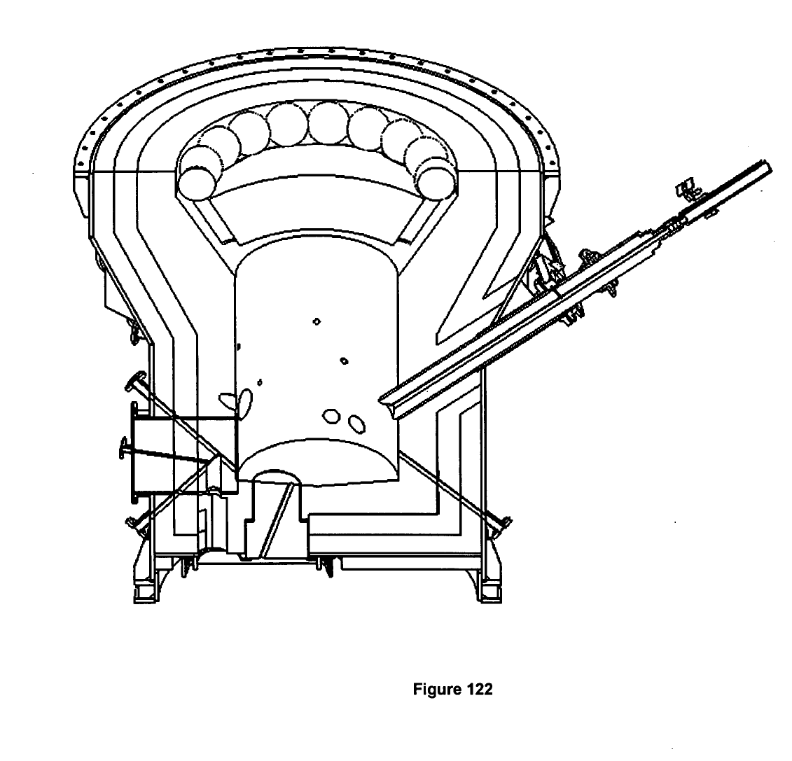

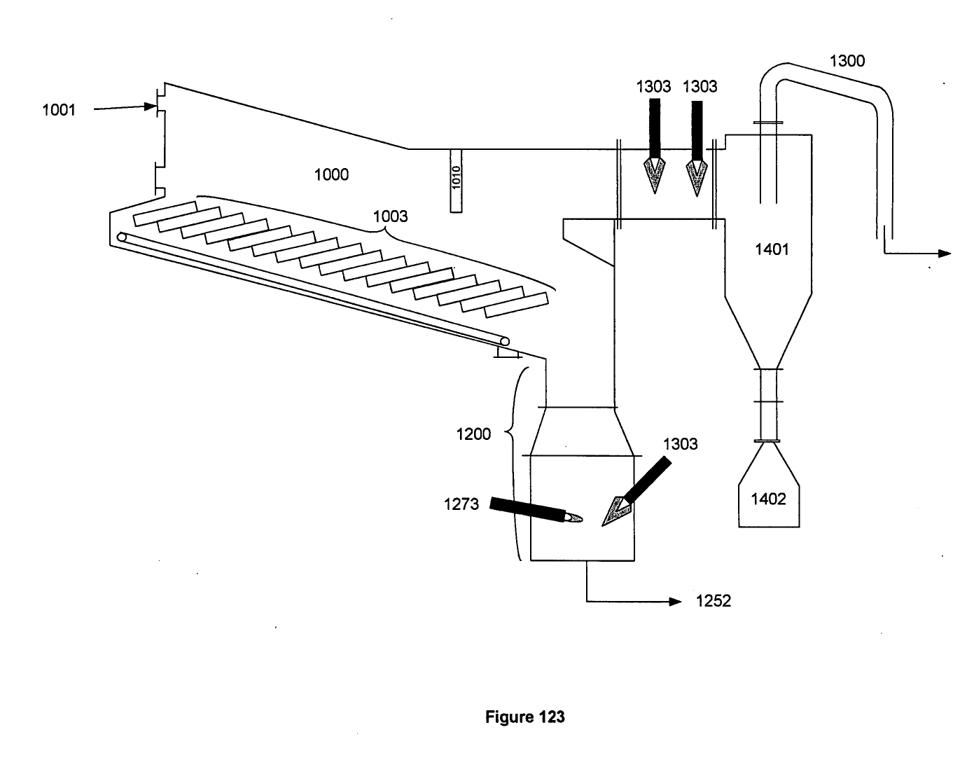

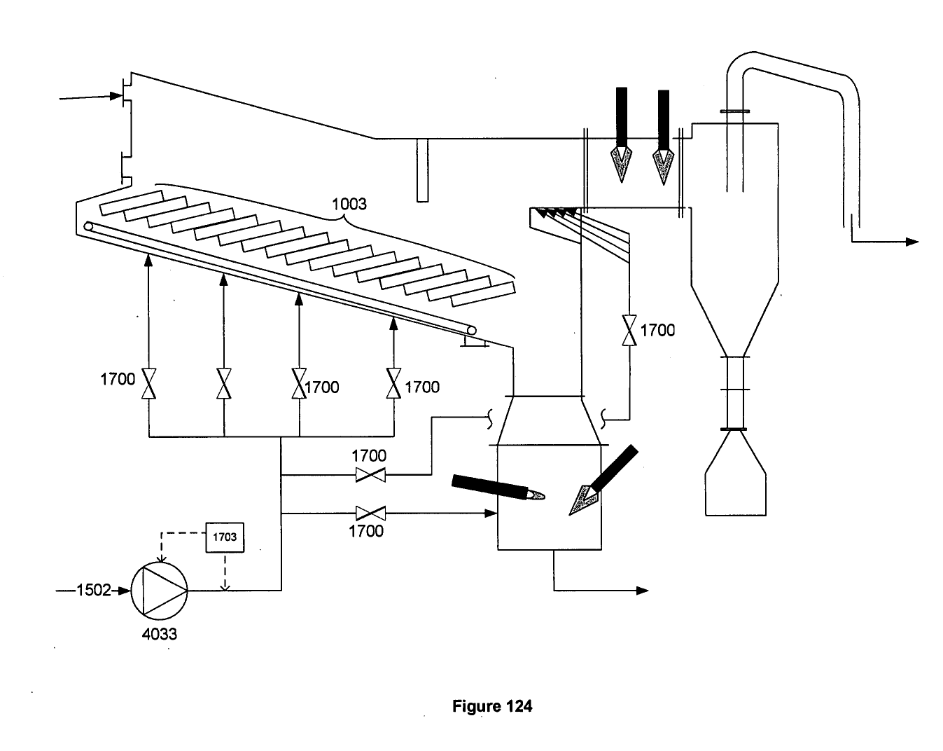

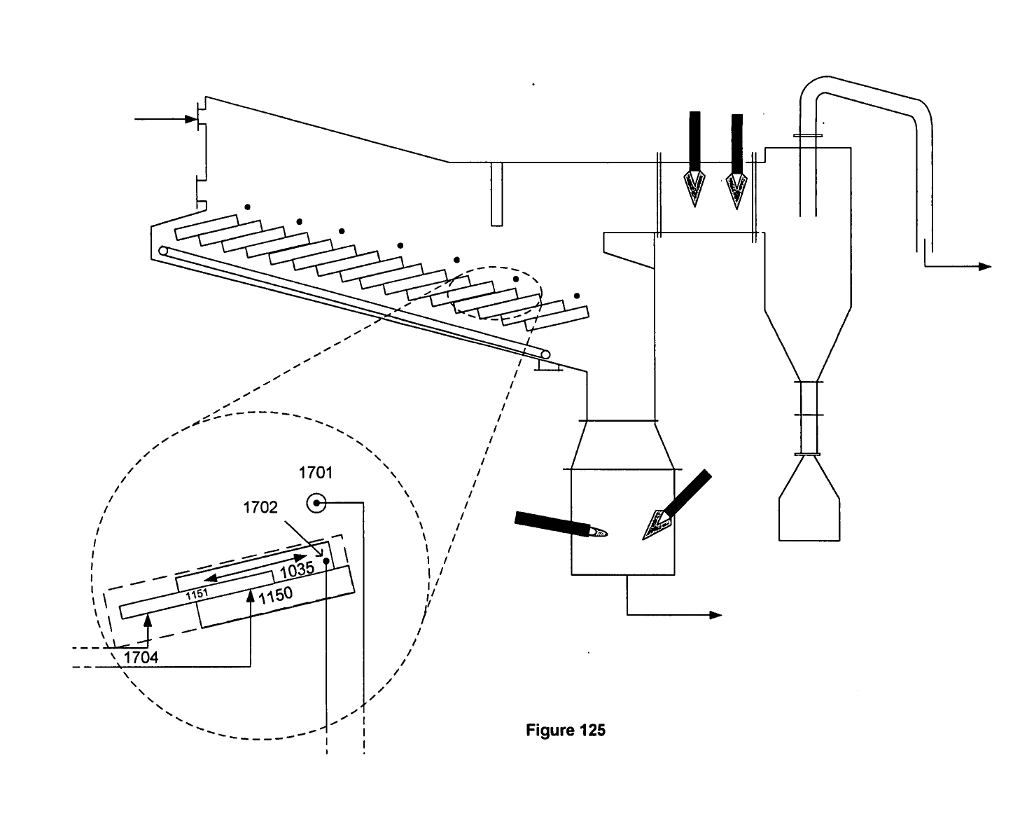

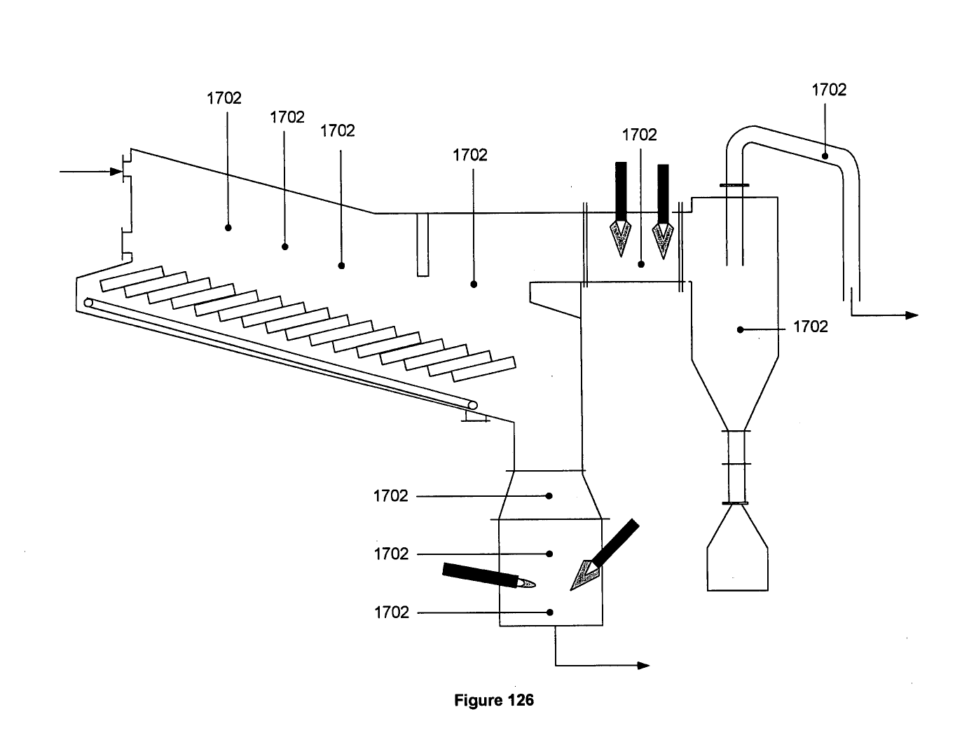

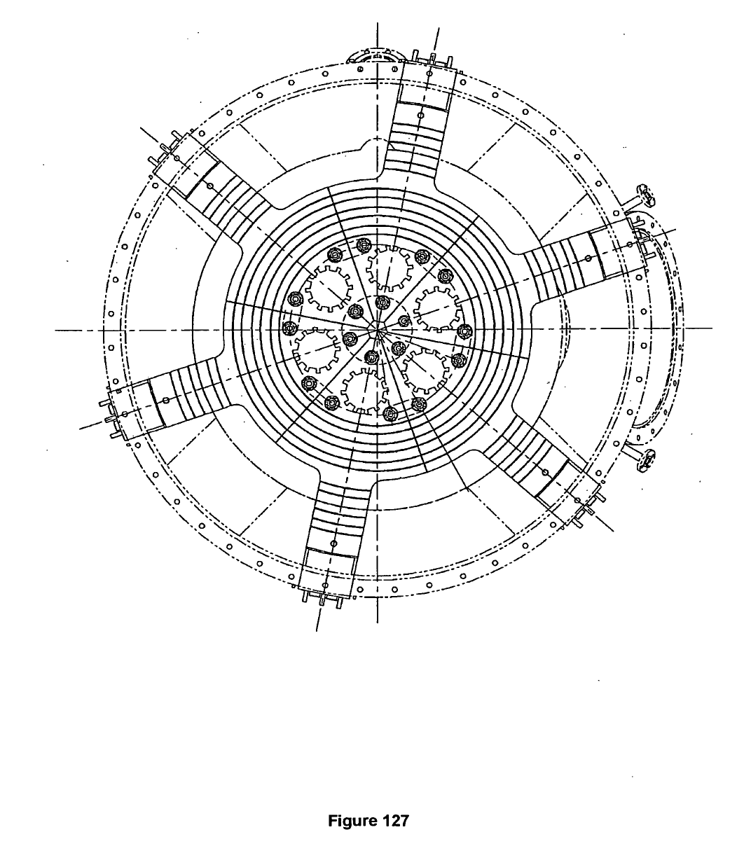

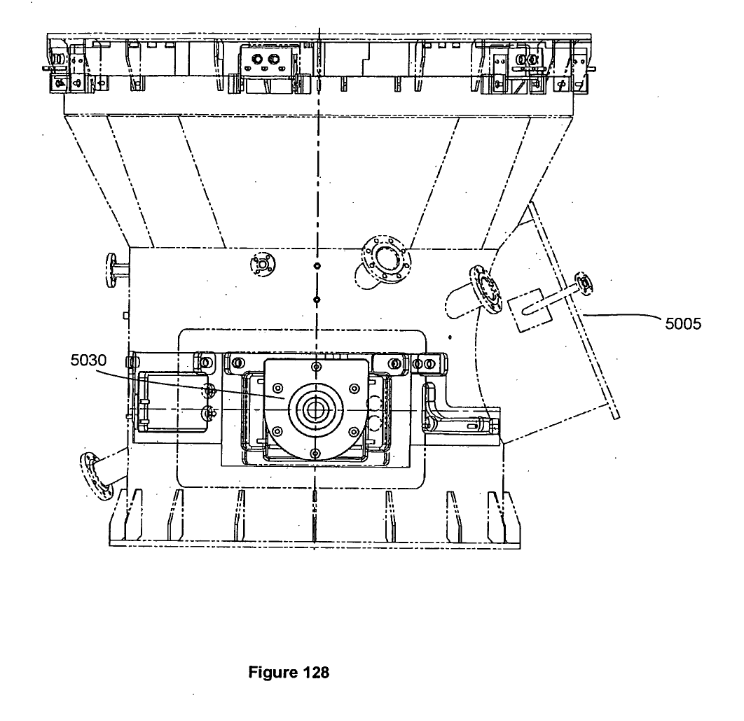

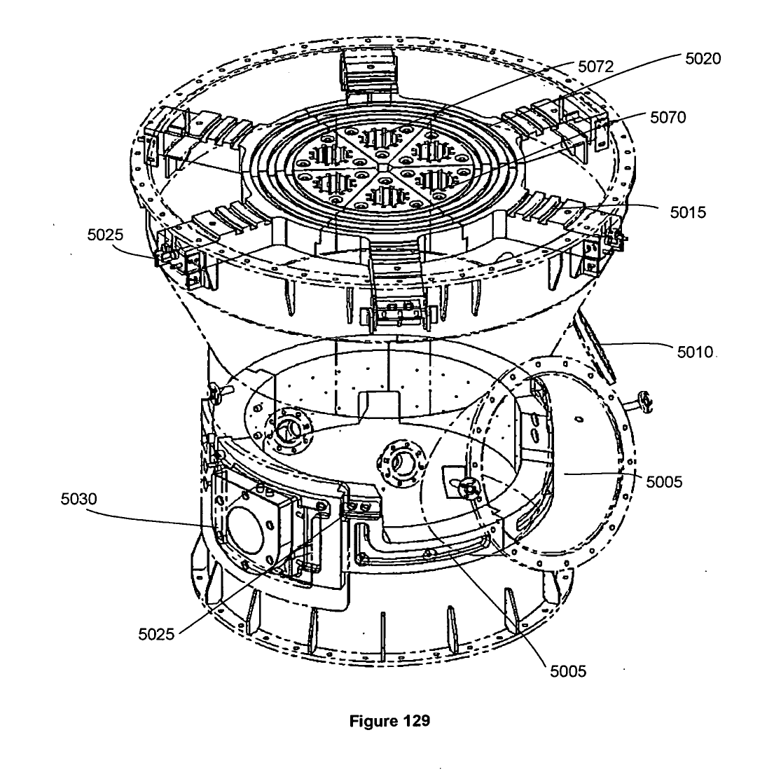

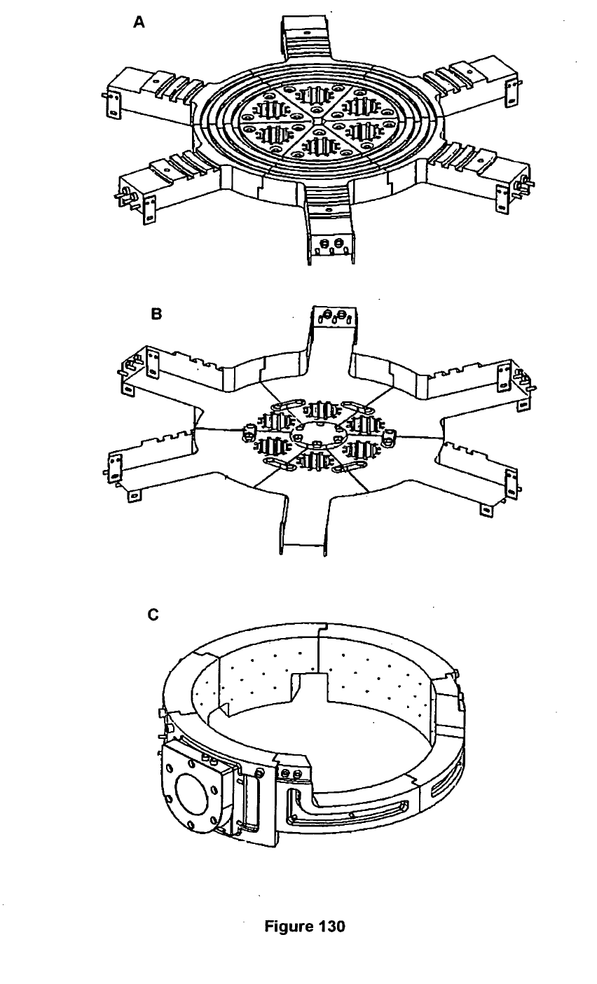

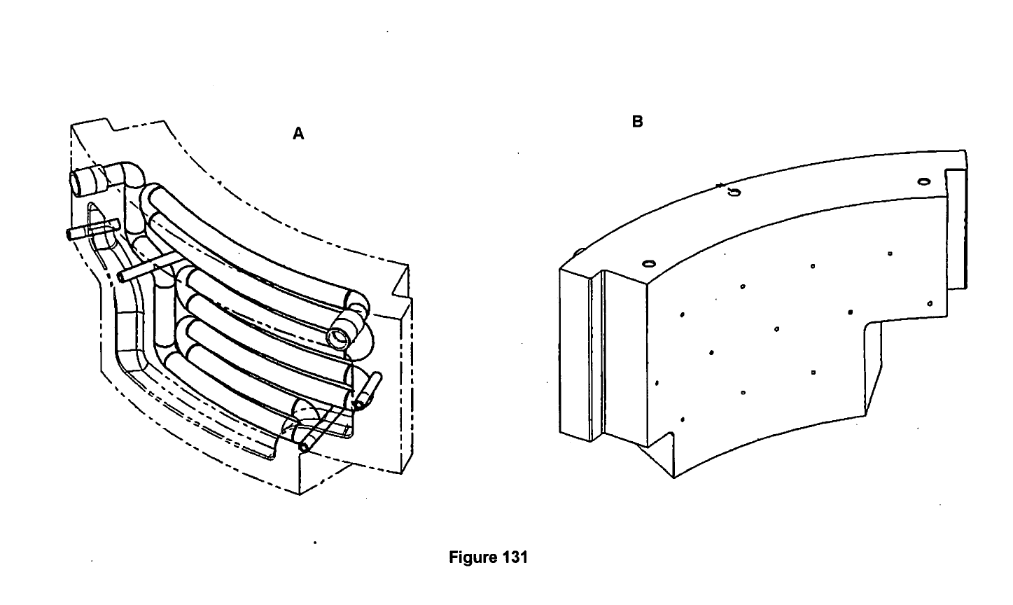

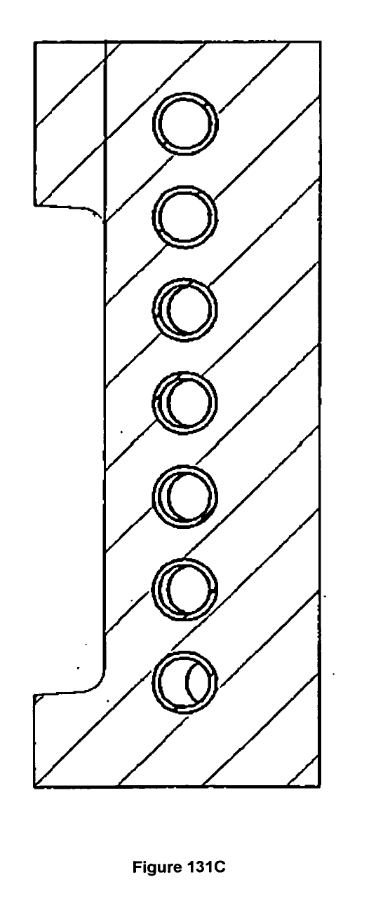

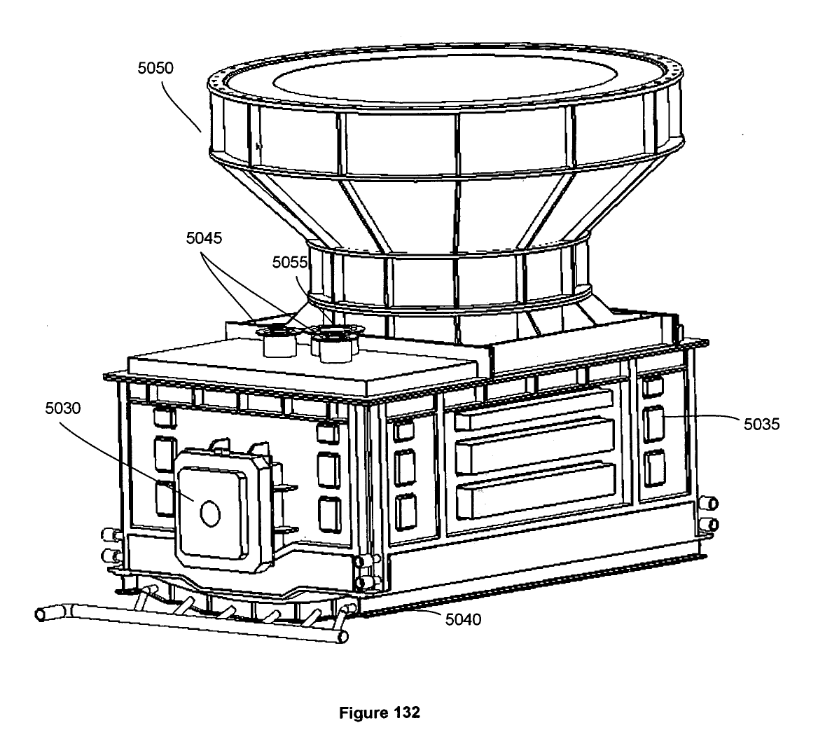

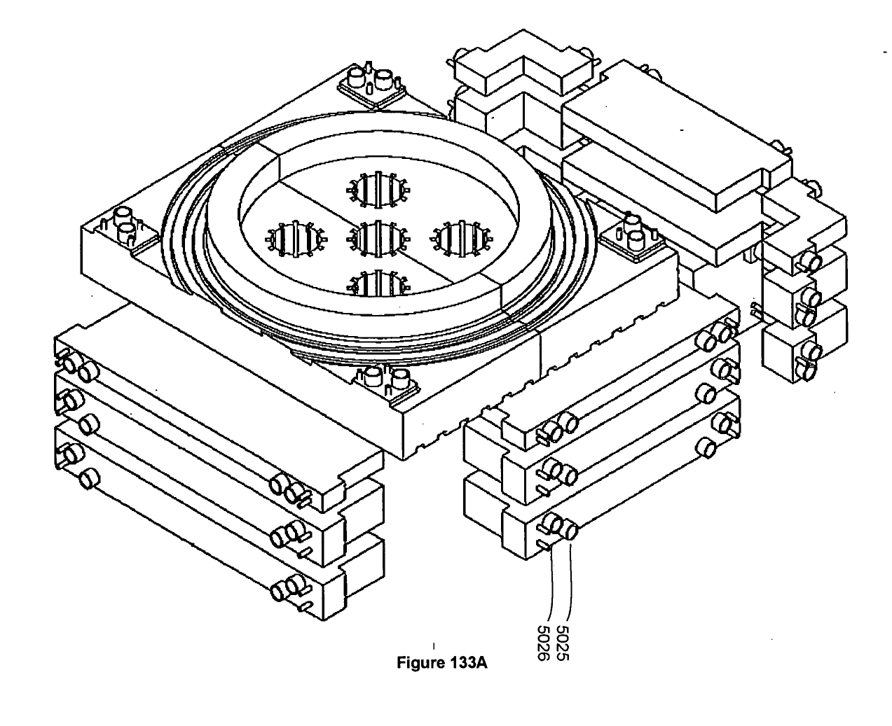

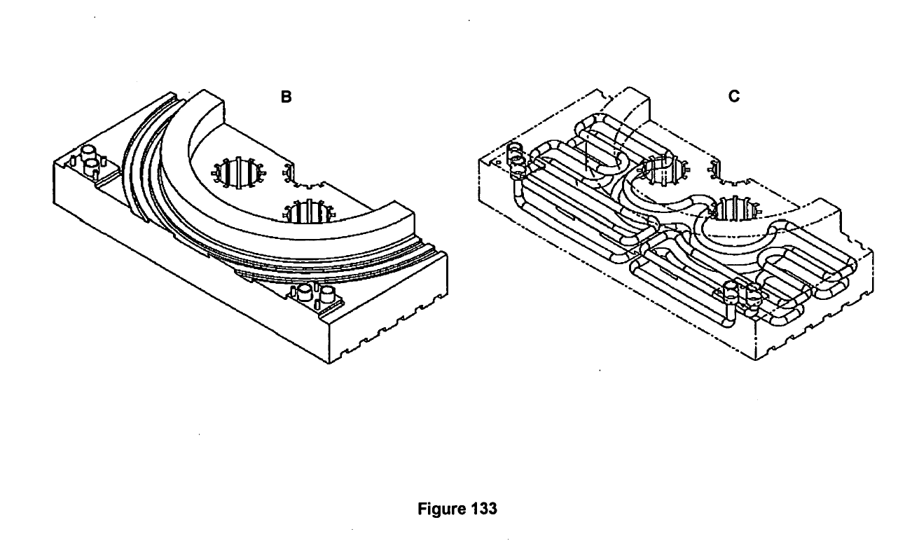

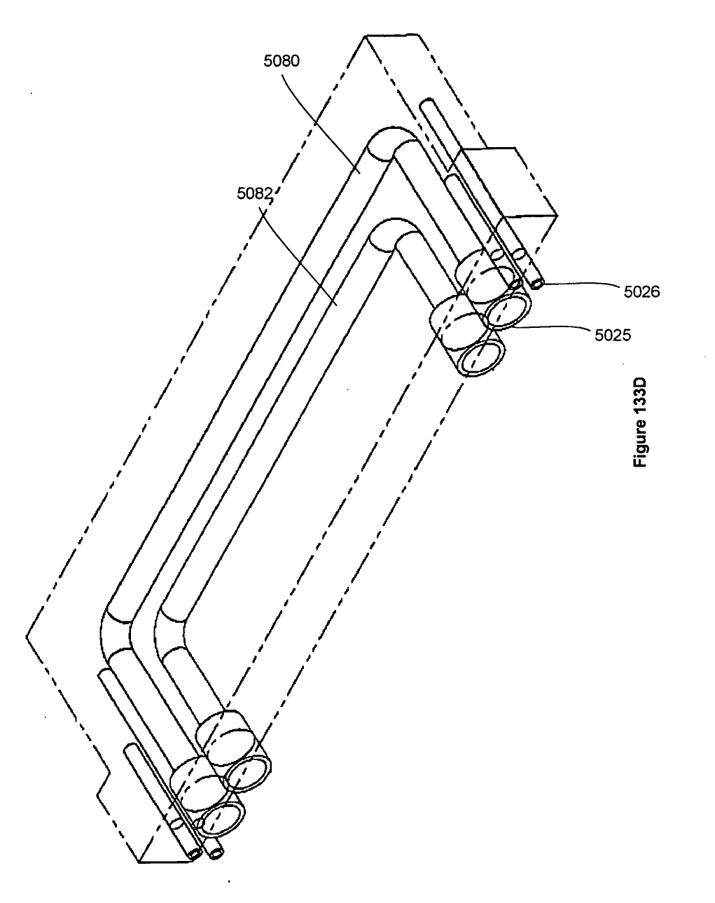

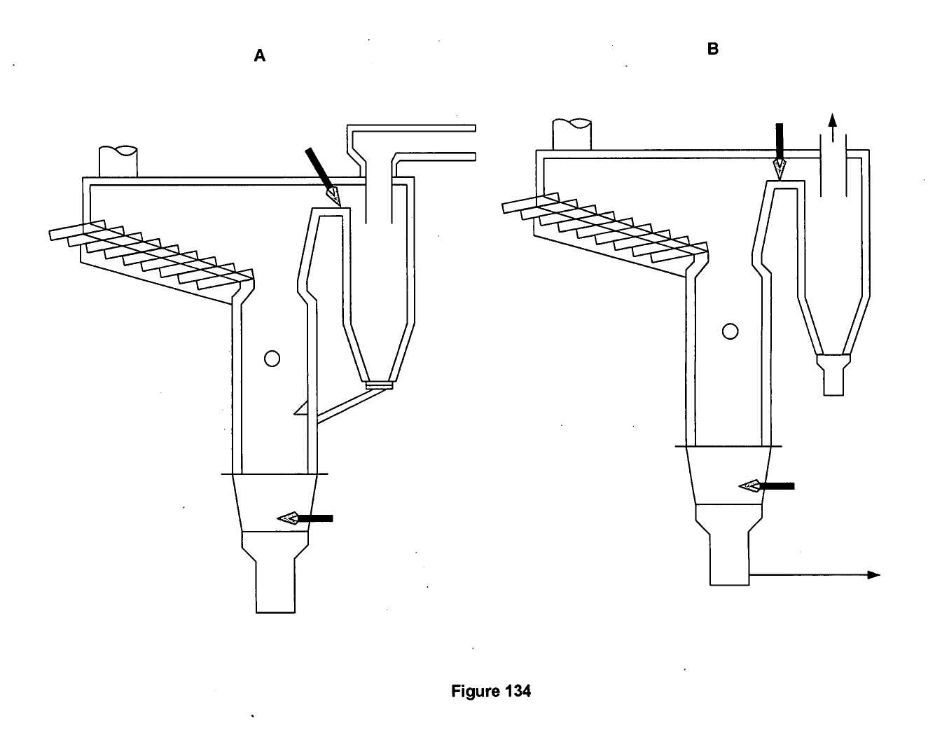

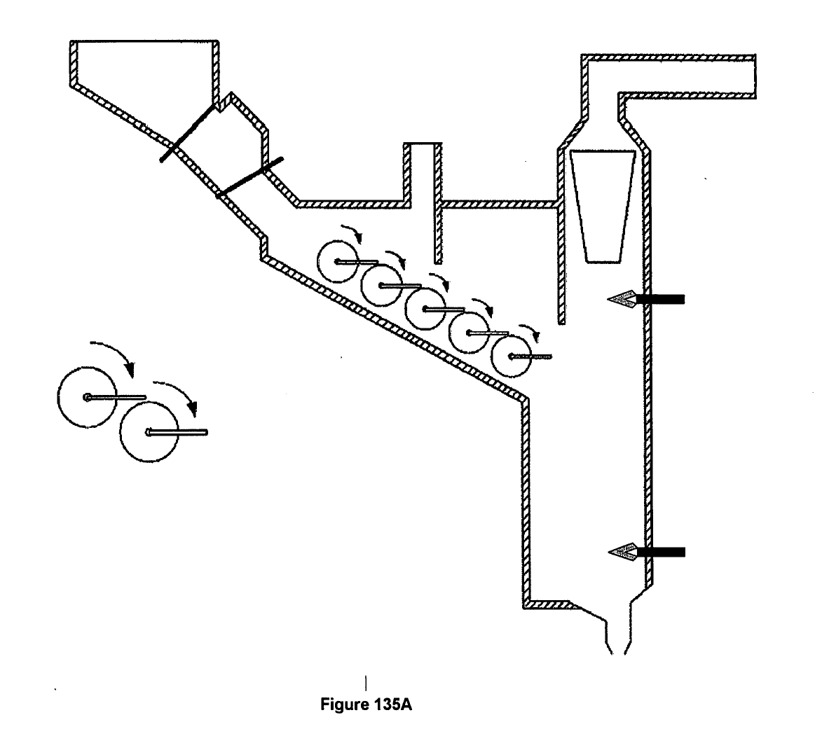

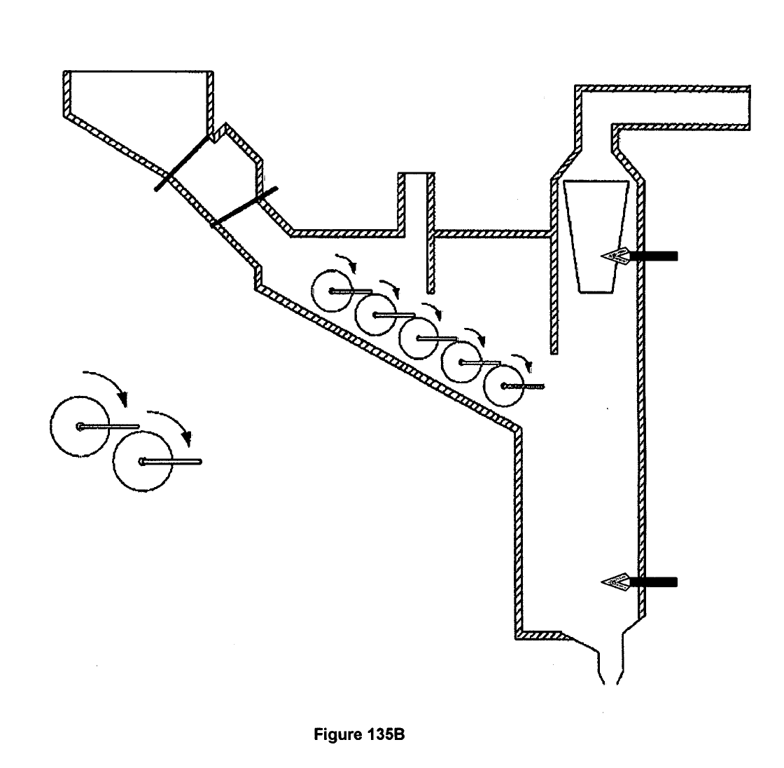

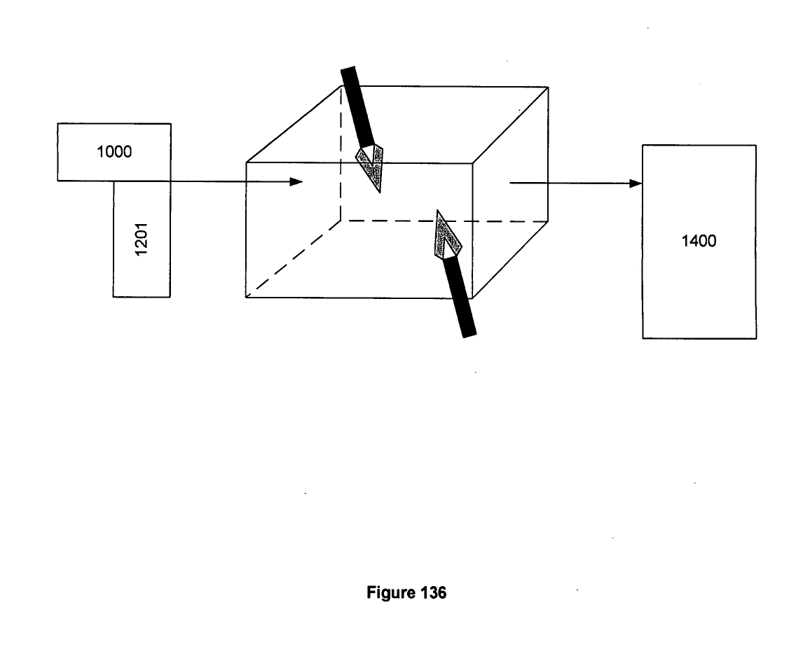

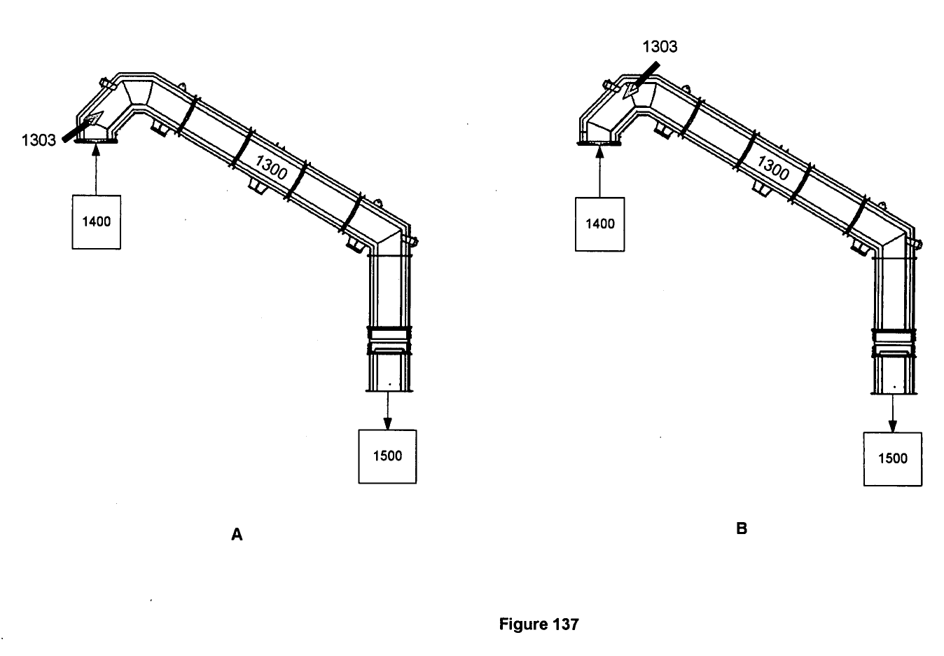

As illustrated, the primary processing unit 1 is connected to the secondary processing unit 2 which in turn in connected to the melting unit 3. The gas reformulating unit 4 is operatively connected with each of the primary processing unit 1, secondary processing unit 2 and the melting unit 3. FIG. 1B is a block flow diagram showing one embodiment of the primary processing unit (1000) with feedstock input (1001), the secondary processing unit (1201) and melting unit (1250) with plasma source (1301), the gas reformulating unit (1300) with the cyclonic separator system (1400) and plasma source (not shown). FIGS. 1B to 1J are block flow diagrams detailing the location of the plasma source (1301) relative to the cyclonic separator system (1400) of the gas reformulating unit (1300) in various embodiments of the invention. Optional slag granulization unit (1251), recuperator (1500) and particulate recycle (1202) are also shown.

FIG. 2 is a schematic representation of a cross-sectional view of one embodiment of the Carbon Conversion System detailing a primary processing unit (1000) with moving grate (1003) and feedstock input (1001), a combined vertically oriented secondary processing and melting unit (1200) with slag outlet (1252) and axial cyclonic separator system (1401) of the gas reformulating unit. The plasma sources are not shown in this schematic.

FIGS. 3A and 3B are schematic representations of one embodiment of the Carbon Conversion System detailing the various functional units and flow of gas and recycled heat in the form of hot air (1503) from a syngas-to-air heat exchanger (1500) (also referred to as a recuperator) that recovers sensible heat from hot syngas (1501) exiting the gas reformulating unit (1300), which includes a cyclonic separator system (1401), and transfers it to ambient air (1502) to provide hot air (1503) to the primary processing unit (1000), the air boxes (1503) of a combined vertically oriented secondary processing and melting unit (1200) and the gas reformulating unit (1300) with axial cyclone (1401). FIG. 3A illustrates one embodiment in which the recuperator (1500) is not directly associated with the gas reformulating unit (1300). FIG. 3B illustrates one embodiment in which the recuperator (1500) is directly connected to the gas reformulating unit (1300).

FIG. 4 is a block flow diagram detailing movement of material and gas through one embodiment of the Carbon Conversion System and downstream systems including recuperator (1500). Carbonaceous feedstock (1002) enters the primary processing unit (1000) where any moisture from the carbonaceous feedstock is removed and volatile components of the feedstock are volatilized by heating via hot air (1505) thereby providing a processed feedstock (1003) comprising char. The secondary processing unit (1201) receives the processed feedstock from the primary processing unit (1000) and converts the processed feedstock to a residue (1206) and an off-gas (1205). The hot air is optionally provided by recuperator (1500) or a multi-fuel burner (1253) that heats ambient or cold air (1502 and 1504). Gas (1204/1205) from the primary processing unit (1000) and secondary processing unit (1201) enters the cyclonic separator (1400) of the gas reformulating unit to reduce off-gas particulate load prior to plasma treatment (1301). Off-gas with reduced particulate load (1403) is subject to plasma treatment. Hot syngas (1501) exiting the plasma treatment transits a recuperator (1500) where sensible heat is recovered for optional reuse. The cooled syngas (1501) is optionally polished or cleaned in a downstream gas conditioning system (1600). Cleaned or polished gas may be stored in appropriate tanks (1601) prior to use in engines (1602). The block flow diagram shows recirculation of the particulate matter (1402) back into the system.

FIG. 5 is a block flow diagram detailing movement of material and gas through one embodiment of the Carbon Conversion System and downstream systems. The block flow diagram shows alternate recirculation of the particulate matter (1402) back into the system.

FIG. 6 is a block flow diagram of one embodiment of the Carbon Conversion System detailing optional input additives (1004) which include, but are not limited to steam, air, O₂, N₂, ozone, catalyst, fluxing agents, water, adsorbents, and high carbon inputs. Each additive arrow may indicate a single type of additive or multiple types of additives. The additive(s) may be inputted in mixed form or though separate additive input devices (and in multiple location within a given functional unit). The primary processing unit (1000), gas reformulating unit (1300) with cyclone (1400), and the secondary processing unit (1201) are detailed. Feedstock (1002) input, processed feedstock (1003), and a particulate reduced off-gas (1403) are also shown.

FIGS. 7A to 7F show a schematic representation of a top down view of various embodiments of the Conversion System. Each separate figure shows a different orientation of plasma torches (1301) within the gas reformulating unit (1300) which includes a cyclonic separator (1400). A recuperator (1500) recovers sensible heat from hot syngas (1501) and transfers it to ambient air (1502) to provide hot air (1505) for the various functional units of the Conversion System. FIG. 7A shows two plasma torches placed in turns which are co-current to the flow. FIG. 7B shows two plasma torches placed together in the straight length of the gas reformulating unit which promote the gas flow direction. FIG. 7C shows two plasma torches placed at the first turn of the gas reformulating unit; one supporting the direction of gas flow, the other counter-current. FIG. 7D shows two plasma torches placed in turns which are counter-current to the flow. FIG. 7E shows two plasma torches placed together in the straight length of the gas reformulating unit which go against the gas flow direction. FIG. 7F shows two torches placed at the last turn of the gas reformulating unit; one supporting the direction of gas flow, the other counter-current.

FIGS. 8A to 8G show a schematic representation of a top down view of various embodiments the Conversion System. Each separate figure shows a different orientation of plasma torches within the gas reformulating unit. FIG. 8A illustrates embodiments in which the plasma treatment zone of the gas reformulating unit is vertical. Part (i) shows a configuration in which the plasma torches are aligned to promote the swirl of gases. Part (ii) shows a configuration in which plasma torches are aligned to promote the mixing of gases (angled against the gas swirl). FIG. 8B shows two plasma torches placed in turns with the first being counter-current and the second co-current to the flow. FIG. 8C shows two plasma torches placed in turns with the first being co-current and the second counter-current to the syngas flow. FIG. 8D shows two plasma torches placed within close proximity to each other in the gas reformulating unit where the two torches are placed in turns with the first being co-current and the second counter-current to the syngas flow. FIG. 8E shows two plasma torches placed within close proximity to each other in the gas reformulating unit where the two torches are placed in turns with the first being counter-current and the second co-current to the syngas flow. FIG. 8F shows two plasma torches placed within close proximity to each other in the gas reformulating unit to maximize plasma mixing with syngas where the two torches are placed in turns with the first being counter-current and the second co-current to the syngas flow. FIG. 8G shows two plasma torches placed within close proximity to each other in the gas reformulating unit to maximize plasma mixing with syngas where the two torches are placed so that they are adjacent to each other and perpendicular to the syngas flow

FIGS. 9A to 9I show a schematic representation of a top down view of various embodiments of the Conversion System. Each separate figure shows a different orientation of plasma torches within the gas reformulating unit. These figures illustrate numerous exemplary combinations available in placing refining technologies such as plasma torches, catalysts (1302), hydrogen activators and back-draft tubes. Where one orientation is shown with one device, another could be placed in its place. FIG. 9A shows two plasma torches placed within close proximity to each other in the gas reformulating unit to maximize plasma mixing with syngas where the two torches are placed so that they are adjacent to each other, the first co-current and the second counter-current to the flow. FIG. 9B shows two plasma torches placed within close proximity to each other in the gas reformulating unit to maximize plasma mixing with gas where the two torches are placed so that they are perpendicular to each other and both are co-current to the gas flow. FIG. 9C shows two plasma torches placed within close proximity to each other in the gas reformulating unit to maximize plasma mixing with syngas where the two torches are placed so that they are perpendicular to each other and both are counter-current to the syngas flow. FIG. 9D shows the gas reformulating unit with a hydrogen activator installed. FIG. 9E shows the gas reformulating unit with a hydrogen activator and plasma torch installed. FIG. 9F shows the gas reformulating unit with a catalyst bed installed between plasma torches. FIG. 9G shows a gas reformulating unit with a catalyst bed, hydrogen activator and plasma torch installed. FIG. 9H shows an embodiment where a plasma plume is created before the gas enters the cyclonic separator. FIG. 9I shows a gas reformulating unit with a back-flow tube installed for improved mixing.

FIG. 10 shows a top down view of one embodiment of the Conversion System. This figure shows a gas reformulating unit with cyclonic separator and expanded section which houses the plasma torches. The torches are aligned such that they face each other, yet are off-set to promote mixing and avoid unnecessary wear.

FIGS. 11A to 11F show a side view of various embodiments of the Carbon Conversion System detailing placement of plasma with the gas reformulating unit. FIG. 11A shows plasma torches positioned at the cyclonic separator output. Particulates collected by the cyclonic separator are channeled to the carbon recovery unit for further processing. FIG. 11B shows plasma torches positioned within the cyclonic separator. Optional processing pathways for collected particulates are shown with the hatched lines. FIG. 11C shows a plasma torch positioned at the bottom of the cyclonic separator aimed up the center vortex to direct catalytic plasma towards the gas with the least amount of particular matter. FIG. 11D shows plasma torches positioned within the cyclonic separator but before the end of the drop tube as to not cause undue mixing of the particulate heavy outer gas vortex with the particulate light inner vortex. FIG. 11E shows a plasma torch at the bottom of the cyclonic separator aimed up the center vortex to direct catalytic plasma towards the gas with the least amount of particular matter. The addition of space around the plasma torch allows particulate matter captured by the cyclonic separator to exit more freely. FIG. 11F shows a plasma torch at the bottom of the cyclonic separator aimed up the center vortex to direct catalytic plasma towards the gas with the least amount of particulate matter. The addition of space around the plasma torch allows particulate matter captured by the cyclonic separator to exit more freely but with the catch hopper off to the side for easier torch placement with less interference.

FIG. 12 shows an embodiment of the Carbon Conversion System where plasma is provided at the exit of the cyclone separator.

FIGS. 13A to 13D illustrate various views of one embodiment of the Carbon Conversion System where the cyclonic separator(s) are external to the shell housing the Conversion System. FIG. 13A shows a vertical cyclonic separator (1506) with a horizontal gas reformulating unit (1300) and a vertical recuperator (1500) which heats ambient air (1502). The figure shows the gas reformulating unit (1300) over top of the rest of the primary processing unit (1000) and a combined vertically oriented secondary processing and melting unit (1200), but it could be placed beside the primary processing unit or in a vertical orientation. The placement of the recuperator in this embodiment minimizes the hot air piping to the primary processing unit (1000) and the combined vertically oriented secondary processing and melting unit (1200) without the need of a specially shaped recuperator. FIG. 13B shows the top view of the embodiment of FIG. 13A where off-gases from the various cyclonic separators are mixed with the addition of plasma or plasma heat alternative and hot air (1505). FIG. 13C shows the middle top view of the embodiment of FIG. 13A where off-gas leaves the primary processing unit and secondary processing unit and goes to external cyclonic separator(s). FIG. 13D the middle top view of the embodiment of FIG. 13A where solid residue is sent to the melting unit for final processing into slag. This embodiment also shows how the hot air is added to the bottom grate of the primary processing unit and to the air boxes in the secondary processing unit.

FIG. 14 is a schematic representation of a top view of one embodiment of the Carbon Conversion System detailing the moving grate (1003), and the horizontally oriented gas reformulating unit with two plasma torches (1301) and cyclonic separator (1401). FIG. 14 further details an optional heat exchanger or recuperator (1500) operatively associated with the gas reformulating unit.

FIGS. 15 to 19 show various configurations of the Carbon Conversion System detailing the various zones.

FIG. 20 is a schematic representation detailing the primary processing unit of one embodiment of the Conversion System, showing the refractory-lined chamber (in part), feedstock input, lateral transfer system, and optional baffle (1010). Also shown is an optional breaker device (1006) for breaking up feedstock as it enters, an optional guillotine (1008), a hydraulically operated reciprocator (1012), a spring loaded scraper plate (1011) and a brush (1014). A, B, and C indicate process additive inputs.

FIG. 21 is a schematic representation detailing the primary processing unit of one embodiment of the Carbon Conversion System with horizontal air feed.

FIG. 22 is a schematic representation detailing the primary processing unit of one embodiment of the Conversion System, showing the refractory-lined chamber (in part), feedstock input, lateral transfer system, and optional baffle (1010). Also shown is an optional breaker device (1006) for breaking up feedstock as it enters, an optional guillotine (1008), a hydraulically operated reciprocator (1012), a spring loaded scraper plate (1011) and a brush (1014). Perforated baffles (1022), feedstock height (1017) and reactant material height (1002) are also shown.

FIG. 23 is a schematic representation detailing the primary processing unit of one embodiment of the Conversion System, showing the refractory-lined chamber (in part), feedstock input (1007), lateral transfer system, and optional baffle (1010). Also shown is an optional breaker device (1006) for breaking up feedstock as it enters, an optional guillotine (1008), a hydraulically operated reciprocator (1012), a spring loaded scraper plate (1011) and a brush (1014). One or more of the perforated baffles (1022) are provided. In this embodiment, the perforated baffles (1022) are suspended using chains to allow for baffle movement. Feedstock height (1017) and reactant material height (1002) are also shown.

FIG. 24 is a schematic representation detailing the construction of a step in one embodiment of the Carbon Conversion System having a stepped floor primary processing unit. The alternating layers of thick metal (1019) and ceramic blank (1020) are shown. Plenums for the introduction of air and/or steam are shown as perforated lines (A, B and C). Air is supplied to the plenums from a header space. Each plenum is equipped with a nozzle (1021). The step is covered by refractory (1018).

FIG. 25 is a schematic representation detailing one embodiment of the primary processing unit (1000) of the Carbon Conversion System, showing the refractory-lined chamber (in part), feedstock input, lateral transfer system, and an optional baffle (1010). Also shown is an optional breaker device (1006) for breaking up feedstock as it enters, an optional guillotine (1008), a hydraulically operated reciprocator (1012), a spring loaded scraper plate (1011) and a brush (1014).

FIG. 26 is a detailed side view of one embodiment of the lateral transfer system showing clockwise operation. The floor of primary processing unit is shown (1029)

FIG. 27 is a detailed view of one embodiment of the lateral transfer system showing counterclockwise operation. Details of one embodiment of the drive system (1031) are shown.

FIG. 28 shows a top view of the lateral transfer system shown in FIGS. 26 and 27.

FIGS. 29A and 29B illustrate one embodiment for a scraper system (1037) for dealing with potential clinker build up in the primary processing unit. FIG. 29A shows the side view detailing process additive inputs A, B and C, a scrape guillotine (1036), a scraper slit in side wall (1038) and a hydraulically operated reciprocator (1034). FIG. 29B shows the front view and details the additives manifold (1032), a reciprocating ram (1035), and the scraper trajectory (1039). Optionally, the scraper (1037) is heated.

FIG. 30 illustrates one embodiment for a scraper system for dealing with potential clinker (1046) build up and sticky feedstock (1047) in the primary processing unit. FIG. 30 shows hydraulic pusher system (1044) guides (1042). Also shown is the stage above (1049) and current stage (1041). Optionally, the scraper is heated. Top panel shows the ram in “home” position. Middle panel shows sticky feedstock removed and the cold scraper stopped. Bottom panel shows the hot scraper removing clinker.

FIG. 31 illustrates slanted stages in the primary processing unit with redirected additives. Top panel shows an approximate 20 to 30 degree slant. Bottom panel shows a slant of less than 20 degrees and optionally steam shooting from the airbox on the ram for clearing off the top.

FIG. 32 illustrates construction of steps in one embodiment of the primary processing unit. The alternating layers of thick metal (1019) and ceramic blank (1020) are shown. Plenums for the introduction of air and/or steam are shown as perforated lines (A, B and C). Air is supplied to the plenums from a header space. Each plenum is equipped with a nozzle (1021). The step is covered by refractory (1018). The position of nozzles in one layer may be staggered relative to the position of nozzles in the layer below or above. A single layer may include air and/or steam inputs. Individual layers may be made as a single solid stage (1055), as a composite of separate bars (1054) or as a composite of separate bars with insulation between the bars (1053).

FIG. 33 illustrates one embodiment of the lateral transfer system comprising cast refractory blocks (1810) with air injection through thin wall tubes connected to a central header. Air is connected to the blocks with flexible stainless steel hoses and flanged fittings. Each block is mounted on a single free rotating axis (1815) and is driven by a separate hydraulic shaft. Water cooling may be provided to each block.

FIG. 34 illustrates one embodiment of a lateral transfer system.

FIG. 35 illustrates one embodiment of the lateral transfer system and air injection. In this embodiment, air injection (1052) is raised slightly above the rams (1048). This is done in order to raise the “hot zone” where partial combustion occurs. The rams (1048) sit on refractory (1018) and is insulated from hot air introduction. Also shown is the air injection header (1055) and the top layer of solid residue (1056).

FIG. 36 illustrates embodiments of the combined air distribution and lateral transfer system of the primary processing unit detailing the air box (1057), air passages (1058), and insulation (1059).

FIG. 37 illustrates one embodiment of the combined air distribution and lateral transfer system of the primary processing unit. The drums rotate continuously to move material along the grate. Vanes (1510) within each drum limit air flow to the target region. The drums are capped on both ends with thick ceramic gasketed plates (1512) which are bolted to the outer drum to maintain the drum's pressure boundary to allow differential expansion. The drums are driven by a central drive shaft connected to the rest of the drum by the vanes. Individual drives may be provided by drum to facilitate replacement. Also shown are air ducts (1516). Air enters the primary processing unit via perforations in the drums surfaces. Steps between successive pairs of drums increase material tumbling.

FIG. 38 illustrates one embodiment of the air distribution system and lateral transfer system of the primary processing unit detailing the rams (1048) sitting directly on top of the air boxes (1057). The perforated surface of the air box is shown as dashed line.

FIG. 39 illustrates one embodiment of the air distribution and ram lateral transfer system of the primary processing unit. In this embodiment, to reduce warpage, the air boxes (1030) are constructed as separate, very heavy duty, solid pieces of steel which only inject hot air in areas where uninterrupted/unhindered flow occurs. Air injection is raised slightly above the rams (1048), and is through air box holes (1060) with one or more jets, space permitting. The rams (1048) sit on refractory (1018). Between the air box and the refractory, packing insulation (1062) is provided. The air box is further provided with insulation (1059). Also shown is the air injection header (1055) and a seal (1064).

FIG. 40 illustrates various embodiments of air injection systems top designs. To reduce warpage, the air boxes are constructed as separate, very heavy duty, solid pieces of steel which only inject hot air in areas where uninterrupted/unhindered flow occurs. Air injection is raised slightly above the rams (1048) and is through raised tops with one or more jets, space permitting. The rams (1048) sit on refractory (1018). Between the air box and the refractory, packing insulation (1062) is provided. The air box is further provided with insulation (1059). Also shown is the air injection header (1055), a seal (1064) and spacing (1066). The top of reactant material is shown by line (1056).

FIG. 41 illustrates one embodiment of a ram lateral transfer system of the primary processing unit (1000) detailing air (1502) and steam (1067) injection. The addition of steam can be used to control the temperature and promote steam gasification. In this embodiment, steam is piped in below the air to further buffer the rams from the hot zone. The top of reactant material is shown by line (1056).

FIG. 42 illustrates one embodiment of a ram lateral transfer system of the primary processing unit (1000) detailing air (1502) and steam (1067) injection, and the air injection header (1055). The addition of steam can be used to control the temperature and promote steam gasification. In this embodiment, the steam is premixed with the air before it is injected into the bed. The top of reactant material is shown by line (1056).

FIG. 43 illustrates a multi-stage ram system of one embodiment of the primary processing unit.

FIG. 44 is an isometric view of the complete grate of FIG. 43.

FIG. 45 illustrates a single stage of the complete grate shown in FIGS. 43 and 44.

FIG. 46 is a side view of the single stage shown in FIG. 45.

FIG. 47 illustrates a combined secondary processing and melting unit of one embodiment of the Carbon Conversion System, in part, detailing ports for auxillary burner (138 and 139), a slag outlet (130), and a zone-specific heating system (i.e. a system that can establish two temperature zones) comprising an air box (135) and plasma torch (140). In this embodiment, the impediment is a solid refractory dome (145) with a plurality of conduits (151) mounted by wedge-shaped mounting bricks (150) in the inter-zonal region. The solid refractory dome is sized such that there is a gap between the outside edge of the dome and the inner wall of the chamber. A plurality of alumina or ceramic balls (165) between 20 to 100 mm in diameter rest on top of the refractory dome to form a bed and provide for diffusion of heated air and to promote the transfer of plasma heat to the ash to initially melt the ash into slag. FIG. 47A is a partial longitudinal-section view. FIG. 47B is a cross-sectional view of the embodiment illustrated in FIG. 47A at level A-A. FIG. 47C is a top view of the impediment and supporting wedges.

FIG. 48 is an illustration detailing various views of an impediment in the inter-zonal region of one embodiment of the Carbon Conversion System. The impediment comprises a series of interconnected refractory bricks (245). The bricks are mounted on a mounting element (250) such that there are gaps (255) between adjacent bricks. The slag outlet (230), plasma torch (240) and auxiliary burner port (239) are also shown.

FIG. 49 is an illustration of an impediment in the inter-zonal region of one embodiment of the Carbon Conversion System comprising a grate. The grate comprises a series of substantially parallel, refractory lined tubes (345) mounted within a mounting ring (350). The tubes are mounted such that there is a gap (355) between adjacent tubes. Optionally, a plurality of alumina or ceramic balls between 20 to 100 mm in diameter rest on top of the impediment to form a bed and provide for diffusion and to promote the transfer of plasma heat to the ash to initially melt the ash into slag in the inter-zonal region. In some embodiments, hot air is fed into the secondary processing zone through perforations in the upper surface of the substantially parallel refractory line tubes (345).

FIG. 50 illustrates one embodiment of a combined secondary processing and melting unit, in part. Heated air is introduced into the secondary processing unit via air boxes (135). The air feed to the air boxes is controllable allowing for regulation of the conversion process. Optionally, steam may be injected into the secondary processing unit via the steam injection ports (not shown). The inter-zonal region comprises a physical impediment (145) to guide the flow of material from the secondary processing unit to the melting unit. A plurality of alumina or ceramic balls (165) between 20 to 100 mm in diameter rest on top of the refractory dome to form a bed and provide for diffusion of heated air and to promote the transfer of plasma heat to the ash to initially melt the ash into slag in the inter-zonal region. The melting unit comprises various ports including a plasma torch port, a burner port to accommodate a burner (139) to pre-heat the chamber, and ports for various process additives including hot air and carbon and/or bag ash. The melting unit is equipped with a plasma torch (140) and tangentially mounted air nozzle (141). Slag outlet (130) is also shown.

FIG. 51A is a cross-sectional view detailing the ports in the melting unit of the carbon recovery zone of one embodiment of the Carbon Conversion System including oxygen and/or air inputs (O), carbon inputs (C), ports for plasma torches (P) and a gas burner port (G). FIG. 51B is a partial longitudinal view of the embodiment shown in FIG. 51A. A slag weir (33) and a quench water bath (78) are also shown.

FIG. 52 is a partial longitudinal-sectional view of one embodiment of the Carbon Conversion System detailing the melting unit with a plasma heat deflector (61). A quench water bath (78) is also shown.

FIG. 53 illustrates one embodiment of the Carbon Conversion System in which the melting unit further comprises a weir (33) to form a slag pool to facilitate slag mixing. A plasma heat deflector (61) is also shown.

FIG. 54 is a partial longitudinal-sectional view of a combined secondary processing and melting unit (in part) of one embodiment of the Carbon Conversion System detailing a slag cooling system (114) including water spray and drag chain. Heated air is introduced into the secondary processing unit via an air box (135). The inter-zonal region comprises a physical impediment (145) to guide the flow of material from the secondary processing unit to the melting unit. The melting unit is equipped with a plasma torch (140) and a tangentially mounted air nozzle (141). A slag outlet (130) is also shown.

FIG. 55 is a partial longitudinal-sectional view of a combined secondary processing and melting unit (in part) of one embodiment of the Carbon Conversion System detailing the air boxes (135). The inter-zonal region comprises a physical impediment (145) to guide the flow of material from the secondary processing unit to the melting unit. The melting unit comprises various ports including a plasma torch port, a burner port to accommodate a burner (139) to pre-heat the chamber, and ports for various process additives including hot air and carbon and/or bag ash. The melting unit is equipped with a plasma torch (140) and tangentially mounted air nozzle (141). A slag outlet (130) and plurality of alumina or ceramic balls (165) are also shown.

FIG. 56 is a cross-sectional view through the air box of the embodiment shown in FIG. 55.

FIG. 57 is a cross-sectional view through the tangentially located air inputs and plasma torch of the embodiment shown in FIG. 55.

FIG. 58 is a cross-sectional view at the burner level of the embodiment shown in FIG. 55.

FIG. 59 illustrates alternative views of the combined secondary processing and melting unit of FIGS. 55 to 58. A slag cooling system (114) including water spray and drag chain is also shown.

FIG. 60 details various views of a combined secondary processing and melting unit (in part) of one embodiment of the Carbon Conversion System detailing the slag outlet (430), and a zone-specific heating system (i.e. a system that can establish two temperature zones) comprising an air inlets and plasma torch (440) and optional tapping spout (446). In this embodiment, the secondary processing zone is centrally located and the slag or melting zone is located towards the periphery of the chamber. The floor of the chamber is sloped such that the secondary processing zone is upstream of the slag zone thereby promoting uni-directional movement of material between these zones. The two zones are separated by the inter-zonal region. The inter-zonal region comprises a physical impediment to regulate the flow of material from the secondary processing zone to the slag zone. In the instant embodiment, the physical impediment comprises a series of substantially vertically-oriented, substantially parallel refractory-lined perforated pipes (445). Heated air is introduced into the secondary processing zone through the perforations in the pipes to the center of the pile of processed feedstock thereby converting and heating the carbon in the processed feedstock. The air is heated slightly as it comes from the bottom, while cooling the pipes. Through air inlets (441) in the slag zone, air is injected outside the row of pipes and serves to keep the outer surface of the pipes very hot so as to keep the slag from freezing. The sloped bottom of the slag zone serves to drain the residue towards the side of the chamber where the plasma torch is located such that the residue is melted into molten slag.

FIG. 61 details various views of a combined secondary processing and melting unit (in part) of one embodiment of the Carbon Conversion System detailing a slag outlet (530), and zone-specific heating system (i.e. a system that can establish two temperature zones) comprising an air inlets (not shown) and plasma torch (540). The inter-zonal region comprises a physical impediment to regulate the flow of material. In the instant embodiment, the physical impediment comprises a cogwheel-shaped dome (545).

FIG. 62 details various views of a combined secondary processing and melting unit (in part) of one embodiment of the Carbon Conversion System. The floor of the slag zone comprises a rotating slanted refractory table. The rotation of the table top facilitates the evacuation of the molten slag. Optionally, the table can include a plurality of ceramic balls to facilitate plasma heat transfer. The floor of the slag zone can be elevated and retracted from the processing zones. The refractory-lined table top is mounted on a drive shaft (846) operatively connected to an externally mounted motor (847). The slag-floor assembly is readily detachable from the inter-zonal region and the carbon-converter zone and is mounted on an elevating table on rails to facilitate clean out. A plurality of ceramic balls (848) promotes the transfer of plasma heat. Optionally, molten slag is cooled by a water spray upon exiting the slag outlet (830) and the solidified slag falls onto a drag chain for removal. The slag outlet (830), plasma torch (840) and impediment (845) are also detailed.

FIG. 63 details various views of a combined secondary processing and melting unit (in part) of one embodiment of the Carbon Conversion System. The impediment comprises a rotating refractory cone (921) mounted on a drive pedestal having a drive shaft (933) linked to an external motor (942). The lower portion of the rotating refractory comprises a well (978) in which slag accumulates prior to exiting the chamber. The impediment/slag-floor assembly is readily detachable from the inter-zonal region and the carbon-converter zone and is mounted on an elevating table on rails to facilitate clean out. Optionally, molten slag is cooled by a water spray upon exiting the slag outlet and the solidified slag falls onto a drag chain for removal. Plasma torch (940) and propane or natural gas burner (937) are also detailed.

FIG. 64 details various views of a combined secondary processing and melting unit (in part) of one embodiment of the Carbon Conversion System plasma torch (640), carbon and/or bag ash inputs (642) and hot air inlets (641).

FIGS. 65A to 65C detail various views of a combined secondary processing and melting unit (in part) of one embodiment of the Carbon Conversion System equipped with multiple hot gas generators (HGGs) to spread out the temperature profile of the chamber and avoid cold spots where the slag would solidify. These figures show how the HGG/Torches could be set-up to swirl the hot gases in the melting unit or focus the melting towards the center. FIG. 65A also shows molten slag transiting water spray.

FIGS. 66A to 66C show various views of a combined secondary processing and melting unit (in part) of one embodiment of the Carbon Conversion System equipped with hot gas generator (HGG). FIG. 66A is a 3D illustration of the melting unit with hot gas generator (1262) using a torch (1303) and having optional inlets for solids and gases in the melting unit. There are multiple inlets for gases and solids on the HGG itself. FIGS. 66B and 66C are sideways view of the lower chamber showing the HGG. A slag quench unit (1259) and plasma torch support (1305) are also shown.

FIGS. 67 and 68 illustrate an HGG system that can be used in a combined secondary processing and melting unit of one embodiment of the Carbon Conversion System. This HGG employs a plasma torch (1303) surrounded by pneumatic solid input (1264) which is then surrounded by a warm gas input (1266) and outputs hot gas (1263). Optionally, gas inputs are air or nitrogen or any type of gas that could be used in gasification including CO₂, O₃, syngas, or other oxygenated gas or combinations thereof. In one embodiment, the warm gas is about ˜600° C. The warm gas outlet can optionally have vanes (1207) for swirling the gas. A plasma torch support (1305) and slag quench (1259) are also shown.

FIG. 69A illustrates the refractory layers and HGG (1262) set-up in a combined secondary processing and melting unit of one embodiment of the Carbon Conversion System. In this embodiment, the outer wall (1272) is generally made of metal or composite material that would be used in construction (cement). The insulation (1059) is designed to buffer the refractory and outer wall from temperature expansion changes. The low temperature refractory (1270) is designed to reduce the temperature between the outer wall and the slagging chamber environment. The high temperature refractory (1269) is designed to withstand the ultra-high temperatures of the melting zone (1271) and the degradation due to slag contact. FIG. 69B is a rotated cross section of FIG. 69A to where there are the optional gas bypass lines (1268). Also shown is the slag tap (1260). The impediment or bed support (1265) and bed support spheres (1267) are also shown.

FIGS. 70A and 70B show an internally located cyclonic separator in one embodiment of the Carbon Conversion System located within the shell of the Conversion System. In the illustrated embodiment, a cyclonic separator bank with gas flow arrows is shown from the angle of gas coming from the primary processing unit and secondary processing unit. A first set of cyclonic separator tubes are cut away to show gas flow lines though the system and where the ash would be depositing. FIG. 70B shows a 3D image of FIG. 70A. Gas with particulates (1409) enters the cyclonic separator and gas with reduced particulate (1300) load exits. Particulates (1402) are collected for optional further processing. Also shown is a butterfly valve (1408).

FIG. 71 shows various upper level configurations of plasma in the gas reformulating unit. A) Plasma Generators (1308) are arranged to all point towards a center. B) Plasma Generators (1308) pointing in random orientation in order to promote effective mixing. C) Plasma Generators (1308) pointing opposite each other and a bit offset to promote turbulence. Arrows indicate process additives and/or off gas. Also shown is a refinement tube (1309).

FIGS. 72A and 72C show the inclusion of turbulence zones (1316) for enhanced reformulation in one embodiment of the gas reformulating unit. FIG. 72C shows examples of turbulence generators including a passive grid (1313), an active grid (1310) with rotating shaft (1314) and fixed shaft (1311), and sheer generator (1312) with linear varying flow obstruction (1312).

FIG. 73 shows the gas (1317) to be reformulated entering tangentially into the gas reformulating unit creating a swirl which is treated by the plasma torches and the gas manipulator in one embodiment of the gas reformulating unit. Residue (1318) is also shown.

FIG. 74 shows exemplary means for generating turbulence. Active grid (1310) includes motors (1320) and an open area (1321). A sheer generator (1323) with variable obstruction for shear generation includes blocked areas (1319) and open areas (1321).

FIG. 75 is a diagram illustrating air-flow out of a Type A nozzle.

FIG. 76 is a diagram illustrating air-flow out of a Type B nozzle.

FIG. 77 is a flow diagram illustrating one embodiment of the Carbon Conversion System with a turbulence generator (1324) detailing optional input additives (1004) which include, but are not limited to steam, air, O₂, N₂, ozone, catalyst, fluxing agents, water, adsorbents, and high carbon inputs. Each additive arrow may indicate a single type of additive or multiple types of additives. The additive(s) may be inputted in mixed form or though separate additive input devices (and in multiple locations within a given functional unit). The primary unit (1000), the gas reformulating unit (1300) with cyclone (1400), and the secondary processing unit (1201) are detailed. Feedstock (1002) input, processed feedstock (1003), a particulate reduce off-gas (1403) are also shown.

FIG. 78 is a flow diagram illustrating various embodiment of the Carbon Conversion System with a turbulence generator (1324).

FIG. 79 is a schematic illustrating the bottom part of the secondary processing unit where ash/slag/char leaves and enters the melting unit of one embodiment of the Carbon Conversion System. The solid residue (1206) flows down a curved slope and into the melting unit. The transferred torch (1277), electrode (1274), burner (1273), gate (1276) and filled/metal removal (1275) are shown.

FIG. 80 is a schematic illustrating the bottom part of the secondary processing unit where ash/slag/char leaves and enters the melting unit of one embodiment of the Carbon Conversion System. This modified melting unit design is such that the melting unit footprint of the melting unit is bigger than the circumference of the secondary processing unit. In this embodiment, the bottom slag pour plug is shown as being replaceable and the dome has annular rings (made of metal and/or refractory) which assist in controlling the slag flow to ensure reduced flow along the walls of the melting unit. Also shown is the transferred arc torch (1277).

FIGS. 81A and 81B are a schematic illustrating the bottom part of the secondary processing unit where ash/slag/char leaves and enters the melting unit of one embodiment of the Carbon Conversion System detailing the side tap-hole. The solid residue (1206) flows down a curved slope having a potential lance location (1279) and into the melting unit. The transferred torch (1277), electrode (1274), burner (1273), baffle (1010), air boxes (1502) and filled/metal removal (1275) are shown. An alternative entry point for TAT is at (1278). A baffle (1010) controls the flow of material and includes a shaft (1280) to adjust baffle height and a baffle support link (1061). FIG. 81B is a view down the pipe from the slag pool (1258).

FIG. 82 details the blocks that make up the side tap-hole within the melting unit in one embodiment of the Carbon Conversion System. The primary functional parts are the plastic refractory wall with a lanced slag pour hole (1287) and the weir (1290) with a gap for slag (1286). The rest of the plug blocks are for support and access and include the support (1291) and packing plug (1289). Middle panel shows block plug system orientation in a melting unit wall.

FIG. 83 details all the various tools required to complete the maintenance on the side tap hole as shown and described in FIG. 84. Plug guides (1296) are made of high temperature resistance metal or refractory, and other tools are made out of high temperature resistant metal and may also have refractory coatings and/or insulation to avoid melting. Support block tongs (1297), plastic refractory skewer (1294), bent oxygen lance (1292) with lance outlet (1293), weir tongs (1299) and tray guide (1298) are shown.

FIG. 84 illustrates the side pour system can be serviced by lancing from cherry picker or extended sunken walk way. Tray (1142), tray guide (1298), hinged open plug door (1103), support block (1106) set aside, lance guide (1296) frozen slag zone B (1101) and A (1100) are shown. Hatching (1143) indicates refractory blocks with centerline hole in it to allow for slag or lancing. Hatching (1018) indicates refractory blocks which are completely solid along the cross section.

FIG. 85 details embodiments of plugs of different sizes. Extra space is filled in with permanent plastic refractory. (1109) shows overhang at hot face only.

FIG. 86 shows how the interior wall of one embodiment of the melting unit could be repaired. Optionally, the repair patch is “permanent” until it wears out. The repair patch is produced using two aluminum plates (1110) to squeeze plastic refractory (1112) together. A plunger (1115) packs in the plastic refractory. An inner pipe is pushed into the melting unit (to be melted into the slag/metal pool) to create a new tap-hole for the side pouring. A plug (1113) unscrews so that aluminum plate and pipe can be pushed into melting unit interior to allow slag to flow. The plastic refractory wall with a lanced slag pour hole (1289) is also shown.

FIG. 87 shows an embodiment where a burner (1117) is used to maintain the temperature at the weir so that the slag doesn't freeze. In this figure, the embodiment is that the burner is hand-held and runs on compressed gas (1118). Optionally, the burner is attached to the side of the melting unit and is a small multi-fuel burner optionally running on syngas. The burner is inserted into the refractory block with a burner hole (1119). The burner hole includes a rubber stopper (1120). Exhaust (1116) is back to the system.

FIG. 88 shows an embodiment where the side pour tap-hole plug of the melting unit has piping (1124) installed to allow for a cooling medium to be used in order to extend the lifetime of the tap-hole and weir. Cooling mediums can be air, water, steam, thermal fluid, etc. A continuous water line (1124) is attached to the weir. A protective insulating blanket is placed between the pipe and the groove of the refractory block (not shown). Water cooling with recycle (1123) is shown with optional by-pass direct to drain. (1121) shows water lines through the plug (solid piece attached to removable weir). The floor of plug (1122) is configured to encourage slag flow away from water lines.

FIG. 89 illustrates a combined secondary processing and melting unit of one embodiment of the Carbon Conversion System, in part, detailing the transferred arc torch (1277).

FIG. 90 illustrates a moving grate lateral transfer system design in the primary processing unit in one embodiment of the Carbon Conversion System. The illustrated moving grate is formed by overlapping cartridges (2000).

FIG. 91 is an alternative view of the moving grate of FIG. 90.

FIG. 92 illustrates an individual cartridge (2000) of the moving grate of FIGS. 90 and 91. A multi-piece cartridge framework (2010) provides the structure of the cartridge and support for components therein. The cartridge is attached to the wall of the primary processing unit via connection plate (2005). The cartridge includes alignment guides (2015) to facilitate the correct insertion of the cartridge into the chamber wall and installation notches (2020) to allow for the insertion of tools to facilitate the insertion and removal of the cartridge. The air box of the cartridge is a composite of multiple smaller air boxes (2025) constructed from thick carbon steel with air holes (2030) in the top of each air box. The air is supplied to the individual air boxes via a single air manifold (2035) connected to an air pipe (2040) which connects to a hot air hook up flange (2045) in the connection plate. The lateral transfer components of the cartridge include a multiple-finger carrier ram (2050). The individual ram fingers comprise a groove configured to engage I-shaped (2075) or C-shaped engagement elements (2078) located between individual air boxes and the outside air boxes and the cartridge framework respectively, where the corresponding anchor bottom holds the rams to the top of the air box.

FIG. 93 illustrates an alternative view of the individual cartridge of FIG. 92 showing air supply to the individual air boxes via a single air manifold (2035) connected to an air pipe (2040).

FIG. 94 illustrates an alternative view of the individual cartridge of FIG. 92.

FIG. 95 illustrates an alternative view of the individual cartridge of FIG. 92.

FIG. 96 illustrates alternative views of the individual cartridge of FIG. 92.

FIG. 97 illustrates a combined secondary processing and melting unit of one embodiment of the Carbon Conversion System, in part, detailing a port for auxiliary burner (139), a slag outlet (130), and plasma torch inlet (141). In this embodiment, the impediment is a solid refractory dome (145) with a plurality of conduits (151) mounted by wedge-shaped mounting bricks in the inter-zonal region.

FIGS. 98 to 100 detail the impediment of the combined secondary processing and melting unit of FIG. 97.

FIG. 101 detail floor profiles for the primary processing unit.

FIG. 102A shows one embodiment of the side pour tap-hole for the melting unit which is made out of two refractory sections (as per dotted lines). Ceramic paper and/or blanket (1020) is shown. FIG. 102B shows various embodiments of how to handle side pour tap-hole refractory plug pieces for placement within the chamber. I shows placed on movable support with rollers. II shows picked up and moved using a rail system. III shows moved into place with a mechanical lift.

FIG. 103 illustrates a combined secondary processing and melting unit of one embodiment of the Carbon Conversion System, in part, detailing where ash/slag/char leaves and enters the melting unit (1250).

FIGS. 104A and 104B are a schematic illustrating the bottom part of a combined secondary processing and melting unit of one embodiment of the Carbon Conversion System, in part, detailing where ash/slag/char leaves and enters the melting unit of one embodiment of the Carbon Conversion System detailing the side tap-hole. The solid residue (1206) flows down a curved slop having a potential lance location (1279) and into the melting unit. The transferred torch (1277), electrode (1274), burner (1273), baffle (1010), air input (1502) and filled/metal removal (1275) are shown. An alternative entry point for TAT is at (1278). A baffle (1010) controls the flow of material. When the door (1128) is open, slabs of refractory (1018) can be slid in to adjust baffle height. The top slabs (1130) are thinner. The blocks (1018) support the baffle. Support grooves (1029) are provided for the blocks or slabs of refractory. FIG. 104B is a view down the pipe from the slag pool.

FIG. 105 is a schematic illustrating a burner in one embodiment of the melting unit (1250) as viewed from above showing burner positioning. Refractory (1018), slag pool (1258), electrode (1274) and burner (1273).

FIG. 106 illustrates one embodiment of a melting unit. Input (1252), plasma torch (1303), hot face (1131), view port and scrape (1135), optional burner exhaust (1145), IFB (1138), steel shell (1134), oxygen lance (1133), optional small burner (1273) to keep slag end hot and water quench (1136) are shown.

FIG. 107 illustrates one embodiment of a melting unit. Input (1252), plasma torch (1303), hot face (1131), view port and scrape (1135), passive grate (1313), optional burner exhaust (1145), IFB (1138), steel shell (1134), oxygen lance (1133), optional small burner (1273) to keep slag end hot and water quench (1136) are shown.

FIG. 108 illustrates one embodiment of a melting unit.

FIG. 109 illustrates various embodiments of tap hole concepts. A) enclosed induction heaters (1137) surround a ‘tube’ exiting the refractory and increase the temperature of the surrounding refractory; this allows the slag (1139) to flow though the ‘tube’ and pour (1140) out of the melting unit (1250). When enough slag has been removed, the induction heaters are turned off, and the slag solidifies in the ‘tube’. During the pour, the level of the molten slag is not allowed to reach the top of the tube, so that gases in the chamber and the atmosphere do not mix. B) The oxygen lance (1133) is used to “burn” a hole into the soft refractory paste (1141) allowing molten slag (1139) to pour (1140) out. The flow is stopped by throwing some refractory powder into the hole or pushing a piece of ceramic blanket into the hole. During the pour the level of the molten slag is not allowed to reach the top of the hole, so that gases in the chamber and the atmosphere do not mix. C) A water cooled plug (1142) is moved out (partially) to expose tap hole. Moved back in as required to stop the flow before the hole opens up the vessel environment to the atmosphere (empty the chamber). Material does not “stick” to the plug because it is a smooth, cool surface. D) A metal “wedge” (1138) is pushed in an out of tap hole to control flow of slag. The wedge can be quickly put back into the chamber to avoid the molten slag level from dropping too far. E) Slag pours out as gravity pushes the slag through the tap-hole maintaining the level of the pool around the level of the tap-hole exit. F) Same method in E except the slag pours down and out a vertical hole made in the refractory and a lance is used to unseal the tap-hole if it gets plugged. G) Slag pours out a temperature controlled (heated or cooled) insert in the side refractory of the chamber with a stopper (generally conical in nature) is pushed against the exit to control/stop the flow of slag out of the chamber. H) Slag pours out due to gravity but the final exit is a weir block which is replaceable. Can be heated or cooled as needed (not shown).

FIGS. 110A to 110G illustrate various isometric outside views of one embodiment the Carbon Conversion System detailing a horizontally-oriented primary processing unit (4000) with moving grate (4002), a combined vertically oriented secondary processing (4201) and melting unit (4250) with inter-zonal region and plasma torch (4301), and a gas reformulating unit with cyclonic separator (4400), refining chamber (4302) and two plasma torches (4301).

FIGS. 111A and 111B illustrate various embodiments of the cyclonic separator of the gas reformulating unit in which reformulated syngas is recycled back into the cyclone to promote mixing and the cyclonic effect. A cyclone tube (1406), cyclone tube insert (1407), minor leakage (1411), recycled gas exit (1412), support for inner tube (1413), support for insert (1414), syngas out (1507) is shown.

FIG. 112 illustrates a side view of one embodiment of the Carbon Conversion System detailing a horizontally-oriented primary processing unit (4000) with a moving grate (4002) and associated feeding system (4001), a combined vertically oriented secondary processing (4201) and melting unit (4250) with inter-zonal region and plasma torch (not shown), and a gas reformulating unit with cyclonic separator (4400), a refining chamber (not shown) and plasma torches (4301). The gas reformulating unit comprises cyclonic separator with plasma torches positioned on the throat of the cyclone inlet and in the alternative location of inside the cyclone chamber.

FIG. 113 illustrates an isometric view of the embodiment shown in FIG. 112.

FIG. 114 illustrates a side of the embodiment shown in FIG. 112, with a cut showing the internals of the vessels (chambers).

FIGS. 115A and 115B illustrate one embodiment of the cyclonic separator of the gas reformulating unit. FIG. 115A shows a front view with the torches positioned at the inlet throat of the cyclone. FIG. 115A shows a top-down view of the cyclone with the lid and torches removed from view.

FIGS. 116A to 116D illustrate alternative views of the embodiment shown in FIG. 115 with internal details. FIG. 116A shows a side view. FIG. 116B shows an isometric view. FIG. 116C shows a side view along the axis with the exit with refining (reformulation) chamber and hot pipe to recuperator. FIG. 116D shows a side view parallel to the inlet of the cyclone.

FIG. 117 illustrates the horizontally oriented primary processing unit of one embodiment of the Carbon Conversion System from the side, and detailing the bottom grate positioning of each cartridge (2000).

FIG. 118 illustrates the horizontally oriented primary processing unit of FIG. 117 in an isometric view. In this view, the inlet to the throat to the cyclone is viewable.

FIGS. 119A and 119B illustrate two more isometric views of the horizontally oriented primary processing unit of one embodiment of the Carbon Conversion System of FIG. 117. FIG. 119A shows the start of the chamber where the feeding of material occurs. FIG. 119B is a cut of the feeding inlet wall, which shows some of the internals of the chamber.

FIG. 120 illustrates a side view of the horizontally oriented primary processing unit of FIG. 117 where a cut along the viewing plane allows for internals, such as the moving grate system and gas flow controlling baffle.

FIG. 121 illustrates a front view of the horizontally oriented primary processing unit of FIG. 117 with a cut to show the inside of the chamber which illustrates the separation between the gas zone at the top and the levels and drop at the bottom of the chamber.

FIG. 122 illustrates a combined secondary processing and melting unit, in part, of one embodiment of the Carbon Conversion System detailing a cogwheel dome and ceramic balls. In addition, this cut also shows the side and bottom pour options for the slag removal from the chamber.

FIG. 123 illustrates of one embodiment of the Carbon Conversion System detailing the primary processing unit (1000) with feedstock input (1001), baffle (1010) and moving grate (1003), a combined secondary processing and melting unit (1200) with plasma source (1303) and burner (1273) and slag outlet (1252), and the gas reformulating unit (1300) with the cyclonic separator system (1401) and plasma source (1303) and particulate collection (1402).

FIG. 124 illustrates control of the Carbon Conversion System of FIG. 123 whereby the flow of air is control by flow control valves (1700) and the pressure in the line is sensed by a sensing element (1703) (e.g. a pressure sensor) to control the process air blower (4033).

FIG. 125 illustrates one embodiment of the control of the Carbon Conversion System of FIG. 123 whereby the position of the ram is determined by pressure in the hydraulic lines (1704) to the rack and pinion system (1151). Overall control of all rams is by the control system, generally in a fixed cycle with other rams. Each ram (1035) can, however, function independently if such an operation was desired by using various sensing elements such as a level switch (1701) above the ram (to indicate that the ram should move forward when it is tripped, and backwards when it is cleared within the travel distance of the rack & pinion system) and/or a temperature thermal couple (1702) (temperature sensor) which could indicate that the air box is too hot and that the material is combusting rather than gasifying, and that the ram should clear that level (and also reduce the air flow to that air box (1150)).

FIG. 126 illustrates one embodiment of control of the Carbon Conversion System of FIG. 123 detailing placement of gas-phase temperature sensors (1702) which could be used by the control program to adjust the control variables in order to optimize the operation of the conversion process.

FIG. 127 illustrates a top view of the dome and melting unit in one embodiment of the Carbon Conversion System which incorporates cooling technology. In this example, the dome is made out of six copper water-cooled pieces which would make up its core and have a refractory cover (not shown) placed on top and refractory coating on any exposed sides and bottom to make up the complete dome.

FIG. 128 illustrates a side view of a round walled melting unit in one embodiment of the Carbon Conversion System which incorporates cooling technology. Here the chamber is partially cooled by water-cooled copper inserts that surround the outside of the vessel and penetrate the outer layer of refractory (not shown) at a height around where the slag pool would form.

FIG. 129 illustrates a partially transparent isometric view of a round wall slag melting chamber of FIG. 128, with cooling inserts prominently not transparent. A burner port (5005), plasma torch port (5010), water-cooled copper insert (5015) for dome cooling, grooves to hold casted slag to copper (5020), water in/out (5025), water-cooled copper insert (5030) for slag tap hole cooling, water cooled insert for slag pool refractory wall cooling (5035), multi-piece refractory dome (5070) with conduits (5072) are shown.

FIGS. 130A to 130C illustrate copper cooling pieces in isometric views of a round walled melting unit in one embodiment of the Carbon Conversion System, which incorporates cooling technology. FIG. 130A shows an isometric view of the top of the dome water-cooled copper elements. FIG. 130B shows an isometric view of the bottom of the dome water-cooled copper elements. FIG. 130C shows an isometric view of the top of the water-cooled copper elements designed to cool the walls around the slag pool.

FIGS. 131A to 131C illustrate copper cooling pieces in isometric views of a round walled melting unit in one embodiment of the Carbon Conversion System which incorporates cooling technology. FIG. 131A is a transparent showing internal cast where water will pass though the copper. FIG. 131B is a non-transparent showing divots where anchors can be attached to hold it to the refractory (if casting of refractory is chosen over bricks). FIG. 131C shows a cut of the water-cooled cooper insert.

FIG. 132 illustrates a side view of a melting unit in one embodiment of the Carbon Conversion System which incorporates cooling technology, where the slag melting zone has flat walls and is rectangular in nature. Water-cooled copper inserts for refractory wall cooling (5035), burner ports (5045), a secondary processing unit interface (5050), a plasma torch port (5045), a water cooler copper insert for slag tap-hole (5030) with inner and outer pieces, and a water cooled channel (5040) are shown.

FIGS. 133A to 133E illustrate various views of the melting unit of FIG. 132. FIG. 133A shows one potential set-up of water-cooled cooper inserts around the chamber (chamber shell and refractory not shown). The grooves hold pour casted refractory to copper. Water inlets and outlets (5025) and thermocouples (5026) are shown. FIG. 133B shows an alternative water-cooled half dome embodiment (rather than six pie shaped pieces). FIG. 133C shows an isometric view of a solid embodiment. FIG. 133D shows an isometric view of it transparent, showing a potential piping channel in the cooper where water would pass. Deep cooling channel (5080), shallow cooling channels (5082), thermocouples (5026) and water inlet/outlet (5025) are shown. Shallow cooling channels are used at lower temperatures than the deep cooling channels. Determination of which cooling channel to use is based on thermocouple and internal process temperatures. FIG. 133E shows a transparent isometric view of a side wall water-cooled cooper insert piece for a slag melting zone with a rectangular shape.

FIGS. 134A and 134B illustrate various embodiments of the Carbon Conversion System. FIG. 134A shows an embodiment where a plasma torch is located at the throat of the cyclone but is oriented partially co-currently. FIG. 134B shows one embodiment where a plasma torch is located at the throat of the cyclone but is oriented perpendicular to the current.

FIGS. 135A and 135B illustrate various embodiments of the Carbon Conversion System. FIG. 134A shows an embodiment where the plasma torches are located between the primary processing unit and secondary processing unit and the cyclone and where the cyclone is internal to the Carbon Conversion System. FIG. 134B shows one embodiment of the invention where the plasma torches are located inside the cyclone and where the cyclone is internal to the Conversion System.

FIG. 136 illustrates one embodiment of the Carbon Conversion System where there are two plasma torches in-between the primary processing unit (1000) and the secondary processing unit (1201) and the cyclone. They are pointed at each-other but off-set enough (generally at least a few inches) so that their plumes do not destroy the other. This causes plasma to be partially added co-current and counter current before the gas enters the cyclone.

FIGS. 137A and 137B illustrate embodiments (in part) of the Carbon Conversion System where the plasma torch (1303) is placed in the reformulation chamber (1300), one where the torch is co-current to the flow right as the gas exits the cyclone (1400), and the other is co-current to flow (but not directed such that its plume would enter the cyclone). Exit to recuperator (1500) is shown.

### DETAILED DESCRIPTION OF THE INVENTION

### Definitions

As used herein, the term “about” refers to an approximately +/−10% variation from a given value. It is to be understood that such a variation is always included in any given value provided herein, whether or not it is specifically referred to.

As used herein, the term “off-gas” means generally, a gas generated during the gasification process, prior to cooling, cleaning or polishing.

As used herein, the term “syngas” means off-gas that has been reformulated.

As used herein, the term “cyclone”, “cyclonic separator” and “cyclonic separator system” are used interchangeably herein includes cyclones, cyclone banks, cyclonic separator, cyclonic reactors and swirl tubes and other gas cleaning technology that works on the principals of particle vs. gas inertia and the centrifugal force of swirls.

Unless defined otherwise, all technical and scientific terms used herein have the same meaning as commonly understood by one of ordinary skill in the art to which this invention belongs.

### Overview of the Carbon Conversion System

The invention provides a Carbon Conversion System having four functional units, each unit comprising one or more zones, wherein the units are integrated to optimize the overall conversion of carbonaceous feedstock into syngas and slag. The processes that occur within each zone of the system can be optimized, for example, by the configuration of each of the units and by managing the conditions that occur within each zone using a control system. In the context of the invention, a conversion or process is “optimized” when, for example, the efficiency of the conversion/process is within predetermined parameters, when the costs associated with the conversion/process meet predetermined criteria, when the content of the syngas produced is within predetermined parameters, or a combination thereof. Syngas produced by the Carbon Conversion System can be utilized, for example, in gas engines, gas turbines, chemical production, fuel cells and the like.

The four functional units comprised by the Carbon Conversion System are: a primary processing unit, a secondary processing unit, a melting unit and a gas reformulating unit. The system may optionally include other units, for example, units that assist with the overall carbon conversion process or that facilitate downstream processing of the syngas.

The primary processing unit is configured to provide at least a drying zone to remove moisture from the carbonaceous feedstock and a volatilization zone to volatilize carbonaceous components of the feedstock thereby generating a processed feedstock and a primary off-gas. The primary processing unit optionally comprises direct or indirect secondary feedstock additive capabilities in order to adjust the carbon content of the primary feedstock. The secondary processing unit comprises one or more zones configured to receive processed feedstock and convert it into a solid residue and a secondary off-gas. The melting unit is configured to efficiently vitrify the solid residue and optionally generate a melting unit gas. The gas reformulating unit comprises one or more zones for reformulating gas generated within one or more of the other functional units.

The control system comprises sensing elements for monitoring and obtaining data regarding operating parameters within the system, and response elements for adjusting operating conditions within the system. The control system functions to maintain a certain range of variability in the product syngas.

The four functional units comprised by the Carbon Conversion System may be provided as discrete interconnected compartments or two or more of the units may be provided as a single compartment. Various embodiments of the invention provide for a Carbon Conversion System in which the four functional units are discrete interconnected compartments, a Carbon Conversion System in which some of the units are discrete interconnected units while others are provided as a single compartment, and a Carbon Conversion System in which the four functional units are provided in a single compartment. It is also envisioned that a given functional unit may comprise more than one compartment.

When functional units are provided as discrete compartments, the inter-unit junctions between contiguous units are configured to account for differences in the conditions under which each unit is operating and differences in the construction of each unit, such that the units function as an integrated system. For example, the inter-unit junctions may be configured to account for different thermal expansion coefficients of individual units and/or to maintain a continual flow of material through the system. The invention also provides for inter-unit junctions that are configured to allow the units to be easily be separated and replaced, if necessary, and/or to allow access to the units. In one embodiment, one or more of the functional units comprised by the Carbon Conversion System are provided as discrete compartments.

When one or more of the functional units are provided as a single compartment, the compartment may be configured to provide discrete sections, which may have different shapes and/or orientations, with each section corresponding to a functional unit. Alternatively, one or more units may be provided as a single compartment having a substantially uniform configuration. In one embodiment, the secondary processing unit and melting units are provided as a single compartment. In one embodiment, the secondary processing unit and melting units are provided as a single compartment which is configured to provide discrete sections, one corresponding to the secondary processing unit and one to the melting unit.

Each functional unit comprised by the Carbon Conversion System comprises one or more zones. In the context of the invention, a zone is a region in which a particular process predominantly takes place. By way of example, the volatilization zone in the primary processing unit is a region within the unit where the volatilization process predominates. For the purposes of clarity, the various zones comprised by the system are described separately. It is understood, however, that these zones are generally interrelated within the Carbon Conversion System, and that the system is not limited to comprising discrete, physically separated zones, although this remains an alternative option. In various embodiments, therefore, the zones will be more or less separated and, as such, may be contiguous, may overlap by various degrees, may be coextensive or may be discrete. Where two or more zones are present in a given unit, they may be distributed substantially parallel to the longitudinal axis of the unit, substantially perpendicular to the longitudinal axis of the unit, or a combination thereof. While the zones are described herein according to the process that takes place predominantly in that zone, it is to be understood that this is not limiting and that, due to the nature of the overall carbon conversion process, other processes may also take place to a lesser extent in that zone.

Conditions within each zone comprised by the Carbon Conversion System are managed by the control system. Processes taking place within a zone are optimized through control of the conditions therein via the control system, as well as by the configuration of the unit in which the zone is located. For example, the positioning of heat or energy sources, additive inlets, and the like, within a unit can assist in optimizing the predominant process taking place in a given zone in that unit.

In general, the carbon conversion process is carried out by the Carbon Conversion System as follows. The feedstock is heated in the primary processing unit at a temperature of generally less than about 800° C., with the main processes being the removal of any residual moisture from the feedstock and rapid and efficient volatilization of carbonaceous components from the feedstock. The resulting processed feedstock, which includes char is subjected to higher temperatures (for example, about 1000° C. to about 1200° C.) in the secondary processing unit, thereby achieving any additional carbon conversion required to complete conversion of the processed feedstock to an off-gas and ash or solid residue. Ash or solid residue from the secondary processing unit is vitrified to slag in the melting unit. Gas generated in any of the primary processing, secondary processing and/or melting units is reformulated in the gas reformulating unit. The gas reformulating unit comprises at least one energy source (for example, a source of plasma or heat) and optionally one or more particle separators (such as cyclonic separators). Other energy sources suitable for inclusion in the reformulating unit, include, for example, thermal heating, plasma plume, hydrogen burners, electron beam, lasers, radiation, and the like.

The hot syngas product of the Carbon Conversion System may optionally be subjected to a cooling step prior to further cleaning and conditioning. In one embodiment of the invention, the Carbon Conversion System comprises a heat recovery unit for cooling the hot syngas produced from the carbon conversion process. In one embodiment, the heat recovery unit is a recuperator. In such an embodiment, the recuperator can comprise a heat exchanger for transferring the sensible heat to a fluid for use elsewhere. In one embodiment, the heat recovery unit is a syngas-to-air heat exchanger (also known generally as a recuperator) that recovers sensible heat from the hot syngas and transfers it to ambient air to provide heated air. In this embodiment, the heated air is optionally passed into the primary processing unit and/or the secondary processing unit. The recuperator may optionally include a heat recovery steam generator to generate steam, which can be used, for example, to drive a steam turbine, or as a process additive in the Carbon Conversion System. In one embodiment of the invention, the Carbon Conversion System comprises a syngas-to-air heat exchanger that recovers sensible heat from the hot syngas and recycles it to the primary processing unit and/or the secondary processing unit.

With reference to FIG. 1A an illustrative embodiment of the Carbon Conversion System is presented, wherein the system comprises four functional units including a primary processing unit 1, a secondary processing unit 2, a melting unit 3 and a gas reformulating unit 4. As illustrated, the primary processing unit 1 is connected to the secondary processing unit 2 which in turn in connected to the melting unit 3. The gas reformulating unit 4 is operatively connected with each of the primary processing unit 1, secondary processing unit 2 and the melting unit 3. Depending on the embodiment of the Carbon Conversion System, the operative connection between the gas reformulating unit and any one of the other three functional units of the carbon conversion system can be envisioned as an indirect operative connection or a direct operative connection.

One embodiment of a Carbon Conversion System is shown in FIG. 1B. In this embodiment, the Carbon Conversion System comprises a multi-zone refractory-lined chamber having one or more input(s) (1001) for receiving carbonaceous feedstock, a syngas outlet, a slag outlet, heated air inputs, an optional particle separator (such as cyclonic separator (1400)), and sources of plasma and/or plasma alternative to melt solid residue into slag and to reformulate the off-gas.

One embodiment of the Carbon Conversion System as shown in FIG. 1C comprises a horizontally oriented primary secondary processing unit (1000), a vertically oriented secondary processing unit (1201) with associated melting unit (1250), a gas reformulating unit (1300) and optional recuperator (1500). The gas reformulating unit comprises a plasma source or its equivalent and an optional cyclonic separator (1400). When a cyclone separator is present, gas in the gas reformulating unit can be subject to reformulation or equivalent before, after or during cyclonic separation. The slag outlet (1252) in some embodiments is operatively associated with a slag granulization system (1251).

Generally, the carbon conversion process (also referred to herein as “gasification”) carried out by the Carbon Conversion System can be subdivided into three stages; namely, drying, volatization and char-to-ash (or carbon) conversion.

### Stage I: Drying of the Material

The first stage of the process is drying, which occurs mainly between 25° C. and 400° C. Some volatilization and some carbon-to-ash conversion may also take place at these lower temperatures.

### Stage II: Volatilization of the Material

The second stage of the process is volatilization, which occurs mainly between 400° C. and 700° C. A small degree (the remainder) of the drying operation as well as some secondary processing (char to off-gas) will also take place at this temperature.

### Stage III: Carbon Conversion

The third stage of the process is that of carbon conversion, which takes place at a temperature range of between 600° C. and 1000° C. A small degree (the remainder) of volatilization will also take place at this temperature. After this stage, the major products are a substantially carbon-free solid residue (ash) and off-gas.

During the above-described process, in order to increase the yield of the desired syngas products, it is preferable to maximize the conversion of the carbonaceous feedstock into the desired gaseous products. The Carbon Conversion System therefore provides a system for ensuring substantially complete conversion of the available carbon in the feedstock into a syngas, while also providing for the recovery of the syngas and a slag product. In various embodiments, the Carbon Conversion System also provides for the addition of heated air and/or process additives, such as steam and/or carbon rich gas and/or carbon, to facilitate the conversion of the carbon to the desired syngas product. The Carbon Conversion System also provides plasma or equivalent to facilitate the complete conversion of the residual inorganic materials (i.e. ash) into a vitrified substance or slag and to polish and/or reformulate the off-gas thereby producing the desired syngas.

The Carbon Conversion System facilitates the production of syngas by providing for, in an integrated system, the sequential promotion of feedstock drying, volatilization, carbon conversion and off-gas reformulation.

In particular, the primary processing unit is designed primarily to dry the feedstock and volatilize the carbonaceous components of the feedstock. The secondary processing unit is designed to remove any remaining volatiles from the processed feedstock and to get value out of the leftover carbon in the char by providing for example additional air, intense heat from the associated melting unit, and a residence time that promotes the recovery of carbon.

As a result, the two processing units produce two distinct streams of off-gas. The primary processing unit provides a high heating value gas full of volatiles, water vapour and other hydrogen compounds, whereas the secondary processing unit produces an off-gas which is mainly CO and CO₂, with some H₂, heavy carbon compounds and carbon soot.

The gas reformulating unit with its optional particle separator provides for the removal or reduction of particulate matter in the gas and the reformulation of the gas into syngas. Inclusion of a particle separator can help to reduce clogging and wear on downstream equipment, reduce the negative effects of particulate, and reduce the need for downstream particulate cleaning where condensable tars may be present.

Referring to FIGS. 4 and 5 which show block flow diagrams detailing movement of material and gas through one embodiment of the Carbon Conversion System and downstream systems including recuperator (1500), carbonaceous feedstock (1002) enters the primary processing unit (1000) of the Carbon Conversion System where any moisture from the carbonaceous feedstock is removed and volatile components of the feedstock are volatilized by heating via hot air (1505) which may be provided by recuperator (1500) or a multi-fuel burner (1253) that heat ambient or cold air (1502 and 1504) thereby providing a processed feedstock (1003) comprising char. The secondary processing unit (1201) receives the processed feedstock from the primary processing unit (1000) and converts the processed feedstock to a residue (1206) and an off-gas (1205). In the illustrated embodiment, gas (1204/1205) from the primary processing unit (1000) and secondary processing unit (1201) enters the cyclonic separator (1400) of the gas reformulating unit to reduce off-gas particulate load prior to reformulation (1301). Off-gas with reduced particulate load (1403) is subject to reformulation. Hot syngas (1501) exiting the reformulating zone transits a recuperator (1500) where sensible heat is recovered for optional reuse. The cooled syngas (1501) is optionally polished or cleaned in downstream gas conditioning (1600). Cleaned and/or polished gas may be stored in appropriate tanks (1601) prior to use in engines (1602).

Residue (1206) from the secondary processing unit and optionally particulate (1402) from the cyclonic separator (1400) is melted in the melting unit to produce a hot slag product (1255) by the application of heat from a plasma source (1301) or equivalent. The hot slag product (1255) is optionally granulized or otherwise handled by a slag handling system (1256) to provide a cooled slag product (1257). Heat is provided to the slag zone by a plasma source (1301) and an auxiliary multi-fuel burner (1253), which can optionally use syngas or an alternative fuel (1254).

Referring to FIG. 6 process additives are optionally added to the system at various stages to facilitate the processes occurring therein and/or to facilitate the conversion of the carbon in the feedstock (1002) to the desired syngas product. Process additives (1004), such as high carbon supplementary feedstock, steam and/or carbon rich gas and/or carbon, can be added to the feedstock prior to initiating the process, during specific stages of the processes (i.e. by the addition in specific units), at the interface between units or to the products of the specific units.

The Carbon Conversion System further comprises one or more of a control system to regulate operation of the Carbon Conversion System, and optional associated units including a slag granulation unit and/or a heat recycling unit for reclaiming heat from the syngas.

### Feedstock

Feedstocks suitable for use with the present Carbon Conversion System include various carbon-containing materials. Examples of suitable feedstock include, but are not limited to, hazardous and non-hazardous waste materials, including municipal solid wastes (MSW); wastes produced by industrial activity; biomedical wastes; carbonaceous material inappropriate for recycling, including non-recyclable plastics; sewage sludge; coal; heavy oils; petroleum coke; bitumen; heavy refinery residuals; refinery wastes; hydrocarbon contaminated solids; biomass; agricultural wastes; municipal solid waste; hazardous waste and industrial waste. Examples of biomass useful for gasification include, but are not limited to, waste wood; fresh wood; remains from fruit, vegetable and grain processing; paper mill residues; straw; grass, and manure.

The present system can be adapted or modified according to the requirements of the feedstock being utilized. For example, when utilizing a higher carbon content feedstock, the Carbon Conversion System can be configured to include a secondary processing unit having a larger size than would be required for a system utilizing a lower carbon content feedstock. Alternatively, where a feedstock having high levels of volatile compounds is utilized, the Carbon Conversion System can be configured to include a primary processing unit that is larger in size than that required for a feedstock having a lower volatile content.

The present Carbon Conversion System can also be adapted to utilize various mixtures of primary feedstock with one or more secondary feedstocks. In this context, a secondary feedstock is a feedstock that functions as a process additive to adjust the carbon content of the primary feedstock in order to maintain a consistency in the final syngas output. For example, where the system utilizes a lower carbon content primary feedstock, such as biomass or MSW, a high carbon secondary feedstock, such as coal or plastics, can be provided as a high carbon process additive to increase the proportion of carbon in the feedstock. Alternatively, where a high carbon feedstock (such as coal) is the primary feedstock, it is contemplated that a lower carbon secondary feedstock (such as biomass) can be provided to offset the high carbon content as may be required.

When more than one feedstock is utilized, the feedstocks may be combined prior to their introduction into the primary processing unit through a common feedstock inlet, or they may each be introduced separately to the primary processing unit through dedicated feedstock inlets.

The feedstock may be pre-processed if necessary. For example, the feedstock may be processed into smaller pieces, for example, by passage of the feedstock through a shredder or other cutting device (either once or in two or more passes), and/or it may be processed to remove metal or other recyclables, for example, by passing the feedstock through a magnetic separator, eddy-current separator, vibrating screen, air knife or the like.

In embodiments where the primary feedstock is MSW, the feedstock may be pre-processed by sorting to remove white goods, mattresses, propane bottles, and other items that are either hazardous or have little energetic potential, by shredding to reduce the size of the material, by separating ferrous metal, by removal of nonferrous materials, by removal of inorganics and plastics, or various combinations of the foregoing.

### The Primary Processing Unit of the Carbon Conversion System

The primary processing unit of the Carbon Conversion System provides for at least the drying of the carbonaceous feedstock and the volatilization of carbonaceous components in the feedstock thereby providing a processed feedstock comprising char, which is subsequently further processed in the secondary processing unit.

The primary processing unit comprises one or more feedstock inputs and is operatively associated with one or more sources of heat and with the secondary processing unit. The primary processing unit also comprises a lateral transfer system for moving material through the unit. Carboneaceous feedstock enters the primary processing unit via the one or more feedstock inputs and is moved through the unit during processing by the lateral transfer system toward the secondary processing unit.

In one embodiment of the invention, the primary processing unit comprises a modular lateral transfer system. The modular lateral transfer system comprises one or more modules, wherein each module has the ability to deliver air and/or process additives (collectively referred to as “process gas”) in addition to moving the material through the primary processing unit.

In the Carbon Conversion System as a whole, the gasification process is facilitated by sequentially promoting drying, volatilization and carbon conversion. This is accomplished by spatially expanding the gasification process such that drying occurs at a certain temperature range prior to moving the material to another zone and allowing volatilization to occur at another temperature range. The processed feedstock is then transferred into the secondary processing unit to allow for char-to-ash conversion to occur at another temperature range.

The primary processing unit comprises two or more zones in which temperature and process additives may be independently controlled and optionally optimized to promote drying and/or volatilization. In one embodiment, the primary processing unit is provided with three or more processing zones.

During processing, feedstock is introduced into the primary processing unit proximal to a first end (hereafter referred to as the “feed end”), through the feedstock input(s) and is transported from the feed end of the unit towards the junction with the secondary processing unit. As the feed material progresses through the primary processing unit, it loses its mass volume and pile height decreases as its volatile fraction is volatilized and the resulting solid material comprising char is transported to the secondary processing unit for further processing.

In one embodiment, the primary processing unit has a stepped floor having a plurality of floor levels or steps. Optionally, each floor level is sloped. In one embodiment, the floor level is sloped between about 5 and about 10 degrees.

In one embodiment, the primary processing unit has a stepped floor with a plurality of floor levels. Referring to FIG. 20, the step riser height progressively decreases towards the outlet.

Optionally, slanting floor sections can be used with due regard to the possibility of air blockage in order to “lengthen” the primary processing unit.

In one embodiment, the primary processing unit floor has an overall slope either towards the secondary processing unit or towards the feed end.

Optionally, the individual steps may be of a solid construction, boxed construction or layered construction. For example, the individual steps may be cast or may be a layered construction. In layered construction embodiments, the individual steps may be formed from alternating layers of metal and ceramic.

Referring to FIG. 24, in one embodiment each step is a layered construction comprising alternating thick metal layers and ceramic blanket layers. The tread of the step is covered with a refractory layer. Each metal layer comprises a series of plenums, each equipped with a nozzle through which air and/or steam can be injected horizontally into the interior of the chamber. Air is injected at predesigned velocities and jet penetration depths. Nozzles of varying diameters are provided to allow for low, medium or high penetration as need to ensure uniform coverage.

In one embodiment, movement over the steps is facilitated by the lateral transfer system with each step optionally being serviced by an independently controlled lateral transfer unit.

For stepped floor embodiments, the number of drops and dimensions can be selected to cover length and residence time requirements. In one embodiment, initially big drops and relatively shorter reciprocating distance may be used, gradually ending with smaller drops and same travel distance (corresponding to top of the material being close to 60 degrees from horizontal initially and 30 degrees at the end). The drop height can be selected such that adequate mixing without uncontrolled tumbling is achieved.

In one embodiment, the primary processing unit has a sloped floor.

In one embodiment, the primary processing unit is provided with internal baffles.

### Lateral Transfer System of the Primary Processing Unit

In one embodiment, the primary processing unit comprises a lateral transfer system. In accordance with this embodiment, the lateral transfer system comprises one or more lateral transfer units. The individual lateral transfer units comprise a moving element and a guiding element or alignment element or means. It would be apparent to a worker skilled in the art that the moving element can be equipped with appropriate guide engagement elements.

The moving element can take various configurations including, but not limited to, a shelf/platform, pusher ram or carrier rams, plow, screw element, grates, conveyor or a belt. The rams can include a single ram or multiple-finger ram.

In one embodiment, the rams are short rams which can be fully retracted with each stroke.

In one embodiment, the primary processing unit is configured to allow for the use of a single ram or multiple-finger ram.

In one embodiment, a multiple-finger ram is used when minimum interference with gas flows is desirable during operation of the rams.

In the multiple-finger ram designs, the multiple-finger ram may be a unitary structure or a structure in which the ram fingers are attached to a ram body, with individual ram fingers optionally being of different widths depending on location. The gap between the fingers in the multiple-finger ram design is selected to avoid particulates of reactant material from bridging.

In one embodiment, the individual fingers are about 2 to about 3 inches wide, about 0.5 to about 1 inch thick with a gap between about 0.5 to about 2 inches wide.

In one embodiment, the moving element is “T-shaped”.

In certain embodiments in which the system operates at very high temperatures, cooling can optionally be provided for the moving elements. Cooling means may be external or may be incorporated into the moving element. In one embodiment using a ram or shelf, cooling within the ram or shelf can be provided. Such cooling could be by fluid (for example, air or water) circulated inside the ram or shelf from outside of the chamber.

In one embodiment, the moving element comprises a plow having folding arms which can be withdrawn when the plow is retracted.

In one embodiment, the moving element comprises a conveyor. In one embodiment, the moving element comprises a belt or flighted chain conveyor.

In one embodiment, a series of toothed wheels are used. Referring to FIGS. 25, 26, 27 and 28, the tooth wheel lateral transfer units allows material movement above a thin layer of solid residue that acts as insulator from the hot reaction zone. During clockwise operation material is prodded along. During counter clockwise operation material is pushed back and off the chamber floor and then allowed to drop thereby allowing gravity and momentum to move the material forward and down.

A small amount of ash/char may fall below (minimized by raising the floor around the slots slightly). This can optionally be collected and fed back into primary processing unit (for example, through the use of screws) to help maintain the insulating ash layer (if ash is hot, it would be necessary to avoid contact with air).

In one embodiment, the drive components for the moving elements are located external to the elements and may optionally use greaseless bearings.

The moving element is constructed of material suitable for use at high temperature. Such materials are well-known to those skilled in the art and can include stainless steel, mild steel, or mild steel partially protected with or fully protected with refractory. The moving elements may optionally be of a cast or solid construction. Optionally the moving elements are sized to ensure agglomeration of a variety of sizes and/or shapes can be effectively moved.

The guide elements for the moving elements can be located in the interior of the primary processing unit or be internally mounted. Alternatively, the guide elements can be located exterior to the primary processing unit or be externally mounted.

In embodiments in which the guide elements are interior or internally mounted, the lateral transfer system can be designed to prevent jamming or debris entrapment.

In embodiments in which the guide elements are located exterior to the primary processing unit or are externally mounted, the primary processing unit includes at least one sealable opening through which the moving element can enter the primary processing unit.

The guide element can include one or more guide channels located in the side walls of the primary processing unit, guide tracks or rails, guide trough or guide chains.

The guide engagement members can optionally include one or more wheels or rollers sized to movably engage the guide element. In one embodiment, the guide engagement member is a sliding member comprising a shoe adapted to slide along the length of the guide track. Optionally, the shoe further comprises at least one replaceable wear pad.

In one embodiment, the guide engagement element can be integral to the moving element. For example, the surface of the moving element may be specifically adapted to engage the guide element. In one embodiment, the floor of the primary processing unit includes tracks and the moving element in contact with the floor of the primary processing unit is specifically shaped to engage the tracks.

In one embodiment, the lateral location of the moving element is provided only at the point at which the moving element enters the primary processing unit, with alignment elements ensuring that the moving element is held angularly aligned at all times thereby eliminating the need for complex, accurate guide mechanisms.

In one embodiment, the alignment element is two chains driven synchronously by a common shaft. The chains are optionally individually adjustable to facilitate proper alignment.

In one embodiment, the lateral transfer system can be a movable shelf/platform in which material is predominantly moved through the primary processing unit by sitting on top of the shelf/platform. A fraction of material may also be pushed by the leading edge of the movable shelf/platform.

In one embodiment, the lateral transfer system can be a carrier ram in which material is predominantly moved through the primary processing unit by sitting on top of the carrier ram. A fraction of material may also be pushed by the leading edge of the carrier ram.

In one embodiment, the lateral transfer system can be a pusher ram in which material is predominantly pushed through the primary processing unit. Optionally, the ram height is substantially the same as the depth of the material to be moved.

In one embodiment, the lateral transfer system can be a set of conveyor screws. Optionally, the conveyor screws can be set in the floor of the primary processing unit thereby allowing material to be moved without interfering with air introduction.

In one embodiment, the lateral transfer system is a moving grate.

Power to propel the lateral transfer system can be provided by one or more motors and drive systems and is controlled by one or more actuators.

The individual lateral transfer units may optionally by powered by dedicated motor and have individual actuators or one or more lateral transfer units may be powered by a single motor and shared actuators.

Various controllable motors or mechanical turning devices known in the art which can provide accurate control of the lateral transfer system can be used to propel the lateral transfer system. Non-limiting examples include electric motors, motors run on syngas or other gases, motors run on steam, motors run on gasoline, motors run on diesel and micro turbines.

In one embodiment, the motor is an electric variable speed motor which drives a motor output shaft selectably in the forward or reverse directions. Optionally, a slip clutch could be provided between the motor and the motor output shaft. The motor may further comprise a gear box.

Movement of the lateral transfer system can be effected by a suitable drive system, for example, a hydraulic system, hydraulic rams, chain and sprocket drive, or a rack and pinion drive. These methods of translating the motor rotary motion into linear motion have the advantage that they can be applied in a synchronized manner at each side of a unit to assist in keeping the unit aligned and thus minimizing the possibility of the mechanism jamming.

In one embodiment, the use of two chains per ram keep the rams angularly aligned without the need for precision guides.

In one embodiment, the lateral transfer system includes one or more pneumatic pistons.

In one embodiment, the lateral transfer system includes one or more hydraulic pistons.

The externally mounted portions or components of the lateral transfer unit is optionally housed in an unsealed, partially sealed or sealed enclosure or casing. The enclosure may further comprise a removable cover to allow for maintenance. In one embodiment, the enclosure may have a higher internal pressure than the interior of the primary processing unit. Higher internal pressure may be achieved, for example, by the use of nitrogen.

### Primary Processing Unit Heating System

The gasification process requires heat. Heat addition can occur directly by partial oxidation of the feedstock or indirectly by the use of one or more heat sources known in the art.

In one embodiment of the invention, the primary processing unit comprises, or is operatively associated with, one or more heat sources. Various suitable heat sources are known in the art and include, but are not limited to, sources of hot air, sources of steam, sources of plasma, electrical heaters, and the like. Heat maybe supplied to one or more defined regions of the primary processing unit, for example, to the floor of the unit or a lower portion of the unit, or to the entire primary processing unit. Positioning of the heat source(s) can assist in optimizing the processes taking place within the primary processing unit. For example, positioning the heat source(s) to deliver heat to the drying zone can assist in optimizing the drying process.

In one embodiment, the heat source can be circulating hot air. The hot air can be supplied from, for example, air boxes, air heaters or heat exchangers or recuperators, all of which are known in the art.

In one embodiment, hot air is provided to each level by independent air feed and distribution systems. Optionally, hot air may be provided horizontally, vertically or a combination thereof. Appropriate air feed and distribution systems are known in the art and include separate air boxes for each step level from which hot air can pass through perforations in the floor of each step level to that step level or via independently controlled spargers for each step level.

In one embodiment, each floor level has one or more grooves running the length of individual steps. The grooves are sized to accommodate hot air and/or steam pipes. The pipes optionally being perforated on their lower third to half to facilitate the uniform distribution of hot air or steam over the length of the step. Alternatively, the sparger pipes can be perforated towards the top of the pipes.

In one embodiment, the number of perforation is designed to promote heat circulation throughout the material.

In one embodiment, the airflow system is integrated into a cast and moulded insert.

In embodiments in which the individual steps are cast, plenums may be cast into the step. Air to the plenums may be provides from a hot air system which supplies hot air to a header space.

Optionally, multiple plenums may be provided for air introduction thereby enabling injection of different amounts of air through different locations to achieve uniform and controlled air distribution. In one embodiment, at least three plenums are provided per step.

In one embodiment, uniform/uninterrupted/unobstructed air distribution without fluidization is achieved by injecting at predesigned (and different) velocities and jet penetration depths well away from ram travel or obstruction by anything else.

Low, medium or high flow through varying nozzle diameters allows for low, medium or high penetration as needed to cover waste area more uniformly.

In one embodiment, the hot air may be moist hot air.

In one embodiment, the heat source can be circulating hot sand.

In one embodiment, the heat source can be an electrical heater or electrical heating elements.

In one embodiment, hot air is provided through airboxes. In one embodiment, hot recycled syngas is provided through airboxes. Optionally, the airboxes are cast and moulded unitary inserts.

In one embodiment, to reduce warpage the airboxes may be constructed as separate, very heavy duty, solid pieces of steel which only inject hot air in areas where uninterrupted/unhindered flow occurs.

In one embodiment, hot air injection is raised slightly above the floor of the chamber by the use of raised injection ports.

### Primary Processing Unit Process Additive Inputs

Process additives may optionally be added to the primary processing unit to facilitate efficient conversion of feedstock into off-gas. Positioning of the additive inputs can assist in optimizing the processes taking place within the primary processing unit. For example, positioning additive inputs to deliver steam and/or air to the volatilization zone can assist in optimizing the volatilization process.

Steam input can be used, for example, to ensure sufficient free oxygen and hydrogen to maximize the conversion of decomposed elements of the input feedstock into off-gas and/or non-hazardous compound's. Air input can be used, for example, to assist in processing chemistry balancing to maximize secondary processing to a fuel gas (minimize free carbon) and to maintain the processing temperatures while minimizing the cost of input heat.

Optionally, other additives may be used to improve emissions.

In one embodiment, addition of process additives is monitored to ensure that the amount of oxygen present in the unit is limited. Creating an oxygen-starved environment can help to prevent the formation of undesirable dioxans and furans.

The primary processing unit, therefore, can include one or more process additive inputs. These include inputs for steam injection and/or air injection. The steam inputs can be located, for example, to direct steam into high temperature regions. The air inputs can be located, for example, in and around the primary processing unit to ensure full coverage of process additives into the processing zone.

In one embodiment, the process additive inputs are located proximal to the floor of the primary processing unit.

In one embodiment, the process additive inputs located proximal to the floor are half-pipe air spargers trenched into the refractory floor. Such air spargers may be designed to facilitate replacement, servicing or modification while minimizing interference with the lateral transfer of reactant material. The number, diameter and placement of the air holes in the air spargers can be varied according to system requirements or lateral transfer system design.

In one embodiment, the process additive inputs are located in the floor of the primary processing unit. Such process additive inputs are designed to minimize plugging by fine particulates or be equipped with an attachment to prevent plugging. Optionally, the process additive inputs can include a pattern of holes through which process additives can be added. Various patterns of holes can be used depending on system requirements or lateral transfer system design. In choosing the pattern of the airholes, factors to consider include avoiding high velocity which would fluidize the bed, avoiding holes too close to primary processing unit walls and ends so that channeling of air along refractory wall is avoided, and ensuring spacing between holes was no more than approximately the nominal feed particle size (2″) to ensure acceptable kinetics.

In one embodiment, airhole pattern is arranged such that operation of the lateral transfer unit does interfere with the air passing through the airholes.

In one embodiment in which a multiple-finger ram is used, the pattern of the airholes is such that when heated the airholes are between the fingers (in the gaps) and are in arrow pattern with an offset to each other. Alternatively, the airhole pattern can also be hybrid where some holes are not covered and others are covered, such that even distribution of air is maximized (ie. areas of floor with no air input at all are minimized).

In one embodiment, the pattern of holes facilitates the even distribution of process additives over a large surface area with minimal disruption or resistance to lateral material transfer.

In one embodiment, the process additive inputs provide diffuse, low velocity input of additives.

In embodiments in which hot air is used to heat the chamber additional air/oxygen injection inputs may optionally be provided.

### Modular Lateral Transfer System

The modular lateral transfer system comprises one or more modules, wherein each module comprises the ability to deliver process gas in addition to moving the reactant material through the primary processing unit. The modular design enables the operator to remove and replace a module of the system, thereby substantially minimizing the downtime of the unit required during servicing.

Each module is configured for interchangability with the primary processing unit. Accordingly, the unit comprises one or more insertion locations for positioning of a module, wherein associated with each of the insertion locations is an operative coupling system configured to provide the module with operative connection to systems and/or supplies that enable the module to perform its desired functionality. For example, the operative coupling system can include one or a combination of connections including a power supply connection, a process additive supply connection, an air supply connection, a steam supply connection, a control system connection, a syngas supply connection and the like. According to embodiments, each insertion location of the primary processing unit can be configured to provide a specific combination of connections, which may be dependent on the operation of the unit and/or the module for insertion at that insertion location. In some embodiments, a complete set of connections is provided at an insertion location, and the use each of these connections can be dependent on the configuration of the module that is inserted into that specific insertion location.

As noted above, each module is configured to deliver process gas in addition to moving the material through the primary processing unit. Accordingly, each module comprises a module lateral transfer system which is configured to move the material from a first location to, or towards, a second location. Each module further comprises one or more module process gas supply systems, wherein a process gas supply system is configured to at least in part provide a process gas to the material. For example, a process gas can be air, a process additive gas, steam, syngas or the like.

According to embodiments, a module further comprises a module support system which is configured to support both the module lateral transfer system and the module process gas supply system. The support system can additionally comprise a mechanism for the interconnection with the primary processing unit to which the module is to be operatively connected. For example, the mechanism for interconnection can be configured based on structural shape, wherein the mechanism is configured to substantially mate with the configuration of the insertion location of the primary processing unit. In another example, the mechanism for interconnection can be configured to provide a locking or retention system which is configured to forcibly maintain the positioning of the module with respect to the insertion location, upon placement thereat.

According to some embodiments, upon insertion of a module into an insertion location of the primary processing unit, the module is substantially automatically interconnected to the operative coupling system associated with the unit. For, example, the operative coupling system can be so configured such that there is a substantially automatic alignment of one or more of power, process gas supplies or others, upon insertion of the module. According to some embodiments, interconnection between a module and the operative coupling system of the unit requires active coupling therebetween. For example, active coupling can be provided by the connection of mating pipes or electrical connections. In some embodiments, interconnection between a module and the operative coupling system the primary processing unit is a combination of automatic and active coupling.

According to embodiments, a module is configured for lateral transfer of material within the primary processing unit and the supply of air and/or other process additives. According to embodiments, a module is configured as a multi-functional “cartridge” specifically configured for insertion into the wall of the primary processing unit. Optionally, the cartridge is configured for rapid replacement and includes a system for the rapid connection of cartridge components to unit or system components including for example, hot air supplies, process additive supplies, power supplies, control system, and the like.

According to some embodiments, a module includes a module lateral transfer system and one or more process gas supply systems configured to supply air. In this embodiment the process gas supply system is configured as one or more air boxes. According to some embodiments, a module includes a module lateral transfer system and a process gas supply system configured to supply one or more process additives. According to some embodiments, a module includes a module lateral transfer system and a process gas supply system configured to supply one or more process additives and air.

According to embodiments, the wall of the primary processing unit is adapted to receive the individual modules at insertion locations configured as slots or openings being provided in the wall for the insertion of the modules. According to embodiments, when more than one module is to be inserted the primary processing unit wall can include multiple slots or openings. Optionally, individual slots or openings in the wall may be configured to accept more than one module. In some embodiments, the primary processing unit is configured such that adjacent cartridges are inserted from opposite sides of the unit. According to some embodiments, should a slot or opening within the wall not require the insertion of a module, a plug or other means of sealing that particular slot or slots in the wall may be provided.

According to embodiments, upon installation the one or more modules form at least part the floor of the primary processing unit. According to some embodiments, wherein the floor is configured as a stepped floor, each of the modules is configured and oriented in order to provide a single step of the stepped floor.

In some embodiments, when installed, individual modules which are configured as cartridges and are covered, in part, by the cartridge above it, such that only a portion of an individual cartridge is exposed to the interior of the primary processing unit. The slot in which the topmost cartridge is inserted is specifically configured such that only a portion of the cartridge is exposed to the interior of the unit. The cartridges, when installed, form a stepped floor and optionally form a sloped stepped floor to facilitate movement of material while at least in part limiting unprocessed material from tumbling.

According to embodiments, sealing means may be provided between modules and/or between a module and the primary processing unit, wherein the sealing means is configured to prevent egress of material and/or gases into and/or out of the unit and/or between modules. According to some embodiments, a module can be sealed in place using high temperature sealant such as high temperature resistant silicone, temperature resistant gaskets or other suitable sealing device. According to some embodiments, the method of sealing the one or more modules is selected in order to enable ease of removal of a module and insertion of a new or repaired module.

According to some embodiments, a module is reversibly fixed in place by one or more of a variety of fasteners, for example bolts, screws. Optionally, a module can be held in a desired location within the wall of the primary processing unit due to friction. According to some embodiments, an insertion location associated with the wall of the primary processing unit can include one or more of insert/position alignment means, connection plates and seals.

According to some embodiments, the primary processing unit can be configured to receive a single format of a module, or multiple different formats of a module. A module may be of varying sizes and configurations and may be specifically adapted for the intended use and/or position within the primary processing unit and/or the configuration of the unit itself.

According to embodiments, a module is configured to provide lateral transfer of material within the primary processing unit and to supply air and/or one or more other process additives. According to these embodiments, the module further comprises a support framework or system configured to provide the structure of the module as well as support for both the lateral transfer system and the air and/or process additive supply system. The module may further comprise a sealing and/or connection system to facilitate the installation of the cartridge into the chamber walls and its securing in position and/or insulation elements.

According to embodiments, the support framework of the module may be constructed of a variety of materials including mild steel, high carbon steel, heat treated steel, an alloy or other material that will be at least in part resistant to the environment in which it is to operate. In addition, the support framework may be configured to facilitate installation and removal, for example, by including notches or attachment sites for tools used in the installation and removal process.

In some embodiments, the lateral transfer system associated with the module is configured to move over the top of a base portion of the module. In this embodiment, air and/or process additives can enter at the base portion of the module or at the bottom of the pile of material wherein the base portion of the module forms a portion of the process gas supply system. The process gas supply system therefore functions as both a process gas supply system and a reactant pile support or unit floor with reactant material being moved across the surface of the process gas supply system exposed to the interior of the unit (i.e. the supply surface) by the lateral transfer system. According to embodiments, the process gas supply surface is the top surface of the process gas supply system, the supply surface of the process gas may be a side surface, end surface, sloping end surface or the like. According to embodiments, the configuration of the process gas supply system is, at least in part, dictated by the configuration of the lateral transfer system of the module.

In some embodiments, an individual cartridge comprises both support/connection elements and functional elements. The support/connection elements include the module structure and one or more connection plates specifically configured for sealing connection to the shell of the primary processing unit. Refractory may be provided between the module structure and connection plate to reduce heat loss and heat transfer to the connection plate. Once inserted, the module may be secured using appropriate fasteners. The module structure includes alignment guides to facilitate the correct insertion of the module into the wall of the primary processing unit and notches to allow for the insertion of tools to facilitate the insertion and removal of the module.

### Module Lateral Transfer System

Each module comprises a module lateral transfer system which is configured to move the material from a first location to or towards a second location. According to embodiments, the module lateral transfer system comprises one or more moving elements and one or more driving elements. The lateral transfer system optionally includes guiding or alignment elements which can provide for the guiding of the movement of the one or more moving elements. According to some embodiments, the module lateral transfer system further includes two or more guide engagement elements which are configured to mesh with the guide elements, and provide a substantially movable interconnection therebetween, thereby facilitating retention of the one or more moving elements in a desired orientation while enabling the desired degree of movement thereof.

In some embodiment, the lateral transfer system and the process gas supply system are configured such that the one or more moving elements of the lateral transfer system move across the supply surface of the process gas supply system. In such embodiments, the one or more moving elements can include, but is not limited to, a shelf/platform, pusher ram, carrier ram, plow or the like. According to some embodiments, the one or more moving elements can be configured as a single ram or a multiple-finger ram.

In some embodiments the moving elements are configured as rams, and furthermore configured as short rams which can are configured to be fully retracted with each stroke. In some embodiments, which include a one or more moving elements configured as a multiple-finger ram design, the multiple-finger ram may be a unitary structure or a structure in which the ram fingers are attached to a ram body, with individual ram fingers optionally being of different widths depending on location.

In some embodiments, which include one or more moving elements configured as a multiple-finger ram, there is a separation space between each of the multiple fingers of the multiple finger ram. This separation space can be configured in order to allow for expansion of the respective multiple fingers during operation of the primary processing unit. For example, the separation space may be determined at least in part based on the maximum operating temperature of the primary processing unit.

According to some embodiments, a moving element is configured as a “T-shaped” moving element.

In some embodiments, the lateral transfer system and the process gas supply system of a module are configured such that the moving element is inserted or embedded within the supply surface of the process gas supply system. In such embodiments, the one or more moving elements can be configured as, but not limited to, a screw element, one or more wheel elements, a conveyor element or the like.

According to embodiments, the one or more moving elements are constructed of material suitable for use at high temperature. Such materials are well-known to those skilled in the art and can include stainless steel, mild steel, or mild steel partially protected with or fully protected with refractory or the like. The one or more moving elements may optionally be of a cast or solid construction. Optionally the one or more moving elements are sized and/or configured to ensure a variety of sized or shaped agglomeration can be effectively moved. For example, as the reactant material changes in shape and/or properties, the one or more moving elements are configured to move the reactant material regardless of these changes.

According to embodiments, the module lateral transfer system includes one or more guide elements which are positioned such that they are exposed to the interior of the primary processing unit. In some embodiments, the one or more guiding elements are positioned such that they are at least in part isolated from the interior of the primary processing unit.

In embodiments in which the guide elements are exposed to the interior of the primary processing unit, the lateral transfer system can be designed to prevent jamming or debris entrapment. According to some embodiments a guide element can be configured as one or more guide channels located in the side walls of the cartridge, one or more guide tracks or one or more rails, one or more guide troughs, one or more guide chains or the like.

According to some embodiments, the module lateral transfer system includes one or more guide engagement members which are configured to movably engage with one or more of the guide elements. The one or more guide engagement members optionally include one or more wheels or rollers sized to movably engage the guide element. In some embodiments, the guide engagement member is a sliding member comprising a shoe adapted to slide along the length of a guide track.

In some embodiments, the one or more guide engagement elements can be integral to or integrally formed with a moving element. For example, the surface of a moving element may be specifically adapted to engage with one or more of the one or more guide elements. In some embodiments, the supply surface of the process gas supply system includes tracks and the one or more moving elements in contact with the supply surface are specifically shaped to engage the tracks.

According to embodiments, the lateral transfer system of a module includes a multiple-finger carrier ram, engagement elements and drive system. Individual ram fingers are attached to a ram body via pins or shoulder bolts, which are configured to substantially not tighten on the individual finger. The ram body is connected to a drive engagement plate that includes parallel racks for operative engagement with a pinion for movement thereof. In some embodiments, the individual ram fingers are configured to engage a T or I-shaped engagement element which holds the ram fingers in proximity to the surface of the air box such that the rams substantially scrape the air box surface during back and forth movement thereby aiding in avoiding clinker build up.

According to some embodiments, the end of a ram finger is bent down to ensure that the tip contacts the top of the air box in the event that the relative locations of the ram and airbox change due, for example, to thermal expansion or contraction of one or more components. This configuration of a ram finger may also lessen detrimental effects on the process due to air holes being covered by the ram, the air will continue to flow through the gap between the ram and air box.

According to embodiments, each of the modules include the drive components necessary to effect movement of the one or more moving elements associated with the module lateral transfer system. For example a drive component can include a chain drive, sprocket drives, rack and pinion drive or other drive component configuration as would be readily understood. According to some embodiments, the drive component further comprises one or more actuators, pumps electrical motors or other mechanism used to operate the drive component. According to some embodiments, the provision of operative power for the respective drive component is provided by the primary processing unit itself, wherein this required operative power can be enable upon operative interconnection of the module with the primary processing unit. Optionally, in a configuration which includes multiple modules, operative power for the each of the module lateral transfer systems can be provided by one or more selected modules. In this manner, the there may be a reduction in costs associated with some of the modules as the operative component does not have to be integrated therein.

According to embodiments, power for moving the one or more moving elements is provided by a hydraulic piston. For example, power to propel the one or more moving elements is supplied by a hydraulic piston which drives one or more pinions on a shaft via a rotary actuator selectably in the forward or reverse direction allowing for extension and retraction of the one or more moving elements at a desired rate. In some embodiments, two pinions are used and engage respective parallel racks operatively connected to the one or more moving elements. According to some embodiments, position sensors can be positioned to detect and transmit position information regarding the one or more moving elements to the control system.

### Module Process Gas Supply System

Each module further comprises one or more module process gas supply systems, wherein a process gas supply system is configured to at least in part provide a process gas to the material in the primary processing unit. For example, a process gas can be air, a process additive gas, steam, syngas or the like.

According to embodiments, process gas is provided to the interior of the primary processing unit through or at the supply surface associated with the module. The process gas supply system may be configured to provide air only or a combination of air and/or one or more process additives either through shared inlets or dedicated inlets.

According to embodiments, the process gas supply system comprises a delivery system, wherein the delivery system may be configured to provide a distributed supply or a more focused supply of air and/or one or more process additives. For example a distributed supply configuration can include a supply surface which is perforated or comprises a series of holes. A more focused supply of air and/or one or more process additives may be provided by the use one or more nozzles. In some embodiments, the injection of air and/or one or more process additives is provided at a location which is raised slightly above the supply surface. This positioning of the provision of the air and/or one or more process additives can be provided by the use of raised inputs.

In some embodiments, the supply surface associated with the process gas supply system includes a plurality of perforations. According to some embodiments, the number of perforations can be optimized to provide heat circulation throughout the material.

In some embodiments, the air supply to a single module may be independently controlled or the air pipes to two or more modules may be connected to a single manifold such that the air supply to the two or more modules is dependently controlled.

In some embodiments wherein the process gas supply system includes one or more nozzles, the nozzles can be configured as low, medium or high flow nozzles. This can be enabled by varying nozzle diameters and can allow for low, medium or high penetration of the process gas being supplied. This configuration of the process gas supply system can be configured to cover the reactant material location are more uniformly.

In some embodiments, hole patterns associated with the process gas supply system are arranged such that operation of the lateral transfer unit does interfere with the process gas passing through the holes. In some embodiments, the pattern of holes facilitates the even distribution of one or more process additives or air over a large surface area with minimal disruption or resistance to lateral material transfer.

In embodiments wherein a multiple-finger ram is used as the moving element, the pattern of the holes is configured such that when heated the holes are between the fingers (in the gaps). In some embodiments, the holes can be configured in an arrow pattern with an offset to each other. In some embodiments, the hole pattern can also be hybrid where some holes are not covered and others are covered, such that even distribution of process gas is substantially maximized (i.e. areas of floor with substantially no process gas input at all are substantially minimized).

In some embodiments, the process gas inputs provide diffuse, low velocity input of process gas. In some embodiment, diffuse, low velocity input is provided for the process additives.

In some embodiments, the process gas supply system further comprises air boxes, manifolds and piping as necessary. In some embodiments, hot air is provided through airboxes. In one embodiment, recycled hot syngas is provided through airboxes. Optionally, the airboxes are cast and moulded unitary inserts. The functional elements include one or more air box components and one or more lateral transfer components.

In some embodiments, the air box component may include multiple smaller air boxes or a single large air box. Optionally the air boxes are specifically configured to reduce distortion, to reduce the risk of stress-related failure or buckling of the air box. In some embodiments, the individual air boxes are constructed from thick carbon steel. In some embodiments, to reduce warpage the airboxes may be constructed as separate, very heavy duty, solid pieces of steel which only inject hot air in areas where uninterrupted/unhindered flow occurs.

In some embodiments, the material for the perforated top plate of the air boxes is an alloy that meets the corrosion resistance requirements for the overall system. If the perforated top sheet is relatively thin stiffening ribs and structural support members to prevent bending or buckling may be provided, for example.

In some embodiments, air enters the primary processing unit at the bottom of the pile of material through air holes or perforations in the top of each air box. If the individual modules include multiple air boxes, air may be supplied to the individual air boxes via a single air manifold connected to an air pipe which connects to a hot air hook up flange in the connection plate. A hot air hook up flange is optionally adapted to facilitate rapid connection to a hot air supply.

In some embodiments, in order to avoid blockage of the air holes during processing, air hole size in the perforated tops of the air boxes is selected such that it creates a restriction and thus a pressure drop across each hole. This pressure drop can be sufficient to prevent particles from entering the holes. The holes can be tapered outwards towards the upper face to preclude particles becoming stuck in a hole. In addition, the movement of the lateral transfer units may dislodge any material blocking the holes.

In one embodiment, referring to FIGS. 93 to 98, when installed, individual cartridges are covered, in part, by the cartridge above it, such that only a portion of an individual cartridge is exposed to the interior of the chamber. The slot in which the top most cartridge is inserted is specifically configured such that only a portion of the cartridge is exposed to the interior of the chamber. The cartridges, when installed, form a stepped floor and are optionally sloped to facilitate movement of material but limit unprocessed material from tumbling.

Referring to FIG. 97, in one embodiment, an individual cartridge (2000) comprises both support/connection elements and functional elements. The support/connection elements include the cartridge structure and connection plate (2005) specifically configured for sealing connection to the shell of the chamber. Refractory (not shown) may be provided between the cartridge structure and connection plate to reduce heat loss and heat transfer to the connection plate. Once inserted, the cartridges may be secured using appropriate fasteners. The cartridge structure, in the illustrated embodiment, includes alignment guides (2015) to facilitate the correct insertion of the cartridge into the chamber wall and notches (2020) to allow for the insertion of tools to facilitate the insertion and removal of the cartridge. The functional elements include one or more air box components and one or more lateral transfer components.

### Feedstock Input(s) of the Primary Processing Unit

In one embodiment, the primary processing unit includes one or more feedstock inputs configured to accommodate various feedstocks having different physical characteristics, each of which feeds directly or indirectly into the primary processing unit. The feedstock input(s) may optionally be operatively associated with various feeder systems that deliver the feedstock(s) to the feedstock input(s) and thereby into the primary processing unit. When the primary processing unit comprises more than one feedstock input, each feedstock input may be operatively associated with the same feeder system, or the feedstock inputs may be operatively associated with a plurality of feeder systems, which may be the same type of feeder system or may be different types of feeder systems.

In one embodiment, the primary processing unit may be operatively associated with a rectangular feedhopper and a hydraulic assisted ram. In this embodiment, a gate may optionally be installed in the feed chute to act as a heat barrier between the primary processing unit and the feedhopper. Limit switches on the feeder control the length of the ram stroke so that the amount of material fed into the primary processing unit with each stroke can be controlled.

In another embodiment, the primary processing unit may be designed to accommodate the feeding of boxes, the form in which hospital biomedical type waste is provided for processing. A rectangular double door port will permit the boxes to be fed into the primary feed hopper where the hydraulic ram can input the feedstock into the primary processing unit.

In yet another embodiment, an auger can be operatively associated with the primary processing unit to provide a granular waste material feed. For example, an auger may be inserted hydraulically into the unit.

Other examples of feeder systems that may be operatively associated with the primary processing unit include, but are not limited to, rotary valve and top gravity feed feeder systems. In addition, liquids and gases can be fed into the primary processing unit simultaneously through their own dedicated ports.

A conditioning process for waste material in the feed system may also be utilized prior to being fed to the primary processing unit.

In one embodiment, minimisation or exclusion of uncontrolled air seepage (through waste feeder apparatus) can be accomplished by substantial compression of the feed such that the compressed feed acts as a good, consistent plug against extensive air seepage. Also guillotine seals may be provided. In embodiments in which the feed material is a vertical drop into the primary processing unit may be provided to break loose the compacted material. Accordingly, in one embodiment the primary processing unit comprises a compaction system.

### The Secondary Processing Unit & Melting Unit

The secondary processing unit of the Carbon Conversion System provides for removal of any remaining volatiles in the processed feedstock received from the primary processing unit and for the conversion of char into an off-gas. The secondary processing unit is in communication with the primary processing unit and is operatively associated with the melting unit.

In one embodiment, the secondary processing unit is contiguous with and positioned above the melting unit. In accordance with this embodiment, the inter-unit junction between the secondary processing unit and the melting unit provides a barrier that prevents solids, such as ash, from passing into the melting chamber.

In one embodiment, the secondary processing unit is oriented such that its longitudinal axis is substantially perpendicular to the longitudinal axis of the primary processing unit. For example, the primary processing unit is oriented such that it is substantially horizontal to the ground and the secondary processing unit is oriented such that it is substantially vertical to the ground. In accordance with this embodiment, the melting unit may be positioned below the secondary processing unit.

In one embodiment, the secondary processing unit is separated from the melting unit by the inter-zonal region or inter-zone that optionally comprises an impediment for restricting or limiting the movement of material between the two units and, in some embodiments, may also provide for the initial melting of the residual substantially carbon free solid material (i.e. ash) into molten slag.

The secondary processing unit also provides for the addition of heated air, and optionally process additives such as steam and/or carbon rich gas and/or carbon, to facilitate the removal of any remaining volatiles and the conversion of the carbon to off-gas. The melting unit also provides heat, for example plasma heat or equivalent, to facilitate the complete conversion of the residual inorganic materials (such as ash) into a vitrified substance or slag.

The inter-zonal region or inter-zone may further comprise additional heat transfer element for efficiently transferring heat. The molten slag material is output from the melting unit of the melting unit and passed into an optional slag cooling subsystem for cooling.

The secondary processing unit and melting unit cooperatively facilitate the production of off-gas and slag by sequentially promoting secondary processing and melting of residual substantially carbon-free solids. This is accomplished by allowing secondary processing to occur at a certain temperature range prior to exposing the residual substantially carbon-free solid to a higher temperature range. The secondary processing unit and melting unit thus minimize or eliminate the amount of carbon trapped in the melt.

In one embodiment, the carbon conversion process is accomplished by providing the appropriate level of oxygen to the solid residue comprising char and raising the temperature of the solid residue to the level required to convert carbon in the solid residue to an off-gas by exposing the solid residue to the specific environment of the secondary processing unit.

The molten slag, at a temperature of, for example, about 1200° C. to about 1800° C., may continuously be output from the melting unit and thereafter cooled to form a solid slag material. Such slag material may be intended for landfill disposal or may further be broken into aggregates for conventional uses. Alternatively, the molten slag can be poured into containers to form ingots, bricks tiles or similar construction material. The resulting slag material may also be used as a supplementary cementing material in concrete, in the production of a lightweight aggregate or mineral wool, in the manufacture of foam glass, or in the development of packaging materials.

Accordingly, the melting unit may also include or be operatively associated with a cooling unit for cooling the molten slag to its solid form. The cooling unit is provided as appropriate to afford the cooled slag product in the desired format.

### Secondary Processing Unit

The carbon conversion process is accomplished by raising the temperature of the processed feedstock comprising char to the level required to convert carbon in the processed feedstock to a off-gas by exposing the processed feedstock to the specific environment of the secondary processing unit (which may include appropriate levels of heat, air, oxygen or steam).

The secondary processing unit receives processed feedstock comprising char from the primary processing unit and is in communication with the melting unit. In one embodiment, the secondary processing unit is in communication with the melting unit via an inter-zonal region or inter-zone.

The secondary processing unit is provided with heat from an appropriate source to provide the required temperature for converting any remaining volatiles and carbon to a off-gas. The unit is also designed to ensure highly efficient exposure of the residue to the heat to minimize the amount of sensible heat that is lost via the off-gas. Therefore, the position and orientation of the heat source are additional factors to be considered in the design of the secondary processing unit.

### Secondary Processing Unit Heating System

The carbon conversion process requires heat. Heat addition can occur directly by partial oxidation of the solid residue comprising char (i.e. by the exothermic reaction of oxygen in the air inputs with carbon and volatiles present in the solid residue comprising char) or indirectly by the use of one or more heat sources known in the art.

In one embodiment, the heat required to convert the unreacted carbon in the processed feedstock is provided (at least partially) by heated air, which may be delivered to the secondary processing unit through, for example, the use of heated air inputs.

The hot air can be supplied from, for example, air boxes, air heaters or heat exchangers, all of which are known in the art.

In one embodiment, hot air is fed into the secondary processing unit by air feed and distribution system with inputs proximal to the junction with the melting unit, for example, in some embodiments proximal to the inter-zonal region or inter-zone. Appropriate air feed and distribution systems are known in the art and include air boxes from which hot air can pass through perforations in the wall of the unit or via air nozzles or spargers.

Additional or supplemental heating as may be required can be provided by one or more heating means known in the art including, but not limited to, a gas burner, circulating hot sand, an electrical heater or electrical heating elements.

In one embodiment, the additional heat source can be circulating hot sand.

In one embodiment, the additional heat source can be an electrical heater or electrical heating elements.

### Secondary Processing Unit Process Additive Inputs

Process additives may optionally be added to the secondary processing unit to facilitate efficient conversion of processed feedstock comprising char into off-gas. Steam input can be used, for example, to ensure sufficient free oxygen and hydrogen to maximize the conversion of decomposed elements of the input processed feedstock comprising char into off-gas and/or non-hazardous compounds. Air input can be used, for example, to assist in processing chemistry balancing to maximize secondary processing to a fuel gas (minimize free carbon) and to maintain the optimum processing temperatures while minimizing the cost of input heat. In addition, oxygen and/or ozone may optionally be inputted through process additive ports into the secondary processing unit.

Optionally, other additives may be used to optimize the carbon conversion process and thereby improve emissions.

Optionally, carbon-rich gas can be used as a process additive.

The secondary processing unit, therefore, can include one or more process additive inputs. These include inputs for steam injection and/or air injection and/or carbon-rich gas. The steam inputs can be located to direct steam into high temperature regions and into the off-gas mass just prior to its exit from the primary processing unit. The air inputs can be located in and around the unit to ensure full coverage of process additives into the secondary processing unit.

In one embodiment, the process additive inputs are located proximal to the inter-zonal region or inter-zone.

In one embodiment, the process additive inputs provide diffuse, low velocity input of additives.

In embodiments in which hot air is used to heat the secondary processing unit additional air/oxygen injection inputs may optionally be provided.

### Inter-Zonal Region or Inter-Zone

In one embodiment of the invention, the junction between the secondary processing unit and the melting unit is configured to provide an inter-zonal region or inter-zone. In accordance with this embodiment, the inter-zonal region or inter-zone functions to substantially spatially segregate the secondary processing unit from the melting unit and optionally provides for the initial melting of the residual solid material (e.g. ash) of secondary processing by effectively transferring heat to the residual solid material and supports the reactant material pile in the secondary processing unit. The inter-zonal region or inter-zone further provides a conduit or connection between the two units. The inter-zone optionally comprises an impediment that limits or regulates the movement of material between the secondary processing and melting units, for example, by partially or intermittently occluding the inter-zone thereby impeding excessive migration of unconverted carbon into the melt. The impediment may optionally comprise heat transfer elements.

In one embodiment, the inter-zone may be substantially contiguous with the melting unit. In another embodiment, the inter-zone may be provided by a narrowing or restriction between the two units, or within one unit. In such an embodiment, a “dome” of bridged material may maintain the secondary processing unit material bed from falling into the melting unit. Alternatively, a baffle may hold the material back from entering the melting unit.

In one embodiment, a solid plate baffle is used in the inter-zonal region of the carbon Conversion System. In accordance with this embodiment, the baffle may optionally be moveable.

In one embodiment, a baffle comprising slabs of refractory material is used in the inter-zonal region of the carbon Conversion System.

In one embodiment, the melting unit is off-set.

In embodiments of the invention in which the inter-zone comprises an impediment, the impediment is configured to limit or regulate the movement of material between the secondary processing and melting units, for example, by either partially or intermittently occluding the inter-zonal region.

The impediment is mounted within the inter-zonal region or inter-zone and can be of various shapes or designs. For example, the impediment may be a flat structure, or it may be dome shaped, pyramidal shaped, cogwheel-shaped etc. Alternatively or in addition, the impediment may comprise, for example, a grate, a plurality of spheres, a plurality of tubes, or a combination thereof. The shape and size of the impediment may in part be dictated by shape and orientation of the chamber. In one embodiment, the impediment is configured to provide one or more conduits sized to limit the flow of material between the secondary processing zone and the slag zone.

In one embodiment, the impediment comprises a series of interconnected bricks arranged to provide conduits between adjacent bricks. In another embodiment, the impediment comprises a plurality of tubes arranged to provide conduits between adjacent tubes. In accordance with this embodiment, the plurality of tubes may be oriented substantially perpendicular to the longitudinal axis of the inter-zone or may be oriented substantially horizontally to the longitudinal axis to the inter-zone.

The impediment and any necessary mounting elements must be able to effectively operate in the harsh conditions of the carbon recovery zone and in particular must be able to operate at high temperatures. Accordingly, the impediment is constructed of materials designed to withstand high temperature. Optionally, the impediment may be refractory-lined or manufactured from solid refractory.

In one embodiment, cooling such as water cooling may be provided within the impediment. In one embodiment, the impediment comprises water cooled copper with refractory lining at top and/or bottom (for example, configured as illustrated in FIGS. 127, 129, 130 and 133A).

In one embodiment, the impediment comprises a plurality of spheres, such as, for example, ceramic balls.

In the embodiment, the impediment comprises a cogwheel-shaped refractory dome.

In one embodiment, the impediment is a solid refractory dome mounted by wedge-shaped mounting bricks in the inter-zonal region. The solid refractory dome is sized such that there is a gap between the outside edge of the dome and the inner wall of the chamber. Optionally, the refractory dome further comprises a plurality of holes. The holes may be vertical oriented.

In one embodiment, an optional plurality of alumina or ceramic balls between 20 to 100 mm in diameter rest on top of the impediment to form a bed and provide for diffusion of heated air and to promote the transfer of plasma heat to the ash to initially melt the ash into slag. In this embodiment, as the ash melts it transits the inter-zonal region through the conduits provided by the impediment and into the melting unit.

In one embodiment, the impediment comprises a solid refractory brick grate. The refractory brick grate is provided with gaps between the individual bricks to allow for communication between the secondary processing unit and the melting unit via the inter-zonal region.

In one embodiment, the impediment comprises a grate structure manufactured from refractory-lined tubes mounted within a mounting ring.

In one embodiment, the impediment comprises a rotating moving grate.

Optionally, the inter-zonal region may further comprise heat transfer or diffusion elements to facilitate the transfer of heat to the ash. Heat transfer elements are known in the art and include, but are not limited to, balls, pebbles, bricks, and similar structures manufactured from an appropriate materials such as ceramic, alumina, refractory and the like.

In one embodiment, the heat transfer element comprises plurality of alumina or ceramic balls between 20 to 100 mm in diameter rest on top of the implement to form a bed and provide for diffusion of heated air and to promote the transfer of plasma heat to the ash to initial melt the ash into slag.

Optionally, the impediment may be or comprise the heat transfer element.

Optionally, the inter-zonal region or inter-zone may be equipped with a source of heat. Appropriate sources of heat include, but are not limited to, an air tuyere, an electrical heater, electrical heating elements, burners including external gas or syngas burners, and sources of plasma heat including plasma torches.

The heating source can be placed in the inter-zonal region and/or at the secondary processing unit/inter-zonal region interface and/or at the inter-zonal region/melting unit interface.

Optionally, any carbon remaining in the ash is converted to an off-gas by the application of plasma heat in inter-zonal region or inter-zone.

Accordingly, the inter-zonal region can include access ports sized to accommodate various sources of heat.

### Melting Unit

The melting process is accomplished by raising the temperature of the residual substantially carbon-free solid material (ash) to the level required to melt the remaining residue and occurs within the melting unit, within the secondary processing unit/melting unit junction, or in embodiments in which the system comprises an inter-zone, within the inter-zone, or various combinations thereof.

The heat required for the melting process is provided by one or more heat sources. This heat may be directly applied or indirectly applied via heat transfer elements. In one embodiment, the heat is provided by one or more plasma heat sources. The heat will also serve to convert any small amounts of carbon remaining in the residue after the secondary processing by the heated air inputs. In embodiments in which the primary heat source is one or more plasma heat sources, additional or supplemental heating may be provided if required by one or more heating means known in the art including, but not limited to, induction heating or joule heating.

The melting unit is provided with a heat source that meets the required temperature for heating the ash (directly or indirectly) to levels required to melt and homogenize the residual solid to provide a molten slag at a temperature sufficient to flow out. Optionally, any carbon remaining in the ash is converted to an off-gas (“melting unit gas”). The melting unit is also designed to ensure highly efficient heat transfer between the heat source(s), for example the plasma gases, and the residue or slag, to minimize the amount of sensible heat that is lost. Therefore, the type of heat source used, as well as the position and orientation of the heat source are additional factors to be considered in the design of the melting unit. Non-limiting examples of suitable melting unit designs are provided in the Figures, however, a worker skilled in the art will appreciate that other designs that meet the requirements noted above are also possible and would be encompassed by the present invention.

The melting unit is also designed to ensure that the residue residence time is sufficient to bring the residue up to an adequate temperature to fully melt and homogenize the residual inorganic materials.

Optionally, the melting unit is provided with a reservoir in which the residue accumulates while being heated by the heat source(s). In one embodiment, the melting unit comprises a reservoir, which also allows mixing of the solid and molten materials during the melting process. Sufficient residence time and adequate mixing facilitates complete melting and a desired composition for the resulting slag.

In certain embodiments, the melting unit is configured such that it is tapered towards the slag outlet and/or to have a sloped floor to facilitate escape of molten slag.

In one embodiment, the melting unit is designed for continuous output of the molten slag material. Continuous slag removal allows the conditioning process to be carried out on a continual basis, wherein the residue for melting may be continuously input and processed, without interruption. Continuous slag exhaust can be achieved using various configurations or devices known in the art. For example, the melting unit can be configured such that it presents an impediment to the egress of the molten slag from the unit, which is breached when the volume of molten slag reaches a certain level.

In one embodiment, continuous slag exhaust is achieved by using a reservoir bounded on one side by a weir that allows the slag pool to accumulate until it exceeds a certain level, at which point the molten slag runs over the weir and out of the chamber. In one embodiment, continuous slag exhaust is achieved via a temperature controlled (heated or cooled) insert in the side refractory of the unit. In this embodiment, flow of slag out of the unit is controlled and/or stopped using a stopper or plug to block the flow of the slag through the insert.

Due to the very high temperatures needed to condition the ash, and particularly to melt any metals that may be present, the wall and floor in the melting unit may optionally be lined with a refractory material that will be subjected to very severe operational demands. The selection of appropriate materials for the design of the melting unit is made according to a number of criteria, such as the operating temperature that will be achieved during typical residue conditioning processes, resistance to thermal shock, and resistance to abrasion and erosion/corrosion due to the molten slag and/or hot gases that are generated during the melting process. The porosity of the material may be considered when choosing material for the melting unit. Various appropriate materials and known in the art.

The melting unit may also include one or more ports to accommodate additional structural elements or instruments that may optionally be required. In one embodiment, the port may be a viewport that optionally includes a closed circuit television to maintain operator full visibility of aspects of the ash processing, including monitoring of the slag outlet for formation of blockages. The chamber may also include service ports to allow for entry or access into the chamber for maintenance and repair. Such ports are known in the art and can include sealable port holes of various sizes.

In one embodiment, the melting unit is configured to provide an upper curved slope and a lower section (referred to as an “igloo” section). The curved slope allows solid material to flow down into the igloo section of the melting unit. High temperatures are generated in this section by the action of the one or more heat sources (such as plasma torches) on the ash and/or slag from the secondary processing unit and slag is removed from the system. Hot gas is also generated in the igloo section, which in certain embodiments, can be used to aid in the conversion of material in the secondary processing unit. When plasma torches are utilized they may be, for example, transferred arc and/or non-transferred arc, or other high enthalpy plasma plume generating device. When a transferred arc plasma torch is employed, it may comprise an electrode within (or at the bottom) the slag pool. The electrode can be made out of various suitable materials, for example, graphite. In one embodiment, additional heat is provided to the igloo section by a burner, which can be of various suitable types known in the art (including, for example, burners that utilize solid carbon fuels, char, soot, carbon black, and the like). In one embodiment, a multi-fuel burner designed to normally operate on air/syngas is employed as a secondary heat source. Allowing a slag pool to accumulate in the bottom of the igloo section can help to homogenize the slag composition and build up a metal layer at the bottom of the pool. The slag is removed from the igloo section, for example, by pouring out the side or the bottom of the melting unit. The base of the unit can be configured to provide slag tap holes, which can be used to remove build up of metal within the pool. Molten metal can, for example, be sold to a recycler and/or refiner. In the event the bottom of the pool is not sufficiently molten due to the distance from the heat source(s), lancing or application of a burner can be employed through the tap holes to assist the metal extraction process. Alternatively, a higher than normal plasma heat can be used to speed up the metal extraction process.

In one embodiment, the melting unit is configured to provide an upper curved slope and a lower “igloo” section and further comprises a “gate” between the curved section and the igloo section to control the flow (and pressure) of the hot gases to the secondary processing unit.

Optionally, the bottom of the secondary processing unit or the inter-zonal region, when present, is configured to provide a “dome” that helps to prevent the material bed in the secondary processing unit from falling into the melting unit. Alternatively a “dome” of bridged material could be used.

Optionally, the melting unit can be water cooled to cool the refractory thereby prolonging the life of the refractory and therefore the entire vessel. The concept is that by cooling the refractory below the melting temperature of slag the inside of the vessel can become coated with a thin layer of slag. In addition if there is a crack in the refractory or some of it spalls off, the slag that enters will cool due to the lower temperature and the refractory wear is reduced or halted.

In one embodiment, the melting unit comprises water-cooled copper inserts around the outside of the unit to provide a cooling function. In accordance with this embodiment, the copper pieces are optionally cast with set pathways (such as, for example, channels or pipes) and with connectors for the water pipes to interface with. Water is pumped through the copper pieces and thermocouples within the metal (along with thermocouples in the melting unit) are used by the control software to vary the flow of water and the temperature.

Additional cooling may be provided around the slag outlet of the melting unit to regulate and/or stop the flow of slag out of the outlet. For example, the outlet may comprise copper with cooling channels for water. The flow of slag is thus controlled by the temperature of the copper piece. Alternatively, a water-cooled plunger can be inserted into the outlet.

### Heat Source of the Melting Unit

The melting unit employs one or more heating sources to convert the ash material produced by the secondary processing processes. The heat sources may be movable, fixed or a combination thereof.

In one embodiment, the heat source(s) are plasma heat source(s). In accordance with this embodiment, the plasma heat sources may comprise a variety of commercially available plasma torches that provide suitably high temperature gases for sustained periods at the point of application. In general, such plasma torches are available in sizes from about 100 kW to over 6 MW in output power. The plasma torch can employ one or a combination of suitable working gases. Examples of suitable working gases include, but are not limited to, air, argon, helium, neon, hydrogen, methane, ammonia, carbon monoxide, oxygen, nitrogen, and carbon dioxide. In one embodiment of the present invention, the plasma heating means is continuously operating so as to produce a temperature in excess of about 900° C. to about 1800° C. as required for converting the residue material to the inert slag product.

In this respect, a number of alternative plasma technologies are suitable for use in the melting unit. For example, it is understood that transferred arc and non-transferred arc torches (both AC and DC), using appropriately selected electrode materials, may be employed. It is also understood that inductively coupled plasma torches (ICP) may also be employed. Selection of an appropriate plasma heat source is within the ordinary skills of a worker in the art.

The use of transferred arc torches instead of non-transferred arc torches may improve the efficiency of the residue conditioning process due to their higher electrical to thermal efficiency, as well as the higher heat transfer efficiency between the hot plasma gases and the material being melted because the arc passes directly through the melt. Where transferred arc torches are used, it is necessary to ensure that the melting unit is electrically isolated since the melting unit outer shell will be electrically connected to the power supply.

In one embodiment, melting unit comprises transferred arc torches to improve energy (heat) transfer as the arc travels from the torch across the gas gap to the slag pool and to the electrode located at the bottom of the pool. As the electrical arc travels across the gas it creates a plume of plasma (similar to a non-transferred arc) but in addition as the arc travel across the slag pool, the pool's electrical resistance causes the arc to heat up the slag pool.

In one embodiment, the one or more heat sources comprise a transferred arc plasma torch which is positioned in the melting unit above the slag pool and is directed towards the pool/electrode. Optionally, the torch is no more than 15° from a vertical orientation. In one embodiment in which the melting unit has a rectangular configuration, the torch is mounted on top of the unit to achieve a more vertical operating position.

In one embodiment, the one or more heat sources comprise a DC non-transferred arc plasma torch.

In one embodiment, the one or more heat sources comprise a graphite plasma torch.

In one embodiment, the one or more plasma heat sources are positioned to optimize the conversion of the residue material to inert slag. The position of the plasma heat source(s) is selected according to the design of the melting unit. For example, where a single plasma heat source is employed, the plasma heat source may be mounted in the top of the unit and disposed in a position relative to the slag pool collecting at the bottom of the unit to ensure sufficient heat exposure to melt the residue material and force the slag to flow. In one embodiment, the plasma heat source is a plasma torch vertically mounted in the top of the unit.

All plasma heat sources are controllable for power and optionally (where movable heat sources are used) position. In one embodiment, the plasma heat rate is varied to accommodate varying residue input rate. The plasma heat rate can also be varied to accommodate varying residue melting temperature properties.

The plasma heat sources may be operated on a continuous or non-continuous basis at the discretion of the operator to accommodate varying residue input rate and melting temperature properties.

Optionally, the melting unit may be equipped with a deflector to deflect or direct the plasma heat.

### Process Additives of Melting Unit

Process additives may optionally be added to the melting unit to facilitate to the conversion of ash to slag and optionally melting unit gas. Examples of process additives that may be employed include, but are not limited to, steam, air, carbon and/or carbon-rich gas and/or oxygen-rich gas and/or bag ash. Accordingly, the melting unit may be equipped with various inputs and/or the melting unit may further comprise a number of ports for these inputs.

### Slag Output of Melting Unit

The melting unit comprises one or more slag outputs. A slag output includes an outlet through which molten slag is exhausted. The outlet is typically located at or near the bottom of the melting unit to facilitate the gravity flow of the molten slag pool out of the unit. A slag output may also optionally include a slag cooling subsystem to facilitate the cooling of the molten slag to its solid form as described below.

The molten slag can be extracted in a continuous manner throughout the full duration of processing. The molten slag can be cooled and collected in a variety of ways that will be apparent to a person skilled in the art to form a dense, non-leachable, solid slag. Continuous extraction embodiments are particularly suitable for systems that are designed to operate on a continuous basis.

In one embodiment, the slag output means also comprises a slag cooling subsystem for cooling the molten slag to provide a solid slag product. In one embodiment, the molten slag is poured into a quench water bath. The water bath provides an efficient system for cooling the slag and causing it to shatter into granules suitable for commercial uses, such as for the manufacture of concrete or for road building. The water bath may also provide a seal to the environment in the form of a shroud that extends from the base of the slag chamber down into the water bath, thereby providing a barrier preventing outside gases from entering the residue conditioning chamber. The solid slag product may be removed from the water bath by a conveyor system. Alternatively, the slag cooling subsystem may comprise a water spray.

In one embodiment of the slag cooling subsystem, the molten slag is dropped into a thick walled steel catch container for cooling. In one embodiment, the molten slag is received in an environmentally sealed bed of silica sand or into moulds to provide solid slag suitable for small scale processing or for testing certain parameters whenever such testing is performed. The small moulds can be control cooled in a preheated oven.

In one embodiment of the slag cooling subsystem, the molten slag is converted to a commercial product such as glass wool.

### The Reformulating Unit

The reformulating unit comprises one or more zones for reformulating gas generated within one or more of the other functional units, one or more energy sources to promote the reformulating process, optionally one or more particle separators and optionally one or more process additive inputs. In those embodiments of the invention in which the reformulating unit comprises one or more particle separators, the particle separators may form part of the reformulating zone. Syngas exiting the reformulating unit typically comprises mostly nitrogen, carbon monoxide and hydrogen, with much lower amounts of methane and other fuel gases, little if any oxygen, and very small amounts of tars and particulates.

The reformulating unit may optionally be operatively associated with a heat exchanger or recuperator. In one embodiment, the reformulating unit is operatively associated with a heat exchanger or recuperator via a conduit which forms part of the reformulating zone. The conduit can be configured such that all parts of the conduit are oriented at an angle from the horizontal to prevent build up of any residual particulate matter on the walls of the conduit.

### Particle Separators

In one embodiment, particulate matter entrained in the off-gas is removed/minimized by the use of a particle separator. In one embodiment, the off-gas from the carbon recovery zone and off-gas from the primary processing unit passes through a cyclonic separator to reduce the particulate load. In some embodiments, the cyclonic separator also promotes mixing of the off-gases from the primary processing unit and the carbon recovery zone thereby improving gas homogeneity.

Particulates within the off-gas may include carbon containing particulate matter which can optionally be processed further in the secondary processing unit/melting unit or collected for processing and/or disposal elsewhere.

The use of a particle separator for removal or reduction of particulates from the gas stream before it enters the reformulating zone can, for example, reduce interference by particulates in the reformulating step, reduce wear on the reformulating unit walls and instruments, reduce slagging of solid particles in the gas stream during reformulation, facilitate catalyst use in reformulation (when implemented), allow for higher gas flows though the primary and/or secondary processing units, and/or allow for the addition of fluxing agents into the secondary processing unit thereby promoting slag generation with lower melting point and allow for the addition of small particle size catalysts or buffer material (such as lime for the reduction of H₂S in the syngas).

Appropriate particle separators are known in the art. Non-limiting examples of cyclonic separators include, but are not limited to, single tube cyclonic separators and multitube cyclonic separators. A worker skilled in the art would appreciate the factors that should be considered when choosing an appropriate particle separator, these factors include capture efficiency, pressure drop, availability, complexity of the unit, need for redundancy and heat losses. The size and number of particle separators is determined on a per system basis and is generally a compromise between mean particle size of particulate, desired removal efficiency, pressure drop and equipment cost.

In one embodiment, to reduce the risk of uneven loading and premature wear of select individual particle separators in a bank of particle separators or multiple detached particle separators, the Carbon Conversion System is designed to ensure incoming gas is well mixed such that particulate is as evenly distributed between the cyclones as possible.

In one embodiment, a bank of cyclonic separators is employed in the Carbon Conversion System which includes a larger inlet plenum in order to homogenize the distribution of particulate within the gas before the cyclone bank to ensure even distribution of gas between each cyclone.

In some embodiments, the Carbon Conversion System comprises a plurality of cyclonic separators, for example as a bank or as multiple individual cyclonic separators. In accordance with this embodiment, the system may be configured such that each cyclonic separator can be individually turned off and/or gas flow can be diverted therefrom.

The particle separators may be internal particle separators or external particle separators. The primary considerations when deciding on internal or external particle separator(s) include cost, ease of maintenance and heat losses through the additional shell surface area.

In some embodiments in which the particle separator is external, the refractory and/or insulating material of the Carbon Conversion System is specifically adapted to reduce heat loss due to the increase in surface area. Optionally, additional safety and failsafe systems may be included in the Carbon Conversion System when external cyclonic separators are included to reduce the risk of external wall breach resulting in hot gas/air interaction.

When the Carbon Conversion System comprises a plurality of particle separators, they may be arranged in serial or parallel, or when more than two particle separators are employed, the Carbon Conversion System may comprise a combination of particle separators arranged in series and particle separators arranged in parallel.

In one embodiment, the Carbon Conversion System comprises a primary and a secondary particle separator in series which sequentially remove particulates. In one embodiment, the Carbon Conversion System comprises a primary and a secondary cyclonic separator in series. When provided in series, it is envisaged that the primary particle separator will remove larger particulates and the secondary particle separator will remove smaller particulates. In such embodiments, optionally particulates from the primary particle separator may be recycled back into the secondary processing unit/melting unit while particulates from the secondary particle separator are optionally collected separately from further processing.

In some embodiments, the Carbon Conversion System comprises two or more cyclonic separators in series.

In some embodiments, the Carbon Conversion System comprises two or more cyclonic separators in parallel.

Optionally in embodiments with primary and secondary particle separators, the primary particle separator may be internal and secondary particle separator external.

In one embodiment, the Carbon Conversion System is configured to provide combined off-gases from the primary processing unit and the secondary processing unit and the melting unit to the particle separator(s).

In one embodiment, the Carbon Conversion System is configured such that a first particle separator, or set or bank of particle separators, is operatively associated with the primary processing unit and a second particle separator, or set or bank of particle separators, is operatively associated with the secondary processing unit and melting unit, and the two off-gas steams are combined after passing though the separate particle separator(s). As the majority of problematic particulates arises in the secondary processing unit/melting unit, the individual particle separators or particle separator banks can be sized according to anticipated particulate load and characteristics of the respective off-gas streams.

In one embodiment, the Carbon Conversion System comprises multiple cyclonic separators in series (with or without also having cyclonic separators in parallel) to improve the overall particulate removal.

In one embodiment, the Carbon Conversion System is configured such that the primary processing unit and secondary processing unit/melting unit are each operatively associated with their own independent cyclonic separator(s) where raw off-gas exits each cyclonic separator to be combined in a final cyclonic separator system before the reformulating zone.

In one embodiment, the Carbon Conversion System comprises one or more pairs of cyclonic separators, each pair having a primary cyclonic separator discharging gas into a secondary cyclonic separator. In accordance with this embodiment, the off-gas passes into the primary cyclonic separator where the bulk of the entrained particulates are captured. The outlet of the primary cyclonic separator discharges into the secondary cyclonic separator carrying the most finely-sized particulates which escape capture in the primary cyclonic separator. Subsequent to capture, the particulates can optionally be transported by a combination of gravity and low velocity gas flow to the secondary processing unit/melting unit for further processing.

In one embodiment in which the cyclonic separator is external, the Carbon Conversion System is configured such that particulates from the cyclonic separator return to secondary processing unit/melting unit through a line, and the off-gas with reduced particulate load enters the reformulating zone through a separate line or conduit.

### Reformulating Zone(s)

The reformulating unit comprises a zone or zones in which the gas reformulating process takes place. The reformulating zone may be provided in the form of a chamber, a tube, a pipe or other suitably configured compartment that provides an appropriate area for application of the one or more energy sources to the off-gases in order to promote the reformulating process. The reformulating zone may be distributed over more than one compartment comprised by the reformulating unit and may in certain embodiments include the one or more particle separators. The reformulating zone receives off-gas from the primary and secondary processing units and the melting unit, energy (for example in the form of heat) from the one or more energy sources, and optionally process additives from the one or more process additive inputs. Suitable energy sources include, but are not limited to, sources of plasma, thermal heating, plasma plume, hydrogen burners, electron beam, lasers, radiation, and the like.

In some embodiments, reformulation occurs concurrently with particulate load reduction. In such embodiments, the reformulating zone includes the particle separator and an energy source, such as a plasma torch, is provided proximal to an inlet or outlet of the particle separator, or within the particle separator. The reformulating unit may optionally comprise an additional source of heat that provides heat to the off-gas entering the reformulation zone prior to contact with the one or more energy sources.

The reformulating zone is optionally specifically adapted to promote turbulence, mixing and/or swirling and may optionally include means to promote mixing and turbulence.

The reformulating zone may take on a variety of configurations, so long as appropriate mixing or turbulence occurs and a desired residence time is maintained. For example, the reformulating zone can be oriented substantially vertically, substantially horizontally or angularly and have a wide range of length-to-diameter ratios.

In one embodiment, the reformulating zone is a straight tubular or venturi shaped zone comprising a first (upstream) end and a second (downstream) end and is oriented in a substantially vertical position or a substantially horizontal position.

In one embodiment, the reformulating zone is configured to have a large length to diameter ratio. In accordance with this embodiment, the area of influence of the energy source will include a substantial part of the cross-sectional area of the reformulating zone thus maximizing the reformulating process. Torches can be placed at several locations along the path of the flow.

In one embodiment, the reformulating zone is provided as a pipe that can be incorporated into the Carbon Conversion System in various orientations.

In one embodiment, the reformulating zone is provided in a tubular shaped compartment which may optionally comprise one or more bends.

Optionally, the compartment providing the reformulating zone can include internal components, such as baffles, to promote back mixing and turbulence of the gas in the reformulating zone.

The reformulating zone may be operatively associated with a recuperator or heat exchanger. In such embodiments, the reformulating zone is configured such that the recuperator can be positioned close to the areas where hot air is needed thereby saving on insulated piping of the gas to the recuperator as well as of the hot air to the secondary processing/melting unit.

In one embodiment, the Carbon Conversion System is configured to provide a by-pass to the reformulating zone.

In one embodiment, the reformulating zone is provided in a compartment that is removable or detachable.

### Energy Sources

The reformulating unit comprises one or more energy sources for providing energy to the reformulating zone in order to promote the reformulation process.

In one embodiment, the reformulating zone includes one or more sources of plasma.

The one or more plasma sources may be chosen from a variety of types including but not limited to non-transferred and transferred arc, alternating current (AC) and direct current (DC), plasma torches, high-frequency induction plasma devices and inductively coupled plasma torches (ICP). In all arc generating systems, the arc is initiated between a cathode and an anode. Selection of an appropriate plasma source is within the skills of a worker in the art.

The transferred arc and non-transferred arc (both AC and DC) torches can employ appropriately selected electrode materials. Materials suitable for electrodes that are known in the art include copper, tungsten alloys, hafnium etc. The electrode lifetime depends on various factors such as the arc-working areas on the electrodes, which in turn depends on the design of the plasma torch and the spatial arrangement of the electrodes. Small arc-working areas generally wear out the electrodes in a shorter time period, unless the electrodes are designed to be cooled by thermionic emission. The electrodes may be spatially adjustable to reduce any variations in the gaps there between, wherein the variations are caused as the electrodes wear down during their lifetimes.

A variety of gases can be used as a carrier gas for plasma torches including but not limited to air, argon, helium, neon, hydrogen, methane, ammonia, carbon monoxide, oxygen, nitrogen, carbon dioxide, C₂H₂ and C₃H₆. The carrier gas may be neutral, reductive or oxidative and is chosen based on the requirements of the gas reformulation process and the ionization potential of the gas. Selection of an appropriate carrier gas and understanding the means of introducing the carrier gas into the plasma torch can impact its efficiency is within the ordinary skills of a worker skilled in the art. In particular, a poorly designed introduction of the carrier gas can result in a non-uniform plasma plume, with hot and cold zones.

In one embodiment, the gas reformulating system comprises one or more non-transferred, reverse polarity DC plasma torches. In one embodiment, the gas reformulating system comprises one or more water cooled, copper electrode, NTAT DC plasma torches. In one embodiment of the invention, the gas reformulating system comprises one or more AC plasma torches.

AC plasma torches may be either single-phase or multiple phase (e.g. 3-phase), with associated variations in arc stability. A 3-phase AC plasma torch may be powered directly from a conventional utility network or from a generator system. Higher phase AC systems (e.g. 6-phase) may also be used, as well as hybrid AC/DC torches or other hybrid devices using but not limited to hydrogen burners, lasers, electron beam guns, or other sources of ionized gases.

Multiple phase AC plasma torches generally have lower losses in the power supply. In addition, the rapid movement of the arc along the electrodes due to rail-gun effect can result in improved redistribution of the thermal load between the electrodes. This redistribution of the thermal load along with any cooling mechanisms for the electrodes, allows the use of materials for electrodes having a relatively low melting point but high thermal conductivity, such as copper alloys.

The plasma source may comprise a variety of commercially available plasma torches that provide suitably high flame temperatures for sustained periods at the point of application. In general, such plasma torches are available in sizes from about 100 kW to over 6 MW in output power. In one embodiment, the plasma torch is two 300 kW plasma torches each operating at the (partial) capacity required.

In one embodiment of the invention, the energy sources for the reformulating zone comprise a hydrogen burner wherein oxygen and hydrogen are reacted to form ultra-high temperature steam (>1200° C.). At these high temperatures, the steam may exist in an ionized form which enhances the gas reformulation process. Hydrogen burners may be operated in conjunction with other energy sources such as plasma torches. Activated hydrogen species include the benefit of rapid dispersion of the reactive species and extensive steam cracking, both of which lead to a high conversion of the initial gas at a lower temperature than achieved with plasma.

The hydrogen for the hydrogen burner may be obtained by electrolysis. The oxygen source may be pure oxygen or air. Other sources for hydrogen and oxygen may also be used as would be readily known to a worker skilled in the art. The design of the burner may utilize standard modeling tools e.g. tools based on computational fluid dynamics (CFD). The burner may also be adapted and sized to fit the requirements of the gas reformulating system taking into account various factors including but not limited to the quantity of gases for reformulation, chamber geometry etc.

In one embodiment of the invention, the hydrogen burner comprises a cylindrical nozzle body, with upper and lower covers coupled to its upper and lower ends respectively and defining a predetermined annular space S in the body. A gas supply pipe is connected to a sidewall of the body such that the pipe is inclined downwards therefrom. The upper cover may be integrated with the body into a single structure, and is provided with a heat transfer part having a thickness sufficient for easy dissipation of heat. A plurality of nozzle orifices, which discharge hydrogen to the atmosphere, is formed through the heat transfer part with an exposing depression formed on the upper surface thereof to communicate with each of the nozzle orifices. An airflow chamber is also defined in the body so that air passes through the chamber. A guide protrusion is formed on the inner surface of the space to guide the current of hydrogen gas to a desired direction in the space. Furthermore, the upper end of the annular space S, which communicates with the lower ends of the nozzle orifices, is configured as a dome shape, thus defining a vaulted guide to guide hydrogen gas to the orifices.

Hydrogen burners operate at a lower temperature and usually mix hydrogen with air. They may also use a oxygen-hydrogen mixture which runs at a significantly higher temperature. This higher temperature can give off more radicals and ions; it also will make the gas highly reactive with hydrocarbon vapor and methane.

In one embodiment of the invention, a hydrogen burner serves as a source of high temperature chemical radicals which can accelerate the reformulation of gaseous hydrocarbons into syngas. The hydrogen burner is operated with an oxidizing agent, with air and oxygen being two common choices. A worker skilled in the art will understand the relative proportion of hydrogen and the oxidizing agent required. In addition to generating high-temperature radicals, the hydrogen burner also generates a controllable amount of steam. Typically, hydrogen burners can be powered with efficiencies similar to a plasma torch.

Electron beam guns may also function as a source of energy for the reformulating zone. Electron Beam Guns produce electron beams with substantially precise kinetic energies either by emission mechanisms such as thermionic, photocathode and cold emission; by focusing pure electrostatic or with magnetic fields and by a number of electrodes.

Electron beam guns can be used to ionize particles by adding or removing electrons from the atom. A worker skilled in the art will readily know that such electron ionization processes have been used in mass spectrometry to ionize gaseous particles.

The designs of electron beam guns are readily known in the art. For example, a DC, electrostatic thermionic electron gun is formed of several parts including a hot cathode which is heated to create a stream of electrons via thermionic emission; electrodes which generate an electric field to focus the beam, such as a Wehnelt cylinder; and one or more anode electrodes which accelerate and further focus the electrons. For larger voltage differences between the cathode and anode, the electrons undergo higher acceleration. A repulsive ring placed between the anode and the cathode focuses the electrons onto a small spot on the anode. The small spot may be designed to be a hole, in which case the electron beam is collimated before reaching a second anode called a collector.

Ionizing radiation may also function as a source of energy for the reformulating zone. Ionizing radiation refers to highly-energetic particles or waves that can ionize an atom or molecule. The ionizing ability is a function of the energy of the individual packets (photons for electromagnetic radiation) of the radiation. Examples of ionizing radiation are energetic beta particles, neutrons, and alpha particles.

The ability of electromagnetic radiation to ionize an atom or molecules varies across the electromagnetic spectrum. X-rays and gamma rays will ionize almost any molecule or atom; far ultraviolet light will ionize many atoms and molecules; near ultraviolet and visible light will ionize very few molecules. Appropriate sources of ionizing radiation are known in the art.

The external energy needed to sustain the reformulation process may also be reduced by harnessing any heat generated by the process. The sensible heat present in the gas leaving the reformulating zone may be captured using heat exchangers, and recycled to enhance the external efficiency of the process.

Other energizing sources based on thermal energy or lasers may also be used, as would be evident to a worker skilled in the art.

Promoting Mixing and/or Turbulence in Reformulating Zone

In some embodiments, the reformulating unit further comprises means designed and configured to substantially enhance the mixing and/or turbulence of the gases provided to the reformulating zone.

In one embodiment, the reformulating unit comprises process additive inlets, the location and positioning of the nozzles of which are arranged to increase turbulence and mixing within the reformulating zone.

In one embodiment, the reformulating unit comprises one or more baffles configured to induce turbulence and thus mixing within the reformulating zone. Different baffle arrangements are known in the art and include but are not limited to cross bar baffles, bridge wall baffles, choke ring baffle arrangements and the like. Baffles may also be located at or near the initial gas inlet to ensure that the initial gas is of more uniform composition and/or temperature, and properly mixed with the process additives.

Referring to FIGS. 77A-B, turbulence may be created either prior to or after the energy sources. FIG. 78C shows three exemplary embodiments of means for creating turbulence: (i) passive grid; (ii) an active grid utilizing a rotating shaft; and (iii) a shear generator. FIGS. 79 and 80 show additional exemplary embodiments of means for generating turbulence.

In one embodiment, the positioning of the energy sources contributes to the mixing prior to or within the reformulating zone. In one embodiment, two plasma torches are positioned tangentially to create the same swirl directions as air and/or oxygen inputs do. In one embodiment of the invention, two plasma torches are positioned at diametric locations along the circumference of the reformulating zone compartment.

The arrangement of the process additive inputs is based on a variety of factors including but not limited to the design of the reformulating zone compartment, the desired flow, jet velocity, penetration and mixing. Various arrangements of the process additive ports and ports for the energy sources are contemplated herein.

For example, the oxygen inputs or ports, steam inputs or ports and ports for the energy sources may be arranged in layers around the circumference of the reformulating zone compartment, allowing for tangential and layered injection. In one embodiment, there is provided nine oxygen source(s) ports arranged in three layers around the circumference of the reformulating zone compartment. In one embodiment there is provided two steam input ports arranged in two layers around the circumference of the reformulating zone compartment and diametrically positioned. In embodiments where the air and/or oxygen input ports are arranged in layers, they may be arranged to maximize the mixing effects.

In one embodiment of the invention, the air and/or oxygen input ports are positioned tangentially, thus allowing the lower level input ports to premix the gas, torch heat it up, and start a swirl motion in the gas. The upper level air input ports can accelerate the swirl motion thereby allowing a re-circulating vortex pattern to be developed and persisted.

In accordance with one embodiment, the gas to be treated enters tangentially into the reformulating zone resulting in formation of swirls. The embodiment also shows an exemplary gas manipulator shaped and positioned to enhance the exposure of the gas stream with the energy source.

In one embodiment, the lowest level of air input ports is composed of four jets which will premix the gases entering the reformulating zone. The other upper two levels of air nozzles provide main momentum and oxygen to mix gases and heat the gases to the temperature required. The arrangements of steam inputs or ports is flexible in number, levels, orientations and angle.

The oxygen and/or steam input ports may also be positioned such that they inject oxygen and steam into the reformulating zone compartment at an angle to the interior wall of the reformulating zone compartment which promotes turbulence or a swirling of the gases. The angle is chosen to achieve enough jet penetration based on compartment diameter and designed air input port flow and velocity. The angle may vary between about 50° and 70°.

The air input ports maybe arranged so that they are in the same plane, or arranged in sequential planes. In one embodiment the air input ports are arranged in lower and upper levels. In one embodiment, there are four air input ports at the lower level and another six air input ports at upper level in which three input ports are slightly higher than the other three to create cross-jet mixing effects.

Optionally, air can be blown into the reformulating zone compartment angularly so that the air creates a rotation or cyclonic movement of the gases passing through the compartment. The gas energizing sources (e.g. plasma torches) may be angled to provide further rotation of the stream.

In one embodiment of the invention, the air and/or oxygen and/or steam inputs comprise high temperature resistance atomizing nozzles or jets. Appropriate air nozzles are known in the art and can include commercially available types such as the type A nozzles and type B nozzles illustrated in FIG. 81. The nozzles may be of a single type or different types. The type of nozzles may be chosen based on functional requirements, for example a type A nozzle is for changing the direction of air flows for creating the desired swirls and a type B nozzle is for creating high velocity of air flow to achieve certain penetrations, and maximum mixing.

The nozzles can be designed to direct the air at a desired angle. In one embodiment, the air jets are positioned tangentially. In one embodiment, angular blowing is achieved by having a deflector at the tip of the input nozzle, thus allowing the inlet pipes and flanges to be square with the chamber.

In one embodiment of the invention, one or more air jets (e.g. air swirl jets) are positioned at or near the initial gas inlet to inject a small amount of air into the initial gas and create a swirling motion in the initial gas stream by taking advantage of the injected air's velocity. The number of air swirl jets can be designed to provide substantially maximum swirl based on the designed air flow and exit velocity, so that the jet can penetrate to the center of the reformulating zone compartment.

### Optional Process Additives

The reformulating unit may optionally comprise one or more process additive ports configured to provide process additives, such as oxygen sources, carbon dioxide, other hydrocarbons or additional gases, to the reformulating zone. Oxygen sources known in the art include but are not limited to oxygen, oxygen-enriched air, air, oxidizing medium, steam and other oxygen sources as would be readily understood by a worker skilled in the art. In one embodiment, the reformulating unit comprises one or more port(s) for air and/or oxygen inputs and optionally one or more ports for steam inputs.

The optional addition of process additives such as air, steam and other gases, may also be achieved without inlets dedicated to their injection. In one embodiment of the invention, the process additives may be added into the off-gas source. Process additives may also be added to the reformulating zone through the energy sources, for example when the energy sources are plasma torches.

Optionally, ports or inlets may be provided so that syngas not meeting quality standards may be re-circulated into the reformulating zone for further processing. Such ports or inlets may be located at various angles and/or locations to promote turbulent mixing of the materials within the reformulating zone.

One or more ports can be included to allow measurements of process temperatures, pressures, gas composition and other conditions of interest.

Optionally, plugs, covers, valves and/or gates are provided to seal one or more of the ports or inlets in the reformulating unit. Appropriate plugs, covers, valves and/or gates are known in the art and can include those that are manually operated or automatic. The ports may further include appropriate seals such as sealing glands.

### Optional Catalysts

The reformulating zone may optionally include one or more catalysts. As is known in the art, a catalyst increases the rate of a chemical reaction by lessening the time needed to reach equilibrium. The use of appropriate catalysts in the reformulating zone may reduce the energy levels required for the reformulation process by providing alternate reaction pathways. The precise pathway offered by a catalyst will depend on the catalyst used. The feasibility of the use of catalysts in reformulating zones, in general, depends on their lifetimes. Lifetimes of catalysts may be shortened by ‘poisoning’, i.e., the degradation in their catalytic capabilities due to impurities in the gas.

In one embodiment of the invention, the reformulating zone comprises a catalyst which effectively lowers the energy threshold required for reformulation. The catalyst may be positioned at a location upstream or downstream of the energy source(s), or it may be in the path of the energy source(s). In one embodiment, a catalyst is included that is positioned before and/or after the energy sources.

The reformulating unit may be configured to allow for easy replacement of the catalyst(s) in the reformulating zone. For example, catalysts may be provided in the form of a bed mounted on a sliding mechanism. The sliding mechanism allows for easy removal and replacement of the catalyst bed.

The catalytic capability of the selected catalyst will also depend on the temperature of operation. The appropriate operating temperature ranges for various catalysts are known in the art. The reformulating unit may incorporate adequate cooling mechanisms to ensure that the catalysts are maintained within their optimal operating temperature ranges. Additives such as steam, water, air, oxygen or recirculated reformulated gas may be added to help increase or decrease the temperature near the catalyst(s). A worker skilled in the art will understand that the specific additive chosen to control the temperature will depend on the position of the catalyst and the gas temperatures in that region.

The irregularity of the catalyst surface and good contact between the large organic molecules and the surface will increase the opportunity for reformulation into smaller molecules, such as H₂ and CO.

Catalysts that may be used include but are not limited to olivine, calcined olivine, dolomite, nickel oxide, zinc oxide and char. The presence of oxides of iron and magnesium in olivine gives it the ability to reformulate longer hydrocarbon molecules. A worker skilled in the art will understand to choose catalysts that do not degrade quickly in the gas environment of the system.

Both nonmetallic and metallic catalysts may be used for enhancing the reformulation process. Dolomites in calcined form are the most widely used nonmetallic catalysts for reformulation of gases from biomass gasification processes. They are relatively inexpensive and are considered disposable. Catalytic efficiency is high when dolomites are operated with steam. Also, the optimal temperature range is between about 800° C. and about 900° C. The catalytic activity and the physical properties of dolomite degrade at higher temperatures.

Dolomite is a calcium magnesium ore with the general chemical formula CaMg(CO₃)₂ that contains ˜20% MgO, ˜30% CaO, and ˜45% CO₂ on a weight basis, with other minor mineral impurities. Calcination of dolomite involves decomposition of the carbonate mineral, eliminating CO₂ to form MgO—CaO. Complete dolomite calcination occurs at fairly high temperatures and is usually performed at 800° C.-900° C. The calcination temperature of dolomite, therefore, restricts the effective use of this catalyst to these relatively high temperatures.

Olivine, another naturally occurring mineral has also demonstrated catalytic activity similar to that of calcined dolomite. Olivine is typically more robust than calcined dolomite.

Other catalytic materials that may be used include but are not limited to carbonate rocks, dolomitic limestone and silicon carbide (SiC).

Char can act as a catalyst at lower temperatures. In one embodiment of the invention, the reformulating zone is operatively linked to the primary processing unit, and at least part of the char created is moved to the reformulating zone for use as a catalyst. For embodiments utilizing char as catalyst, the catalyst bed is typically placed before the energy source(s).

### Syngas Outlet

The reformulating unit comprises one or more syngas outlets or ports to pass the syngas from the reformulating zone to downstream processing or storage.

In one embodiment, the reformulating unit comprises one or more outlets for the syngas located at or near the downstream end of the reformulating zone. The outlet(s) may comprise an opening or, alternatively, may comprise a device to control the flow of the syngas out of the reformulating zone.

In one embodiment, the outlet comprises the open second (downstream) end of the reformulating zone.

In one embodiment, the outlet comprises one or more openings located in the closed second (downstream) end of the reformulating zone.

In one embodiment, the outlet comprises an opening in the wall of the reformulating zone near the second (downstream) end.

### Optional Heat Recycling Means

Heat may be recovered from the syngas and be used for various purposes, including but not limited to, heating the process additives (e.g. air, steam) for the process and/or generating electricity in combined cycle systems. The recovered electricity can be used to drive the gas reformulation process, thereby alleviating the expense of local electricity consumption.

In one embodiment of the invention, the heat recovered from the syngas is supplied to the secondary processing unit and/or melting unit. The heat exchanger may be operated in conjunction with a control system optionally configured to minimize energy consumption and maximize energy production/recovery, for enhanced efficiency.

In one embodiment of the invention, a gas-to-fluid heat exchanger is to transfer the heat from the syngas to a fluid resulting in a heated fluid and a cooled gas. The heat exchanger comprises means (e.g. conduit systems) for transfer of the syngas and fluid to and from the heat exchanger. Suitable fluids include but are not limited to air, water, oil, or another gas such as nitrogen or carbon dioxide.

The conduit systems may optionally employ one or more regulators (e.g. blowers) appropriately located to manage the flow rates of the syngas and the fluid. These conduit systems may be designed to minimize heat losses to enhance the amount of sensible heat that is recoverable from the syngas. Heat loss may be minimized, for example, through the use of insulating barriers around the conduits, comprising insulating materials as are known in the art and/or by reducing the surface area of the conduits.

In one embodiment of the invention, the gas-to-fluid heat exchanger is a gas-to-air heat exchanger, wherein the heat is transferred from the syngas to air to produce a heated air. In one embodiment of the invention, the gas-to-fluid heat exchanger is a heat recovery steam generator, wherein the heat is transferred to water to produce heated water or steam.

Different classes of heat exchangers may be used including shell and tube heat exchangers, both of straight, single-pass design and of U-tube, multiple pass design, as well as plate-type heat exchangers. The selection of appropriate heat exchangers is within the knowledge of a worker of ordinary skill in the art.

Due to the significant difference in the air input temperature and hot syngas, each tube in the gas-to-air heat exchanger optionally has individual expansion bellows to avoid tube rupture. Tube rupture may occur where a single tube becomes plugged and therefore no longer expands/contracts with the rest of the tube bundle. In those embodiments where the air pressure is greater than the syngas pressure, tube rupture presents a high hazard due to problems resulting from air entering gas mixture.

After heat is recovered in the gas-to-fluid heat exchanger, the cooled syngas may still contain too much heat for the systems further downstream. Selection of an appropriate system for further cooling of the syngas prior to conditioning is within the knowledge of a worker skilled in the art.

In one embodiment, the hot syngas passes through the gas-to-air heat exchanger to produce a partially cooled syngas and heated exchange-air. The air input to the heat exchanger may be supplied by a process air blower. The partially cooled syngas undergoes a dry quench step, where the addition of a controlled amount of atomized water results in further cooled syngas.

The cooling of the syngas may also be achieved using a wet, dry or hybrid cooling system. The wet and dry cooling systems may be direct or indirect. Appropriate cooling systems are known in the art and as such a worker skilled in the art in view of the requirements of the system would be able to select an appropriate system.

In one embodiment, the cooling system is a wet cooling system. The wet cooling system can be direct or indirect. In cooling systems that utilize indirect wet cooling, a circulating cooling water system is provided which absorbs the heat from the syngas. The heat is expelled to the atmosphere by evaporation through one or more cooling towers. Alternatively, to facilitate water conservation, the water vapor is condensed and returned to the system in closed loop.

In one embodiment, the cooling system is a dry cooling system. The dry cooling system can be direct or indirect. In one embodiment, the dry cooling system is a draft dry cooling system. Although, dry cooling will add modestly to the cost of the facility, it may be preferred in areas with a limited water supply.

In one embodiment, the syngas cooler is a radiant gas cooler. Various radiant gas coolers are known in the art and include those disclosed in US Patent Application No. 20070119577, and U.S. Pat. No. 5,233,943.

The syngas may also be cooled by direct water evaporation in an evaporator such as quencher.

The exit temperature of the syngas may also be reduced by re-circulating, through appropriately located inlets, cooled syngas to the gas reformulating unit for mixing with newly produced syngas.

### Control System

A control system may be provided to control one or more processes implemented in, and/or by, the system and/or one or more functional units disclosed herein, and/or provide control of one or more process devices contemplated herein for affecting such processes. In general, the control system may operatively control various local and/or regional processes related to a given system, function unit or component thereof, and/or related to one or more global processes implemented within a system, such as a gasification system, within or in cooperation with which the various embodiments of the invention may be operated, and thereby adjusts various control parameters thereof adapted to affect these processes for a defined result. Various sensing elements and response elements may therefore be distributed throughout the controlled system and/or one or more controlled functional units, or in relation to one or more components thereof, and used to acquire various process, reactant and/or product characteristics, and if required generate or determine one or more adjustments conducive to achieving a desired result, and respond by implementing changes in one or more of the ongoing processes via one or more controllable process devices.

In general, the control system comprises one or more computing platforms that are configured to receive one or or more signals indicative of one or more characteristics related to the operation of the overall system, or one or more of the functional units thereof. A characteristic can be indicative of one or more process implemented within the system, one or more functional units or both; one or more inputs into the system or one or more functional units or both; or one or more outputs generated by the system or one or more functional units or both. As would be readily understood, an input can be considered at an overall system level or a functional unit level. Furthermore, an output can be indicative of something, for example, a gas, solid, semisolid, liquid or other product or combination thereof, being transferred between functional units within the overall system or an output can be indicative of something that is exiting the system for example. The control system is further configured to determine one or more process control parameters, at least in part derived from the one or more input signals in conjunction with one or more control loops or control schemes. Each of the one or more control loop or control schemes provide a level of parameterization of a desired level of operation of the system or one or more of the functional units. The process control parameters which are generated by the control system, can at least in part be used to control one or more response elements which are configured to adjuste one or more aspects of operation of the system or one or more of the functional units.

In some embodiments, the control system comprises, for example, one or more sensing elements for sensing one or more characteristics related to the system, one or more functional units, process(es) implemented therein, input(s) provided therefor, and/or output(s) generated thereby. One or more computing platforms are communicatively linked to these sensing elements for accessing a characteristic value representative of the sensed characteristic(s), and configured to compare the characteristic value(s) with a predetermined range of such values defined to characterise these characteristics as suitable for selected operational and/or downstream results, and compute one or more process control parameters conducive to maintaining the characteristic value with this predetermined range. A plurality of response elements may thus be operatively linked to one or more process devices operable to affect the system and/or one or more functional units, process, input and/or output and thereby adjust the sensed characteristic, and communicatively linked to the computing platform(s) for accessing the computed process control parameter(s) and operating the process device(s) in accordance therewith.

According to some embodiments, the overall system comprises four or more functional units, wherein each of the functional units comprises one or more zones. In this embodiment, the control system is configured to capture information relating to one or more characteristics related to the overall system, and if required determine one or more modifications to the operational conditions of the overall system in order to develop the respective desired one or more zones in each of the four or more functional units. In this manner, the control system can provide for the development, creation, maintenance or adjustment of the operational conditions in order to ensure the required one or more zones are provided in each of the four or more functional units. For example, the operational conditions of the overall system together with the four or more functional units in association with the structural configurations thereof, including additive input locations for example, enable formation and/or maintenance and/or modification of the desired zones within each of the four or more functional units.

In some embodiments, each of the four or more functional units comprises an associated control subsystem, wherein these control subsystems are communicatively linked such that the individual operation of each of these control subsystems is at least in part controlled by a global control system, thereby providing a means for enabling modification of an operational characteristic in a first functional unit, based at least in part on a characteristic determined in relation to another functional unit. In this manner, the global control system can enable an alignment with desired functionality of the overall system.

In some embodiments, the control system is configured to provide real time control of the operational conditions of the entire gasification system. In some embodiments, the control system is configured to provide just in time control of the operational conditions of the entire gasification system.

In some embodiments, the control system is configured to provide a combination of just in time control and real time control of the operational conditions of the entire gasification system. For example, a configuration of the control system includes a global control system and one or more control subsystems each of which are configured for control of a portion of the entire gasification system, for example a functional unit, or a particular zone in a particular functional unit, or the like. In this example, one or more of the control subsystems can be configured to provide substantially real-time control of the respective functional unit or particular zone in a particular functional unit, and the entire control system is configured to provide just in time overall control of the entire gasification system. It will be readily understood that the configuration and operational timing of the control system can be provided in a plurality of configurations, and these configurations can be dependent on for example, the complexity of the desired control, level of desired control, acceptability ranges of the one or more processes being performed by the gasification system, the sensitivity to modifications of the one or more processes and the like.

In one embodiment, the control system provides a feedback, feedforward and/or predictive control of the system, one or more functional units, processes, inputs and/or outputs related to the conversion of carbonaceous feedstock into a gas, so to promote an efficiency of one or more processes implemented in relation thereto. For instance, various process characteristics may be evaluated and controllably adjusted to influence these processes, which may include, but are not limited to, the heating value and/or composition of the feedstock, the characteristics of the syngas (e.g. heating value, temperature, pressure, flow, composition, carbon content, etc.), the degree of variation allowed for such characteristics, and the cost of the inputs versus the value of the outputs.

In some embodiments, continuous and/or real-time adjustments to various control parameters, which may include, but are not limited to, heat source power, additive feed rate(s) (e.g. oxygen, oxidants, steam, etc.), feedstock feed rate(s) (e.g. one or more distinct and/or mixed feeds), gas and/or system pressure/flow regulators (e.g. blowers, relief and/or control valves, flares, etc.), and the like, can be executed in a manner whereby one or more process-related characteristics are assessed and modified according to design and/or downstream specifications.

In a system and/or one or more functional units utilizing pure feed-forward control, changes in the environment related to the system and/or one or more functional units in the form of a measured disturbance, results in a response that is pre-defined. In contrast, a system and/or one or more functional units utilizing feedback control enable the maintenance of a desired state of the system and/or one or more functional units. Therefore, depending on the level of accuracy of the modelling or parameterization of the operation of the system and/or one or more functional units, feedback control may not have the level of stability problems of feedforward control.

According to embodiments, feed-forward control can be timely effective when the following prerequisites are met: the disturbance must be measurable, the effect of the disturbance to the output of the system must be known and the time it takes for the disturbance to affect the output is longer than the time it takes the feed-forward control to affect the output.

Feed-forward control can respond quicker to known and measurable kinds of disturbances, however it may be an inappropriate control mechanism should novel disturbances be somewhat consistent. In contrast, feed-back control can provide a level if control of one or more deviations from desired system and/or functional unit behavior. However, feedback control requires one or more measured variables (output) from the system or one or more functional units to react to the disturbance in order to identify a deviation. Upon identification of a deviation a feedback control system can provide for a modification to one or more characteristics of the operation of the system and/or one or more functional units in order to move operation of the system and/or one or more functional units back to a desired level.

Feedforward and feedback control are not mutually exclusive. In some embodiments, the control system includes both feedforward and feedback control configurations. For example, feedforward control can be used to provide a relatively quick response adjustments necessary based on specific inputs, and an additional feedback control system can provide a means for readjustment of system operation, or error correction based on the predetermined adjustment made by the feed-forward system. According to some embodiments, the integration of both feedforward and feedback control can provide a means for a relatively quick initial response and substantantially reduction of operational error.

In some embodiments, the overall system can be controlled using feedback control and each of the one or more functional units can be controlled using feedback or feedforward control. For example, the selection of feedback or feedforward control for each of the functional units can be determined based on the level of sophistication of the modelling or parameterization of the operation of the function of the respective functional unit. The more complete the modelling, the more likely that feedforward may be applicable to a respective functional unit. In some embodiments, the operational control of one or more of the functional units is provided by both feedback and feedforward control.

In some embodiments of the invention, model predictive control techniques may be used in the system and/or one or more functional units.

In corrective, or feedback, control the value of a control parameter or control variable, monitored via an appropriate sensing element, is compared to a specified value or range. A control signal is determined based on the deviation between the two values and provided to a control element in order to reduce the deviation. It will be appreciated that a conventional feedback or responsive control system may further be adapted to comprise an adaptive and/or predictive component, wherein response to a given condition may be tailored in accordance with modeled and/or previously monitored reactions to provide a reactive response to a sensed characteristic while limiting potential overshoots in compensatory action. For instance, acquired and/or historical data provided for a given system configuration may be used cooperatively to adjust a response to a system and/or process characteristic being sensed to be within a given range from an optimal value for which previous responses have been monitored and adjusted to provide a desired result. Such adaptive and/or predictive control schemes are well known in the art, and as such, are not considered to depart from the general scope and nature of the present disclosure.

Alternatively, or in addition thereto, the control system may be configured to monitor operation of the various components of a the system and/or one or more functional units for assuring proper operation, and optionally, for ensuring that the process(es) implemented thereby are within regulatory standards, when such standards apply.

In accordance with one embodiment, the control system may further be used in monitoring and controlling the total energetic impact of the system and/or one or more functional units. For instance, the system and/or one or more functional units may be operated such that an energetic impact thereof is reduced, or again minimized, for example, by optimising one or more of the processes implemented thereby, or again by increasing the recuperation of energy (e.g. waste heat) generated by these processes. Alternatively, or in addition thereto, the control system may be configured to adjust a composition and/or other characteristics (e.g. temperature, pressure, flow, etc.) of a syngas generated via the controlled process(es) such that such characteristics are not only suitable for downstream use, but also substantially optimized for efficient and/or optimal use. For example, in an embodiment where the syngas is used for driving a gas engine of a given type for the production of electricity, the characteristics of the syngas may be adjusted such that these characteristics are best matched to optimal input characteristics for such engines.

In one embodiment, the control system may be configured to adjust a given process such that limitations or performance guidelines with regards to reactant and/or product residence times in various components, or with respect to various processes of the overall process are met and/or optimized for. For example, an upstream process rate may be controlled so to substantially match one or more subsequent downstream processes.

In addition, the control system may, in various embodiments, be adapted for the sequential and/or simultaneous control of various aspects of a given process in a continuous and/or real time manner.

According to embodiments, the control system comprises one or more control loops enabling the determination of one or more adjustments to be made to the operational of the system and/or one or more functional units, in order to achieve one or a combination of desired results. A control loop can be representative of the overall functionality of the system, the overall functionality of a functional unit, the functionality of a subcomponent of a functional unit, a combination thereof or a subcomponent thereof.

In some embodiments, the control system includes a plurality of control loops, wherein each of the control loops is associated with a desired level of functionality of the system, one or more functional units or subcomponents thereof. Each of the plurality of control loops can be assigned a level of hierarchy in order to enable the control system to determine which control loop is to either be considered or evaluated first or even considered to be the most important to meet the requirements thereof. This level of hierarchy of the plurality of control loops can thereby provide a means for enabling the control system to determine which of the plurality of control loops to attempt to satisfy, should there be conflicting outcomes of one or more processes of the system and/or functional units associated with two or more of the plurality of control loops.

According to some embodiments of the present technology, the control loops can be configured as a plurality of nested control loops, wherein each control loop of a particular nest of control loops can be assigned a weighting factor, for example a higher weighting factor can represent a higher importance for meeting the parameterization associated with that particular control loop. In addition for example, a weighting function for a particular control loop can dependent on one or more conditions associated with the system and/or functional units, wherein this dependency can result in a modification or adjustment of the importance level of the control loop, thereby resulting in an adjustment of the hierarchy of the control loops.

In general, the control system may comprise any type of control system architecture suitable for the application at hand. For example, the control system may comprise a substantially centralized control system, a distributed control system, or a combination thereof. A centralized control system will generally comprise a central controller configured to communicate with various local and/or remote sensing devices and response elements configured to respectively sense various characteristics relevant to the controlled process, and respond thereto via one or more controllable process devices adapted to directly or indirectly affect the controlled process. Using a centralized architecture, most computations are implemented centrally via a centralized processor or processors, such that most of the necessary hardware and/or software for implementing control of the process is located in a same location.

A distributed control system will generally comprise two or more distributed controllers which may each communicate with respective sensing and response elements for monitoring local and/or regional characteristics, and respond thereto via local and/or regional process devices configured to affect a local process or sub-process. Communication may also take place between distributed controllers via various network configurations, wherein a characteristic sensed via a first controller may be communicated to a second controller for response thereat, wherein such distal response may have an impact on the characteristic sensed at the first location. For example, a characteristic of a downstream syngas may be sensed by a downstream monitoring device, and adjusted by adjusting a control parameter associated with the drying/volatilization unit that is controlled by an upstream controller. In a distributed architecture, control hardware and/or software is also distributed between controllers, wherein a same but modularly configured control scheme may be implemented on each controller, or various cooperative modular control schemes may be implemented on respective controllers.

Alternatively, the control system may be subdivided into separate yet communicatively linked local, regional and/or global control subsystems. Such an architecture could allow a given process, or series of interrelated processes to take place and be controlled locally with minimal interaction with other local control subsystems. A global master control system could then communicate with each respective local control subsystem to direct necessary adjustments to local processes for a global result.

According to embodiments, a local control system is associated with each of the functional units and configured to control, in response to inputs from within the functional unit and/or from outside the functional unit, the processes being performed in the same functional unit. A global control system is operatively coupled to each of the functional unit controllers, thereby providing a means for providing a level of overall management of system operation.

The control system of the present invention may use any of the above architectures, or any other architecture commonly known in the art, which are considered to be within the general scope and nature of the present disclosure. For instance, processes controlled and implemented within the context of the present invention may be controlled in a dedicated local environment, with optional external communication to any central and/or remote control system used for related upstream or downstream processes, when applicable. Alternatively, the control system may comprise a sub-component of a regional and/or global control system designed to cooperatively control a regional and/or global process. For instance, a modular control system may be designed such that control modules interactively control various sub-components of a system, while providing for inter-modular communications as needed for regional and/or global control.

The control system generally comprises one or more central, networked and/or distributed processors, one or more inputs for receiving current sensed characteristics from the various sensing elements, and one or more outputs for communicating new or updated control parameters to the various response elements. The one or more computing platforms of the control system may also comprise one or more local and/or remote computer readable media (e.g. ROM, RAM, removable media, local and/or network access media, etc.) for storing therein various predetermined and/or readjusted control parameters, set or preferred system and process characteristic operating ranges, system monitoring and control software, operational data, and the like. Optionally, the computing platforms may also have access, either directly or via various data storage devices, to process simulation data and/or system parameter optimization and modeling means. Also, the computing platforms may be equipped with one or more optional graphical user interfaces and input peripherals for providing managerial access to the control system (system upgrades, maintenance, modification, adaptation to new system modules and/or equipment, etc.), as well as various optional output peripherals for communicating data and information with external sources (e.g. modem, network connection, printer, etc.).

The processing system and any one of the sub-processing systems can comprise exclusively hardware or any combination of hardware, firmware and software. Any of the sub-processing systems can comprise any combination of one or more proportional (P), integral (I) or differential (D) controllers, for example, a P-controller, an I-controller, a PI-controller, a PD controller, a PID controller etc. It will be apparent to a person skilled in the art that the ideal choice of combinations of P, I, and D controllers depends on the dynamics and delay time of the part of the reaction process of the gasification system and the range of operating conditions that the combination is intended to control, and the dynamics and delay time of the combination controller. It will be apparent to a person skilled in the art that these combinations can be implemented in an analog hardwired form which can continuously monitor, via sensing elements, the value of a characteristic and compare it with a specified value to influence a respective control element to make an adequate adjustment, via response elements, to reduce the difference between the observed and the specified value. It will further be apparent to a person skilled in the art that the combinations can be implemented in a mixed digital hardware software environment. Relevant effects of the additionally discretionary sampling, data acquisition, and digital processing are well known to a person skilled in the art. P, I, D combination control can be implemented in feed forward and feedback control schemes.

### Control Elements

Sensing elements contemplated within the present context, as defined and described above, can include, but are not limited to, elements that monitor gas chemical composition, flow rate and temperature of the syngas, monitor temperature, monitor the pressure, monitor opacity of the gas and various parameters relating to the energy source (for example, power and position).

According to embodiments, a resulting H₂:CO ratio in syngas is dependant on various factors not limited to the operating scenario (pyrolytic or with adequate O₂/Air), on the processing temperature, the moisture content and the H₂:CO ratio of the initial gas. Gasification technologies generally yield a syngas whose H₂:CO ratio varies from as high as about 6:1 to as low as about 1:1 with the downstream application dictating the optimal H₂:CO ratio. In one embodiment, the resulting H₂:CO ratio ranges from about 1.1 and about 1.2. In one embodiment, the resulting H₂:CO ratio is 1.1:1.

Taking into account one or more of the above factors, according to embodiments, the control system regulates the composition of the syngas over a range of possible H₂:CO ratios by adjusting the balance between applied gas energizing field (e.g. plasma torch heat), process additives (e.g. air, oxygen, carbon, steam) thereby allowing syngas composition to be optimized for a specific downstream application.

In some embodiments, a number of operational parameters may be regularly or continuously monitored to determine whether the Gas Reformulating System is operating within the optimal set point. The parameters being monitored may include, but are not limited to, the chemical composition, flow rate and temperature of the syngas, the temperature at various points within the system, the pressure of the system, and various parameters relating to the gas energizing sources (e.g. power and position of plasma torches) and the data are used to determine if there needs to be an adjustment to the system parameters.

### The Composition and Opacity of the Syngas

The syngas can be sampled and analyzed using methods well known to the skilled technician. One method that can be used to determine the chemical composition of the syngas is through gas chromatography (GC) analysis. Sample points for these analyses can be located throughout the system. In one embodiment, the gas composition is measured using a Fourier Transform Infrared (FTIR) Analyser, which measures the infrared spectrum of the gas.

According to embodiments, the control system can be configured to determine whether too much or too little oxygen is present in the syngas stream and adjusting the process accordingly. In one embodiment, an analyzer or sensor in the carbon monoxide stream detects the presence and concentration of carbon dioxide or other suitable reference oxygen rich material. In one embodiment, oxygen is measured directly.

In one embodiment of the invention, a thermogravimetric analyzer (TGA) may be used.

In one embodiment, the sensors analyze the composition of the syngas for carbon monoxide, hydrogen, hydrocarbons and carbon dioxide. Based on the data analyzed, a controller sends a signal to the oxygen and/or steam inlets to control the amount of oxygen and/or steam injected into the chamber and/or a signal to the gas energizing source(s).

In one embodiment, one or more optional opacity monitors are installed within the system to provide real-time feedback of opacity, thereby providing an optional mechanism for automation of process additive input rates, primarily steam, to maintain the level of particulate matter below the maximum allowable concentration.

### The Temperature at Various Locations in System

In an embodiment, there is provided means to monitor the temperature of the syngas and the temperature at sites located throughout the system, wherein such data are acquired on a continuous basis. Means for monitoring the temperature in the chamber, for example, may be located on the outside wall of the chamber, or inside the refractory at the top, middle and bottom of the chamber. Additionally, sensors for monitoring the exit temperature of the syngas are provided.

In an embodiment, the means for monitoring the temperature is provided by thermocouples installed at locations in the system as required.

### The Pressure of System

In one embodiment, there is provided means to monitor the pressure within the chamber, wherein such data are acquired on a continuous, real time basis. In a further embodiment, these pressure monitoring means comprise pressure sensors such as pressure transducers or pressure taps located anywhere on the drying/volatilization unit, for example on a vertical wall of the drying/volatilization unit.

### The Rate of Gas Flow

In an embodiment, there is provided means to monitor the flow rate of syngas at sites located throughout the system, wherein such data are acquired on a continuous basis.

Fluctuations in the gas flow may be the result of non-homogeneous conditions (e.g. torch malfunction or out for electrode change or other support equipment malfunction). As a temporary measure fluctuations in gas flow may be corrected by feedback control of blower speed, feed rates of material, secondary feedstock, air, steam, and torch power. If fluctuations in gas flow persist, the system may be shut down until the problem is solved.

### Addition of Process Additives

In an embodiment, the control system comprises response elements to adjust the reactants, including any process additives, to manage the chemical reformulating of initial gas to syngas. For example, process additives may be fed into the chamber to facilitate the efficient reformulating of an initial gas of a certain chemical composition into a syngas of a different desired chemical composition.

In one embodiment, if the sensors detect excess carbon dioxide in the syngas, the steam and/or oxygen injection is decreased.

Response elements contemplated within the present context, as defined and described above, can include, but are not limited to, various control elements operatively coupled to process-related devices configured to affect a given process by adjustment of a given control parameter related thereto. For instance, process devices operable within the present context via one or more response elements, may include, but are not limited to elements that regulate oxygen source(s) inputs and the gas energizing source(s).

Adjusting Gas Energizing Field (e.g. Power to a Torch)

The gas energizing field may be altered. In one embodiment, the plasma torch heat is controlled to drive the reaction. Addition of air into the chamber also bears part of the torch heat load by releasing torch heat energy with combustion of syngas. The flow rate of process air is adjusted to keep torch power in a suitable operating range.

In one embodiment, the plasma torch power is adjusted to stabilize the syngas exit temperatures at the design set point. In one embodiment, the design set point is above 1000° C. to promote full decomposition of the tars and soot in the gas.

Adjusting Pressure within the System

In one embodiment, the control system comprises a response element for controlling the internal pressure of the chamber. In one embodiment, the internal pressure is maintained at a negative pressure, i.e., a pressure slightly below atmospheric pressure. For example, the pressure of the chamber may be maintained at about 1-3 mbar vacuum. In one embodiment, the pressure of the system is maintained at a positive pressure.

An exemplary embodiment of such means for controlling the internal pressure is provided by an induction blower in gaseous communication with the Gas Reformulating System. The induction blower thus employed maintains the system at a negative pressure. In systems in which positive pressure is maintained the blower is commanded to operate at lower RPM than the negative pressure case or a compressor may be used.

According to embodiments, in response to data acquired by pressure sensors located throughout the system, the speed of the induction blower will be adjusted according to whether the pressure in the system is increasing (whereby the fan will increase in speed) or decreasing (whereby the fan will decrease in speed).

According to embodiments, the system may be maintained under slight negative pressure relative to atmospheric pressure to prevent gases being expelled into the environment.

According to embodiments, pressure can be stabilized by adjusting the syngas blower's speed. Optionally, at speeds below the blower's minimum operating frequency, a secondary control overrides and adjusts the recirculation valve instead. Once the recirculation valve returns to fully closed, the primary control re-engages.

### Example Control Concepts

According to embodiments, the plurality of control loops can be configured such that they represent one or more control variables selected from the group comprising: syngas LHV flux (MJ/hr), Lower Heating Value—LHV (MJ/m3), Syngas flow (m3/hr), Feed rate (kg/hr) which may be considered if a specified throughput is desired, Syngas composition (CO:CO2 ratio, CH4, H2) and Slag Flow (kg/hr). Furthermore, the plurality of control loops can be configured such that they represent one or more manipulated variables selected from the group comprising: Ram cycle time (seconds), ram travel speed, Process Air Flow which can include one or more of CRV air (m3/hr) and Bottom grate air zones (m3/hr) and refining chamber air (m3/hr), Air blower discharge pressure (mBar), Refining Chamber Torch power (kWeletrical), Solid Residue Melter torch power (kWelectrical), Solid Residue Melter burner power (kWthermal). In some embodiments, an optimal ram motion sequence is selected via testing, and is not adjusted by the control system. In addition, the plurality of control loops can be configured such that they represent one or more constraints selected from the group comprising: Air box temperatures (° C.), Converter gas phase temperatures (° C.), Refining chamber gas temperatures (° C.), System pressure drop (syngas blower motor current, vessel design pressures), Air flow control valve (FCVs) position (%), (CRV, bottom grate air zones & refining chamber), Melt Chamber Temperature (° C.), Primary Converter Level (cm), CRV Upper Chamber Level (cm) and Solid Residue Melter Level (cm).

According to some embodiments, the ultimate goal for the facility is to maximize electricity production, which can be achieved by ensuring that the flux of energy to the each engine to which the syngas is supplied, is sufficient to keep each engine operating at full load. Syngas energy flux is the syngas flow multiplied by the syngas heating value. Improving conversion efficiency and/or increasing throughput will enable the flux to be substantially maximized, thereby ensuring that the engines remain at full load.

According to embodiments, there are two main methods to increase syngas flow; increasing air flows, and/or increasing feed rate. Increasing air flows beyond a certain optimum can begin to reduce the heating value; thereby negatively impacting the overall LHV flux. Therefore, there is an optimum air flow to achieve both high flow and high LHV. The control system can be configured to evaluate LHV and syngas flow, and manipulate the system and/or one or more functional units associated air flows to optimize.

In some embodiments, if conversion is poor due to reduced in-feed energy quality, extra in-feed moisture, varying ambient conditions (shell losses from wind/air), the control system can be configured to adjust feed rates to ensure the engines are always fully loaded. When feed rate is adjusted, the control system can be further configured to adjust air flows to keep the conversion (thereby the LHV flux) optimized. In addition, feed rate can be adjusted by manipulating the ram cycle time or ram travel speed, which will displace more material through the system thereby increasing throughput and syngas generation.

According to embodiment, there are constraints that limit the ability to adjust some of the manipulated variables. For example, the bottom grate can have thermocouples installed in each cartridge, wherein the information captured from these thermocouples can be used to serve as an indication of level of reaction throughout the various stages of the grate, and additionally notify or identify any potential hot spots or locations of potential over conversion. A primary purpose of these thermocouples is to protect against exceeding bottom grate design temperatures, however they are also be used by the control system to identify potential degrees of conversion.

According to embodiments, the gas phase temperatures, located above the bottom grate and the pile of converting material can be used to indicate localized hot spots from combustion. Both the air box temperatures and the gas phase temperatures are used by the control system to modulate air flow rates to each of the bottom grate air zones, which can impact the degree of conversion; thereby substantially directly impacting the syngas flux.

According to embodiments, there are temperature measurements being made throughout the refining chamber, wherein these measurements can be used to adjust air flow rates. According to embodiments, these temperature measurements can only be used for adjusting low rates in the refining chamber air flow. The response to refining air flow rates is seen on temperatures however they can also be used to control syngas flow and LHV. In some embodiments, the refining chamber temperatures can be used to protect against exceeding refractory design temperatures, however they may also be used by the control system to modulate refining air flow rates.

According to embodiments, the refining chamber temperatures are determined at locations downstream of the torches, and this information can be used by the control system to modulate the torch power. Syngas temperature control at that point is an optimization between refining air flow and torch power. According to embodiments, a goal of the control system as it relates to torch power is to minimize power consumption while optimizing conversion and tar destruction. Therefore, syngas composition (CO:CO2 ratio, CH4, H2) models and temperature models are also used by the control system to substantially optimize the torch power.

According to embodiments, another limitation to the air flow rates and the feed rate (for example ram cycle time or travel speed) is related to vessel pressure drops. For example, as syngas flow generation is increased, pressure drops throughout the process also increase. If these pressure drops get too high, vessels could reach their pressure or vacuum design ratings, or the syngas blower, which is a main mover for the syngas, can exceed its design capacity and reach high current on its motor, or its top speed. Accordingly, in some embodiments, these pressure drop constraints can limit the increase in feedrate and air flowrates.

According to some embodiments, there is an electrical parasitic power optimization control that runs independently of the syngas flux optimization controller. This parasitic power optimization controller can be configured to reduce the process air blower discharge pressure as low as possible to minimize the air blower horse power—thereby reducing plant power parasitic. According to embodiments, there are constraints on how low the air blower discharge pressure can be lowered, wherein these constraints can include the air flow control valve positions, for example located at bottom grate, refining chamber, CRV. According to embodiments, air FCVs (flow control valves) are typically maintained a set valve opening that allows for a desired level of flow control.

According to embodiments, a main control loop in the CRV is the bed height level control. Bed height is maintained by manipulating CRV process air flow and SRM burner firing rate. As more material accumulates in the CRV, air flow rates are typically increased to convert it. According to embodiments, the burner firing rate is a secondary control knob used to control bed height as it provides heat flux from the lower SRM and aids in heating/converting the lower portion of the CRV bed height.

According to embodiments, response to air flow rate and burner firing rate adjustments are monitored by a syngas analyzer. For example, a goal is to optimize syngas flux which is indicative of syngas flow time syngas heating value. For example, although the pile height level control may call for more air flow, if too much air is added, the LHV or other syngas parameters (CO:CO₂ ratio, carbon rate, H₂, CH₄) may go past a optimum or desired level. In such a case, air cannot always be cut back since pile height must be maintained, however in this instance feed rate can be cut back, in order to compensate.

### Optional Further Processing

The syngas stream may undergo further processing before being utilized in a downstream application, stored or flared off. For example, the reformulated gas may cooled, conditioned, and/or held in a holding tank.

Typically, syngas exits the reformulation unit at a high temperature, for example, a temperature of approximately 1050° C. In one embodiment, the syngas is cooled prior to any further processing.

In one embodiment, the syngas is conditioned to remove additional impurities. For example, the syngas can be passed through a gas conditioning system in which the syngas is treated to remove remaining particulate matter, acid gases (HCl, H₂S) and/or heavy metals. Examples of suitable treatments include, for example, venturi scrubbers, HCl scrubbers to remove acid gases, H₂S scrubbers to remove hydrogen sulfide, electro-filters and fabric baghouse filters for final removal of particulates, and a carbon beds for removal of any remaining tars and heavy metals.

The syngas may also be passed through a homogenization chamber, the residence time and shape of which is designed to encourage mixing of the reformulated gas to attenuate fluctuations in the characteristics thereof.

### Structure of the Carbon Conversion System Units

Typically, the Carbon Conversion System comprises one or more compartments each comprising one or more of the functional units of the system. For example, the four functional units comprised by the Carbon Conversion System may be provided as discrete interconnected compartments or two or more of the units may be provided as a single compartment. When more than one unit is provided in a single compartment, the compartment may comprise discrete sections or may be substantially uniform in structure. In certain embodiments, these compartments may be referred to as “chambers.” The various compartments are designed to provide a sealed, insulated space for processing of feedstock into syngas and to allow for the passage of syngas to downstream process such as cooling or refining or other and for processing of ash into slag. The design of the compartments reflects the specific requirements of the processes taking place in the units. The design may optionally provide for access to the interior of the Carbon Conversion System for inspection, maintenance and repair. The compartment(s) may optionally be flanged to facilitate the replacement of the individual units or zones.

For use in the Carbon Conversion System, the compartments may be refractory-lined and may be manufactured with multiple layers of materials as are appropriate. For example, the outer layer, or shell, is typically steel. Moreover, it may be beneficial to provide one or more insulating layers between the inner refractory layer and the outer steel shell to reduce the temperature of the steel casing. An insulating board around the outer surface may also be provided to reduce the temperature of the steel casing. Optionally, a ceramic blanket may be used as an insulator. When room for expansion of the refractory without cracking is required, a compressible material, such as a ceramic blanket, can be used against the steel shell. The insulating materials are selected to provide a shell temperature high enough to avoid acid gas condensation if such an issue is relevant, but not so high as to compromise the integrity of the outer shell.

The refractory protects the compartment from high temperatures and corrosive gases and minimizes unnecessary loss of heat. The refractory material can be a conventional refractory material well-known to those skilled in the art and which is suitable for use for a high temperature e.g., a temperature of about 1100° C. to 1800° C.), un-pressurized reaction. When choosing a refractory system factors to be considered include internal temperature, abrasion; erosion and corrosion; desired heat conservation/limitation of temperature of the external vessel; desired life of the refractory. Examples of appropriate refractory material include high temperature fired ceramics, i.e., aluminum oxide, aluminum nitride, aluminum silicate boron nitride, zirconium phosphate, glass ceramics and high alumina brick containing principally, silica, alumina, chromia and titanic. To provide further protection from corrosive gases the compartment can optionally be partially or fully lined with a protective membrane. Such membranes are known in the art and, as such, a worker skilled in the art would readily be able to identify appropriate membranes based on the requirements of the system and, for example, include Sauereisen High Temperature Membrane No 49.

In one embodiment, the refractory employed in the Carbon Conversion System is a multilayer design with a high density layer on the inside to resist the high temperature, abrasion, erosion and corrosion. Outside the high density material is a lower density material with lower resistance properties but higher insulation factor. Optionally, outside this layer is a very low density foam board material with very high insulation factor and can be used because it will not be exposed to abrasion of erosion. Appropriate materials for use in a multilayer refractory are well known in the art.

In one embodiment, the multilayer refractory comprises an internally oriented chromia layer; a middle alumina layer and an outer insulboard layer.

Optionally, the refractory in the individual zones and regions may be specifically adapted for the environment within that particular area of the compartment. For example, the melting unit may have a thicker refractory where the working temperature is higher. In addition, the refractory of the melting unit may be adapted to withstand higher temperatures and be designed to limit slag penetration into the refractory thereby reduce corrosion of the refractory.

The wall of the compartment can optionally incorporate supports for the refractory lining or refractory anchors. Appropriate refractory supports and anchors are known in the art.

Due to the severe operating conditions, it is anticipated that the refractory may require periodic maintenance. Accordingly, in one embodiment, flanged chambers are utilized in the Carbon Conversion System. In one embodiment, the chamber is suspended from a support structure such that the lower portion can be dropped away from the upper portion to facilitate maintenance. This embodiment provides for removing the lower portion without disturbing any connections between the chamber upper portion and upstream or downstream components of the system.

To gain a better understanding of the invention described herein, the following examples are set forth. It will be understood that these examples are intended to describe illustrative embodiments of the invention and are not intended to limit the scope of the invention in any way.

### EXAMPLES

### Example 1

Referring to FIGS. 110A to G, in one embodiment, the Conversion System comprises a horizontally-oriented primary processing unit (4000) with moving grate (4002), a combined vertically oriented secondary processing (4201) and melting unit (4250) with inter-zonal region and plasma torch (4301), and gas reformulating unit with cyclonic separator (4400), refining chamber (4302) and two plasma torches (4301).

### Horizontally-Oriented Primary Processing Unit

The horizontally-oriented primary processing unit is refractory-lined and has a feedstock input with hydraulic pump and airlock, various service and access ports are also provided. Referring to FIGS. 117 to 120, the horizontally-oriented primary processing unit has a stepped floor with a plurality of floor levels. Each floor level is sloped to facilitate movement of reactant material through the unit without tumbling of unprocessed feedstock. Individual floor levels correspond to a combined lateral transfer and air input cartridge such that a plurality of these cartridge (2000) form the moving grate.

The side walls of the primary processing unit are provided with opening for the insertion of the individual cartridges. Adjacent cartridges are inserted from opposite sides of the unit. When installed, individual cartridges are covered, in part, by the cartridge above it, such that only a portion of an individual cartridge is exposed to the interior of the unit.

Referring to FIGS. 90 to 96, a series of individual cartridges in situ forms a moving grate (4002). An individual cartridge (2000) comprises both support/connection elements and functional elements. The support/connection elements include the cartridge framework (2010) and connection plate (2005) specifically configured for sealing connection to the shell of the primary processing unit. Refractory (not shown) is provided between the cartridge structure and connection plate (2005) to reduce heat loss and heat transfer to the connection plate. Once inserted, the cartridges are secured using appropriate fasteners. The cartridge includes alignment guides (2015) to facilitate the correct insertion of the cartridge into the chamber wall and installation notches (2020) to allow for the insertion of tools to facilitate the insertion and removal of the cartridge from the primary processing unit.

The functional elements of the cartridge include air box components and lateral transfer components. The air box of the cartridge is a composite of multiple smaller air boxes (2025) constructed from thick carbon steel.

Air enters the primary processing unit at the bottom of the pile of reactant material through air holes (2030) or perforations in the top of each air box (2025). The air is supplied to the individual air boxes via a single air manifold (2035) connected to an air pipe (2040) which connects to a hot air hook up flange (2045) in the connection plate. The connection plate further includes inputs for thermocouples (2046).

The lateral transfer components of the cartridge include a multiple-finger carrier ram (2050), engagement elements and drive system. Individual ram fingers (2051) are attached to a ram body (2055) via pins or shoulder bolts (2060), which do not tighten on the individual finger. The ram body is connected to a drive engagement plate (2065) that includes two parallel racks (2070).

The individual ram fingers (2051) comprise a groove configured to engage a T-shaped (2075) or half T-shaped engagement elements (2078) located between individual air boxes and the outside air boxes and the cartridge framework respectively. The engagement elements which hold the rams in proximity to the surface of the air box such that the rams scrape the air box surface during back and forth movement thereby avoiding clinker build up.

Power for moving the multiple-finger ram is provided by a hydraulic piston (2080). Briefly, in the illustrated embodiment, power to propel the ram is supplied by a hydraulic piston (2080) which drives two pinions (2085) on a shaft (2086) via a rotary actuator (2090) selectably in the forward or reverse direction allowing for extension and retraction of the rams at a controlled rate. Position sensors transmit ram position information to the control system. Two pinions (2085) engage parallel racks (2070) on the drive engagement plate (2065).

Combined Vertically Oriented Secondary Processing and Melting Unit

Referring to FIG. 114, the combined vertically oriented secondary process and melting unit is a vertical extension of the primary processing unit and receives processed feedstock directly there from. The combined vertically oriented secondary processing and melting unit is segregated by an inter-zonal or inter-unit region into an upper secondary processing unit and lower melting unit. The secondary processing unit is maintained at a temperature of about 950° C. to about 1100° C. and the melting unit is maintained at a temperature of about 1350° C. to about 1600° C.

The combined vertically oriented conversion and melting unit comprises a refractory-lined vertically-oriented chamber with a slag outlet, and heating system comprising air boxes and plasma torch.

Referring to FIG. 114, heated air is introduced into the secondary processing unit via eight air boxes (4402) located proximal to the downstream end of this unit. The air feed to the air box is controllable allowing for regulation of the conversion process. The air flow rate is controlled by the feed/air ratio and operating temperature change. Optionally, steam may be injected into the secondary processing unit via the steam injection ports.

Referring to FIGS. 114 and 129, the secondary processing unit tapers to the narrowed inter-zonal or inter-unit region. The inter-zonal region or inter-unit comprises a physical impediment to support the reactant pile in the secondary processing unit and guide the flow of material from the secondary processing unit to the melting unit. Referring to FIGS. 129 and 130, six copper water-cooled pieces form the core of the impediment. The copper inserts (5015) are provided with grooves (5020) to hold casted refractory cover. Refractory coating is further provided on any exposed sides and bottom to make up the complete dome. The impediment is mounted in the inter-zonal region and comprises a plurality of holes thereby providing a plurality of conduits for transfer of material and gases between secondary processing unit and the melting unit.

A plurality of alumina or ceramic balls, between 20 to 100 mm in diameter, rest on top of the refractory structure to form a bed. These alumina or ceramic balls provide for diffusion of heated air and promote the transfer of heat to the ash to initially melt the ash into slag in the inter-zonal or inter-unit region.

Referring to FIGS. 128 and 129, located downstream of the inter-zonal region is the melting unit. The melting unit is a refractory-lined structure having a tap hole. The melting unit is flanged into at two sections (upper Melter and lower Melter) to facilitate replacement of lower/tap-hole section. The melting unit further comprises a transferred arc plasma torch, a main process burner, optional secondary burner(s) in weir overflow, lancing ports, view ports, and instrumentation.

The plasma torch and a propane-fired burner provide the hot gases which melt material above the impediment into slag. Slag collects at the bottom of the melting unit and is removed via a tap hole. If the tap hole becomes sealed with cool slag, the tap hole is re-opened using an oxygen lance. A slag granulation and cooling system is operatively associated with the tap hole.

The melting unit has water-cooled copper inserts around the outside to cool the refractory thereby prolonging the life of the refractory and therefore the entire vessel. The copper pieces are casted with set pathways (channels, pipe) and with connectors for the water pipes to interface with. Water is pumped through the copper pieces and thermocouples within the metal (along with thermocouples in the melting unit) are used by the control system to vary the flow of water and the temperature.

Additional cooling is provided around the slag pour, whereby the exit of the slag tap-hole is made of copper with cooling channels for the water and the flow of slag is controlled by the temperature of the copper piece. A water-cooled conical plunger which is inserted into tap-hole is used to regulate and stop the rate of slag pouring.

### The Gas Reformulating Unit:

Referring to FIGS. 114 to 116, the gas reformulating unit is connected to the primary processing unit and receives gas from both the primary processing unit and the combined secondary processing and melting unit. The gas reformulating unit comprises two plasma torches, a cyclone and extended reformulating chamber. The two plasma torches are positioned in the throat of the cyclone prior to particulate removal.

The plasma torches of the gas reformulating unit are transferred arc torches, generally in the range of 100 kw-1 MW depending on the size of the system. Each plasma torch is mounted on a sliding mechanism that can move the torch into and out of the gas reformulating unit. The torch is sealed to the gas reformulating unit by means of a sealing gland. This gland is sealed against a gate valve, which is, in turn, mounted on and sealed to the vessel. To remove a torch, it is pulled out of the reformulating chamber by the slide mechanism. Initial movement of the slide disables the high voltage torch power supply for safety purposes. The gate valve shuts automatically when the torch has retracted past the valve and the coolant circulation is stopped. The hoses and cable are disconnected from the torch, the gland is released from the gate valve and the torch is lifted away by a hoist.

Replacement of a torch is done using the reverse of the above procedure; the slide mechanism can be adjusted to permit variation of the insertion depth of the torch. The gate valve is operated mechanically so that operation is automatic. A pneumatic actuator is used to automatically withdraw the torch in the event of cooling system failure. Compressed air for operating the actuator is supplied from a dedicated air reservoir so that power is always available even in the event of electrical power failure. The same air reservoir provides the air for the gate valve. An electrically interlocked cover is used a further safety feature by preventing access to the high voltage torch connections.

### Example 2

### Start Slag Pour Procedure

### Beginning of Operation and/or after Plugging

Normally a temperature differential of 100° C. over the melting temperature will be adequate to initiate the pour automatically (can be lower once flow starts). With reference to the FIG. 87, the following procedure is for abnormal or upset conditions:
i) Place Metal Tray with Fireblanket under opening.
ii) Open Packing Plug using Double Hinged System. Remove Support Block with Tongs and plane on Tray. Place Lance Guide on edge of Plug Entrance (bottom of guide slit). Lance Weir & frozen slag in Zone A until pour starts.
iii) Determine if Melting unit B, is entirely fluid (will self-empty after step 6). If Zone B has frozen slag—use the bent lance and lance out any slag at the top of and behind the weir.
iv) Remove Lance and Lance Guides and place on tray.
v) Using Plastic Refractory on a skewer plug lance hole at the bottom of the weir. If Slag does not flow over weir repeat steps 4-9.
vi) If that does not work, remove old weir with weir tongs and replace with new weir.
vii) Replace Support Block
viii) Close Packing Plug.

### Example 3

This example provides one embodiment of the Carbon Conversion System and process used to convert municipal solid waste (MSW) to:
1) an energetic syngas, which is subsequently cleaned and cooled to become fuel for internal combustion engine generators; and
2) bottom ash, from which carbon is extracted and which is vitrified to an essentially non-leachable aggregate.

The unit processes involved include material preparation, conversion of MSW to energetic syngas and aggregate, and cleaning and cooling of the syngas so that it is suitable for fueling internal combustion engines.

### Material Preparation

MSW is received directly from garbage trucks. It is not sorted, except for removing white goods, mattresses, propane bottles, and other items that are either hazardous or have little energetic potential. In this embodiment, the Conversion System can treat MSW of 11000 MJ/tonne or more, with a moisture content of 25%-45%.

Material preparation consists of two-pass shredding to reduce the material to a size of 2″ minus. This is followed by ferrous metal separation using commercially available magnetic separators. If warranted by the waste content and economics, nonferrous materials may be removed by commercial eddy-current separators, while inorganics and plastics may be removed with vibrating screens, an air knife, or other mechanical means.

Sorted and sized MSW is kept in sufficient quantity in the feed preparation area to ensure a steady supply of material to the conversion process, while limiting the quantity of material to that specified by the environmental permit. The inventory of prepared material is mixed regularly in order to average out the composition of the material and facilitate process control.

The material preparation area is kept under negative air pressure to avoid the buildup of odors.

### Conversion of MSW to Energetic Syngas and Aggregate

### MSW Feeding

Prepared MSW is conveyed from the material preparation area to a feeding device whose function is to provide a metered supply of MSW to the Carbon Conversion System while maintaining an airtight seal. The Carbon Conversion System feeding device consists of a reciprocating hydraulic ram that pushes MSW into the primary processing unit through a small enough passage to ensure a good seal. The ram is triangular in cross-section, and incorporates a shearing device to resist bridging, even in the presence of stringy or sticky materials.

The Carbon Conversion System is separated into several sub-processes as follows:

### Initial Drying and Volatilization

This is achieved in a primary processing unit at temperatures up to 800° C. using preheated air. The preheated air is blown under the MSW through small holes in a reciprocating horizontal grate that is divided into multiple cascaded sections. The quantity of air is controlled so that limited oxidation occurs under the MSW pile, and the atmosphere above the pile is substoichiometric. Process temperatures, feed rates, pile height, air flow volume, air temperature, number, location, and diameter of discharge holes all influence the process. The horizontal grate sections are driven hydraulically using a rack and pinion system, with independent controls provided for each section.

As the MSW is dried and volatilized in the primary processing unit, it gives off raw syngas, and is converted to a char/ash mixture. The oxygen-starved environment prevents the formation of dioxins and furans, a common problem with incinerators. Cooling of the horizontal grate is done using preheated process air. Because the cooling air is at nearly 600° C., the design of the grate is uniquely configured to minimize distortion. Individual grate sections are modular, in order to minimize the time required for maintenance.

### Carbon Recovery

Bottom ash from the primary processing unit is conveyed by the bottom grate to the end of the primary processing unit, where it drops into a secondary processing unit. The ash builds in a vertical pile on a cooled refractory barrier between the secondary processing unit and the melting unit. Preheated air at approximately 600° C. is blown from near the bottom of the pile and travels upwards through it. The reaction with carbon is exothermic, heating the ash to its melting point (1200-1400° C.), while generating carbon monoxide gas. The pile height, diameter, air flows, temperatures, air nozzle number, size, and location influence performance. By the time the ash gets to the bottom of the barrier, it is depleted of carbon and has melted.

The melted ash flows by gravity from the bottom of the pile through holes in the water-cooled refractory barrier that separate the secondary processing unit from the melting unit. Carbon monoxide gas exits the top of the secondary processing unit into the primary processing unit at about 800° C.

### Solid Residue Vitrification

Melted ash from the secondary processing unit is maintained at superheat in the melting unit using bulk heat from fuel gas and a high temperature plasma plume that is directed on the melt pool. The melting unit geometry is designed to minimize erosion of the refractory, while the bottom and tide line are actively water cooled with embedded copper blocks. The molten ash is tapped from the side of the melting unit and pours out in an amorphous structure that is essentially nonleachable, and is suitable for construction aggregate. The taphole serves as a pressure boundary to separate the melting unit from the outside.

The melted ash may be fractured into small particles by overquenching it with high pressure water jets, or it may be air cooled, followed by mechanical crushing and sizing.

### Syngas Reformulating

Syngas generated in the primary processing unit and the secondary processing unit is heated at the entrance to a reformulating zone using directed turbulent air jets to cause starved combustion. From there, the heated syngas passes through the plumes of two plasma torches. The torches serve to further heat the syngas to nearly 1100° C., and to break up long chain hydrocarbons into their component species through the activity of electron-driven chemistry resulting from the active species in the plasma plume. The syngas then moves through a passage exiting the primary processing unit into two chambers in series, namely:
1) A hot gas cyclone used to remove particulate matter, and
2) A hot gas pipe used to convey the syngas to the recuperator vessel.

The volumes of the hot gas cyclone and the hot gas pipe are additive, and allow for sufficient residence time to complete the chemical reactions required to refine the syngas. The hot gas cyclone is of refractory-lined construction and of sufficient size to allow for considerable particle buildup on its walls while maintaining process efficiency. The hot gas pipe has no horizontal sections, in order to prevent buildup of particulate.

Syngas exiting the hot gas pipe consists mostly of nitrogen, carbon monoxide and hydrogen, with much lower amounts of methane and other fuel gases, no oxygen, and very small amounts of tars and particulates.

### Cleaning and Cooling of Syngas

Syngas exits the hot gas pipe at a temperature of approximately 1050° C. It is cooled in an air/gas recuperator and then moves on through a Gas Quality Cleaning Suite (GQCS), where it is further cooled and cleaned. The heat removed from the syngas in the recuperator is used to heat process air for use in the primary processing unit, secondary processing unit, and gas reformulating unit.

The GQCS consists of cooling and cleaning in a venturi scrubber, followed by an HCl scrubber to remove acid gases, an H₂S scrubber to remove hydrogen sulfide, a baghouse for final removal of particulate, and a carbon bed for removal of any remaining tars and heavy metals. Particulate and tars removed from the gases are recycled back to feed the primary processing unit.

Waste water from the scrubbing process is cleaned to surface discharge standards using commercially available technology including an equalization vessel, an air stripper, advanced oxidation, carbon beds, and resin beds.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A Carbon Conversion System for the conversion of a carbonaceous feedstock into a syngas and slag product, the Carbon Conversion System comprising:
(i) a primary processing unit for conversion of carbonaceous feedstock into a primary off-gas and a processed feedstock comprising char, the primary processing unit comprising two or more processing zones, a lateral transfer system, one or more feedstock inputs, wherein the primary processing unit is operatively associated with a heating mechanism for delivering heat to the processing zones;
(ii) a secondary processing unit adapted to receive the processed feedstock comprising char from the primary processing unit and convert the processed feedstock into a solid residue and a secondary off-gas;
(iii) a melting unit operatively associated with the secondary processing unit comprising one or more sources of plasma, the melting unit configured to vitrify the solid residue and optionally generate a melting unit gas;
(iv) a reformulating unit for reformulating off-gas to a syngas in a reformulation zone, the reformulating unit comprising one or more cyclonic separators adapted to reduce particulate load in an input gas, and one or more energy sources configured to provide energy to at least a part of the reformulating unit; and
(v) a control system configured to regulate one or more operating parameters of the Carbon Conversion System.

2. The Carbon Conversion System of claim 1, wherein the lateral transfer system is a moving grate.

3. (canceled)

4. The Carbon Conversion System of claim 1, wherein the one or more cyclonic separators comprises two or more cyclonic separators are arranged in series or in parallel.

5. (canceled)

6. The Carbon Conversion System of claim 4, wherein the primary processing unit further comprises one or more process additive inputs.

7. The Carbon Conversion System of claim 4, wherein the lateral transfer system is a modular lateral transfer system that moves the processed feedstock material through the primary processing unit and supplying process gas.

8. The Carbon Conversion System of claim 7, wherein the secondary processing unit and the melting unit are connected via an inter-zonal region, wherein the inter-zonal region comprises an impediment to limit flow of the processed feedstock between the secondary processing unit and the melting unit.

9. The Carbon Conversion System of claim 8, wherein the impediment is arranged substantially parallel to the longitudinal axis of the inter-zonal region.

10. The Carbon Conversion System of claim 8, wherein the impediment is arranged substantially perpendicular to the longitudinal axis of the inter-zonal region.

11. The Carbon Conversion System of claim 10, wherein the one or more energy sources of the reformulation zone are one or more plasma torches.

12. The Carbon Conversion System of claim 1, wherein the reformulating unit is configured such that the off-gas is subject to reformulation before, after or by the one or more cyclonic separators.

13. The Carbon Conversion System of claim 9, wherein the reformulating unit is configured such that the off-gas enters the one or more cyclonic separators prior to plasma treatment.

14. The Carbon Conversion System of claim 11, wherein the one or more plasma torches are positioned within the one or more cyclonic separator.

15. The Carbon Conversion System of claim 11, wherein the one or more plasma torches are positioned at an inlet throat of the one or more cyclonic separator.

16. The Carbon Conversion System of claim 8, wherein the impediment comprises water cooled copper with refractory lining at a top portion or a bottom portion.

17. The Carbon Conversion System of claim 1, further comprising a recuperator or heat exchanger operatively associated with the reformulating unit.

18. The Carbon Conversion System of claim 1, wherein the reformulating unit comprises a catalyst.
